(19) United States
(12) Patent Application Publication
(10) Pub. No.: US 2010/0223944 A1
(43) Pub. Date: Sep. 9, 2010

(54) REFRIGERATOR

(75) Inventors: Kahoru Tsujimoto, Shiga (JP); Toyoshi Kamisako, Shiga (JP); Yoshihiro Ueda, Nara (JP); Tadashi Adachi, Shiga (JP); Kazuya Nakanishi, Shiga (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/682,169

(22) PCT Filed: Oct. 8, 2008
(86) PCT No.: PCT/JP2008/002837

§ 371 Date: Apr. 8, 2010

(30) Foreign Application Priority Data
Oct. 9, 2007 (JP) 2007-263116
Nov. 6, 2007 (JP) 2007-288370
Dec. 7, 2007 (JP) 2007-316912
Jan. 25, 2008 (JP) 2008-014625
Jan. 30, 2008 (JP) 2008-018701
Mar. 14, 2008 (JP) 2008-065408
Mar. 31, 2008 (JP) 2008-091155

(51) Int. Cl. F25D 27/00; B05B 5/025; F28D 5/00

(52) U.S. Cl. 62/264; 239/690; 62/304

(57) ABSTRACT

To provide a refrigerator including: a heat-insulating main body; a storage compartment defined in the heat-insulating main body; and a mist spray apparatus that sprays a fine mist into the storage compartment. The fine mist generated by the mist spray apparatus has a nano-size particle diameter and reduces microorganisms adhering to the inside of the storage compartment and to vegetable surfaces, the microorganisms including molds, bacteria, yeasts, and viruses.

### TECHNICAL FIELD

The present invention relates to a refrigerator having an atomization apparatus installed in a storage compartment space for storing vegetables and the like.

### BACKGROUND ART

Influential factors in a decrease in freshness of vegetables include temperature, humidity, environmental gas, microorganisms, light, and so on. Vegetables are living things on surfaces of which respiration and transpiration are performed. To maintain freshness, such respiration and transpiration need to be suppressed. Except some vegetables that suffer from low temperature damage, many vegetables can be prevented from respiration by a low temperature and prevented from transpiration by a high humidity. In recent years, household refrigerators are provided with a sealed vegetable container for the purpose of vegetable preservation, where vegetables are cooled at a proper temperature and also control is exercised to suppress transpiration of the vegetables by, for example, creating a high humidity state inside the container. One such means for creating a high humidity state inside the container is mist spray.

Conventionally, in a refrigerator having this type of mist spray function, an ultrasonic atomization apparatus generates and sprays a mist to humidify the inside of a vegetable compartment when the inside of the vegetable compartment is at a low humidity, thereby suppressing transpiration of vegetables (for example, see Patent Reference 1).

FIG. 84 shows the conventional refrigerator including the ultrasonic atomization apparatus described in Patent Reference 1. FIG. 85 is an enlarged perspective view showing a relevant part of the ultrasonic atomization apparatus shown in FIG. 84.

As shown in the drawing, a vegetable compartment 21 is provided at a lower part of a main body case 26 of a refrigerator main body 20, and has a front opening closed by a drawer door 22 that can be slid in and out. The vegetable compartment 21 is separated from a refrigerator compartment (not shown) located above, by a partition plate 2.

A fixed hanger 23 is fixed to an inner surface of the drawer door 22, and a vegetable container 1 for storing foods such as vegetables is mounted on the fixed hanger 23. An upper opening of the vegetable container 1 is sealed by a lid 3. A thawing compartment 4 is provided inside the vegetable container 1, and an ultrasonic atomization apparatus 5 is included in the thawing compartment 4.

As shown in FIG. 85, the ultrasonic atomization apparatus 5 includes a mist blowing port 6, a water storage tank 7, a humidity sensor 8, and a hose receptacle 9. The water storage tank 7 is connected to a defrost water hose 10 by the hose receptacle 9. A purifying filter 11 for purifying defrost water is equipped in a part of the defrost water hose 10.

An operation of the refrigerator having the above-mentioned structure is described below.

Air cooled by a heat exchange cooler (not shown) flows along outer surfaces of the vegetable container 1 and the lid 3, as a result of which the vegetable container 1 and the foods stored in the vegetable container 1 are cooled. Moreover, defrost water generated from the cooler during refrigerator operation is purified by the purifying filter 11 when passing through the defrost water hose 10, and supplied to the water storage tank 7 in the ultrasonic atomization apparatus 5.

Next, when the humidity sensor 8 detects an inside humidity to be less than 90%, the ultrasonic atomization apparatus 5 starts humidification, allowing for an adjustment to a proper humidity for freshly preserving vegetables and the like in the vegetable container 1.

When the humidity sensor 8 detects the inside humidity to be equal to or more than 90%, the ultrasonic atomization apparatus 5 stops excessive humidification. Thus, the inside of the vegetable compartment can be humidified speedily by the ultrasonic atomization apparatus 5, with it being possible to constantly maintain a high humidity in the vegetable compartment. This suppresses transpiration of vegetables and the like, so that the vegetables and the like can be kept fresh.

There is also a refrigerator that includes an ozone water mist apparatus (for example, see Patent Reference 2). As a humidification means having a microbial elimination effect in addition to a humidification effect, ozone water is generated by mixing water and ozone gas that is produced by decomposing oxygen in the air by an ozone generator of a discharge type or an ultraviolet type, and a mist of ozone water is sprayed by an ultrasonic spray method.

FIG. 86 shows the conventional refrigerator including the ozone water mist apparatus described in Patent Reference 2. As shown in FIG. 86, an ozone generator 71, an exhaust port 72, a water supply path directly connected to tap water, and an ozone water supply path are provided near a vegetable compartment 70, with the ozone water supply path being led to the vegetable compartment 70. The ozone generator 71 is connected to the water supply unit directly connected to tap water, and the exhaust port 72 is connected to the ozone water supply path. The water supply path includes an on-off valve V4, whereas the ozone water supply path includes an on-off valve V5. An ultrasonic element 73 is included in the vegetable compartment 70.

An operation of the refrigerator having the above-mentioned structure is described below.

In the refrigerator that performs cooling by forced circulation of cool air, the vegetable compartment 70 sealed as a high humidity storage compartment is cooled at about 5° C. with a humidity of 80% or more, by indirect cooling from its periphery. The ozone generator 71 is capable of generating ozone by applying an AC voltage of 5 kV to 25 kV according to a silent discharge method. The generated ozone is brought into contact with water to obtain ozone water as treated water. At this time, ozone that has not dissolved in water is exhausted from the exhaust port 72. This ozone is detoxified by a honeycomb ozone decomposition catalyst installed in the exhaust port 72. The generated ozone water is then guided to the vegetable compartment 70 in the refrigerator. The guided ozone water is atomized by the ultrasonic vibrator 73 and sprayed in the vegetable compartment 70. The sprayed ozone water kills bacteria adhering to foods and discourages bacterial growth. This enables food decay to be retarded.

Furthermore, though not shown, there is a technique whereby freshness of foods is preserved by combining a negative ion generation apparatus, a centrifugal force and Coriolis force generation apparatus, and a gas-liquid separation apparatus (for example, see Patent Reference 3).

The centrifugal force and Coriolis force generation apparatus is a mechanism for performing an ion dissociation process, a liquid droplet activation process, and a gas molecule ionization process, and generates water molecule addition negative ions in the air. The gas-liquid separation apparatus separates the air containing the negative ions from liquid droplets and supplies it to a storage compartment. The storage compartment is maintained at a temperature equal to or less than a normal temperature and a humidity equal to or more than 80%, where an atmosphere of negative ion containing air with at least 1000 negative ions per cc is formed to preserve foods.

By filling the storage compartment with this high humidity air, the storage compartment can be maintained in a highly clean and also sterile state, and the effects of preserving freshness of foods and reviving animals and plants can be achieved through microbial elimination and deodorization by the negative ions contained in the air.

In addition, there is another humidification method (for example, see Patent Reference 4).

FIG. 87 is a side sectional view of a conventional refrigerator described in Patent Reference 4, and FIG. 88 is a relevant part enlarged sectional view of a humidifier in the refrigerator shown in FIG. 87.

In FIG. 87, a refrigerator 51 includes a refrigerator compartment 52 (one of the refrigeration temperature zone compartments), a pivoted door 53 of the refrigerator compartment 52, a vegetable compartment 54 (one of the refrigeration temperature zone compartments), a drawer door 55, a freezer compartment 56, and a drawer door 57. A partition plate 58 separates the refrigerator compartment 52 and the vegetable compartment 54 from each other. Cool air from the refrigerator compartment 52 flows into the vegetable compartment 54 via a hole 59. A vegetable container 60 is pulled out together with the drawer door 55.

A vegetable container lid 61 is fixed to a refrigerator main body. The vegetable container lid 61 covers the vegetable container 60 when the drawer door 55 is closed. An ultrasonic humidification apparatus 62 transpires water into the vegetable container 60. A cooler 63 is a refrigeration temperature zone compartment cooler, and cools the refrigerator compartment 52 and the vegetable compartment 54.

Though not shown, the refrigerator 51 also includes a freezing temperature zone compartment cooler that cools the freezer compartment 56. A cool air circulation fan 64 for the freezing temperature zone compartment operates to cause the cool air from the cooler 63 to circulate in the refrigerator compartment 52 and the vegetable compartment 54. The ultrasonic humidification apparatus 62 is provided in a hole 65 of the vegetable container lid 61, and composed of an absorbent member 66 and an ultrasonic oscillator 67.

An operation of the refrigerator having the above-mentioned structure is described below.

When the refrigerator compartment 52 and the vegetable compartment 54 increase in temperature, a refrigerant flows into the cooler 63 and the cool air circulation fan 64 is driven. As a result, ambient cool air of the cooler 63 passes through the refrigerator compartment 52, the hole 59, and the vegetable compartment 54 and then returns to the cooler 63, as indicated by arrows in FIG. 87. Thus, the refrigerator compartment 52 and the vegetable compartment 54 are cooled. This state is referred to as a cooling mode.

Once the refrigerator compartment 52 and the vegetable compartment 54 have been roughly cooled, the supply of the refrigerant to the cooler 63 is stopped. Meanwhile, the cool air circulation fan 64 continues its operation. Hence, frost adhering to the cooler 63 melts down and as a result the refrigerator compartment 52 and the vegetable compartment 54 are humidified. This state is referred to as a humidification mode (the so-called “moisture operation”).

After the humidification mode is continued for a predetermined time period (several minutes), the cool air circulation fan 64 is stopped to switch to an operation stop mode. Subsequently, when the refrigerator compartment 52 and the vegetable compartment 54 increase in temperature, the refrigerator 51 enters the cooling mode again.

The ultrasonic humidification apparatus 62 shown in FIG. 88 is described next.

The absorbent member 66 is made of a water-absorbing material such as silica gel, zeolite, and activated carbon. Accordingly, the absorbent member 66 adsorbs water in the flowing air in the above-mentioned humidification mode. In the latter part of the cooling mode, the ultrasonic oscillator 67 is driven. This causes the water in the absorbent member 66 to be discharged outwardly and the inside of the vegetable container to be humidified. Note that the driving of the ultrasonic oscillator 67 in the latter part of the cooling mode is intended to prevent the vegetable compartment 54 from drying due to a decrease in humidity.

As described above, the ultrasonic humidification apparatus 62 includes the absorbent member 66 and the ultrasonic oscillator 67 for vibrating the absorbent member 66. This makes it unnecessary to provide a water tank and a water supply pipe for humidification.

Moreover, in the refrigerator having the humidification mode, the ultrasonic humidification apparatus 62 is operated other than during the humidification mode. Hence, a fluctuation in humidity in the storage compartment can be suppressed.

In addition, in the refrigerator that is cooled by flowing the refrigerant into the cooler 63 and operating the cool air circulation fan 64, the ultrasonic humidification apparatus 62 is operated at the time of this cooling. Thus, the humidification is performed at the time of cooling during which drying tends to occur, so that a fluctuation in humidity in the storage compartment can be suppressed.

Furthermore, the ultrasonic humidification apparatus 62 includes the absorbent member 66 and the ultrasonic oscillator 67, where the absorbent member 66 absorbs water in the air above the vegetable container lid 61, and the ultrasonic oscillator 67 vibrates the absorbent member 66 to emit the water contained in the absorbent member 66 into the vegetable container 60. This allows the inside of the vegetable container 60 to be humidified.

However, the refrigerators of the conventional structures described above have the following problem. In the method of atomizing water or ozone water by an ultrasonic vibrator, atomized water particles or ozone water particles cannot be finely produced and so cannot be uniformly sprayed in the storage compartment.

The conventional structures also have the following problem. In the method of generating ozone water by adding fine bubbles of ozone gas to water to thereby dissolve ozone, most of generated ozone gas cannot be sufficiently dissolved in water. For users, this causes residual ozone gas of an ozone concentration level that poses a danger to human bodies. To reduce the residual gas to such a low concentration level that is safe for human bodies and also has no ozone odor, an ozone decomposition unit needs to be provided, which requires a complex structure.

The conventional structures also have the following problem. Though a mist is sprayed in order to increase the humidity of the storage compartment in the refrigerator, this is intended only for moisture retention of vegetables, and there is neither description nor suggestion about suppression of low temperature damage in addition to moisture retention of vegetables.

Moreover, a mechanism of ionizing liquid droplets in the storage compartment is extremely large and is not suitable for use in household refrigerators. Furthermore, simple ionization merely produces low oxidative power of liquid droplets, and therefore the mechanism has a relatively insignificant advantage.

### PRIOR ART REFERENCES

### Patent References

Patent Reference 1: Japanese Unexamined Patent Application Publication No. 6-257933

Patent Reference 2: Japanese Unexamined Patent Application Publication No. 2000-220949

Patent Reference 3: Japanese Unexamined Patent Application Publication No. 7-135945

Patent Reference 4: Japanese Unexamined Patent Application Publication No. 2004-125179

### DISCLOSURE OF INVENTION

A refrigerator according to the present invention includes: a heat-insulating main body; a storage compartment defined in the heat-insulating main body; and a mist spray apparatus that sprays a fine mist into the storage compartment, wherein the fine mist generated by the mist spray apparatus has a nano-size particle diameter and reduces microorganisms adhering to inside of the storage compartment and to vegetable surfaces, the microorganisms including molds, bacteria, yeasts, and viruses.

Such a refrigerator generates a nano-size mist and sprays the mist directly to foods in a container, as a result of which the mist can be uniformly sprayed into the storage compartment. In addition, it is possible to eliminate and inhibit the growth of microorganisms such as molds, bacteria, yeasts, and viruses adhering to surfaces of vegetables and fruits and to surfaces of a storage compartment case, and also maintain a high humidity state and improve freshness preservation.

Moreover, a refrigerator according to the present invention includes: a heat-insulated storage compartment; an atomization unit that sprays a mist into the storage compartment; and an atomization tip included in the atomization unit, the mist being sprayed from the atomization tip, wherein the atomization unit generates the mist that adheres to vegetables and fruits stored in the storage compartment to suppress low temperature damage.

Such a refrigerator sprays mist particles into the storage compartment from the atomization tip, as a result of which the mist can be uniformly sprayed into the storage compartment. In addition, freshness preservation in a low temperature environment can be improved by suppression of low temperature damage as well as moisture retention of vegetables.

### BRIEF DESCRIPTION OF DRAWINGS

FIG. 1 is a longitudinal sectional view showing a section when a refrigerator in a first embodiment of the present invention is cut into left and right.

FIG. 2 is a relevant part front view showing a back surface of a vegetable compartment in the refrigerator in the first embodiment of the present invention.

FIG. 3 is a sectional view of an electrostatic atomization apparatus and its periphery included in the vegetable compartment in the refrigerator in the first embodiment of the present invention, as taken along line A-A in FIG. 2 and seen from an arrow direction.

FIG. 4 is a sectional view of an electrostatic atomization apparatus and its periphery included in a vegetable compartment in a refrigerator in a second embodiment of the present invention, as taken along line A-A in FIG. 2 and seen from the arrow direction.

FIG. 5 is a relevant part longitudinal sectional view showing a section when a door-side peripheral part of a partition wall above a vegetable compartment in a refrigerator in a third embodiment of the present invention is cut into left and right.

FIG. 6 is a sectional view of an electrostatic atomization apparatus and its periphery included in a vegetable compartment in a refrigerator in a fourth embodiment of the present invention, as taken along line A-A in FIG. 2 and seen from the arrow direction.

FIG. 7 is a sectional view of an electrostatic atomization apparatus and its periphery included in a vegetable compartment in a refrigerator in a fifth embodiment of the present invention, as taken along line A-A in FIG. 2 and seen from the arrow direction.

FIG. 8 is a sectional view of an electrostatic atomization apparatus and its periphery included in a vegetable compartment in a refrigerator in a sixth embodiment of the present invention, as taken along line A-A in FIG. 2 and seen from the arrow direction.

FIG. 9 is a relevant part longitudinal sectional view showing a section when a vegetable compartment and a periphery of a partition wall above the vegetable compartment in a refrigerator in a seventh embodiment of the present invention are cut into left and right.

FIG. 10 is a sectional view of the refrigerator in the seventh embodiment of the present invention, as taken along line B-B in FIG. 9 and seen from an arrow direction.

FIG. 11 is a sectional view of the partition wall above the vegetable compartment in the refrigerator in the seventh embodiment of the present invention, as taken along line C-C in FIG. 10 and seen from an arrow direction.

FIG. 12 is a detailed sectional view of an ultrasonic atomization apparatus and its periphery in a refrigerator in an eighth embodiment of the present invention.

FIG. 13 is a sectional view of an electrostatic atomization apparatus and its periphery included in a vegetable compartment in a refrigerator in a ninth embodiment of the present invention, as taken along line A-A in FIG. 2 and seen from the arrow direction.

FIG. 14 is a sectional view of an electrostatic atomization apparatus and its periphery included in a vegetable compartment in a refrigerator in a tenth embodiment of the present invention, as taken along line A-A in FIG. 2 and seen from the arrow direction.

FIG. 15 is a sectional view of a vegetable compartment and its vicinity in a refrigerator in an eleventh embodiment of the present invention.

FIG. 16 is a sectional view of a vegetable compartment and its vicinity in a refrigerator of another form in the eleventh embodiment of the present invention.

FIG. 17 is a detailed plan view of an electrostatic atomization apparatus and its vicinity taken along line D-D in FIG. 16.

FIG. 18 is a sectional view of a vegetable compartment and its vicinity in a refrigerator in a twelfth embodiment of the present invention.

FIG. 19 is a longitudinal sectional view showing a section when a refrigerator in a thirteenth embodiment of the present invention is cut into left and right.

FIG. 20 is a schematic view of a cooling cycle in the refrigerator in the thirteenth embodiment of the present invention.

FIG. 21 is a sectional view of an electrostatic atomization apparatus and its periphery included in a vegetable compartment in the refrigerator in the thirteenth embodiment of the present invention.

FIG. 22A is a sectional view of a vegetable compartment and its periphery in a refrigerator in a fourteenth embodiment of the present invention.

FIG. 22B is a sectional view of an electrostatic atomization apparatus and its periphery included in the vegetable compartment in the refrigerator in the fourteenth embodiment of the present invention.

FIG. 23 is a sectional view of a vegetable compartment and its periphery in a refrigerator in a fifteenth embodiment of the present invention.

FIG. 24 is a sectional view of a vegetable compartment and its vicinity in a refrigerator in a sixteenth embodiment of the present invention.

FIG. 25 is a partial cutaway perspective view showing an indoor unit of an air conditioner using an electrostatic atomization apparatus in a seventeenth embodiment of the present invention.

FIG. 26 is a sectional structural view of the air conditioner shown in FIG. 25.

FIG. 27 is a longitudinal sectional view of a refrigerator in an eighteenth embodiment of the present invention.

FIG. 28 is a front view of a refrigerator compartment and its vicinity in the refrigerator in the eighteenth embodiment of the present invention.

FIG. 29 is a detailed sectional view of an electrostatic atomization apparatus and its vicinity taken along line E-E in FIG. 28.

FIG. 30 is an example of a functional block diagram of the refrigerator in the eighteenth embodiment of the present invention.

FIG. 31 is an example of a flowchart of a control flow in the refrigerator in the eighteenth embodiment of the present invention.

FIG. 32 is a detailed sectional view of an electrostatic atomization apparatus and its vicinity in a nineteenth embodiment of the present invention taken along line E-E in FIG. 28.

FIG. 33 is a detailed sectional view of an electrostatic atomization apparatus and its vicinity in a twentieth embodiment of the present invention taken along line E-E in FIG. 28.

FIG. 34 is a detailed sectional view of an electrostatic atomization apparatus and its vicinity in a twenty-first embodiment of the present invention taken along line E-E in FIG. 28.

FIG. 35 is a detailed sectional view of an electrostatic atomization apparatus and its vicinity in a twenty-second embodiment of the present invention taken along line E-E in FIG. 28.

FIG. 36 is a longitudinal sectional view of a refrigerator in a twenty-third embodiment of the present invention.

FIG. 37 is a detailed sectional view of an electrostatic atomization apparatus and its vicinity in the refrigerator in the twenty-third embodiment of the present invention taken along line E-E in FIG. 28.

FIG. 38 is a detailed sectional view of an electrostatic atomization apparatus and its vicinity in a twenty-fourth embodiment of the present invention taken along line E-E in FIG. 28.

FIG. 39 is a detailed sectional view of an electrostatic atomization apparatus and its vicinity in a twenty-fifth embodiment of the present invention taken along line E-E in FIG. 28.

FIG. 40 is a longitudinal sectional view of a refrigerator in a twenty-sixth embodiment of the present invention.

FIG. 41 is a relevant part enlarged sectional view of a vegetable compartment in the refrigerator in the twenty-sixth embodiment of the present invention.

FIG. 42 is a block diagram showing a control structure related to an electrostatic atomization apparatus in the refrigerator in the twenty-sixth embodiment of the present invention.

FIG. 43 is a characteristic chart showing a relation between a particle diameter and a particle number of a mist generated by a spray unit in the refrigerator in the twenty-sixth embodiment of the present invention.

FIG. 44A is a characteristic chart showing a relation between a discharge current value and an ozone generation concentration in an ozone amount determination unit of the electrostatic atomization apparatus in the refrigerator in the twenty-sixth embodiment of the present invention.

FIG. 44B is a characteristic chart showing a relation between an atomization amount and each of an ozone concentration and a discharge current value in the electrostatic atomization apparatus in the refrigerator in the twenty-sixth embodiment of the present invention.

FIG. 45A is a characteristic chart showing a water content recovery effect for a wilting vegetable in the refrigerator in the twenty-sixth embodiment of the present invention.

FIG. 45B is a characteristic chart showing a change in vitamin C in the refrigerator in the twenty-sixth embodiment of the present invention, as compared with a conventional example.

FIG. 45C is a characteristic chart showing agricultural chemical removal performance of the electrostatic atomization apparatus in the refrigerator in the twenty-sixth embodiment of the present invention.

FIG. 45D is a characteristic chart showing microbial elimination performance of the electrostatic atomization apparatus in the refrigerator in the twenty-sixth embodiment of the present invention.

FIG. 46 is a relevant part enlarged sectional view of a vegetable compartment in a refrigerator in a twenty-seventh embodiment of the present invention.

FIG. 47 is a block diagram showing a control structure related to an electrostatic atomization apparatus in the refrigerator in the twenty-seventh embodiment of the present invention.

FIG. 48 is a relevant part enlarged sectional view of a refrigerator in a twenty-eighth embodiment of the present invention.

FIG. 49 is a block diagram showing a control structure related to an electrostatic atomization apparatus in the refrigerator in the twenty-eighth embodiment of the present invention.

FIG. 50 is a relevant part enlarged sectional view of a refrigerator in a twenty-ninth embodiment of the present invention.

FIG. 51 is a side sectional view of a refrigerator in a thirtieth embodiment of the present invention.

FIG. 52 is a sectional view of a water collection unit and its vicinity in the refrigerator in the thirtieth embodiment of the present invention.

FIG. 53 is a sectional view taken along line F-F in FIG. 52.

FIG. 54 is a chart showing vegetable preservability and an ozone concentration in the refrigerator in the thirtieth embodiment of the present invention.

FIG. 55 is a chart showing vegetable preservability and a radical amount in the refrigerator in the thirtieth embodiment of the present invention.

FIG. 56 is a side sectional view of a refrigerator in a thirty-first embodiment of the present invention.

FIG. 57 is a longitudinal sectional view of a water collection unit and its vicinity in the refrigerator in the thirty-first embodiment of the present invention.

FIG. 58 is a front view of the water collection unit and its vicinity in the refrigerator in the thirty-first embodiment of the present invention.

FIG. 59 is a front view of the water collection unit and its vicinity in the refrigerator in the thirty-first embodiment of the present invention.

FIG. 60 is a functional block diagram of the refrigerator in the thirty-first embodiment of the present invention.

FIG. 61 is a microbial elimination image diagram of the refrigerator in the thirty-first embodiment of the present invention.

FIG. 62 is a chart showing a bacteria elimination effect in a box assumed to be the refrigerator in the thirty-first embodiment of the present invention.

FIG. 63 is a mold suppression image diagram of the refrigerator in the thirty-first embodiment of the present invention.

FIG. 64 is a chart showing a mold elimination effect in a box assumed to be the refrigerator in the thirty-first embodiment of the present invention.

FIG. 65 is an antivirus image diagram of the refrigerator in the thirty-first embodiment of the present invention.

FIG. 66 is a chart showing an antiviral effect in a box assumed to be the refrigerator in the thirty-first embodiment of the present invention.

FIG. 67 is a longitudinal sectional view of a water collection unit and its vicinity in a refrigerator in a thirty-second embodiment of the present invention.

FIG. 68 is a functional block diagram of the refrigerator in the thirty-second embodiment of the present invention.

FIG. 69 is a longitudinal sectional view of a refrigerator in a thirty-third embodiment of the present invention.

FIG. 70A is a front view of a vegetable compartment and its vicinity in the refrigerator in the thirty-third embodiment of the present invention.

FIG. 70B is a front view of another form of the vegetable compartment and its vicinity in the refrigerator in the thirty-third embodiment of the present invention.

FIG. 71A is a sectional view of the vegetable compartment and its vicinity in the refrigerator in the thirty-third embodiment of the present invention.

FIG. 71B is a side view of the vegetable compartment in the refrigerator in the thirty-third embodiment of the present invention.

FIG. 71C is an enlarged view of an I part in FIG. 71B.

FIG. 71D is a perspective view of the vegetable compartment in the refrigerator in the thirty-third embodiment of the present invention, as seen from its front.

FIG. 72A is a detailed sectional view of an electrostatic atomization apparatus and its vicinity in the refrigerator in the thirty-third embodiment of the present invention, as taken along line G-G in FIG. 70A.

FIG. 72B is a detailed sectional view of another form of the electrostatic atomization apparatus and its vicinity in the refrigerator in the thirty-third embodiment of the present invention, as taken along line G-G in FIG. 70A.

FIG. 73 is a chart showing an experimental result of a discharge current monitor voltage value indicating an atomization state and a temperature behavior of an atomization electrode in the refrigerator in the thirty-third embodiment of the present invention.

FIG. 74 is a photographic comparison view of an experimental result using bananas in the refrigerator in the thirty-third embodiment of the present invention.

FIG. 75A is a photographic comparison view of an experimental result using carrots in the refrigerator in the thirty-third embodiment of the present invention.

FIG. 75B is a photographic comparison view of an experimental result using shiitake mushrooms in the refrigerator in the thirty-third embodiment of the present invention.

FIG. 75C is a photographic comparison view of an experimental result using eggplants in the refrigerator in the thirty-third embodiment of the present invention.

FIG. 76A is a chart showing potassium ion leakage that indicates a degree of low temperature damage in the refrigerator in the thirty-third embodiment of the present invention.

FIG. 76B is a chart showing potassium ion leakage that indicates a degree of low temperature damage in the refrigerator in the thirty-third embodiment of the present invention.

FIG. 77 is an ethylene gas decomposition capacity chart of the refrigerator in the thirty-third embodiment of the present invention.

FIG. 78 is a view showing an ethylene gas concentration measurement result in a vegetable and fruit preservation environment in the refrigerator in the thirty-third embodiment of the present invention.

FIG. 79A is a chart showing an experimental result of a vitamin C content of broccoli sprouts in the refrigerator in the thirty-third embodiment of the present invention.

FIG. 79B is a chart showing an experimental result of a vitamin A content of mulukhiyas in the refrigerator in the thirty-third embodiment of the present invention.

FIG. 79C is a chart showing an experimental result of a vitamin E content of mulukhiyas in the refrigerator in the thirty-third embodiment of the present invention.

FIG. 79D is a chart showing an experimental result of a vitamin E content of watercresses in the refrigerator in the thirty-third embodiment of the present invention.

FIG. 80 is a sectional view of a vegetable compartment and its vicinity in a refrigerator in a thirty-fourth embodiment of the present invention.

FIG. 81 is a sectional view of a vegetable compartment and its vicinity in a refrigerator of another form in the thirty-fourth embodiment of the present invention.

FIG. 82 is a detailed plan view of an electrostatic atomization apparatus and its vicinity taken along line J-J in FIG. 81.

FIG. 83 is a sectional view of a vegetable compartment and its vicinity in a refrigerator in a thirty-fifth embodiment of the present invention.

FIG. 84 is a view showing a conventional refrigerator including an ultrasonic atomization apparatus.

FIG. 85 is an enlarged perspective view showing a relevant part of the ultrasonic atomization apparatus shown in FIG. 84.

FIG. 86 is a view showing a conventional refrigerator including an ozone water mist apparatus.

FIG. 87 is a side sectional view of a conventional refrigerator.

FIG. 88 is a relevant part enlarged sectional view of a humidifier in the refrigerator shown in FIG. 87.

### NUMERICAL REFERENCES

100, 700, 901, 1101, 1200 Refrigerator
101, 701, 1201 Heat-insulating main body
102, 1202 Outer case
103, 1203 Inner case
104, 704, 1103, 1203 Refrigerator compartment
105, 1104, 1205 Switch compartment
106, 1107, 1206 Ice compartment
107, 907, 1105, 1207 Vegetable compartment
108, 1106, 1208 Freezer compartment
109, 1209 Compressor
110, 1210 Cooling compartment
111, 711, 1211 Back partition wall
111a, 1211a Depression
112, 712, 1212 Cooler
113, 1213 Cooling fan
114, 1214 Radiant heater
115, 1215 Drain pan
116, 1216 Drain tube
117, 1217 Evaporation dish
118, 1218 Door
119, 1219 Lower storage container
120, 1220 Upper storage container
122, 1222 Lid
123, 1223 First partition wall
124, 1224 Vegetable compartment discharge port
125, 1225 Second partition wall
126, 1226 Vegetable compartment suction port
131, 731, 915, 1114, 1231 Electrostatic atomization apparatus (mist spray apparatus)
132, 1232 Spray port
133, 733, 935, 1119, 1233 Voltage application unit
134 Cooling pin (heat transfer cooling member)
134a, 1234a Projection
135, 735, 1235 Atomization electrode
136, 736, 921, 1118, 1236 Counter electrode
137, 1237 External case
138, 1238 Moisture supply port
139, 739, 1239 Atomization unit
140 Refrigerator compartment return air path
141, 1241 Freezer compartment discharge air path
146, 1142, 1246 Control unit
151, 1251 Back partition wall surface
152, 1252 Heat insulator
154, 1124 Heating unit
155, 1255 Heat insulator depression
156, 1256 Low temperature air path
161 Cooling compartment partition wall
162 Heat insulator protrusion
165 Through part
166 Cooling pin cover
167 Opening
171 Heat insulator
172 Freezer compartment side partition plate
173 Vegetable compartment side partition plate
174 Partition wall
176 Mist discharge port
177 Mist air path
178 Heater
181 Vegetable compartment suction air path
182 Vegetable compartment discharge air path
183 Mist suction port
191, 1281 Projection
192, 1282 Hole (spray port)
193, 1283 Moisture supply port
194, 1284 Tape (cool air blocking member)
196, 1286 Void
197a, 197b, 197c, 197d, 1287a, 1287b, 1287c Void filling member (butyl)
200 Horn-type ultrasonic atomization apparatus (mist spray apparatus)
201 Horn unit
202 Electrode
203 Piezoelectric element
204 Electrode
205 Cooling pin
207 External case
208 Horn-type ultrasonic vibrator
209 Spray port
211 Atomization unit
251, 1291, 1301 Partition wall
252, 1302 Vegetable compartment discharge air path
253, 1303 Vegetable compartment suction air path
254, 1304 Air flow hole
255, 1305 Atomization apparatus cooling air path
301 Temperature changing compartment
302 Damper
303 Low temperature side evaporator
304 High temperature side evaporator
305 First partition wall
306 Second partition wall
307 Condenser
308 Three way valve
309 Low temperature side capillary
310 High temperature side capillary
311 Temperature changing compartment side cooling air path
312 Freezer compartment side cooling air path
313 Temperature changing compartment back partition wall
314 Freezer compartment back partition wall
321, 1102 Partition plate
322 Refrigerator compartment fan
323 Refrigerator compartment partition plate
324 Refrigerator compartment air path
325 Temperature changing compartment discharge port
326 Temperature changing compartment suction port
723 Partition wall
724 Refrigerator compartment discharge port
726 Refrigerator compartment suction port
734, 1234 Heat transfer connection member (metal pin)
741, 756, 1109 Air path
750 Heat pipe
754, 1258 Metal pin heater
770 Second cooler
801 Peltier module (Peltier element)
902 Main body
920, 1116 Application electrode
967 Ultrasonic atomization apparatus (first spray unit)
1108 Vegetable container
1110 Storage compartment partition
1111 Atomization unit
1112 Water collection unit
1113 Mist generation unit (mist spray apparatus)
1115 Holder
1117 Water retainer
1120 Main body outer wall
1122 Cooler
1123 Water collection plate
1125 Air blow unit
1126 Circulation air path
1127, 1132 Cover
1128 First circulation air path opening
1129 Second circulation air path opening
1130 Temperature detection unit
1131 Water conveyance unit
1133 Container
1137 Luminous body
1138 Diffusion plate
1139 Inside temperature detection unit
1140 Inside humidity detection unit
1141 Door detection unit
1143 Cooling unit
1254 Partition wall heater
1261 Upper rib
1262 Lower rib
1266 Beverage storage unit
1267 Beverage partition plate
1285 Metal pin cover

### BEST MODE FOR CARRYING OUT THE INVENTION

The following describes embodiments of the present invention with reference to drawings. Note that detailed description is omitted for parts to which same structures or same technical ideas as embodiments described earlier can be applied, and disclosed examples of individual embodiments can be combined for use especially for a structure of a mist spray apparatus, a structure of attaching the mist spray apparatus to a refrigerator, and a functional advantage of the mist spray apparatus according to the present invention. Note also that the present invention is not limited to these embodiments.

### First Embodiment

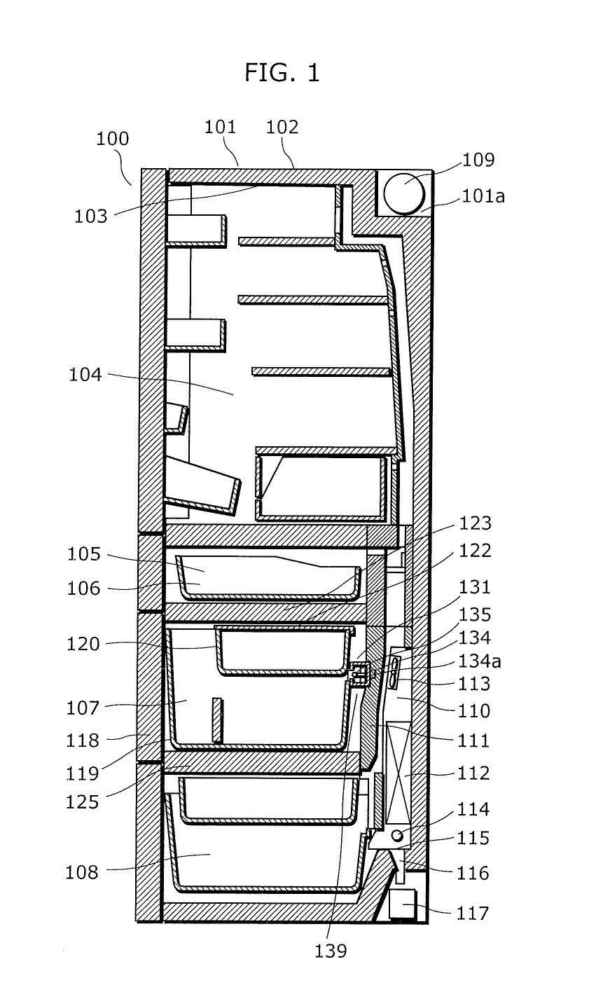

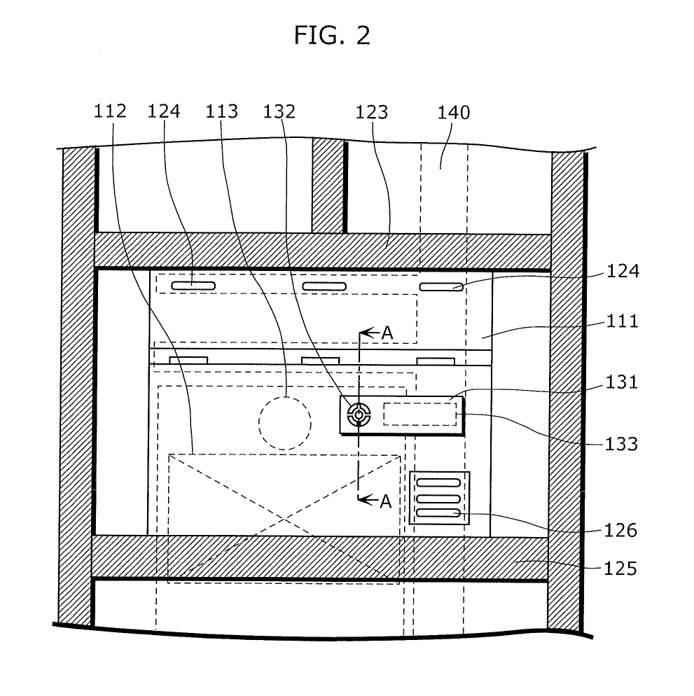

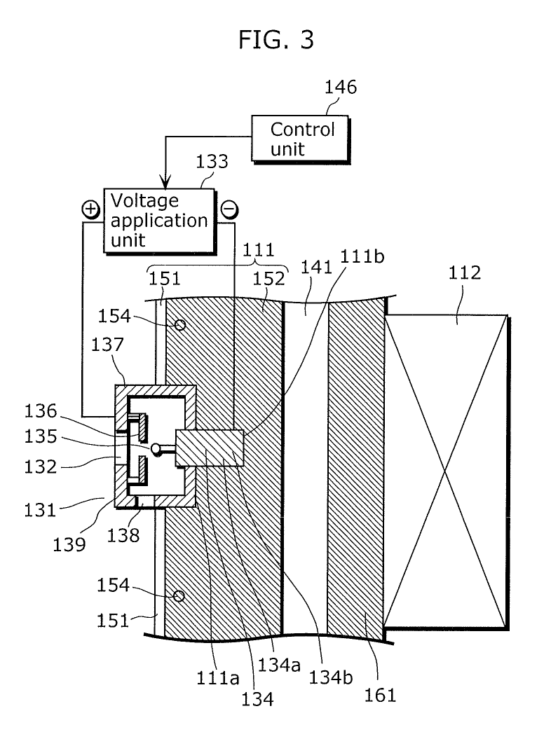

FIG. 1 is a longitudinal sectional view showing a section when a refrigerator in a first embodiment of the present invention is cut into left and right. FIG. 2 is a relevant part front view showing a back surface of a vegetable compartment in the refrigerator. FIG. 3 is a sectional view of an electrostatic atomization apparatus and its periphery included in the vegetable compartment in the refrigerator, as taken along line A-A in FIG. 2 and seen from an arrow direction.

In the drawings, a heat-insulating main body 101 which is a main body of a refrigerator 100 is formed by an outer case 102 mainly composed of a steel plate, an inner case 103 molded with a resin such as ABS, and a foam heat insulation material such as rigid urethane foam charged in a space between the outer case 102 and the inner case 103. The heat-insulating main body 101 is thermally insulated from its surroundings, and the refrigerator 100 is partitioned into a plurality of thermally insulated storage compartments by partition walls. A refrigerator compartment 104 as a first storage compartment is located at the top. A switch compartment 105 as a fourth storage compartment and an ice compartment 106 as a fifth storage compartment are located side by side below the refrigerator compartment 104. A vegetable compartment 107 as a second storage compartment is located below the switch compartment 105 and the ice compartment 106. A freezer compartment 108 as a third storage compartment is located at the bottom.

The refrigerator compartment 104 is typically set to 1° C. to 5° C., with a lower limit being a temperature low enough for refrigerated storage but high enough not to freeze. The vegetable compartment 107 is set to a temperature of 2° C. to 7° C. that is equal to or slightly higher than the temperature of the refrigerator compartment 104. The freezer compartment 108 is set to a freezing temperature zone. The freezer compartment 108 is typically set to −22° C. to −15° C. for frozen storage, but may be set to a lower temperature such as −30° C. and −25° C. for an improvement in frozen storage state.

The switch compartment 105 is capable of switching to not only the refrigeration temperature zone of 1° C. to 5° C., the vegetable temperature zone of 2° C. to 7° C., and the freezing temperature zone of typically −22° C. to −15° C., but also a preset temperature zone between the refrigeration temperature zone and the freezing temperature zone. The switch compartment 105 is a storage compartment with an independent door arranged side by side with the ice compartment 106, and often has a drawer door.

Note that, though the switch compartment 105 is a storage compartment including the refrigeration and freezing temperature zones in this embodiment, the switch compartment 105 may be a storage compartment specialized for switching to only the above-mentioned intermediate temperature zone between the refrigerated storage and the frozen storage, while leaving the refrigerated storage to the refrigerator compartment 104 and the vegetable compartment 107 and the frozen storage to the freezer compartment 108. Alternatively, the switch compartment 105 may be a storage compartment fixed to a specific temperature zone.

The ice compartment 106 makes ice by an automatic ice machine (not shown) disposed in an upper part of the ice compartment 106 using water sent from a water storage tank (not shown) in the refrigerator compartment 104, and stores the ice in an ice storage container (not shown) disposed in a lower part of the ice compartment 106.

A top part of the heat-insulating main body 101 has a depression stepped toward the back of the refrigerator. A machinery compartment 101a is formed in this stepped depression, and high-pressure components of a refrigeration cycle such as a compressor 109 and a dryer (not shown) for water removal are housed in the machinery compartment 101a. That is, the machinery compartment 101a including the compressor 109 is formed cutting into a rear area of an uppermost part of the refrigerator compartment 104.

By forming the machinery compartment 101a to dispose the compressor 109 in the rear area of the uppermost storage compartment in the heat-insulating main body 101 which is hard to reach and so used to be a dead space, a machinery compartment space provided at the bottom of the heat-insulating main body 101 in a conventional refrigerator so as to be easily accessible by users can be effectively converted to a storage compartment capacity. This significantly improves storability and usability.

Note that the matters relating to the relevant part of the present invention described below in this embodiment are also applicable to a conventional type of refrigerator in which the machinery compartment is formed to dispose the compressor 109 in the rear area of the lowermost storage compartment in the heat-insulating main body 101.

A cooling compartment 110 for generating cool air is provided behind the vegetable compartment 107 and the freezer compartment 108 and separated from an air path 141. The air path 141 for conveying cool air to each compartment having heat insulation properties and a back partition wall 111 for heat insulating partition from each storage compartment are formed between the cooling compartment 110 and each of the vegetable compartment 107 and the freezer compartment 108. A partition plate 161 for isolating a freezer compartment discharge air path 141 and the cooling compartment 110 from each other is provided, too. A cooler 112 is disposed in the cooling compartment 110, and a cooling fan 113 for blowing air cooled by the cooler 112 into the refrigerator compartment 104, the switch compartment 105, the ice compartment 106, the vegetable compartment 107, and the freezer compartment 108 by a forced convection method is placed in a space above the cooler 112.

Moreover, a radiant heater 114 made up of a glass tube for defrosting by removing frost or ice adhering to the cooler 112 and its periphery during cooling is provided in a space below the cooler 112. Furthermore, a drain pan 115 for receiving defrost water generated during defrosting and a drain tube 116 passing from a deepest part of the drain pan 115 through to outside the compartment are formed below the radiant heater 114. An evaporation dish 117 is formed outside the compartment downstream of the drain tube 116.

The vegetable compartment 107 includes a lower storage container 119 that is mounted on a frame attached to a drawer door 118 of the vegetable compartment 107, and an upper storage container 120 mounted on the lower storage container 119.

A lid 122 for substantially sealing mainly the upper storage container 120 in a closed state of the drawer door 118 is held by the inner case 103 and a first partition wall 123 above the vegetable compartment 107. In the closed state of the drawer door 118, left, right, and back sides of an upper surface of the upper storage container 120 are in close contact with the lid 122, and a front side of the upper surface of the upper storage container 120 is substantially in close contact with the lid 122. In addition, a boundary between the lower storage container 119 and left, right, and lower sides of a back surface of the upper storage container 120 has a narrow gap so as to prevent moisture in the food storage unit from escaping, in a range of not interfering with the upper storage container 120 during operation.

An air path of cool air discharged from a vegetable compartment discharge port 124 formed in the back partition wall 111 is provided between the lid 122 and the first partition wall 123. Moreover, a space is provided between the lower storage container 119 and a second partition wall 125, thereby forming a cool air path. A vegetable compartment suction port 126 through which cool air, having cooled the inside of the vegetable compartment 107 and undergone heat exchange, returns to the cooler 112 is disposed in a lower part of the back partition wall 111 on the back of the vegetable compartment 107.

Note that the matters relating to the relevant part of the present invention described below in this embodiment are also applicable to a conventional type of refrigerator that is opened and closed by a frame attached to a door and a rail formed on an inner case.

The back partition wall 111 includes a back partition wall surface 151 made of a resin such as ABS, and a heat insulator 152 made of styrene foam or the like for ensuring the heat insulation of the storage compartment by isolating the storage compartment from the air path 141 and the cooling compartment 110. Here, a depression 111a is formed in a part of a storage compartment side wall surface of the back partition wall 111 so as to be lower in temperature than other parts, and an electrostatic atomization apparatus 131 which is a mist spray apparatus is installed in the depression 111a.

The electrostatic atomization apparatus 131 is mainly composed of an atomization unit 139, a voltage application unit 133, and an external case 137. A spray port 132 and a moisture supply port 138 are each formed in a part of the external case 137. An atomization electrode 135 as an atomization tip is placed in the atomization unit 139. The atomization electrode 135 is securely connected to a cooling pin 134 which is a heat transfer cooling member made of a good heat conductive material such as aluminum, stainless steel, or the like.

The atomization electrode 135 placed in the atomization unit 139 is an electrode connection member made of a good heat conductive material such as aluminum, stainless steel, brass, or the like. The atomization electrode 135 is fixed to an approximate center of one end of the cooling pin 134, and also electrically connected including one end wired from the voltage application unit 133.

The cooling pin 134 which is an electrode connection member is, for example, formed as a cylinder of about 10 mm in diameter and about 15 mm in length, and has a large heat capacity 50 times to 1000 times and preferably 100 times to 500 times that of the atomization electrode 135 of about 1 mm in diameter and about 5 mm in length. Thus, the cooling pin 134 has a heat capacity equal to or more than 50 times and preferably equal to or more than 100 times that of the atomization electrode 135. This further alleviates a direct significant influence of a temperature change of the cooling unit on the atomization electrode, with it being possible to spray a mist more stably with a smaller load fluctuation. Moreover, as a heat capacity upper limit, the cooling pin 134 has a heat capacity equal to or less than 1000 times and preferably equal to or less than 500 times that of the atomization electrode 135. When the heat capacity of the cooling pin 134 is excessively high, large energy is required to cool the cooling pin 134, making it difficult to save energy in cooling the cooling pin 134. By restricting the heat capacity within such an upper limit, however, it is possible to cool the atomization electrode stably and energy-efficiently, while alleviating a significant influence on the atomization electrode in the case where a heat load fluctuation from the cooling unit changes. In addition, by restricting the heat capacity within such an upper limit, a time lag required to cool the atomization electrode 135 via the cooling pin 134 can be kept within a proper range. Hence, slow start when cooling the atomization electrode, that is, when supplying water to the atomization apparatus, can be prevented and as a result the atomization electrode can be cooled stably and properly.

Moreover, the cooling pin 134 is preferably made of a high heat conductive material such as aluminum, copper, or the like. To efficiently conduct cold heat from one end to the other end of the cooling pin 134 by heat conduction, it is desirable that the heat insulator 152 covers a circumference of the cooling pin 134.

Furthermore, the heat conduction of the atomization electrode 135 and the cooling pin 134 needs to be maintained for a long time. Accordingly, an epoxy material or the like is poured into the connection part to prevent moisture and the like from entering, thereby suppressing a heat resistance and fixing the atomization electrode 135 and the cooling pin 134 together. Here, the atomization electrode 135 may be fixed to the cooling pin 134 by pressing and the like, in order to reduce the heat resistance.

In addition, since the cooling pin 134 needs to conduct cool temperature heat in the heat insulator 152 for thermally insulating the storage compartment from the cooler 112 or the air path, it is desirable that the cooling pin 134 has a length equal to or more than 5 mm and preferably equal to or more than 10 mm. That is, it is desirable that the length of the cooling pin 134 is equal to or more than 5 mm, and preferably equal to or more than 10 mm. Note, however, that a length equal to or more than 30 mm reduces effectiveness.

Note that the electrostatic atomization apparatus 131 placed in the storage compartment (vegetable compartment 107) is in a high humidity environment and this humidity may affect the cooling pin 134. Accordingly, the cooling pin 134 is preferably made of a metal material that is resistant to corrosion and rust, or a material that has been coated or surface-treated by, for example, alumite.

In this embodiment, the cooling pin 134 as the heat transfer cooling member is shaped as a cylinder. This being so, when fitting the cooling pin 134 into the depression 111a of the heat insulator 152, the cooling pin 134 can be press-fit while rotating the electrostatic atomization apparatus 131 even in the case where a fitting dimension is slightly tight. This enables the cooling pin 134 to be attached with less clearance. Alternatively, the cooling pin 134 may be shaped as a rectangular parallelepiped or a regular polyhedron. Such polygonal shapes allow for easier positioning than the cylinder, so that the electrostatic atomization apparatus 131 can be put in a proper position.

Furthermore, the atomization electrode 135 as the atomization tip is attached on a central axis of the cooling pin 134. Accordingly, when attaching the cooling pin 134, a distance between the atomization electrode 135 and a counter electrode 136 can be kept constant even though the electrostatic atomization apparatus 131 is rotated. Hence, a stable discharge distance can be ensured.

The cooling pin 134 as the heat transfer cooling member is fixed to the external case 137, where the cooling pin 134 itself has a projection 134a that protrudes from the external case 137. The projection 134a of the cooling pin 134 is located opposite to the atomization electrode 135, and fit into a deepest depression 111b that is deeper than the depression 111a of the back partition wall 111.

Thus, the deepest depression 111b deeper than the depression 111a is formed on the back of the cooling pin 134 as the heat transfer cooling member, and this part of the heat insulator 152 on the cooling compartment 110 side, that is, on the air path 141 side, is thinner than other parts in the back partition wall 111 on the back of the vegetable compartment 107. The thinner heat insulator 152 serves as a heat relaxation member, and the cooling pin 134 is cooled from the back by the cool air of the cooling compartment 110 via the heat insulator 152 as the heat relaxation member.

Here, the cool air generated in the cooling compartment 110 is used to cool the cooling pin 134 as the heat transfer cooling member, and the cooling pin 134 is formed of a metal piece having excellent heat conductivity. Accordingly, the cooling unit can perform cooling necessary for dew condensation of the atomization electrode 135 as the atomization tip, just by heat conduction from the air path (freezer compartment discharge air path 141) through which the cool air generated by the cooler 112 flows. Hence, dew condensation can be formed.

Since the cooling unit can be realized by such a simple structure, highly reliable atomization with a low incidence of troubles can be achieved. Moreover, the cooling pin 134 as the heat transfer cooling member and the atomization electrode 135 as the atomization tip can be cooled by using the cooling source of the refrigeration cycle, which contributes to energy-efficient atomization.

The cooling pin 134 as the heat transfer cooling member in this embodiment is shaped to have the projection 134a on the opposite side to the atomization electrode 135 as the atomization tip. This being so, in the atomization unit 139, an end 134b on a projection 134a side is closest to the cooling unit. Therefore, the cooling pin 134 is cooled by the cool air of the cooling unit, from the end 134b farthest from the atomization electrode 135.

The counter electrode 136 shaped like a circular doughnut plate is installed in a position facing the atomization electrode 135 on a storage compartment (vegetable compartment 107) side, so as to have the constant distance from the tip of the atomization electrode 135. The spray port 132 is formed on a further extension from the atomization electrode 135.

Furthermore, the voltage application unit 133 is formed near the atomization unit 139. A negative potential side of the voltage application unit 133 generating a high voltage is electrically connected to the atomization electrode 135, and a positive potential side of the voltage application unit 133 is electrically connected to the counter electrode 136.

Discharge constantly occurs in the vicinity of the atomization electrode 135 for mist spray, which raises a possibility that the tip of the atomization electrode 135 wears out. The refrigerator 100 is typically intended to operate over a long period of 10 years or more. Therefore, a strong surface treatment needs to be performed on the surface of the atomization electrode 135. For example, the use of nickel plating, gold plating, or platinum plating is desirable.

The counter electrode 136 is made of, for example, stainless steel. Long-term reliability needs to be ensured for the counter electrode 136. In particular, to prevent foreign substance adhesion and contamination, it is desirable to perform a surface treatment such as platinum plating on the counter electrode 136.

The voltage application unit 133 communicates with and is controlled by a control unit 146 of the refrigerator main body, and switches the high voltage on or off according to an input signal from the refrigerator 100 or the electrostatic atomization apparatus 131.

In this embodiment, the voltage application unit 133 is placed inside the electrostatic atomization apparatus 131 and so is present in a low temperature and high humidity atmosphere in the storage compartment (vegetable compartment 107). Accordingly, a molding material or a coating material for moisture prevention is applied to a board surface of the voltage application unit 133.

In the case where the voltage application unit 133 is placed in a high temperature part outside the storage compartment, however, no coating is needed.

Note that a heating unit 154 such as a heater is disposed between the heat insulator 152 and the back partition wall surface 151 to which the electrostatic atomization apparatus 131 is fixed, in order to adjust the temperature of the storage compartment (vegetable compartment 107) or prevent surface dew condensation.

An operation and working of the refrigerator 100 in this embodiment having the above-mentioned structure are described below.

An operation of the refrigeration cycle is described first. The refrigeration cycle is activated by a signal from a control board (not shown) according to a set temperature inside the refrigerator, as a result of which a cooling operation is performed. A high temperature and high pressure refrigerant discharged by an operation of the compressor 109 is condensed into liquid to some extent by a condenser (not shown), is further condensed into liquid without causing dew condensation of the refrigerator main body (heat-insulating main body 101) while passing through a refrigerant pipe (not shown) and the like disposed on the side and back surfaces of the refrigerator main body (heat-insulating main body 101) and in a front opening of the refrigerator main body (heat-insulating main body 101), and reaches a capillary tube (not shown). Subsequently, the refrigerant is reduced in pressure in the capillary tube while undergoing heat exchange with a suction pipe (not shown) leading to the compressor 109 to thereby become a low temperature and low pressure liquid refrigerant, and reaches the cooler 112.

Here, the low temperature and low pressure liquid refrigerant undergoes heat exchange with the air in each storage compartment such as the freezer compartment discharge air path 141 conveyed by an operation of the cooling fan 113, as a result of which the refrigerant in the cooler 112 evaporates. Hence, the cool air for cooling each storage compartment is generated in the cooling compartment 110. The low temperature cool air from the cooling fan 113 is branched into the refrigerator compartment 104, the switch compartment 105, the ice compartment 106, the vegetable compartment 107, and the freezer compartment 108 using air paths and dampers, and cools each storage compartment to a desired temperature zone. In particular, the vegetable compartment 107 is adjusted to 2° C. to 7° C. by cool air allocation and an on/off operation of the heating unit 154 and the like, and usually does not have an inside temperature detection unit.

After cooling the refrigerator compartment 104, the air is discharged into the vegetable compartment 107 from the vegetable compartment discharge port 124 formed in a refrigerator compartment return air path 140 for circulating the air to the cooler 112, and flows around the upper storage container 120 and the lower storage container 119 for indirect cooling. The air then returns to the cooler 112 from the vegetable compartment suction port 126.

In a part of the back partition wall 111 that is in a relatively high humidity environment, the heat insulator 152 has a smaller wall thickness than other parts. In particular, there is the deepest depression 111b behind the cooling pin 134 where the heat insulator 152 is, for example, about 2 mm to 10 mm in thickness. In the refrigerator 100 of this embodiment, such a thickness is appropriate for the heat relaxation member located between the cooling pin 134 and the cooling unit. Thus, the depression 111a is formed in the back partition wall 111, and the electrostatic atomization apparatus 131 having the protruding projection 134a of the cooling pin 134 is fit into the deepest depression 111b on a backmost side of the depression 111a.

Cool air of about −15° C. to −25° C. generated by the cooler 112 and blown by the cooling fan 113 according to an operation of a cooling system flows in the freezer compartment discharge air path 141 behind the cooling pin 134, as a result of which the cooling pin 134 as the heat transfer cooling member is cooled to, for example, about 0° C. to −10° C. by heat conduction from the air path surface. Since the cooling pin 134 is a good heat conductive member, the cooling pin 134 transmits cold heat extremely easily, so that the atomization electrode 135 as the atomization tip is indirectly cooled to about 0° C. to −10° C. via the cooling pin 134.

Here, the vegetable compartment 107 is 2° C. to 7° C. in temperature, and also is in a relatively high humidity state due to transpiration from vegetables and the like. Accordingly, when the atomization electrode 135 as the atomization tip drops to a dew point temperature or below, water is generated and water droplets adhere to the atomization electrode 135 including its tip.

The voltage application unit 133 applies a high voltage (for example, 4 kV to 10 kV) between the atomization electrode 135 as the atomization tip to which the water droplets adhere and the counter electrode 136, where the atomization electrode 135 is on a negative voltage side and the counter electrode 136 is on a positive voltage side. This causes corona discharge to occur between the electrodes. The water droplets at the tip of the atomization electrode 135 as the atomization tip are finely divided by electrostatic energy. Furthermore, since the liquid droplets are electrically charged, a nano-level fine mist carrying an invisible charge of a several nm level, accompanied by ozone, OH radicals, and so on, is generated by Rayleigh fission. The voltage applied between the electrodes is an extremely high voltage of 4 kV to 10 kV. However, a discharge current value at this time is at a several μA level, and therefore an input is extremely low, about 0.5 W to 1.5 W.

In detail, suppose the atomization electrode 135 is on a reference potential side (0 V) and the counter electrode 136 is on a high voltage side (+7 kV). An air insulation layer between the atomization electrode 135 and the counter electrode 136 is broken down, and discharge is induced by an electrostatic force. At this time, the dew condensation water adhering to the tip of the atomization electrode 135 is electrically charged and becomes fine particles. Since the counter electrode 136 is on the positive side, the charged fine mist is attracted to the counter electrode 136, and the liquid droplets are more finely divided. Thus, the nano-level fine mist carrying an invisible charge of a several nm level containing radicals is attracted to the counter electrode 136, and sprayed toward the storage compartment (vegetable compartment 107) by its inertial force.

Note that, when there is no water on the atomization electrode 135, the discharge distance increases and the air insulation layer cannot be broken down, and therefore no discharge phenomenon takes place. Hence, no current flows between the atomization electrode 135 and the counter electrode 136.

By cooling the cooling pin 134 as the heat transfer cooling member instead of directly cooling the atomization electrode 135 as the atomization tip, the atomization electrode 135 can be cooled indirectly. Here, since the cooling pin 134 as the heat transfer cooling member has a larger heat capacity than the atomization electrode 135, the atomization electrode 135 can be cooled while alleviating a direct significant influence on the atomization electrode 135 as the atomization tip. Moreover, as a result of the cooling pin 134 functioning as a cool storage, a sudden temperature fluctuation of the atomization electrode 135 can be prevented and mist spray of a stable spray amount can be realized.

Thus, by cooling the cooling pin 134 as the heat transfer cooling member instead of directly cooling the atomization electrode 135 as the atomization tip, the atomization electrode 135 can be cooled indirectly. Here, since the heat transfer cooling member has a larger heat capacity than the atomization electrode 135, the atomization electrode 135 as the atomization tip can be cooled while alleviating a direct significant influence of a temperature change of the cooling unit on the atomization electrode 135. Therefore, a load fluctuation of the atomization electrode 135 can be suppressed, with it being possible to realize mist spray of a stable spray amount.

As described above, the counter electrode 136 is disposed at a position facing the atomization electrode 135, and the voltage application unit 133 generates a high-voltage potential difference between the atomization electrode 135 and the counter electrode 136. This enables an electric field near the atomization electrode 135 to be formed stably. As a result, an atomization phenomenon and a spray direction are determined, and accuracy of a fine mist sprayed into the storage containers (lower storage container 119, upper storage container 120) is enhanced, which contributes to improved accuracy of the atomization unit 139. Hence, the electrostatic atomization apparatus 131 of high reliability can be provided.

In addition, the cooling pin 134 as the heat transfer cooling member is cooled via the heat relaxation member (heat insulator 152). This achieves dual-structure indirect cooling, that is, the atomization electrode 135 is indirectly cooled via the cooling pin 134 and further via the heat insulator 152 as the heat relaxation member. In so doing, the atomization electrode 135 as the atomization tip can be kept from being cooled excessively.

When the temperature of the atomization electrode 135 decreases by 1 K, a water generation speed of the tip of the atomization electrode 135 increases by about 10%. However, when the atomization electrode 135 is cooled excessively, a dew condensation speed increases sharply. This causes a large amount of dew condensation, and an increase in load of the atomization unit 139 raises concern about an input increase in the electrostatic atomization apparatus 131 and freezing and an atomization failure of the atomization unit 139. According to the above-mentioned structure, on the other hand, such problems due to the load increase of the atomization unit 139 can be prevented. Since an appropriate dew condensation amount can be ensured, stable mist spray can be achieved with a low input.

In terms of assembly, the cooling pin 134 as the heat transfer cooling member is desirably shaped as a cylinder. To be exact, the cooling pin 134 may also be shaped as a rectangular parallelepiped or a regular polyhedron. In the case of a cylinder, however, the cooling pin 134 can be fit into the depression 111a of the heat insulator 152 while tilting the electrostatic atomization apparatus 131. In the case of a polygonal shape, on the other hand, positioning is easer than in the case of a cylinder.

Moreover, by attaching the atomization electrode 135 on the central axis of the cooling pin 134, when attaching the cooling pin 134, the distance between the atomization electrode 135 and the counter electrode 136 can be kept constant even though the electrostatic atomization apparatus 131 is rotated. Hence, a stable discharge distance can be ensured.

Furthermore, by indirectly cooling the atomization electrode 135 as the atomization tip in the dual structure via the heat transfer cooling member (cooling pin 134) and the heat relaxation member (heat insulator 152), a direct significant influence of a temperature change of the cooling unit on the atomization electrode 135 as the atomization tip can be further alleviated. This suppresses a load fluctuation of the atomization electrode 135, so that mist spray of a stable spray amount can be achieved.

Besides, the cool air generated in the cooling compartment 110 is used to cool the cooling pin 134 as the heat transfer cooling member, and the cooling pin 134 is formed of a metal piece having excellent heat conductivity. Accordingly, the cooling unit can perform necessary cooling just by heat conduction from the air path (freezer compartment discharge air path 141) through which the cool air generated by the cooler 112 flows.

The cooling pin 134 as the heat transfer cooling member in this embodiment is shaped to have the projection 134a on the opposite side to the atomization electrode 135 as the atomization tip. This being so, in the atomization unit 139, the end 134b on the projection 134a side is closest to the cooling unit. Therefore, the cooling pin 134 as the heat transfer cooling member is cooled by the cool air of the cooling unit, from the end 134b farthest from the atomization electrode 135 as the atomization tip.

Since the cooling unit can be made by such a simple structure, the atomization unit 139 of high reliability with a low incidence of troubles can be realized. Moreover, the cooling pin 134 as the heat transfer cooling member and the atomization electrode 135 as the atomization tip can be cooled by using the cooling source of the refrigeration cycle, which contributes to energy-efficient atomization.

Thus, the cooling by the cooling unit is performed from the end 134b which is a part of the cooling pin 134 as the heat transfer cooling member farthest from the atomization electrode 135 as the atomization tip. In doing so, after the large heat capacity of the cooling pin 134 is cooled, the atomization electrode 135 is cooled by the cooling pin 134. This further alleviates a direct significant influence of a temperature change of the cooling unit on the atomization electrode 135, with it being possible to realize stable mist spray with a smaller load fluctuation.

Moreover, the depression 111a is formed in a storage compartment (vegetable compartment 107) side part of the back partition wall 111 to which the atomization unit 139 is attached, and the atomization unit 139 having the projection 134a is inserted into this depression 111a. In this way, the heat insulator 152 constituting the back partition wall 111 of the storage compartment (vegetable compartment 107) can be used as the heat relaxation member. Hence, the heat relaxation member for properly cooling the atomization electrode 135 as the atomization tip can be provided by adjusting the thickness of the heat insulator 152, with there being no need to prepare a particular heat relaxation member. This contributes to a more simplified structure of the atomization unit 139.

In addition, by inserting the atomization unit 139 having the projection 134a composed of the cooling pin 134 into the depression 111a, the atomization unit 139 can be securely attached to the partition wall without looseness, and also a protuberance toward the vegetable compartment 107 as the storage compartment can be prevented. Such an atomization unit 139 is difficult to reach by hand, so that safety can be improved.

Besides, the atomization unit 139 does not extend through and protrude out of the back partition wall 111 of the vegetable compartment 107 as the storage compartment. Accordingly, an air path cross-sectional area of the freezer compartment discharge air path 141 is unaffected, and a decrease in cooling amount caused by an increased air path resistance can be prevented.

Moreover, the depression 111a is formed in a part of the vegetable compartment 107 and the atomization unit 139 is inserted into this depression 111a, so that a storage capacity for storing vegetables, fruits, and other foods is unaffected. In addition, while reliably cooling the cooling pin 134 as the heat transfer cooling member, a wall thickness enough for ensuring heat insulation properties is secured for other parts. This prevents dew condensation in the external case 137, thereby enhancing reliability.

Additionally, the cooling pin 134 as the electrode connection member has a certain level of heat capacity and is capable of lessening a response to heat conduction from the cooling air path (freezer compartment discharge air path 141), so that a temperature fluctuation of the atomization electrode 135 as the atomization tip can be suppressed. The cooling pin 134 also functions as a cool storage member, thereby ensuring a dew condensation time for the atomization electrode 135 as the atomization tip and also preventing freezing.

Furthermore, by combining the good heat conductive cooling pin 134 and the heat insulator 152, the cold heat can be conducted favorably without loss. Besides, by suppressing a heat resistance at the connection part between the cooling pin 134 and the atomization electrode 135, temperature fluctuations of the atomization electrode 135 and the cooling pin 134 follow each other favorably. In addition, thermal bonding can be maintained for a long time because moisture cannot enter into the connection part.

Moreover, since the storage compartment (vegetable compartment 107) is in a high humidity environment and this humidity may affect the cooling pin 134 as the heat transfer cooling member, the cooling pin 134 is made of a metal material that is resistant to corrosion and rust or a material that has been coated or surface-treated by, for example, alumite. This prevents rust and the like, suppresses an increase in surface heat resistance, and ensures stable heat conduction.

Further, nickel plating, gold plating, or platinum plating is used on the surface of the atomization electrode 135 as the atomization tip, which enables the tip of the atomization electrode 135 to be kept from wearing due to discharge. Thus, the tip of the atomization electrode 135 can be maintained in shape, as a result of which spray can be performed over a long period of time and also a stable liquid droplet shape at the tip can be attained.

When the fine mist is sprayed from the atomization electrode 135, an ion wind is generated. During this time, high humidity air newly flows into the part of the atomization electrode 135 inside the external case 137 from the moisture supply port 138 formed in the external case 137. This allows the spray to be performed continuously.

The fine mist generated by the atomization electrode 135 is mainly sprayed into the lower storage container 119, but also reaches the upper storage container 120 because the fine mist is made up of extremely small particles and so has high diffusivity. The sprayed fine mist is generated by high-voltage discharge, and so is negatively charged. Meanwhile, green leafy vegetables, fruits, and the like stored in the vegetable compartment 107 tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces, thereby enhancing freshness preservation.

The nano-level fine mist adhering to the vegetable surfaces sufficiently contains OH radicals, a small amount of ozone, and the like. Such a nano-level fine mist is effective in sterilization, antimicrobial activity, microbial elimination, and so on, and also stimulates increases in nutrient of the vegetables such as vitamin C through agricultural chemical removal and antioxidation by oxidative decomposition.

When there is no water on the atomization electrode 135, the discharge distance increases and the air insulation layer cannot be broken down, and therefore no discharge phenomenon takes place. Hence, no current flows between the atomization electrode 135 and the counter electrode 136. This phenomenon may be detected by the control unit 146 of the refrigerator 100 to control on/off of the high voltage of the voltage application unit 133.

In this embodiment, the voltage application unit 133 is installed at a relatively low temperature and high humidity position in the storage compartment (vegetable compartment 107). Accordingly, a dampproof and waterproof structure by a potting material or a coating material is employed for the voltage application unit 133 for circuit protection.

Note, however, that the above-mentioned measure is unnecessary in the case where the voltage application unit 133 is installed outside the storage compartment.

As described above, in the first embodiment, the thermally insulated storage compartment (vegetable compartment 107 and the like) and the electrostatic atomization apparatus 131 (atomization unit 139) that sprays a mist into the storage compartment (vegetable compartment 107) are provided. The atomization unit 139 in the electrostatic atomization apparatus 131 includes the atomization tip (atomization electrode 135) electrically connected to the voltage application unit 133 for generating a high voltage and spraying the mist, the counter electrode 136 disposed facing the atomization electrode 135, the heat transfer cooling member (cooling pin 134) connected to the atomization tip (atomization electrode 135), and the cooling unit that cools the heat transfer cooling member (cooling pin 134) in order to bring the atomization electrode 135 to not more than the dew point that is a temperature at which water in the air builds up dew condensation. The cooling unit cools the heat transfer cooling member (cooling pin 134), thereby indirectly cooling the atomization tip (atomization electrode 135) to the dew point or below. This causes water in the air to build up dew condensation on the atomization tip (atomization electrode 135) and to be sprayed as a mist into the storage compartment (vegetable compartment 107). Thus, the dew condensation is formed on the atomization tip (atomization electrode 135) easily and reliably from an excess water vapor in the storage compartment (vegetable compartment 107), and the nano-level fine mist is generated by high-voltage corona discharge with the counter electrode 136. The atomized fine mist is sprayed to uniformly adhere to surfaces of vegetables and fruits, thereby suppressing transpiration from the vegetables and fruits and enhancing freshness preservation.

The fine mist also penetrates into tissues via intercellular spaces, stomata, and the like on the surfaces of the vegetables and fruits, as a result of which water is supplied into wilted cells and the vegetables and fruits return to a fresh state.

Here, since the discharge is induced between the atomization electrode 135 and the counter electrode 136, an electric field can be formed stably to determine a spray direction. As a result, the fine mist can be sprayed into the storage containers (lower storage container 119, upper storage container 120) more accurately.

Moreover, ozone and OH radicals generated simultaneously with the mist contribute to enhanced effects of deodorization, removal of harmful substances from food surfaces, contamination prevention, and the like.

Besides, the mist can be directly sprayed over the foods in the storage containers (lower storage container 119, upper storage container 120) in the vegetable compartment 107, and the potentials of the mist and the vegetables are exploited to cause the mist to adhere to the vegetable surfaces. This improves freshness preservation efficiency.

Furthermore, the mist is sprayed by causing an excess water vapor in the storage compartment (vegetable compartment 107) to build up dew condensation on the atomization electrode 135 and water droplets to adhere to the atomization electrode 135. This makes it unnecessary to provide any of a defrost hose for supplying mist spray water, a purifying filter, a water supply path directly connected to tap water, a water storage tank, and so on. A water conveyance unit such as a pump is not used, either. Hence, the fine mist can be supplied to the storage compartment (vegetable compartment 107) by a simple structure, with there being no need for a complex mechanism.

Since the fine mist is supplied to the storage compartment (vegetable compartment 107) stably by a simple structure, the possibility of troubles of the refrigerator 100 can be significantly reduced. This enables the refrigerator 100 to exhibit higher quality in addition to higher reliability.

Here, dew condensation water having no mineral compositions or impurities is used instead of tap water, so that deterioration in water retentivity caused by water retainer deterioration or clogging in the case of using a water retainer can be prevented.

Further, the atomization performed here is not ultrasonic atomization by ultrasonic vibration, with there being no need to take noise and vibration of resonance and the like associated with ultrasonic frequency oscillation into consideration.

Moreover, since no water storage tank is necessary, there is no need to provide, for example, a water level sensor that is required in the case of using a water storage tank in order to address ultrasonic element destruction caused by a water shortage. Hence, the atomization apparatus can be provided in the refrigerator by a simpler structure.

In addition, the part accommodating the voltage application unit 133 is also buried in the back partition wall 111 and cooled, with it being possible to suppress a temperature increase of the board. This allows for a reduction in temperature effect in the storage compartment (vegetable compartment 107).

In this embodiment, the cooler 112 for cooling each of the storage compartments 104, 105, 106, 107, and 108 and the back partition wall 111 for thermally insulating the storage compartment (vegetable compartment 107) from the cooling compartment 110 including the cooler 112 are provided, and the electrostatic atomization apparatus 131 is attached to the back partition wall 111.

By such installing the electrostatic atomization apparatus 131 in the gap in the storage compartment (vegetable compartment 107), a reduction in storage capacity can be avoided. Additionally, the electrostatic atomization apparatus 131 is difficult to reach by hand because it is attached to the back surface, which contributes to enhanced safety.

In this embodiment, the heat transfer cooling member (cooling pin 134) connected to the atomization electrode 135 as the atomization tip of the electrostatic atomization apparatus 131 is a metal piece having good heat conductivity, and the cooling unit for cooling the heat transfer cooling member (cooling pin 134) utilizes heat conduction from the air path (freezer compartment discharge air path 141) through which the cool air generated by the cooler 112 flows. By adjusting the wall thickness of the heat insulator 152 of the back partition wall 111 as the heat relaxation member, it is possible to easily set the temperatures of the cooling pin 134 as the heat transfer cooling member and the atomization electrode 135 as the atomization tip. In addition, interposing the heat insulator 152 as the heat relaxation member suppresses leakage of cool temperature air, so that frost formation and dew condensation of the external case 137 and the like that lead to lower reliability can be prevented.

In this embodiment, the depression 111a is formed in a storage compartment (vegetable compartment 107) side part of the back partition wall 111 to which the atomization unit 139 of the electrostatic atomization apparatus 131 is attached, and the heat transfer cooling member (cooling pin 134) connected to the atomization electrode 135 as the atomization tip of the electrostatic atomization apparatus 131 is inserted into this depression 111a. Accordingly, the storage capacity for storing vegetables, fruits, and other foods is unaffected. In addition, while reliably cooling the heat transfer cooling member (cooling pin 134), a wall thickness enough for ensuring heat insulation properties is secured for other parts in the electrostatic atomization apparatus 131. This prevents dew condensation in the external case 137, thereby enhancing reliability.

Note that, though ozone is generated together with the fine mist because the electrostatic atomization apparatus 131 in this embodiment applies a high voltage between the atomization electrode 135 as the atomization tip and the counter electrode 136, an ozone concentration in the storage compartment (vegetable compartment 107) can be adjusted by on/off operation control of the electrostatic atomization apparatus 131. By properly adjusting the ozone concentration, deterioration such as yellowing of vegetables due to excessive ozone can be prevented, and sterilization and antimicrobial activity on vegetable surfaces can be enhanced.

In this embodiment, the atomization electrode 135 is set on the reference potential side (0 V) and the positive potential (+7 kV) is applied to the counter electrode 136, thereby generating a high-voltage potential difference between the electrodes. Alternatively, a high-voltage potential difference may be generated between the electrodes by setting the counter electrode 136 on the reference potential side (0 V) and applying a negative potential (−7 kV) to the atomization electrode 135. In this case, the counter electrode 136 closer to the storage compartment (vegetable compartment 107) is on the reference potential side, and therefore an electric shock or the like can be avoided even when a user's hand comes near the counter electrode 136. Moreover, in the case where the atomization electrode 135 is at the negative potential of −7 kV, the counter electrode 136 may be omitted by setting the storage compartment (vegetable compartment 107) on the reference potential side.

In such a case, for example, a conductive storage container is provided in the heat-insulated storage compartment (vegetable compartment 107), where the conductive storage container is electrically connected to a (conductive) holding member of the storage container and also is made detachable from the holding member. In this structure, the holding member is connected to a reference potential part to be grounded (0 V).

This allows the potential difference to be constantly maintained between the atomization unit 139 and each of the storage container and the holding member, so that a stable electric field is generated. As a result, the mist can be sprayed stably from the atomization unit 139. Besides, since the entire storage container is at the reference potential, the sprayed mist can be diffused throughout the storage container. Further, electrostatic charges to surrounding objects can be prevented.

Thus, there is no need to particularly provide the counter electrode 136, because the potential difference from the atomization electrode 135 can be created to spray the mist by providing the grounded holding member in a part of the storage compartment (vegetable compartment 107). In this way, a stable electric field can be generated by a simpler structure, thereby enabling the mist to be sprayed stably from the atomization unit.

In addition, when the holding member is attached to the storage container side, the entire storage container is at the reference potential, and therefore the sprayed mist can be diffused throughout the storage container. Further, electrostatic charges to surrounding objects can be prevented.

Though the air path for cooling the cooling pin 134 as the heat transfer cooling member is the freezer compartment discharge air path 141 in this embodiment, the air path may instead be a low temperature air path such as a freezer compartment return air path or a discharge air path of the ice compartment 106. This expands an area in which the electrostatic atomization apparatus 131 can be installed.

Though the cooling unit for cooling the cooling pin 134 as the heat transfer cooling member is the air cooled using the cooling source generated in the refrigeration cycle of the refrigerator 100 in this embodiment, it is also possible to utilize heat transmission from a cooling pipe that uses a cool temperature or cool air from the cooling source of the refrigerator 100. In such a case, by adjusting a temperature of the cooling pipe, the cooling pin 134 as the heat transfer cooling member can be cooled at an arbitrary temperature. This eases temperature control when cooling the atomization electrode 135.

Though no water retainer is provided around the atomization electrode 135 of the electrostatic atomization apparatus 131 in this embodiment, a water retainer may be provided. This enables dew condensation water generated near the atomization electrode 135 to be retained around the atomization electrode 135, with it being possible to timely supply the water to the atomization electrode 135.

Though the storage compartment to which the mist is sprayed from the atomization unit 139 of the electrostatic atomization apparatus 131 is the vegetable compartment 107 in this embodiment, the mist may be sprayed to storage compartments of other temperature zones such as the refrigerator compartment 104 and the switch compartment 105. In such a case, various applications can be developed.

### Second Embodiment

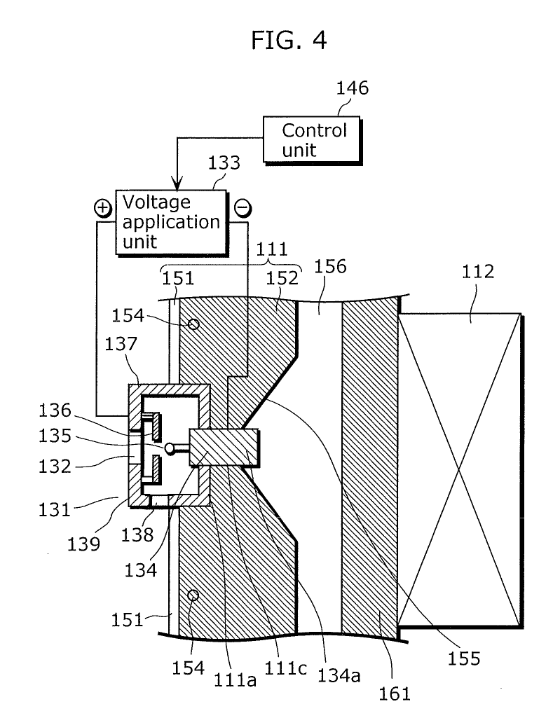

A longitudinal sectional view showing a section when a refrigerator in a second embodiment of the present invention is cut into left and right is approximately the same as FIG. 1, and a relevant part front view showing a back surface of a vegetable compartment in the refrigerator in the second embodiment of the present invention is the same as FIG. 2. FIG. 4 is a sectional view of an electrostatic atomization apparatus and its periphery included in the vegetable compartment in the refrigerator in the second embodiment of the present invention, as taken along line A-A in FIG. 2 and seen from the arrow direction.

In the drawing, the back partition wall 111 includes the back partition wall surface 151 made of a resin such as ABS, and the heat insulator 152 made of styrene foam or the like for ensuring the heat insulation of the storage compartment by isolating the storage compartment from an air path 156 and the cooling compartment 110. A depression is formed in a part of a storage compartment side wall surface of the back partition wall 111 so as to be lower in temperature than other parts. In addition, a further depression is formed in an installation site of the cooling pin 134 on a cooler 112 side, as a result of which a through part 111c is generated. The electrostatic atomization apparatus 131 which is a mist spray apparatus is installed in the through part 111c.

Here, a part of the cooling pin 134 as a heat transfer cooling member passes through the heat insulator 152 and is exposed to a part of the low temperature air path 156. The low temperature air path 156 has a projection near the back of the cooling pin 134, that is, a heat insulator depression 155 is formed. Thus, the air path is partly widened.

An operation and working of the refrigerator 100 having the above-mentioned structure are described below.

In a part of the back partition wall 111 that is in a relatively high humidity environment, the heat insulator 152 is smaller in wall thickness than other parts. In particular, the heat insulator 152 behind the cooling pin 134 has a thickness of, for example, about 2 mm to 10 mm. Accordingly, the through part 111c is formed in the back partition wall 111, and the electrostatic atomization apparatus 131 is attached in the through part 111c.

The cooling pin 134 is partly exposed to the low temperature air path 156 located behind. Cool air of a temperature lower than the vegetable compartment temperature is generated by the cooler 112 and blown by the cooling fan 113 according to an operation of a cooling system, and as a result the cooling pin 134 is cooled to, for example, about 0° C. to −10° C. Since the cooling pin 134 is a good heat conductive member, the cooling pin 134 transmits cold heat extremely easily, so that the atomization electrode 135 as the atomization tip is also cooled to about 0° C. to −10° C.

Here, the low temperature air path 156 is widened near the heat insulator depression 155, thereby decreasing an air path resistance. This allows an increased amount of air to be blown from the cooling fan 113. Hence, cooling system efficiency can be improved.

The voltage application unit 133 applies a high voltage (for example, 4 kV to 10 kV) between the atomization electrode 135 to which water droplets adhere and the counter electrode 136, where the atomization electrode 135 is on a negative voltage side and the counter electrode 136 is on a positive voltage side. This causes corona discharge to occur between the electrodes. The water droplets at the tip of the atomization electrode 135 are finely divided by electrostatic energy. Furthermore, since the liquid droplets are electrically charged, a nano-level fine mist carrying an invisible charge of a several nm level, accompanied by ozone, OH radicals, and so on, is generated by Rayleigh fission. The voltage applied between the electrodes is an extremely high voltage of 4 kV to 10 kV. However, a discharge current value at this time is at a several μA level, and therefore an input is extremely low, about 0.5 W to 1.5 W.

The generated fine mist is sprayed into the lower storage container 119, but also reaches the upper storage container 120 because the fine mist is made up of extremely small particles and so has high diffusivity. The sprayed fine mist is generated by high-voltage discharge, and so is negatively charged.

Meanwhile, green leafy vegetables, fruits, and the like stored in the vegetable compartment 107 tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces, thereby enhancing freshness preservation.

The nano-level fine mist adhering to the vegetable surfaces sufficiently contains OH radicals, a small amount of ozone, and the like. Such a nano-level fine mist is effective in sterilization, antimicrobial activity, microbial elimination, and so on, and also stimulates increases in nutrient of the vegetables such as vitamin C through agricultural chemical removal and antioxidation by oxidative decomposition.

As described above, in this embodiment, at least one air path (low temperature air path 156) for conveying cool air to the storage compartment or the cooler 112 and the heat insulator 152 thermally insulated so as to suppress a heat effect between the storage compartment and other air paths are provided on the back surface side of the back partition wall 111 for partitioning the cooler 112 and the storage compartment (vegetable compartment 107) in a heat insulation manner. The cooling unit (heat transfer cooling member) that cools the atomization electrode 135 as the atomization tip of the atomization unit 139 in the electrostatic atomization apparatus 131 to cause dew condensation is the cooling pin 134 composed of a good heat conductive metal piece connected to the atomization electrode 135 as the atomization tip. The cooling unit that cools the cooling pin 134 can reliably cool the atomization electrode 135 as the atomization tip by using the cool air generated by the cooler 112. This can be achieved by a simple structure at low cost, because any particular new cooling unit is not used.

Moreover, in this embodiment, a storage compartment (vegetable compartment 107) side part of the back partition wall 111 to which the atomization unit 139 of the electrostatic atomization apparatus 131 is attached has a depression, and the through part 111c is formed in the back partition wall 111 by the heat insulator depression 155. The cooling pin 134 as the heat transfer cooling member is inserted into this through part 111c, thereby attaching the electrostatic atomization apparatus 131 (atomization unit 139) to the back partition wall 111.

A part of the cooling pin 134 as the heat transfer cooling member inserted into the through part 111c passes through the heat insulator 152 and is exposed to a part of the low temperature air path 156. This allows the heat transfer cooling member (cooling pin 134) composed of a metal piece to be cooled reliably. In addition, by forming the heat insulator depression 155 in the low temperature air path 156 to widen an air path cross-sectional area of the low temperature air path 156, the air path resistance can be lowered or made equal, so that a decrease in cooling amount can be prevented. Furthermore, the temperature of the atomization electrode 135 as the atomization tip can be adjusted easily, by adjusting an exposed surface area of the cooling pin 134 as the heat transfer cooling member to the low temperature air path 156.

### Third Embodiment

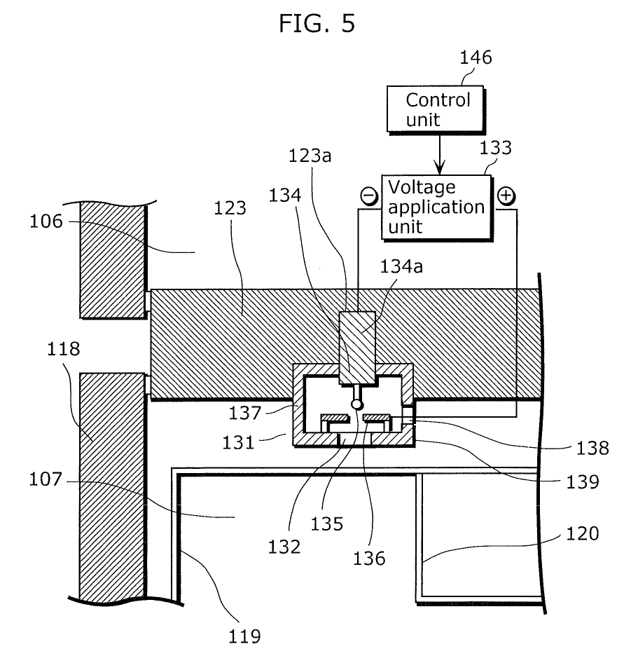

FIG. 5 is a relevant part longitudinal sectional view showing a section when a door-side peripheral part of a partition wall in an upper part of a vegetable compartment in a refrigerator in a third embodiment of the present invention is cut into left and right.

As shown in the drawing, the electrostatic atomization apparatus 131 is incorporated in the first partition wall 123 that secures heat insulation in order to separate the temperature zones of the vegetable compartment 107 and the ice compartment 106. In particular, the heat insulator has a depression in a part corresponding to the cooling pin 134 of the atomization unit 139.

The refrigerator main body (heat-insulating main body 101) of the refrigerator 100 in this embodiment has a plurality of storage compartments. The lower temperature storage compartment (ice compartment 106) maintained at a lower temperature than the vegetable compartment 107 including the atomization unit 139 of the electrostatic atomization apparatus 131 as the mist spray apparatus is provided on a top side of the vegetable compartment 107 including the atomization unit 139, and the atomization unit of the electrostatic atomization apparatus 131 is attached to the first partition wall 123 on the top side of the vegetable compartment 107 including the atomization unit 139 of the electrostatic atomization apparatus 131. The first partition wall 123 has a depression 123a on the vegetable compartment 107 side, and the cooling pin 134 as the heat transfer cooling member is inserted into the depression 123a.

An operation and working of the refrigerator 100 in this embodiment having the above-mentioned structure are described below.

The first partition wall 123 in which the atomization unit 139 of the electrostatic atomization apparatus 131 is installed needs to have such a thickness that allows the cooling pin 134 as the heat transfer cooling member to which the atomization electrode 135 as the atomization tip is fixed, to be cooled. Accordingly, a part of the first partition wall 123 provided with the electrostatic atomization apparatus 131 has a smaller wall thickness than other parts. As a result, the cooling pin 134 can be cooled by heat conduction from the ice compartment 106 of a relatively lower temperature than the vegetable compartment 107, with it being possible to cool the atomization electrode 135. When the tip of the atomization electrode 135 drops to the dew point or below, a water vapor near the atomization electrode 135 builds up dew condensation on the atomization electrode 135, thereby reliably generating water droplets.

Though not shown, by installing an inside temperature detection unit, an inside humidity detection unit, an atomization electrode temperature detection unit, an atomization electrode humidity detection unit, and the like in the storage compartment, the dew point can be precisely calculated by a predetermined computation according to a change in storage compartment environment.

In this state, the voltage application unit 133 applies a high voltage (for example, 7.5 kV) between the atomization electrode 135 and the counter electrode 136, where the atomization electrode 135 is on a negative voltage side and the counter electrode 136 is on a positive voltage side. This causes an air insulation layer to be broken down and corona discharge to occur between the electrodes. Water on the atomization electrode 135 is atomized from the electrode tip, and a nano-level fine mist carrying an invisible charge less than 1 μm, accompanied by ozone, OH radicals, and so on, is generated.

The generated fine mist is sprayed into the vegetable containers (lower storage container 119, upper storage container 120). The fine mist sprayed from the electrostatic atomization apparatus 131 is negatively charged. Meanwhile, green leafy vegetables, fruits, and the like stored in the vegetable compartment 107 usually tend to be in a rather wilted state as a result of transpiration on the way home from shopping or transpiration during storage, and so these vegetables and fruits are usually positively charged. Accordingly, the sprayed fine mist carrying a negative charge tends to gather on vegetable surfaces.

Thus, the sprayed fine mist increases the humidity of the vegetable compartment 107 again and simultaneously adheres to surfaces of vegetables and fruits, thereby suppressing transpiration from the vegetables and fruits and enhancing freshness preservation. The fine mist also penetrates into tissues via intercellular spaces of the vegetables and fruits, as a result of which water is supplied into cells that have wilted due to moisture evaporation to resolve the wilting by cell turgor pressure, and the vegetables and fruits return to a fresh state.

Moreover, the generated fine mist contains ozone, OH radicals, and the like, which possess strong oxidative power. Hence, the generated fine mist can perform deodorization in the vegetable compartment 107 and antimicrobial activity and sterilization on the vegetable surfaces, and also oxidative-decompose and remove harmful substances such as agricultural chemicals and wax adhering to the vegetable surfaces.

Currently, isobutane which is a flammable refrigerant with a low global warming potential is mainly used as a refrigerant of a refrigeration cycle, in view of global environmental protection.

Isobutane which is a hydrocarbon has a specific gravity about twice the air at a room temperature and an atmospheric pressure (2.04, 300 K).

In the case where isobutane which is a flammable refrigerant leaks from the refrigeration system when the compressor 109 is stopped, isobutane leaks downward because it is heavier than the air. Here, the refrigerant may leak into storage compartments over the back partition wall 111. In particular, when the refrigerant leaks from the cooler 112 where a large amount of refrigerant is retained, a large amount of leakage may occur. However, the vegetable compartment 107 including the electrostatic atomization apparatus 131 is located above the cooler 112. Accordingly, even when the leakage occurs, the refrigerant does not leak into the vegetable compartment 107.

Moreover, even if the flammable refrigerant (isobutane) leaks from the cooler 112 into the vegetable compartment 107, the flammable refrigerant (isobutane) stays in a lower part of the storage compartment (vegetable compartment 107) because it is heavier than the air. Since the electrostatic atomization apparatus 131 is installed at the top of the storage compartment (vegetable compartment 107), the possibility that the vicinity of the electrostatic atomization apparatus 131 reaches a flammable concentration is extremely low.

As described above, in this embodiment, the refrigerator main body (heat-insulating main body 101) has a plurality of storage compartments. The ice compartment 106 as the lower temperature storage compartment maintained at a lower temperature than the vegetable compartment 107 as the storage compartment including the atomization unit 139 is provided on the top side of the vegetable compartment 107 as the storage compartment including the atomization unit 139. The atomization unit 139 is attached to the first partition wall 123 on the top side of the vegetable compartment 107.

Thus, in the case where a freezing temperature zone storage compartment (the ice compartment 106 in this embodiment) such as the freezer compartment or the ice compartment is located above the storage compartment (vegetable compartment 107) including the atomization unit 139, by installing the atomization unit 139 in the first partition wall 123 at the top separating these storage compartments, the cooling pin 134 as the heat transfer cooling member in the atomization unit 139 is cooled by cool air of the storage compartment (ice compartment 106) above the vegetable compartment 107, with it being possible to cool and build up dew condensation on the atomization electrode 135 as the atomization tip. Since the atomization unit can be provided by a simple structure with there being no need for a particular cooling apparatus, a highly reliable atomization unit with a low incidence of troubles can be realized.

In this embodiment, the refrigerator 100 is provided with the partition wall (first partition wall 123) for separating the storage compartment (vegetable compartment 107), and the lower temperature storage compartment (ice compartment 106) of a lower temperature than the storage compartment (vegetable compartment 107) on the top side of the storage compartment (vegetable compartment 107). The electrostatic atomization apparatus 131 is attached to the first partition wall 123 at the top of the vegetable compartment 107. Thus, in the case where a freezing temperature zone storage compartment such as the freezer compartment or the ice compartment is located above the storage compartment (vegetable compartment 107) including the electrostatic atomization apparatus 131, by installing the electrostatic atomization apparatus 131 in the partition wall (first partition wall 123) at the top separating these compartments, a cooling source of the freezing temperature zone storage compartment can be used to cool and build up dew condensation on the atomization electrode 135 of the electrostatic atomization apparatus 131 via the cooling pin 134 as the heat transfer cooling member. This makes it unnecessary to provide any particular cooling apparatus. Moreover, since the mist is sprayed from the top, the mist can be easily diffused throughout the storage containers (lower storage container 119, upper storage container 120). In addition, the atomization unit 139 is difficult to reach by hand, which contributes to enhanced safety.

In this embodiment, the atomization unit 139 generates a mist according to the electrostatic atomization method, where water droplets are finely divided using electrical energy such as a high voltage to thereby form a fine mist. The generated mist is electrically charged. This being so, by causing the mist to carry an opposite charge to vegetables, fruits, and the like to which the mist is intended to adhere, for example, by spraying a negatively charged mist over positively charged vegetables, the adhesion of the mist to the vegetables and fruits increases, as a result of which the mist can adhere to the vegetable surfaces more uniformly. In this way, a mist adhesion ratio can be improved when compared with an uncharged mist. Moreover, the fine mist can be directly sprayed over the foods in the vegetable containers, and the potentials of the fine mist and the vegetables are exploited to cause the fine mist to adhere to the vegetable surfaces. This improves freshness preservation efficiently.

In this embodiment, not tap water supplied from outside but dew condensation water is used as makeup water. Since dew condensation water is free from mineral compositions and impurities, deterioration in water retentivity caused by deterioration or clogging of the tip of the atomization electrode can be prevented.

In this embodiment, the mist contains radicals, so that agricultural chemicals, wax, and the like adhering to the vegetable surfaces can be decomposed and removed with an extremely small amount of water. This benefits water conservation, and also achieves a low input.

Moreover, since the electrostatic atomization apparatus 131 is located above the evaporator (cooler 112), even when a flammable refrigerant such as isobutane or propane used in a refrigeration cycle leaks, the vegetable compartment 107 is kept from being filled with the refrigerant because the refrigerant is heavier than the air. Thus, safety can be ensured.

In addition, since the atomization unit 139 of the electrostatic atomization apparatus 131 is installed in an upper part of the storage compartment (vegetable compartment 107), even when the refrigerant leaks, ignition can be prevented because the refrigerant stays in a lower part of the storage compartment (vegetable compartment 107).

Note that no part in the storage compartment (vegetable compartment 107) directly faces a refrigerant pipe or the like, and so the refrigerant does not leak into the storage compartment. Accordingly, ignition through the flammable refrigerant can be prevented.

### Fourth Embodiment

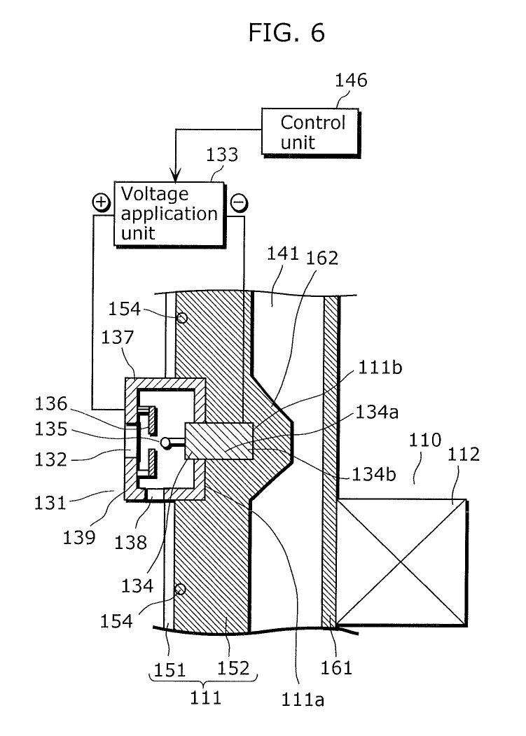

A longitudinal sectional view showing a section when a refrigerator in a fourth embodiment of the present invention is cut into left and right is approximately the same as FIG. 1, and a relevant part front view showing a back surface of a vegetable compartment in the refrigerator in the fourth embodiment of the present invention is the same as FIG. 2. FIG. 6 is a sectional view of an electrostatic atomization apparatus and its periphery included in the vegetable compartment in the refrigerator in the fourth embodiment of the present invention, as taken along line A-A in FIG. 2 and seen from the arrow direction.

In this embodiment, detailed description is given only for parts that differ from the structures described in the first to third embodiments, with description being omitted for parts that are the same as the structures described in the first to third embodiments or parts to which the same technical ideas are applicable.

In the drawing, the back partition wall 111 includes the back partition wall surface 151 made of a resin such as ABS as a partition for separating the storage compartment (vegetable compartment 107), and the heat insulator 152 for thermally insulating the storage compartment from the air path 141 through which cool air for cooling the storage compartment (freezer compartment 108) flows. There is also the partition plate 161 for isolating the freezer compartment discharge air path 141 and the cooling compartment 110 from each other. The heat insulator 152 made of styrene foam or the like for ensuring heat insulation is located between the back partition wall surface 151 on the vegetable compartment 107 side and the freezer compartment discharge air path 141. Moreover, the heating unit 154 such as a heater is disposed between the heat insulator 152 and the back partition wall surface 151, in order to adjust the temperature of the storage compartment (vegetable compartment 107) or prevent surface dew condensation.

Here, the depression 111a is formed in a part of a storage compartment side wall surface of the back partition wall 111, and the electrostatic atomization apparatus 131 as the mist spray apparatus is buried in the depression 111a.

The electrostatic atomization apparatus 131 cools the atomization electrode 135 as the atomization tip included in the atomization unit 139 to the dew point temperature or below by a cooling unit, thereby causing water in the air around the atomization unit 139 to build up dew condensation on the atomization electrode 135 and generated dew condensation water to be sprayed as a mist.

In this embodiment, when causing the dew condensation, low temperature cool air flowing in the freezer compartment discharge air path 141 is used as the cooling unit and, instead of directly cooling the atomization electrode 135 as the atomization tip, the atomization electrode 135 is cooled via the cooling pin 134 as the heat transfer cooling member having a larger heat capacity than the atomization electrode 135.

To cool the cooling pin 134 as the heat transfer cooling member, it is desirable that the heat insulator 152 on the cooling compartment 110 side, i.e., on the back side of the cooling pin 134 as the heat transfer cooling member is made thinner (as in FIG. 3 described in the first embodiment). However, when there is an extremely thin walled part in molding of styrene foam or the like, the thin walled part decreases in rigidity, which raises a possibility of problems such as a crack and a hole caused by insufficient strength or defective molding. Thus, there is concern about quality deterioration.

In view of this, in this embodiment, the heat insulator 152 near the back of the cooling pin 134 is provided with a protrusion 162, thereby enhancing rigidity around the cooling pin 134 when compared with a flat part, and further enhancing rigidity by securing the wall thickness of the heat insulator 152. In addition, by forming the protrusion 162, the cooling pin 134 can be cooled both from its back and its side.

Furthermore, in order to suppress an increase in air path resistance, an outer peripheral surface of the protrusion 162 is sloped in a conical shape that tapers toward the end.

An operation and working of the refrigerator 100 in this embodiment having the above-mentioned structure are described below.

The cooling pin 134 as the heat transfer cooling member is cooled via the heat insulator 152 as the heat relaxation member. This achieves dual-structure indirect cooling, that is, the atomization electrode 135 as the atomization tip is indirectly cooled via the cooling pin 134 and further via the heat insulator 152 as the heat relaxation member. In so doing, the atomization electrode 135 as the atomization tip can be kept from being cooled excessively. Excessively cooling the atomization electrode 135 as the atomization tip causes a large amount of dew condensation on the atomization unit 139, and an increase in load during atomization raises concern about an increase in input of the electrostatic atomization apparatus 131 and an atomization failure of the atomization unit 139 due to freezing and the like. According to the above-mentioned structure, however, such problems due to the load increase of the atomization unit 139 can be prevented. Since an appropriate dew condensation amount can be ensured, stable mist spray can be achieved with a low input.

Furthermore, by indirectly cooling the atomization electrode 135 as the atomization tip in the dual structure via the heat transfer cooling member (cooling pin 134) and the heat relaxation member (heat insulator 152), a direct significant influence of a temperature change of the cooling unit (low temperature cool air flowing in the freezer compartment discharge air path 141) on the atomization electrode 135 as the atomization tip can be further alleviated. This suppresses a load fluctuation of the atomization electrode 135 as the atomization tip, so that mist spray of a stable spray amount can be achieved.

Besides, the cool air generated in the cooling compartment 110 is used to cool the cooling pin 134 as the heat transfer cooling member, and the cooling pin 134 is formed of a metal piece having excellent heat conductivity. Accordingly, the cooling unit can perform necessary cooling just by heat conduction from the air path through which the cool air generated by the cooler 112 flows.

The cooling pin 134 as the heat transfer cooling member in this embodiment is shaped to have the projection 134a on the opposite side to the atomization electrode 135 as the atomization tip. This being so, in the atomization unit 139, the end 134b on the projection 134a side is closest to the cooling unit. Therefore, the cooling pin 134 is cooled by the cool air as the cooling unit, from the end 134b farthest from the atomization electrode 135.

Thus, in the part exposed to the vegetable compartment 107, only the atomization electrode 135 as the atomization tip is cooled by heat conduction. This allows for dew condensation and mist generation on the atomization electrode 135. Meanwhile, heat insulation is ensured for other components, with it being possible to prevent, for example, dew condensation of the external case 137.

Moreover, there is no communicating part between the electrostatic atomization apparatus 131 and the freezer compartment discharge air path 141, and so the low temperature cool air does not leak into the storage compartment. Accordingly, the storage compartment (vegetable compartment 107) and its peripheral components can be protected from dew condensation, low temperature anomalies, and so on.

Since the cooling unit can be made by such a simple structure, the highly reliable atomization unit 139 with a low incidence of troubles can be realized. Moreover, the cooling pin 134 as the heat transfer cooling member and the atomization electrode 135 as the atomization tip can be cooled by using the cooling source of the refrigeration cycle, which contributes to energy-efficient atomization.

In addition, the depression 111a is formed in a storage compartment (vegetable compartment 107) side part of the back partition wall 111 to which the atomization unit 139 is attached, and the atomization unit 139 having the projection 134a is inserted into this depression 111a. In this way, the heat insulator 152 constituting the back partition wall 111 of the storage compartment (vegetable compartment 107) can be used as the heat relaxation member. Hence, the heat relaxation member for properly cooling the atomization electrode 135 as the atomization tip can be provided by adjusting the thickness of the heat insulator 152, with there being no need to prepare a particular heat relaxation member. This contributes to a more simplified structure of the atomization unit 139.

Besides, in the freezer compartment discharge air path 141 situated behind the back partition wall 111, the heat insulator 152 forms the partially conical protrusion 162, but this protrusion 162 is gently sloped so as not to resist against the flow of the cool air. Accordingly, cooling capacity deterioration can be prevented. Moreover, an increase in heat conduction area for the cooling pin 134 leads to enhanced cooling efficiency for the cooling pin 134.

Thus, in this embodiment, the protrusion 162 protruding toward the freezer compartment discharge air path 141 is formed on the heat insulator 152 of the back partition wall 111 near the back of the cooling pin 134 as the heat transfer cooling member, thereby enhancing rigidity around the cooling pin 134 and further enhancing rigidity by securing the wall thickness of the heat insulator 152 when compared with the case where the cooling pin 134 side surface in the freezer compartment discharge air path 141 is flat without providing the protrusion 162 in the freezer compartment discharge air path 141. Even in such a case, the surface area for heat conduction can be increased because the cooling pin 134 as the heat transfer cooling member can be cooled both from its back and its side. Hence, the rigidity around the cooling pin 134 can be enhanced without a decrease in cooling efficiency of the cooling pin 134 as the heat transfer cooling member.

Moreover, by shaping the outer peripheral surface of the protrusion 162 to be sloped in a conical shape that tapers toward the end, the cool air flows along the outer periphery of the protrusion 162 that is curved with respect to the cool air flow direction, so that an increase in air path resistance can be suppressed. Besides, by uniformly cooling the cooling pin 134 from the outer periphery of the side wall, the cooling pin 134 as the heat transfer cooling member can be cooled evenly, as a result of which the atomization electrode 135 as the atomization tip can be cooled efficiently via the cooling pin 134 as the heat transfer cooling member.

In addition, the cooling pin 134 as the electrode connection member (heat transfer cooling member) has a certain level of heat capacity and is capable of lessening a response to heat conduction from the cooling air path (freezer compartment discharge air path 141), so that a temperature fluctuation of the atomization electrode 135 as the atomization tip can be suppressed. The cooling pin 134 also functions as a cool storage member, thereby ensuring a dew condensation time for the atomization electrode 135 as the atomization tip and also preventing freezing.

Moreover, by using the electrostatic atomization apparatus 131 as the atomization apparatus, the generated fine mist reaches throughout the vegetable compartment 107 when sprayed because the fine mist is made up of extremely small particles and so has high diffusivity. The sprayed fine mist is generated by high-voltage discharge, and so is negatively charged. Meanwhile, vegetables and fruits stored in the vegetable compartment 107 are positively charged. Accordingly, the atomized mist tends to adhere to vegetable surfaces, as a result of which the vegetable surfaces increase in humidity and also water penetrates into cells from the surfaces. This contributes to enhanced freshness preservation.

Furthermore, the nano-level fine mist adhering to the vegetable surfaces sufficiently contains OH radicals, a small amount of ozone, and the like. Such a nano-level fine mist is effective in sterilization, antimicrobial activity, microbial elimination, and so on, and also stimulates increases in nutrient of the vegetables such as vitamin C through agricultural chemical removal and antioxidation by oxidative decomposition.

When there is no water on the atomization electrode 135 as the atomization tip, the discharge distance increases and the air insulation layer cannot be broken down, and therefore no discharge phenomenon takes place. Hence, no current flows between the atomization electrode 135 and the counter electrode 136. This phenomenon may be detected by the control unit 146 of the refrigerator 100 to control on/off of the high voltage of the voltage application unit 133. By doing so, a heat load in the storage compartment can be reduced and energy can be saved.

As described above, in the fourth embodiment, the conical protrusion 162 protruding toward the freezer compartment discharge air path 141 is formed on the heat insulator 152 behind the cooling pin 134 as the projection 134a of the atomization unit 139. By enhancing the rigidity of the heat insulator 152 in this way, the heat insulator 152 can be molded easily. Moreover, the flow path resistance of the freezer compartment discharge air path 141 is minimized to ensure the cooling capacity for the cooling pin 134 as the heat transfer cooling member.

In addition, in this embodiment, by securing the wall thickness of the heat insulator 152, no leakage of low temperature cool air occurs between the vegetable compartment 107 and the adjacent freezer compartment discharge air path 141 which are separated from each other. Hence, frost formation and dew condensation of the external case 137 and the like that lead to lower reliability can be prevented.

Though the air path as the cooling unit for cooling the cooling pin 134 as the heat transfer cooling member is the freezer compartment discharge air path 141 in this embodiment, the air path may instead be a low temperature air path such as a return air path of the freezer compartment 108 or a discharge air path of the ice compartment 106. Moreover, the cooling unit is not limited to an air path, as cool air in a storage compartment of a lower temperature than the vegetable compartment 107 may equally be used. This expands an area in which the electrostatic atomization apparatus 131 can be installed.

Though the cooling unit for cooling the cooling pin 134 as the heat transfer cooling member is the air cooled using the cooling source generated in the refrigeration cycle of the refrigerator in this embodiment, it is also possible to utilize heat transmission from a cooling pipe that uses a cool temperature or cool air from the cooling source of the refrigerator. In such a case, by adjusting a temperature of the cooling pipe, the cooling pin 134 as the heat transfer cooling member can be cooled at an arbitrary temperature. This eases temperature control when cooling the atomization electrode 135 as the atomization tip.

Though the cooling unit for cooling the cooling pin 134 as the heat transfer cooling member is low temperature cool air in this embodiment, a Peltier element that utilizes a Peltier effect may be used here as an auxiliary component. In such a case, the temperature of the tip of the atomization electrode 135 can be controlled very finely by a voltage supplied to the Peltier element.

Though no cushioning material is used between the external case 137 of the electrostatic atomization apparatus 131 and the depression 111a of the heat insulator 152 in this embodiment, it is more desirable to provide a cushioning material such as urethane foam on the external case 137 of the electrostatic atomization apparatus 131 or the depression 111a of the heat insulator 152 in order to prevent the entry of moisture into the cooling pin 134 and suppress rattling. In so doing, moisture can be kept from entering into the cooling pin 134, and dew condensation on the heat insulator 152 can be prevented.

Though no water retainer is provided around the atomization electrode 135 as the atomization tip in this embodiment, a water retainer may be provided. This enables dew condensation water generated near the atomization electrode 135 to be retained around the atomization electrode 135, with it being possible to timely supply the water to the atomization electrode 135. Further, by including a water retainer or a sealing unit in the vegetable compartment 107, a high humidity can be maintained.

Though the storage compartment to which the mist is sprayed from the atomization unit 139 of the electrostatic atomization apparatus 131 is the vegetable compartment 107 in this embodiment, the mist may be sprayed to storage compartments of other temperature zones such as the refrigerator compartment 104 and the switch compartment 105. In such a case, various applications can be developed.

### Fifth Embodiment

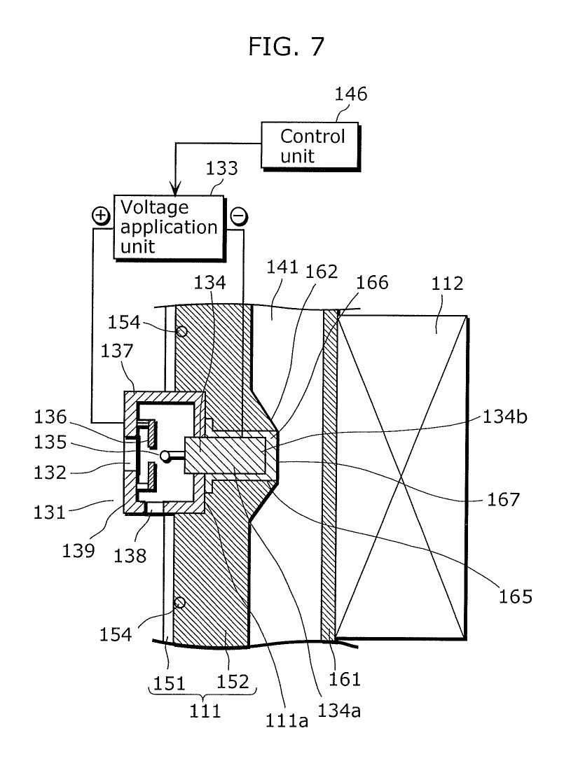

A longitudinal sectional view showing a section when a refrigerator in a fifth embodiment of the present invention is cut into left and right is approximately the same as FIG. 1, and a relevant part front view showing a back surface of a vegetable compartment in the refrigerator in the fifth embodiment of the present invention is the same as FIG. 2. FIG. 7 is a sectional view of an electrostatic atomization apparatus and its periphery included in the vegetable compartment in the refrigerator in the fifth embodiment of the present invention, as taken along line A-A in FIG. 2 and seen from the arrow direction.

In this embodiment, detailed description is given only for parts that differ from the structures described in the first to fourth embodiments, with description being omitted for parts that are the same as the structures described in the first to fourth embodiments or parts to which the same technical ideas are applicable.

In the drawing, the back partition wall 111 includes the back partition wall surface 151 made of a resin such as ABS, and the heat insulator 152 made of styrene foam or the like for ensuring heat insulation between the back partition wall surface 151 and the freezer compartment discharge air path 141. There is also the partition plate 161 for isolating the freezer compartment discharge air path 141 and the cooling compartment 110 from each other. Moreover, the heating unit 154 such as a heater is disposed between the heat insulator 152 and the back partition wall surface 151, in order to adjust the temperature of the storage compartment (vegetable compartment 107) or prevent surface dew condensation.

Here, a through part 165 is formed in a part of a storage compartment (vegetable compartment 107) side wall surface of the back partition wall 111, and the electrostatic atomization apparatus 131 as the mist spray apparatus is installed in the through part 165.

The electrostatic atomization apparatus 131 cools the atomization electrode 135 as the atomization tip included in the atomization unit 139 to the dew point temperature or below by a cooling unit, thereby causing water in the air around the atomization unit 139 to build up dew condensation on the atomization electrode 135 and generated dew condensation water to be sprayed as a mist.

In this embodiment, when causing the dew condensation, low temperature cool air flowing in the freezer compartment discharge air path 141 is used as the cooling unit and, instead of directly cooling the atomization electrode 135 as the atomization tip, the atomization electrode 135 as the atomization tip is cooled via the cooling pin 134 as the heat transfer cooling member having a larger heat capacity than the atomization electrode 135.

The electrostatic atomization apparatus 131 is mainly composed of the atomization unit 139, the voltage application unit 133, and the external case 137. The spray port 132 and the moisture supply port 138 are each formed in a part of the external case 137. The atomization electrode 135 as the atomization tip is placed in the atomization unit 139. The atomization electrode 135 is securely connected to the cooling pin 134 as the heat transfer cooling member made of a good heat conductive material such as aluminum, stainless steel, or the like, and also electrically connected including one end wired from the voltage application unit 133.

The cooling pin 134 as the electrode connection member (heat transfer cooling member) has a large heat capacity 50 times to 1000 times and preferably 100 times to 500 times that of the atomization electrode 135 as the atomization tip. The cooling pin 134 is preferably a high heat conductive member such as aluminum, copper, or the like. To efficiently conduct cold heat from one end to the other end of the cooling pin 134 by heat conduction, it is desirable that the heat insulator 152 covers a circumference of the cooling pin 134.

Thus, the cooling pin 134 has a heat capacity equal to or more than 50 times and preferably equal to or more than 100 times that of the atomization electrode 135. This further alleviates a direct significant influence of a temperature change of the cooling unit on the atomization electrode, with it being possible to spray a mist more stably with a smaller load fluctuation. Moreover, as a heat capacity upper limit, the cooling pin 134 has a heat capacity equal to or less than 1000 times and preferably equal to or less than 500 times that of the atomization electrode 135. When the heat capacity of the cooling pin 134 is excessively high, large energy is required to cool the cooling pin 134, making it difficult to save energy in cooling the cooling pin 134. By restricting the heat capacity within such an upper limit, however, it is possible to cool the atomization electrode stably and energy-efficiently, while alleviating a significant influence on the atomization electrode in the case where a heat load fluctuation from the cooling unit changes. In addition, by restricting the heat capacity within such an upper limit, a time lag required to cool the atomization electrode 135 via the cooling pin 134 can be kept within a proper range. Hence, slow start when cooling the atomization electrode, that is, when supplying water to the atomization apparatus, can be prevented and as a result the atomization electrode can be cooled stably and properly.

In the case where the through part 165 in which the cooling pin 134 as the heat transfer cooling member is provided is formed as in this embodiment, in molding of styrene foam or the like, the heat insulator decreases in rigidity, which raises a possibility of problems such as a crack and a hole caused by insufficient strength or defective molding. Thus, there is concern about quality deterioration.

In view of this, in this embodiment, the heat insulator 152 of the back partition wall 111 near the through part 165 in which the cooling pin 134 as the heat transfer cooling member is placed is provided with the protrusion 162 protruding toward the freezer compartment discharge air path 141, thereby enhancing rigidity around the through part 165 and further enhancing rigidity by securing the wall thickness of the heat insulator 152, when compared with the case where the cooling pin 134 side surface in the freezer compartment discharge air path 141 is flat without providing the protrusion 162 in the freezer compartment discharge air path 141. In addition, by forming the protrusion 162, the cooling pin 134 can be cooled both from its back and its side.

Furthermore, in order to suppress an increase in air path resistance, an outer peripheral surface of the protrusion 162 is sloped in a conical shape that tapers toward the end.

In this case, when the cooling pin 134 is directly placed in the air path (freezer compartment discharge air path 141), there is a possibility of excessive cooling that may cause an excessive amount of dew condensation or freezing of the atomization electrode 135.

Accordingly, the hole (through part 165) is formed in the heat insulator near the back of the cooling pin 134, the cooling pin 134 is inserted into the hole, and a cooling pin cover 166 formed of a resin such as PS or PP having heat insulation properties and also high waterproof properties is provided around the cooling pin 134, thereby ensuring heat insulation.

Here, the cooling pin cover 166 may be, for example, insulating tape having heat insulation properties.

Though not shown, by using a cushioning material between the hole (through part 165) and the cooling pin cover 166 to ensure sealability, it is possible to more effectively prevent the cool air from the freezer compartment discharge air path 141 from entering around the cooling pin 134.

Furthermore, though not shown, it is more advantageous to block the cool air by attaching tape or the like to an opening 167 of the through part 165.

An operation and working of the refrigerator 100 in this embodiment having the above-mentioned structure are described below.

The cooling pin 134 as the heat transfer cooling member is cooled via the cooling pin cover 166. This achieves dual-structure indirect cooling, that is, the atomization electrode 135 as the atomization tip is indirectly cooled via the cooling pin 134 and further via the cooling pin cover 166 as the heat relaxation member. In so doing, the atomization electrode 135 as the atomization tip can be kept from being cooled excessively. Excessively cooling the atomization electrode 135 as the atomization tip causes a large amount of dew condensation, and an increase in load of the atomization unit 139 raises concern about an increase in input of the electrostatic atomization apparatus 131 and an atomization failure of the atomization unit 139 due to freezing and the like. According to the above-mentioned structure, however, such problems due to the load increase of the atomization unit 139 can be prevented. Since an appropriate dew condensation amount can be ensured, stable mist spray can be achieved with a low input.

Moreover, by indirectly cooling the atomization electrode 135 as the atomization tip in the dual structure via the cooling pin 134 as the heat transfer cooling member and the heat relaxation member (cooling pin cover 166, heat insulator 152), a direct significant influence of a temperature change of the cooling unit on the atomization electrode 135 as the atomization tip can be further alleviated. This suppresses a load fluctuation of the atomization electrode 135, so that mist spray of a stable spray amount can be achieved.

Besides, the cool air generated in the cooling compartment 110 is used to cool the cooling pin 134 as the heat transfer cooling member, and the cooling pin 134 is formed of a metal piece having excellent heat conductivity. Accordingly, the cooling unit can perform necessary cooling just by heat conduction from the air path (freezer compartment discharge air path 141) through which the cool air generated by the cooler 112 flows.

The cooling pin 134 as the heat transfer cooling member in this embodiment is shaped to have the projection 134a on the opposite side to the atomization electrode 135. This being so, in the atomization unit 139, the end 134b on the projection 134a side is closest to the cooling unit. Therefore, the cooling pin 134 is cooled by the cool air as the cooling unit, from the end 134b farthest from the atomization electrode 135 as the atomization tip.

Thus, in this embodiment, the protrusion 162 protruding toward the freezer compartment discharge air path 141 is formed on the heat insulator 152 near the through part 165, thereby enhancing rigidity around the through part 165. Even in such a case, the surface area for heat conduction can be increased because the cooling pin 134 can be cooled both from its back and its side. Hence, the rigidity around the cooling pin 134 can be enhanced without a decrease in cooling efficiency of the cooling pin 134 as the heat transfer cooling member.

Moreover, by shaping the outer peripheral surface of the protrusion 162 to be sloped in a conical shape that tapers toward the end, the cool air flows along the outer periphery of the protrusion 162 that is curved with respect to the cool air flow direction, so that an increase in air path resistance can be suppressed. Besides, by uniformly cooling the cooling pin 134 as the heat transfer cooling member from the outer periphery of the side wall, the cooling pin 134 can be cooled evenly, as a result of which the atomization electrode 135 as the atomization tip can be cooled efficiently via the cooling pin 134.

In addition, the through part 165 as a through hole is formed only in one part of the heat insulator 152 behind the cooling pin 134, with there being no thin walled part. This eases molding of styrene foam, and prevents problems such as a breakage during assembly.

Furthermore, according to the structure of this embodiment, the back surface part of the cooling pin cover 166 in contact with the cooling unit (low temperature cool air) serves as the heat relaxation member. Since a heat relaxation state of the heat relaxation member can be adjusted by changing in thickness of the part of the cooling pin cover 166 in contact with the cool air, it is possible to easily change a cooling state of the cooling pin 134 as the heat transfer cooling member. For example, this structure can be applied to refrigerators of various storage capacities, by changing the thickness of the cooling pin cover 166 according to a corresponding cooling load.

Besides, there is no clearance between the cooling pin cover 166 and the through part 165 and also the opening of the through part 165 is sealed by tape or the like to block the entry of cool air from the adjacent section, so that the low temperature cool air does not leak into the storage compartment. Accordingly, the storage compartment (vegetable compartment 107) and its peripheral components can be protected from dew condensation, low temperature anomalies, and so on.

The cooling by the cooling unit is performed from the end 134b which is a part of the cooling pin 134 as the heat transfer cooling member farthest from the atomization electrode 135. In doing so, after the large heat capacity of the cooling pin 134 is cooled, the atomization electrode 135 as the atomization tip is cooled by the cooling pin 134 as the heat transfer cooling member. This further alleviates a direct significant influence of a temperature change of the cooling unit on the atomization electrode 135 as the atomization tip, with it being possible to realize stable mist spray with a smaller load fluctuation.

The generated fine mist sprayed in the vegetable compartment 107 is made up of extremely small particles and so has high diffusivity, and therefore reaches throughout the vegetable compartment 107.

By using the electrostatic atomization apparatus 131 as the atomization apparatus, the generated fine mist reaches throughout the vegetable compartment 107 when sprayed because the fine mist is made up of extremely small particles and so has high diffusivity. The sprayed fine mist is generated by high-voltage discharge, and so is negatively charged. Meanwhile, vegetables and fruits stored in the vegetable compartment 107 are positively charged. Accordingly, the atomized mist tends to gather on vegetable surfaces. This contributes to enhanced freshness preservation.

Furthermore, the nano-level fine mist adhering to the vegetable surfaces sufficiently contains OH radicals, a small amount of ozone, and the like. Such a nano-level fine mist is effective in sterilization, antimicrobial activity, microbial elimination, and so on, and also stimulates increases in nutrient of the vegetables such as vitamin C through agricultural chemical removal and antioxidation by oxidative decomposition.

In the case of using, for mist spray, dew condensation water generated from water in the air by cooling the atomization electrode 135 as the atomization tip as in this embodiment, when there is no water on the atomization electrode 135, the discharge distance increases and the air insulation layer cannot be broken down, and therefore no discharge phenomenon takes place. Hence, no current flows between the atomization electrode 135 and the counter electrode 136. This phenomenon may be detected by the control unit 146 of the refrigerator 100 to control on/off of the high voltage of the voltage application unit 133. By doing so, a heat load in the storage compartment can be reduced and energy can be saved.

As described above, in the fifth embodiment, regarding the structure of the cooling pin 134 as the projection 134a of the atomization unit 139, the through part 165 as the through hole is formed in the heat insulator 152, the cooling pin 134 is inserted into the through part 165, and the cooling pin cover 166 is provided around the cooling pin 134. This eases the molding of the heat insulator 152, while ensuring the cooling capacity for the cooling pin 134 as the heat transfer cooling member.

Moreover, by covering the side and back of the cooling pin 134 as the heat transfer cooling member with the integrally formed cooling pin cover 166, it is possible to effectively prevent the cool air from the freezer compartment discharge air path 141 situated at the back from entering around the cooling pin 134.

Though no cushioning material is provided around the cooling pin 134 in the fifth embodiment, a cushioning material may be provided. This allows for close contact between the through hole (through part 165) and the cooling pin cover 166, with it being possible to prevent cool air leakage.

Though a shield such as tape is not disposed at the opening 167 of the through hole (through part 165) in the fifth embodiment, a shield may be disposed. This makes it possible to further prevent cool air leakage.

Though the air path for cooling the cooling pin 134 as the heat transfer cooling member is the freezer compartment discharge air path 141 in this embodiment, the air path may instead be a low temperature air path such as a return air path of the freezer compartment 108 or a discharge air path of the ice compartment 106. This expands an area in which the electrostatic atomization apparatus 131 can be installed.

Though the cooling unit for cooling the cooling pin 134 as the heat transfer cooling member is the air cooled using the cooling source generated in the refrigeration cycle of the refrigerator 100 in this embodiment, it is also possible to utilize heat transmission from a cooling pipe that uses a cool temperature or cool air from the cooling source of the refrigerator 100. In such a case, by adjusting a temperature of the cooling pipe, the cooling pin 134 as the heat transfer cooling member can be cooled at an arbitrary temperature. This eases temperature control when cooling the atomization electrode 135 as the atomization tip.

In this embodiment, the cooling unit for cooling the cooling pin 134 as the heat transfer cooling member may use a Peltier element that utilizes a Peltier effect as an auxiliary component. In such a case, the temperature of the tip of the atomization electrode 135 can be controlled very finely by a voltage supplied to the Peltier element.

Though no cushioning material is used between the external case 137 of the electrostatic atomization apparatus 131 and the depression 111a of the heat insulator 152 in this embodiment, a cushioning material such as urethane foam may be disposed on the external case 137 of the electrostatic atomization apparatus 131 or the depression 111a of the heat insulator 152, in order to prevent the entry of moisture into the cooling pin 134 and suppress rattling. In so doing, moisture can be kept from entering into the cooling pin 134, and dew condensation on the heat insulator 152 can be prevented.

### Sixth Embodiment

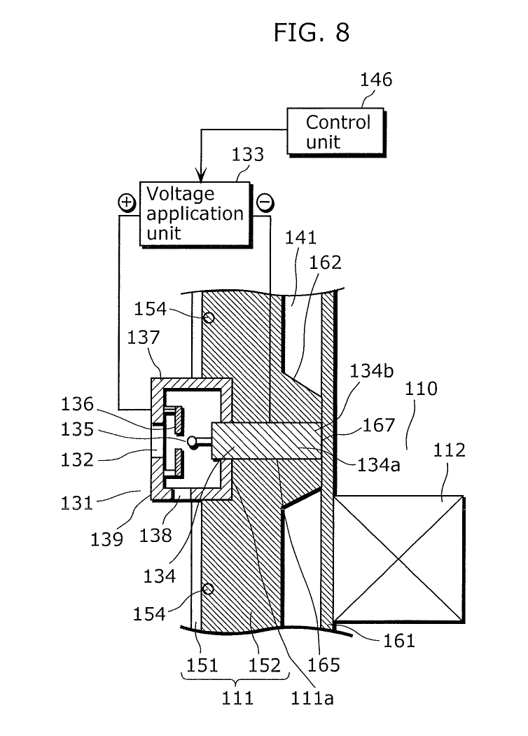

A longitudinal sectional view showing a section when a refrigerator in a sixth embodiment of the present invention is cut into left and right is approximately the same as FIG. 1, and a relevant part front view showing a back surface of a vegetable compartment in the refrigerator in the sixth embodiment of the present invention is the same as FIG. 2. FIG. 8 is a sectional view of an electrostatic atomization apparatus and its periphery included in the vegetable compartment in the refrigerator in the sixth embodiment of the present invention, as taken along line A-A in FIG. 2 and seen from the arrow direction.

In this embodiment, detailed description is given only for parts that differ from the structures described in the first to fifth embodiments, with description being omitted for parts that are the same as the structures described in the first to fifth embodiments or parts to which the same technical ideas are applicable.

In the drawing, the back partition wall 111 includes the back partition wall surface 151 made of a resin such as ABS, and the heat insulator 152 made of styrene foam or the like for ensuring heat insulation between the back partition wall surface 151 and the freezer compartment discharge air path 141. There is also the partition plate 161 for isolating the freezer compartment discharge air path 141 and the cooling compartment 110 from each other. Moreover, the heating unit 154 such as a heater is disposed between the heat insulator 152 and the back partition wall surface 151, in order to adjust the temperature of the storage compartment (vegetable compartment 107) or prevent surface dew condensation.

Here, the through part 165 is formed in a part of a storage compartment (vegetable compartment 107) side wall surface of the back partition wall 111 so as to be lower in temperature than other parts, and the electrostatic atomization apparatus 131 as the mist spray apparatus is installed in the through part 165.

The electrostatic atomization apparatus 131 is mainly composed of the atomization unit 139, the voltage application unit 133, and the external case 137. The spray port 132 and the moisture supply port 138 are each formed in a part of the external case 137.

The electrostatic atomization apparatus 131 cools the atomization electrode 135 as the atomization tip included in the atomization unit 139 to the dew point temperature or below by a cooling unit, thereby causing water in the air around the atomization unit 139 to build up dew condensation on the atomization electrode 135 and generated dew condensation water to be sprayed as a mist.

In this embodiment, when causing the dew condensation, low temperature cool air flowing in the freezer compartment discharge air path 141 is used as the cooling unit and, instead of directly cooling the atomization electrode 135 as the atomization tip, the atomization electrode 135 as the atomization tip is cooled via the cooling pin 134 as the heat transfer cooling member having a larger heat capacity than the atomization electrode 135.

The atomization electrode 135 as the atomization tip is placed in the atomization unit 139. The atomization electrode 135 is securely connected to the cooling pin 134 as the heat transfer cooling member made of a good heat conductive material such as aluminum, stainless steel, or the like, and also electrically connected including one end wired from the voltage application unit 133.

The cooling pin 134 as the electrode connection member (heat transfer cooling member) has a large heat capacity 50 times to 1000 times and preferably 100 times to 500 times that of the atomization electrode 135. The cooling pin 134 is preferably a high heat conductive member such as aluminum, copper, or the like. To efficiently conduct cold heat from one end to the other end of the cooling pin 134 by heat conduction, it is desirable that the heat insulator 152 covers a circumference of the cooling pin 134.

Thus, the cooling pin 134 has a heat capacity equal to or more than 50 times and preferably equal to or more than 100 times that of the atomization electrode 135. This further alleviates a direct significant influence of a temperature change of the cooling unit on the atomization electrode, with it being possible to spray a mist more stably with a smaller load fluctuation. Moreover, as a heat capacity upper limit, the cooling pin 134 has a heat capacity equal to or less than 1000 times and preferably equal to or less than 500 times that of the atomization electrode 135. When the heat capacity of the cooling pin 134 is excessively high, large energy is required to cool the cooling pin 134, making it difficult to save energy in cooling the cooling pin 134. By restricting the heat capacity within such an upper limit, however, it is possible to cool the atomization electrode stably and energy-efficiently, while alleviating a significant influence on the atomization electrode in the case where a heat load fluctuation from the cooling unit changes. In addition, by restricting the heat capacity within such an upper limit, a time lag required to cool the atomization electrode 135 via the cooling pin 134 can be kept within a proper range. Hence, slow start when cooling the atomization electrode, that is, when supplying water to the atomization apparatus, can be prevented and as a result the atomization electrode can be cooled stably and properly.

The through part 165 is formed behind the depression 111a, and the projection 134a of the cooling pin 134 as the heat transfer cooling member is placed in the through part 165.

In the case where the through part 165 in which the cooling pin 134 as the heat transfer cooling member is provided is formed as in this embodiment, in molding of styrene foam or the like, the heat insulating wall decreases in rigidity, which raises a possibility of problems such as a crack and a hole caused by insufficient strength or defective molding. Thus, there is concern about quality deterioration.

In view of this, in this embodiment, the heat insulator 152 near the through part 165 is provided with the protrusion 162 protruding toward the freezer compartment discharge air path 141 so that its end is in contact with the partition plate 161, thereby enhancing rigidity around the through part 165 and further enhancing rigidity by securing the wall thickness of the heat insulator 152, when compared with the case where the cooling pin 134 side surface in the freezer compartment discharge air path 141 is flat without providing the protrusion 162 in the freezer compartment discharge air path 141. In addition, by forming the protrusion 162, the cooling pin 134 can be cooled both from its back and its side.

When the cooling pin 134 as the heat transfer cooling member is directly placed in the air path (freezer compartment discharge air path 141), there is a possibility of excessive cooling that may cause an excessive amount of dew condensation or freezing of the atomization electrode 135 as the atomization tip.

Accordingly, the through hole 165 is formed in the heat insulator 152 behind the atomization electrode 135 as the atomization tip, the protrusion 162 protruding toward the freezer compartment discharge air path 141 so that its end is in contact with the partition plate 161 is formed on the heat insulator 152 near the through part 165, and the cooling pin 134 is inserted into the through hole 165, thereby ensuring heat insulation. By doing so, the cooling pin 134 is not directly in contact with the cooling unit, but in contact with the cooling unit via the partition plate 161 and the heat insulator 152 as the heat relaxation member.

In this case, the side surfaces of the substantially cylindrical cooling pin 134 are entirely covered with the heat insulator 152.

Moreover, the partition plate 161 that separates the freezer compartment discharge air path 141 and the cooling compartment 110 from each other shields the opening 167 of the through part 165 from the air path, thereby ensuring sealability.

Though not shown, tape or the like may be attached to the opening 167 of the through hole (through part 165) to block the cool air.

An operation and working of the refrigerator 100 in this embodiment having the above-mentioned structure are described below.

The cooling pin 134 as the heat transfer cooling member is cooled from its side via the protrusion 162 of the heat insulator 152. This achieves dual-structure indirect cooling, that is, the atomization electrode 135 as the atomization tip is indirectly cooled via the cooling pin 134 and further via the protrusion 162 of the heat insulator 152. In so doing, the atomization electrode 135 can be kept from being cooled excessively.

Moreover, the heat insulator 152 conically surrounds the circumference of the cylindrical cooling pin 134, where a thinnest heat insulation wall part is farthest from the atomization electrode 135. This makes it possible to cool especially a side peripheral part of the cooling pin 134 near the opening 167 most intensively and also cool other parts from the outer periphery of the side wall uniformly.

In addition, the end surface of the cooling pin 134 on the air path (freezer compartment discharge air path 141) side is shielded from the air path (freezer compartment discharge air path 141) by the partition plate 161. Furthermore, a creepage distance is ensured by pressing the protrusion 162 against the partition plate 161 while securing a certain distance of the end surface of the protrusion 162, to thereby prevent the cool air from directly contacting the cooling pin 134 as the heat transfer cooling member. Here, tape or the like may be attached to the end surface to enhance sealability. By fixing the opening 167 of the through hole 165 to the partition plate 161 in this manner, even when a heat deformation occurs in the refrigerator 100 that widely varies in temperature due to outside air temperature, inside temperature, defrosting control, and the like, the cooling pin 135 and the atomization unit 139 can be fixed more securely.

Moreover, the through hole 165 is formed only in one part of the heat insulator 152 behind the cooling pin 134, with there being no thin walled part. This eases molding of styrene foam, and prevents problems such as a breakage during assembly.

Furthermore, there is no clearance between the cooling pin 134 and the through hole 165, and also the opening 167 of the through hole 165 is shielded from the cool air by tape or the like. Since there is no communicating part, the low temperature cool air does not leak into the storage compartment. Accordingly, the storage compartment (vegetable compartment 107) and its peripheral components can be protected from dew condensation, low temperature anomalies, and so on.

Besides, the back partition wall 111 can be made thinner, allowing for an increase in storage capacity of the storage compartment.

In such cooling by the cooling unit, the end 134b which is a part of the cooling pin 134 as the heat transfer cooling member farthest from the atomization electrode 135 is cooled most intensively. In doing so, after the large heat capacity of the cooling pin 134 is cooled, the atomization electrode 135 as the atomization tip is cooled by the cooling pin 134 as the heat transfer cooling member. This further alleviates a direct significant influence of a temperature change of the cooling unit on the atomization electrode 135 as the atomization tip, with it being possible to realize stable mist spray with a smaller load fluctuation.

By using the electrostatic atomization apparatus 131 as the atomization apparatus, the generated fine mist reaches throughout the vegetable compartment 107 when sprayed because the fine mist is made up of extremely small particles and so has high diffusivity. The sprayed fine mist is generated by high-voltage discharge, and so is negatively charged. Meanwhile, vegetables and fruits stored in the vegetable compartment 107 are positively charged. Accordingly, the atomized mist tends to gather on vegetable surfaces. This contributes to enhanced freshness preservation.

Furthermore, the nano-level fine mist adhering to the vegetable surfaces sufficiently contains OH radicals, a small amount of ozone, and the like. Such a nano-level fine mist is effective in sterilization, antimicrobial activity, microbial elimination, and so on, and also stimulates increases in nutrient of the vegetables such as vitamin C through agricultural chemical removal and antioxidation by oxidative decomposition.

When there is no water on the atomization electrode 135, the discharge distance increases and the air insulation layer cannot be broken down, and therefore no discharge phenomenon takes place. Hence, no current flows between the atomization electrode 135 and the counter electrode 136. This phenomenon may be detected by the control unit 146 of the refrigerator 100 to control on/off of the high voltage of the voltage application unit 133. By doing so, a heat load in the storage compartment can be reduced and energy can be saved.

As described above, in the sixth embodiment, regarding the structures of the cooling pin 134 as the projection 134a of the atomization unit 139, the heat insulator 152, and the cooling compartment 110, the through hole 165 is formed in the heat insulator 152, the cooling pin 134 is inserted into the through hole 165, and the end surface of the cooling pin 134 is covered with the partition plate 161. As a result, the cooling pin 134 as the heat transfer cooling member is cooled via the protrusion 162 of the heat insulator 152 and the partition plate 161. This achieves dual-structure indirect cooling, that is, the atomization electrode 135 as the atomization tip is indirectly cooled via the cooling pin 134 as the heat transfer cooling member and further via the protrusion 162 of the heat insulator 152. In so doing, the atomization electrode 135 as the atomization tip can be kept from being cooled excessively. In addition, the end surface of the cooling pin 134 on the air path (freezer compartment discharge air path 141) side is shielded from the air path (freezer compartment discharge air path 141) by the partition plate 161. Furthermore, a creepage distance is ensured by pressing the protrusion 162 against the partition plate 161 while securing a certain distance of the end surface of the protrusion 162, to thereby prevent the cool air from directly contacting the cooling pin 134.

Moreover, in the case of forming the through hole 165 in the heat insulator 152 behind the atomization unit 139 as in this embodiment, by abutting and fixing one end of the atomization unit 139 not only to the wall surface of the storage compartment including the atomization unit 139 but also to the partition plate 161 via the air path, the atomization unit 139 can be fixed more accurately even when the heat insulator 152 as the heat insulation wall is somewhat deformed by heat contraction or heat expansion due to a temperature change in the refrigerator. It is possible to prevent quality deterioration caused by leakage of cool air into the storage compartment and the like as a result of providing the through hole 165 in the heat insulator 152. Hence, the storage compartment including the atomization unit 139 of sufficient reliability can be provided even in the refrigerator that is intended to be used for a long period of time.

Thus, the cooling pin 134 can be protected from excessive cooling, and the storage compartment (vegetable compartment 107) can be protected from excessive cooling and dew condensation caused by cool air leakage and the like.

In addition, in this embodiment, the protrusion 162 protruding toward the freezer compartment discharge air path 141 is formed on the heat insulator 152 of the back partition wall 111 near the back of the cooling pin 134 as the heat transfer cooling member, thereby enhancing rigidity around the cooling pin 134 when compared with the case where the cooling pin 134 side surface in the freezer compartment discharge air path 141 is flat without providing the protrusion 162 in the freezer compartment discharge air path 141. This enables the cooling pin 134 as the heat transfer cooling member to be cooled from its side, and so the surface area for heat conduction can be increased. Hence, the rigidity around the cooling pin 134 can be enhanced without a decrease in cooling efficiency of the cooling pin 134 as the heat transfer cooling member.

Moreover, by shaping the outer peripheral surface of the protrusion 162 to be sloped in a conical shape that tapers toward the end, the cool air flows along the outer periphery of the protrusion 162 that is curved with respect to the cool air flow direction, so that an increase in air path resistance of the freezer compartment discharge air path 141 can be suppressed. Besides, by uniformly cooling the cooling pin 134 from the outer periphery of the side wall, the cooling pin 134 can be cooled evenly, as a result of which the atomization electrode 135 as the atomization tip can be cooled efficiently via the cooling pin 134 as the heat transfer cooling member.

Here, the protrusion 162 may be shaped as a cylinder. In such a case, the cooling pin 134 can be cooled uniformly from its side, with it being possible to cool the cooling pin 134 more evenly.

In this embodiment, by fixing (pressing) the opening 167 of the through hole 165 to the partition plate 161, even when a heat deformation occurs in the refrigerator 100 that widely varies in temperature due to outside air temperature, inside temperature, defrosting control, and the like, the cooling pin 135 and the atomization unit 139 can be fixed more securely.

Though no cushioning material is provided around the cooling pin 134 in the sixth embodiment, a cushioning material may be provided. This allows for close contact between the through hole (through part 165) and the cooling pin 134, with it being possible to prevent cool air leakage. Moreover, though a shield such as tape is not disposed at the opening 167 of the through hole (through part 165) in the sixth embodiment, a shield may be disposed. This makes it possible to further prevent cool air leakage.

Though no cushioning material is used between the external case 137 of the electrostatic atomization apparatus 131 and the through hole 165 of the heat insulator 152 in this embodiment, a cushioning material such as urethane foam may be disposed on the external case 137 of the electrostatic atomization apparatus 131 or the depression 111a or the through hole 165 of the heat insulator 152, in order to prevent the entry of moisture into the cooling pin 134 and suppress rattling. Moreover, the cooling pin cover may be provided as in the fifth embodiment shown in FIG. 7. In so doing, moisture can be kept from entering into the cooling pin 134, and dew condensation on the heat insulator 152 can be prevented.

### Seventh Embodiment

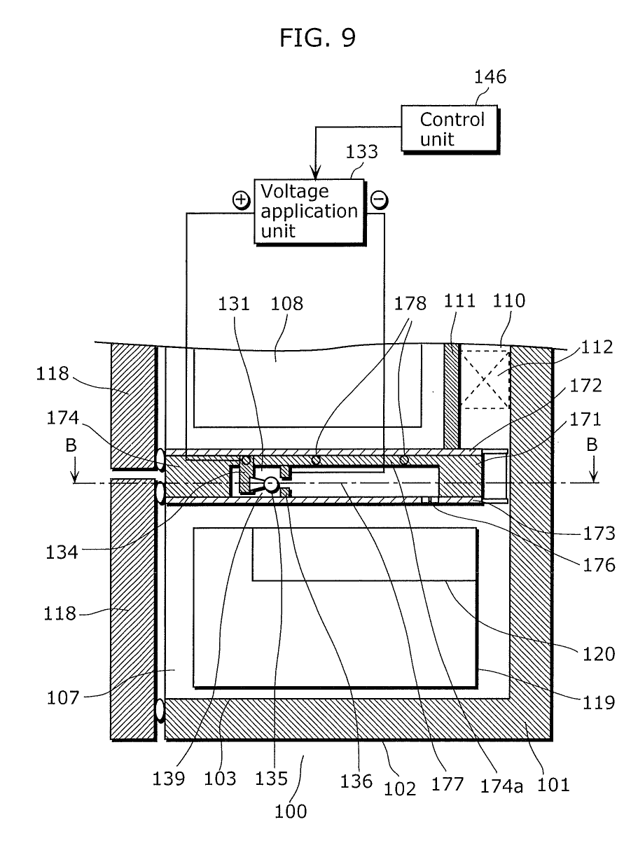

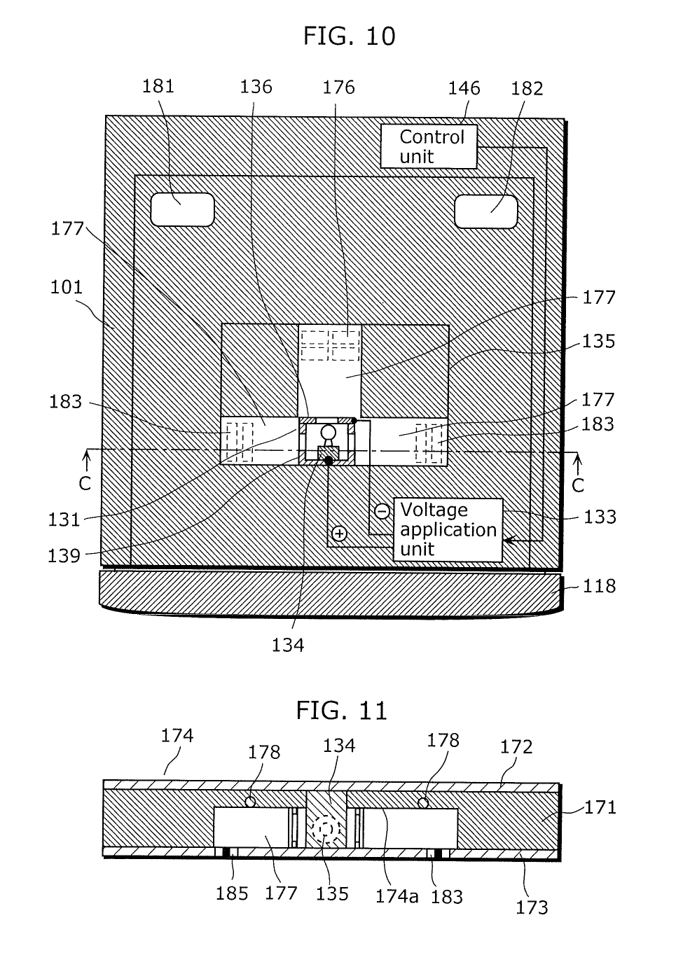

FIG. 9 is a relevant part longitudinal sectional view showing a section when a vegetable compartment and a periphery of a partition wall above the vegetable compartment in a refrigerator in a seventh embodiment of the present invention are cut into left and right. FIG. 10 is a sectional view of the refrigerator in the seventh embodiment of the present invention, as taken along line B-B in FIG. 9 and seen from an arrow direction. FIG. 11 is a sectional view of the partition wall above the vegetable compartment in the refrigerator in the seventh embodiment of the present invention, as taken along line C-C in FIG. 10 and seen from an arrow direction.

In this embodiment, detailed description is mainly given for parts that differ from the structures described in the first to sixth embodiments, with detailed description being omitted for parts that are the same as the structures described in the first to sixth embodiments or parts to which the same technical ideas are applicable.

In the drawing, the heat-insulating main body 101 which is a main body of the refrigerator 100 is formed by the outer case 102 mainly composed of a steel plate, the inner case 103 molded with a resin such as ABS, and a foam heat insulation material such as rigid urethane foam charged in a space between the outer case 102 and the inner case 103. The heat-insulating main body 101 is thermally insulated from its surroundings, and the refrigerator 100 is partitioned into a plurality of storage compartments. In this embodiment, the vegetable compartment 107 is located at the bottom of the refrigerator 100, and the freezer compartment 108 set at a freezing temperature which is a relatively low temperature is located above the vegetable compartment 107. The vegetable compartment 107 and the freezer compartment 108 are separated by a partition wall 174 as separate storage compartments.

The cooling compartment 110 for generating cool air is provided behind the freezer compartment 108. An air path for conveying cool air to each compartment having heat insulation properties and the back partition wall 111 for heat insulating partition from each storage compartment are formed between the cooling compartment 110 and the freezer compartment 108.

The cool air generated by the cooler 112 in the cooling compartment 110 is conveyed to each storage compartment by the cooling fan 113. In this embodiment, the cool air generated by the cooler 112 above the vegetable compartment 107 flows into the vegetable compartment 107 via a vegetable compartment discharge air path 182, directly or using a return air path after heat exchange in another storage compartment. The cool air then returns to the cooler 112 via a vegetable compartment suction air path 181.

The partition wall 174 is disposed above the vegetable compartment 107 to separate the vegetable compartment 107 from the freezer compartment 108.

The partition wall 174 includes a vegetable compartment side partition plate 173 and a freezer compartment side partition plate 172 made of a resin such as ABS, and a heat insulator 171 made of styrene foam, urethane, or the like for ensuring heat insulation between the vegetable compartment side partition plate 173 and the freezer compartment side partition plate 172. Here, a depression 174a is formed in a part of a storage compartment 107 side wall surface of the partition wall 174 so as to be lower in temperature than other parts, and the electrostatic atomization apparatus 131 as the mist spray apparatus and a mist air path 177 are situated in the depression 174a.

The electrostatic atomization apparatus 131 is mainly composed of the atomization unit 139 and the voltage application unit 133. The atomization electrode 135 is placed in the atomization unit 139. The atomization electrode 135 is securely connected to the cooling pin 134 as the electrode connection member (heat transfer cooling member) made of a good heat conductive material such as aluminum, stainless steel, brass, or the like, and also electrically connected including one end wired from the voltage application unit 133.

The cooling pin 134 as the electrode connection member (heat transfer cooling member) has a large heat capacity equal to or more than 50 times and preferably equal to or more than 100 times that of the atomization electrode 135. The cooling pin 134 is preferably a high heat conductive member such as aluminum, copper, or the like. To efficiently conduct cold heat from one end to the other end of the cooling pin 134 by heat conduction, it is desirable that the heat insulator covers a circumference of the cooling pin 134.

Moreover, the heat conduction of the atomization electrode 135 and the cooling pin 134 needs to be maintained for a long time. Accordingly, an epoxy material or the like is poured into the connection part to prevent moisture and the like from entering, thereby suppressing a heat resistance and fixing the atomization electrode 135 and the cooling pin 134 together. Here, the atomization electrode 135 may be fixed to the cooling pin 134 by pressing and the like, in order to reduce the heat resistance.

In addition, since the cooling pin 134 needs to conduct cool temperature heat in the heat insulator for thermally insulating the storage compartment from the cooler 112 or the air path, it is desirable that the cooling pin 134 has a length equal to or more than 5 mm and preferably equal to or more than 10 mm. Note, however, that a length equal to or more than 30 mm reduces effectiveness, and also causes an increase in thickness of the partition wall 174 which leads to a smaller storage capacity.

Note that the electrostatic atomization apparatus 131 placed in the storage compartment (vegetable compartment 107) is in a high humidity environment and this humidity may affect the cooling pin 134. Accordingly, the cooling pin 134 is preferably made of a metal material that is resistant to corrosion and rust, or a material that has been coated or surface-treated by, for example, alumite.

The cooling pin 134 as the heat transfer cooling member is fixed to the heat insulator 171 by being fitted in the depression 174a formed in a part of the heat insulator 171, and the atomization electrode 135 is attached to the cooling pin 134 so as to form an L-shaped protrusion. This contributes to the thinner partition wall 174 to thereby increase the storage capacity.

This being so, an opposite end surface of the cooling pin 134 as the heat transfer cooling member to the atomization electrode 135 is pressed against the freezer compartment side partition plate 172 formed of a resin such as ABS or PP. The atomization electrode 135 as the atomization tip is cooled by heat conduction from the freezer compartment 108 via the freezer compartment side partition plate 172, thereby building up dew condensation on the tip of the atomization electrode 135 and generating water.

Since the cooling unit can be made by such a simple structure, the atomization unit 139 of high reliability with a low incidence of troubles can be realized. Moreover, the cooling pin 134 as the heat transfer cooling member and the atomization electrode 135 as the atomization tip can be cooled by using the cooling source of the refrigeration cycle, which contributes to energy-efficient atomization.

The counter electrode 136 shaped like a circular doughnut plate is installed in a position facing the atomization electrode 135 so as to have a constant distance from the tip of the atomization electrode 135. The mist air path 177 is formed on a further extension from the atomization electrode 135.

The mist air path 177 is provided in the depression 174a of the partition wall 174 that separates the vegetable compartment 107 and the freezer compartment 108 from each other.

The partition wall 174 is 25 mm to 45 mm to ensure the heat insulation and the storage capacity. The mist air path 177 is situated in the depression 174a of the partition wall 174.

The mist air path 177 has a suction port 183 for supplying moisture from the vegetable compartment 107 and a mist discharge port 176 for spraying a mist into the vegetable compartment 107. High humidity air flows into the atomization unit 139 from this mist suction port 183, and the atomization electrode 135 of the atomization unit 139 is cooled via the cooling pin by heat conduction from the freezer compartment, as a result of which dew condensation is formed at the tip of the atomization electrode 135.

Applying a high voltage between the tip of the atomization electrode 135 and the counter electrode 136 causes a mist to be generated.

The generated mist passes through the mist air path 177, and is sprayed into the vegetable compartment 107 from the mist discharge port 176.

Moreover, the voltage application unit 133 is electrically connected to the atomization unit 139. A negative potential side of the voltage application unit 133 generating a high voltage is electrically wired and connected to the atomization electrode 135, and a positive potential side of the voltage application unit 133 is electrically wired and connected to the counter electrode 136.

Discharge constantly occurs in the vicinity of the atomization electrode 135 for mist spray, which raises a possibility that the tip of the atomization electrode 135 wears out. The refrigerator 100 is typically intended to operate for 10 years or more. Therefore, a strong surface treatment needs to be performed on the surface of the atomization electrode 135. For example, the use of nickel plating, gold plating, or platinum plating is desirable.

The counter electrode 136 is made of, for example, stainless steel. Long-term reliability needs to be ensured for the counter electrode 136. In particular, to prevent foreign substance adhesion and contamination, it is desirable to perform a surface treatment such as platinum plating on the counter electrode 136.

The voltage application unit 133 communicates with and is controlled by the control unit 146 of the refrigerator main body (heat-insulating main body 101), and switches the high voltage on or off according to an input signal from the refrigerator 100 or the electrostatic atomization apparatus 131.

Note that a heating unit 178 such as a heater is disposed in the partition wall 174 to which the electrostatic atomization apparatus 131 is fixed, in order to prevent dew condensation in the air path.

An operation and working of the refrigerator having the above-mentioned structure are described below.

The heat insulator 171 of the partition wall 174 in which the electrostatic atomization apparatus 131 is installed needs to have such a thickness that allows the cooling pin 134 to which the atomization electrode 135 is fixed, to be cooled. Accordingly, a part of the heat insulator 171 provided with the electrostatic atomization apparatus 131 has a smaller wall thickness than other parts. As a result, the cooling pin 134 as the heat transfer cooling member can be cooled by heat conduction from the freezer compartment of a relatively low temperature, with it being possible to cool the atomization electrode 135 as the atomization tip. When the tip of the atomization electrode 135 drops to the dew point or below, a water vapor near the atomization electrode 135 builds up dew condensation on the atomization electrode 135, thereby reliably generating water droplets.

Though not shown, by installing an inside temperature detection unit, an inside humidity detection unit, and the like in the storage compartment, the dew point can be precisely calculated by a predetermined computation according to a change in storage compartment environment.

In this state, the voltage application unit 133 applies a high voltage (for example, 7.5 kV) between the atomization electrode 135 and the counter electrode 136, where the atomization electrode 135 is on a negative voltage side and the counter electrode 136 is on a positive voltage side. This causes an air insulation layer to be broken down and corona discharge to occur between the electrodes. Water on the atomization electrode 135 is atomized from the electrode tip, and a nano-level fine mist carrying an invisible charge less than 1 μm, accompanied by ozone, OH radicals, and so on, is generated.

The generated fine mist is sprayed into the vegetable containers (lower storage container 119, upper storage container 120) in the vegetable compartment 107. The fine mist sprayed from the electrostatic atomization apparatus 131 is negatively charged. Meanwhile, green leafy vegetables, fruits, and the like stored in the vegetable compartment 107 usually tend to be in a rather wilted state as a result of transpiration on the way home from shopping or transpiration during storage, and so these vegetables and fruits are usually positively charged. Accordingly, the sprayed fine mist carrying a negative charge tends to gather on vegetable surfaces. Thus, the sprayed fine mist increases the humidity of the vegetable compartment 107 again and simultaneously adheres to the surfaces of the vegetables and fruits, thereby suppressing transpiration from the vegetables and fruits and enhancing freshness preservation. The fine mist also penetrates into tissues via intercellular spaces of the vegetables and fruits, as a result of which water is supplied into cells that have wilted due to moisture evaporation to resolve the wilting by cell turgor pressure, and the vegetables and fruits return to a fresh state.

Moreover, the generated fine mist contains ozone, OH radicals, and the like, which possess strong oxidative power. Hence, the generated fine mist can perform deodorization in the vegetable compartment and antimicrobial activity and sterilization on the vegetable surfaces, and also oxidative-decompose and remove harmful substances such as agricultural chemicals and wax adhering to the vegetable surfaces.

As described above, in the seventh embodiment, the refrigerator main body (heat-insulating main body 101) has a plurality of storage compartments. The freezer compartment 108 as the lower temperature storage compartment maintained at a lower temperature than the vegetable compartment 107 as the storage compartment including the atomization unit 139 is provided on the top side of the vegetable compartment 107 as the storage compartment including the atomization unit 139. The atomization unit 139 is attached to the partition wall 174 on the top side of the vegetable compartment 107.

Thus, in the case where a freezing temperature zone storage compartment such as the freezer compartment 108 or the ice compartment 106 is located above the storage compartment (vegetable compartment 107) including the atomization unit 139, by installing the atomization unit 139 in the partition wall 174 at the top separating these storage compartments, the cooling pin 134 as the heat transfer cooling member in the atomization unit 139 is cooled by cool air of the storage compartment (freezer compartment 108) above the vegetable compartment 107, with it being possible to cool and build up dew condensation on the atomization electrode 135. Since the atomization unit 139 can be provided by a simple structure with there being no need for a particular cooling apparatus, a highly reliable atomization unit with a low incidence of troubles can be realized.

In this embodiment, the refrigerator 100 is provided with the partition wall for separating the storage compartment, and the lower temperature storage compartment (freezer compartment 108) on the top side of the storage compartment (vegetable compartment 107). The electrostatic atomization apparatus 131 is attached to the partition wall 174 at the top of the vegetable compartment 107. Thus, in the case where a freezing temperature zone storage compartment such as the freezer compartment 108 or the ice compartment 106 is located above the storage compartment, by installing the electrostatic atomization apparatus 131 in the partition wall 174 at the top separating these compartments, a cooling source of the freezing temperature zone storage compartment can be used to cool and build up dew condensation on the atomization electrode 135 as the atomization tip of the electrostatic atomization apparatus 131. This makes it unnecessary to provide any particular cooling apparatus. Moreover, since the mist is sprayed from the top, the mist can be easily diffused throughout the storage containers (lower storage container 119, upper storage container 120) in the vegetable compartment 107.

In addition, since the atomization unit 139 is not disposed in the storage space of the vegetable compartment 107 but disposed on the back side of the vegetable compartment side partition plate 173, the atomization unit 139 is difficult to reach by hand, which contributes to enhanced safety.

In this embodiment, the atomization unit 139 generates a mist according to the electrostatic atomization method, where water droplets are finely divided using electrical energy such as a high voltage to thereby form a fine mist. The generated mist is electrically charged. This being so, by causing the mist to carry an opposite charge to vegetables, fruits, and the like to which the mist is intended to adhere, for example, by spraying a negatively charged mist over positively charged vegetables, the adhesion of the mist to the vegetables and fruits increases, as a result of which the mist can adhere to the vegetable surfaces more uniformly. In this way, a mist adhesion ratio can be improved when compared with an uncharged mist. Moreover, the fine mist can be directly sprayed over the foods in the vegetable containers (lower storage container 119, upper storage container 120), and the potentials of the fine mist and the vegetables are exploited to cause the fine mist to adhere to the vegetable surfaces. This improves freshness preservation efficiently.

In this embodiment, not tap water supplied from outside but dew condensation water is used. Since dew condensation water is free from mineral compositions and impurities, deterioration in water retentivity caused by deterioration or clogging of the tip of the atomization electrode 135 can be prevented.

In this embodiment, the mist contains radicals, so that agricultural chemicals, wax, and the like adhering to the vegetable surfaces can be decomposed and removed with an extremely small amount of water. This benefits water conservation, and also achieves a low input.

### Eighth Embodiment

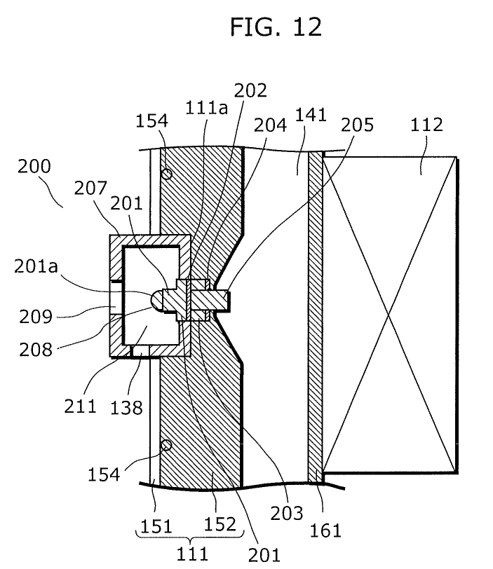

FIG. 12 is a detailed sectional view of an ultrasonic atomization apparatus and its periphery in a refrigerator in an eighth embodiment of the present invention.

In this embodiment, detailed description is mainly given for parts that differ from the structures described in the first to seventh embodiments, with detailed description being omitted for parts that are the same as the structures described in the first to seventh embodiments or parts to which the same technical ideas are applicable.

In the drawing, the back partition wall 111 includes the back partition wall surface 151 made of a resin such as ABS, and the heat insulator 152 made of styrene foam or the like for ensuring heat insulation of the storage compartment. There is also the partition plate 161 for isolating the freezer compartment discharge air path 141 and the cooling compartment 110 from each other. Moreover, the heating unit 154 such as a heater is disposed between the heat insulator 152 and the back partition wall surface 151, in order to adjust the temperature of the storage compartment or prevent surface dew condensation.

Here, the depression 111a is formed in a part of a storage compartment side wall surface of the back partition wall 111, and a horn-type ultrasonic atomization apparatus 200 which is a mist spray apparatus, namely, an atomization apparatus, is installed in the depression 111a.

Thus, the ultrasonic atomization apparatus 200 as the atomization apparatus is installed in the back partition wall 111 including the heating unit 154 such as a heater from among the side walls, where the heating unit 154 is disposed at least at a lower position than the ultrasonic atomization apparatus 200.

The ultrasonic atomization apparatus 200 includes a horn-type ultrasonic vibrator 208 composed of a horn unit 201 and a cooling pin 205 (heat transfer cooling member) as an atomization unit 211, electrodes 202 and 204, and a piezoelectric element 203, an external case 207 fixing and surrounding these components, and a spray port 209 included in the external case to spray a mist into the vegetable compartment. The horn unit 201 as an atomization tip has a projection from its bottom toward its end by a process such as cutting or sintering. A tip 201a of the horn unit 201 is processed in a rectangular or circular shape, and has a cross-sectional ratio of about ⅕ or below. A side surface shape of the horn unit 201 depends on an oscillation frequency of the piezoelectric element 203. The horn unit 201, the electrode 202, the piezoelectric element 203, and the electrode 204 are integrally formed in this order, and each connection part is bonded and fixed by an epoxy or silicon adhesive. The horn-type ultrasonic vibrator 208 is designed so that the vibration generated by the piezoelectric element 203 reaches a maximum amplitude at the horn unit tip 201a.

Though not shown, the piezoelectric element and the electrode are shaped as a cylinder with a hollow central part. The cooling pin is formed in this hollow, and fixed to the horn unit 201 by pressure.

The outline of the horn-type ultrasonic vibrator 208 is coated with a silicon resin, an epoxy resin, an acrylic resin, or the like (not shown).

The horn unit 201 as the atomization tip is made of a high heat conductive material. Examples of the material include metals such as aluminum, titanium, and stainless steel. In particular, a material having aluminum as a main component is preferable in terms of light weight, high heat conduction, and amplitude amplification performance during ultrasonic propagation. However, for a refrigerator and the like which require a corrosion resistance and a service life improvement, a material having stainless steel such as SUS304 and SUS316L as a main component is desirable because aged deterioration hardly occurs and reliability can be ensured over a long period of time.

The spray port 209 is formed as a rectangular or circular hole in a part of the external case 207 so as to be situated in a direction in which the liquid is atomized from the atomization unit 211, that is, in a part of the external case 207 facing the tip 201a of the horn unit 201.

The ultrasonic atomization apparatus 200 as the atomization apparatus cools the horn 201 as the atomization tip included in the atomization unit 211 to the dew point temperature or below by a cooling unit, thereby causing water in the air around the atomization unit to build up dew condensation on the horn unit 201 and generated dew condensation water to be sprayed as a mist from the tip 201a.

When a high humidity state continues due to door opening/closing or the like and dew condensation water is supplied to the horn unit 201 more than necessary, water is discharged from the drainage port 138. The drainage port 138 has a function as a cool air supply port for taking cool air into the external case 207, in addition to a function as a drainage hole for draining water accumulated in the external case 207 to outside.

The drained dew condensation water flows along the back partition wall surface 151 of the partition wall 111, but is evaporated by convection in the vegetable compartment and the heater on the back surface because it is of an extremely small quantity. At this time, since the heating unit 154 such as the heater is installed in the wall surface, an ascending air current is likely to occur around the back partition wall 111 when compared with other side walls. Accordingly, by disposing the atomization unit 211 in the back partition wall 111, high humidity cool air flows in again from the drainage port 138 situated in a lower part of the external case 207 that houses the atomization unit and functioning as a cool air supply port, with it being possible to further stimulate dew condensation.

An operation of the refrigerator having the above-mentioned structure is described below.

The cooling pin 205 in the ultrasonic atomization apparatus 200 installed in a part of the back partition wall 111 is cooled by the freezer compartment air path in which lower temperature cool air than the vegetable compartment flows. Since the cooling pin 205 and the horn unit 201 are pressed together, the horn unit 201 as the atomization tip is cooled by heat conduction, and as a result an excess water vapor contained in high humidity air in the vegetable compartment forms dew condensation on the horn unit 201 decreased in temperature. Dew condensation water generated in this way adheres to the tip 201a.

In this state, by energizing a high voltage oscillation circuit, a high voltage is generated at a predetermined frequency (for example, 80 kHz to 210 kHz) and applied to the electrodes 202 and 204. This causes the piezoelectric element 202 to vibrate, as a result of which a capillary wave occurs on the surface of the supplied water adhering to the tip 201a of the atomization unit 211, and the water at the tip is divided into fine particles of several μm to several tens of μm and atomized as a mist in a vibration direction. When the fine particle mist passes through the spray port 209, a mist of a large particle diameter generated from other than the tip 201a of the horn unit 201 collides with a peripheral wall of the rectangular or circular spray port 209 and remains inside the case without being sprayed into the storage compartment. Therefore, only a fine mist of a relatively small particle diameter is sorted and sprayed into the vegetable compartment 107 as the storage compartment.

The ultrasonic atomization apparatus 200 is energized at a fixed interval, such as by turning on for one minute and turning off for nine minutes. In this way, the mist is sprayed into the vegetable compartment 107 while adjusting an atomization amount, thereby quickly humidifying the vegetable compartment 107. This enables the vegetable compartment 107 to become high in humidity, as a result of which transpiration from vegetables can be suppressed. Moreover, since energy is concentrated so that the vibration generated by the piezoelectric element 203 is maximized in amplitude at the tip 201a of the horn unit 201, the piezoelectric element 203 is limited to a low amount of heat generation of about 1 W to 2 W, with it being possible to reduce a temperature influence on the vegetable compartment 107.

It is preferable that, in terms of amplitude amplification performance during ultrasonic propagation, a coating material covering the piezoelectric element 203 is mainly composed of a silicon resin that has flexibility and so does not easily deteriorate even by repeated vibrations, in order to prevent coating material deterioration in a refrigerator that is intended to be used over a long period of time of about 10 years on average. By preventing liquid and water vapor entry in each connection part between the horn unit 201, the electrode 202, the piezoelectric element 203, and the electrode 204 and also preventing adhesive deterioration, lifetime reliability can be improved, with it being possible to achieve a structure that can tolerate an actual load when installed in a refrigerator.

Note that a packing material (not shown) may be used in a clearance between the external case 207 and the horn-type ultrasonic vibrator, for water leakage prevention and resonance prevention. In so doing, the liquid or water vapor entry mentioned above can be prevented more reliably, and also noise can be reduced. In detail, the use of a fluorine-based packing material contributes to improved lifetime reliability.

As described above, in this embodiment, the vegetable compartment is thermally insulated in a relatively high humidity environment, and the horn-type ultrasonic atomization apparatus is provided to spray the liquid into the vegetable compartment. By installing the cooling pin in the horn unit to generate dew condensation water at the horn tip, dew condensation is formed at the tip and directly sprayed to thereby preserve food quality in the vegetable compartment.

Note that, in this embodiment, the atomized liquid may be zinc ion water, silver ion water, copper ion water, or the like containing a metal ion that has bacteriostatic power and deodorizing power. This makes it possible to enhance the effect of suppressing bacteria generated in the storage compartment.

Though the shape of the part of the heat insulator 152 provided with the cooling pin 205 is exemplified as shown in FIG. 12 in this embodiment, it should be obvious that the same advantages can be attained even when the shape of the part where the cooling pin 205 is disposed is any of the shapes as described in the first to seventh embodiments.

Though the atomization apparatus is the ultrasonic atomization apparatus 200 in this embodiment, other atomization apparatuses such as the electrostatic atomization apparatus described in the first to seventh embodiments and atomization apparatuses of other types such as an ejector type are also applicable so long as mist spray is performed using dew condensation water actively formed from water in the air. Thus, the technical ideas described in the above embodiments may be applied.

### Ninth Embodiment

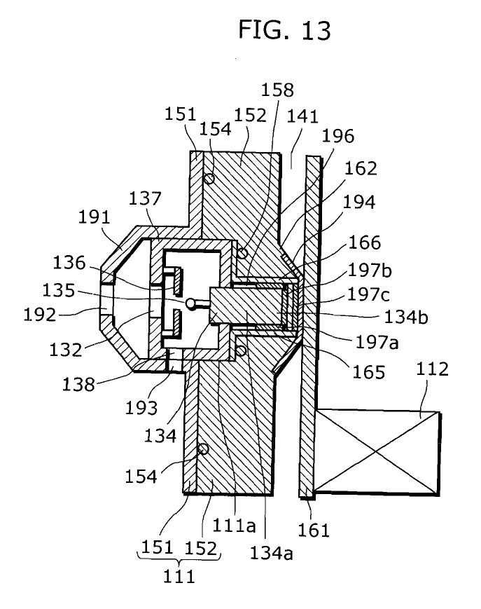

A longitudinal sectional view showing a section when a refrigerator in a ninth embodiment of the present invention is cut into left and right is approximately the same as FIG. 1, and a relevant part front view showing a back surface of a vegetable compartment in the refrigerator in the ninth embodiment of the present invention is the same as FIG. 2. FIG. 13 is a sectional view of an electrostatic atomization apparatus and its periphery included in the vegetable compartment in the refrigerator in the ninth embodiment of the present invention, as taken along line A-A in FIG. 2 and seen from the arrow direction.

In this embodiment, detailed description is given only for parts that differ from the structures described in the first to eighth embodiments, with description being omitted for parts that are the same as the structures described in the first to eighth embodiments or parts to which the same technical ideas are applicable.

In the drawing, a depression and the through part 165 are formed in a part of a storage compartment (vegetable compartment 107) side wall surface of the back partition wall 111, and the electrostatic atomization apparatus 131 as the mist spray apparatus is installed at this position.

A projection 191 is formed on the back partition wall surface 151 where the electrostatic atomization apparatus 131 is installed, and the electrostatic atomization apparatus 131 is sandwiched between the projection 191 of the back partition wall surface and the heat insulator 152.

A hole (spray port) 192 is provided in the projection 191 of the back partition wall surface, on an extension from the spray port 132 in the electrostatic atomization apparatus 131. Likewise, a moisture supply port 193 is provided in the projection 191 of the back partition wall surface, near the moisture supply port 138 in a part of the external case of the electrostatic atomization apparatus 131.

Regarding the through part 165 in which the cooling pin 134 is situated, when there is a thin walled part of about 2 mm in molding of styrene foam or the like, the heat insulation wall decreases in rigidity, which raises a possibility of problems such as a crack and a hole caused by insufficient strength or defective molding. Thus, there is concern about quality deterioration.

In view of this, in this embodiment, the heat insulator 152 of the back partition wall 111 near the through hole 165 in which the cooling pin 134 is situated is provided with the protrusion 162 protruding toward the freezer compartment discharge air path 141, thereby enhancing rigidity around the through part 165 and further enhancing rigidity by securing the wall thickness of the heat insulator 152 when compared with the case where the cooling pin 134 side surface in the freezer compartment discharge air path 141 is flat without providing the protrusion 162 in the freezer compartment discharge air path 141. In addition, by forming the protrusion 162, the cooling pin 134 can be cooled both from its back and its side.

Furthermore, in order to suppress an increase in air path resistance, an outer peripheral surface of the protrusion 162 is sloped in a conical shape that tapers toward the end.

In this case, when the cooling pin 134 is directly placed in the air path (freezer compartment discharge air path 141), there is a possibility of excessive cooling that may cause an excessive amount of dew condensation or freezing of the atomization electrode 135.

Accordingly, the hole (through part 165) is formed in the heat insulator near the back of the cooling pin 134, the cooling pin 134 is inserted into the hole, and the cooling pin cover 166 formed of a resin such as PS or PP having heat insulation properties and also high waterproof properties is provided around the cooling pin 134, thereby ensuring heat insulation.

Here, the cooling pin cover 166 may be, for example, insulating tape having heat insulation properties.

Though not shown, by using a cushioning material between the hole (through part 165) and the cooling pin cover 166 to ensure sealability, it is possible to effectively prevent the cool air from the freezer compartment discharge air path 141 from entering around the cooling pin 134, flowing into the storage compartment, and causing excessive cooling or freezing in the storage compartment.

The cooling pin 134 is fixed to the external case 137, where the cooling pin 134 itself has the projection 134a that protrudes from the external case 137. The projection 134a of the cooling pin 134 is located opposite to the atomization electrode 135. The projection 134a is fit into the depression as the through part 165 smaller than the depression 111a of the heat insulator 152 of the back partition wall 111, and tape such as aluminum tape as a cool air blocking member 194 is attached to the heat insulator 152 at the opening 167 of the through part 165 on the freezer compartment discharge air path 141 side, to thereby block cool air.

The tape 194 attached to the opening 167 may be pressed by the partition plate 161. This makes the tape 194 more resistant to peeling. Cold heat is transmitted from the cooling compartment 110 via the partition plate 161, from the back end 134b of the cooling pin 134.

Note here that, due to some dimension error or the like, a void 196 of a certain extent is present between the cooling pin 134 and the cooling pin cover 166. When the void 196 is present, an air layer is generated in this area and shows heat insulation properties, making it difficult to cool the cooling pin 134. In view of this, a heat conduction retention member such as butyl or a heat transferable compound is buried between the cooling pin 134 and the cooling pin cover 166 and between the cooling pin cover 166 and the tape 194, as void filling members 197a, 197b, and 197c for filling the void 196.

An operation and working of the refrigerator 100 in this embodiment having the above-mentioned structure are described below.

The cooling pin 134 is cooled via the cooling pin cover 166. This achieves dual-structure indirect cooling, that is, the atomization electrode 135 as the atomization tip is indirectly cooled via the cooling pin 134 and further via the cooling pin cover 166 as the heat relaxation member. Here, there is a possibility that the void 196 occurs between the cooling pin 134 and the cooling pin cover 166 or between the cooling pin cover 166 and the tape 194 due to processing accuracy. When the void 196 occurs, heat conductivity in that space deteriorates significantly, making it impossible to sufficiently cool the cooling pin 134. This causes temperature variations of the cooling pin 134 and the atomization electrode 135 and, in some cases, hampers dew condensation on the atomization electrode tip.

To prevent this, the void 196 is filled with the void filling members 197a, 197b, and 197c such as butyl or a heat transferable compound, thereby ensuring heat conduction from the tape 194 to the cooling pin cover 166 and from the cooling pin cover 166 to the cooling pin 134. Thus, the cooling capacity for the atomization electrode 135 can be ensured.

Besides, the cooling pin 134 can be cooled using the cool air generated in the cooling compartment 110, both from the side of the cooling pin 134 from the freezer compartment discharge air path 141 via the heat insulator 152, and from the back end 134b of the cooling pin 134 by heat conduction via the tape 194 and the partition plate 161 of the cooling compartment 110.

Thus, in this embodiment, the protrusion 162 protruding toward the freezer compartment discharge air path 141 is formed on the heat insulator 152 near the through part 165, thereby enhancing rigidity around the through part 165. Even in such a case, the surface area for heat conduction can be increased because the cooling pin 134 can be cooled both from its back and its side. Hence, the rigidity around the cooling pin 134 can be enhanced without a decrease in cooling efficiency of the cooling pin 134 as the heat transfer cooling member.

Moreover, by shaping the outer peripheral surface of the protrusion 162 to be sloped in a conical shape that tapers toward the end, the cool air flows along the outer periphery of the protrusion 162 that is curved with respect to the cool air flow direction, so that an increase in air path resistance can be suppressed. Besides, by uniformly cooling the cooling pin 134 as the heat transfer cooling member from the outer periphery of the side wall, the cooling pin 134 can be cooled evenly, as a result of which the atomization electrode 135 as the atomization tip can be cooled efficiently via the cooling pin 134.

In addition, the through part 165 as a through hole is formed only in one part of the heat insulator 152 behind the cooling pin 134, with there being no thin walled part. This eases molding of styrene foam, and prevents problems such as a breakage during assembly.

Furthermore, there is no clearance between the cooling pin cover 166 and the through part 165 and also the opening 167 of the through part 165 is sealed by the tape 194 to block the entry of cool air from the adjacent cooling air path, so that the low temperature cool air does not leak into the storage compartment. Accordingly, the storage compartment (vegetable compartment 107) and its peripheral components can be protected from dew condensation, low temperature anomalies, and so on.

Regarding heat conduction deterioration due to a void that inevitably occurs between the cooling pin cover 166 and the cooling pin 134 due to processing accuracy and assembly accuracy, the void 196 is filled with a heat conductive member such as butyl to ensure heat conductivity, thereby ensuring the cooling capacity. The void 196 between the tape 194 and the cooling pin cover 166 can be dealt with in the same manner.

As a result of the cooling, dew condensation is formed on the atomization electrode 135. The fine mist generated by causing high-voltage discharge between the counter electrode 136 and the atomization electrode 135 passes through the spray port 132 formed in the external case 137 of the electrostatic atomization apparatus 131, and is sprayed into the vegetable compartment 107 from the hole (spray port) 192 formed in the back partition wall surface 151. The sprayed fine mist reaches throughout the vegetable compartment 107 because the fine mist is made up of extremely small particles and so has high diffusivity. The sprayed fine mist is generated by high-voltage discharge, and so is negatively charged. Meanwhile, vegetables and fruits stored in the vegetable compartment 107 are positively charged. Accordingly, the atomized mist tends to gather on vegetable surfaces. This contributes to enhanced freshness preservation.

Even in the case where unusual dew condensation occurs on the atomization electrode 135, it is possible to prevent an error caused by water accumulated in the atomization unit 139, because the moisture supply port 138 is located below the atomization electrode 135 and also the moisture supply port 193 is located in the back partition wall surface 151 on the extension from the moisture supply port 138.

As described above, in the ninth embodiment, regarding the structure of the cooling pin 134 as the projection 134a of the atomization unit 139, the through part 165 as the through hole is formed in the heat insulator 152, the cooling pin 134 is inserted into the through part 165, and the cooling pin cover 166 is provided around the cooling pin 134. The void 196 between the cooling pin cover 166 and the cooling pin 134 and the void 196 between the cooling pin 134 and the tape 194 attached to the opening 167 of the through part 165 are eliminated by burying the void filling member. Thus, heat conduction from the cooling air path and the cooling compartment 110 can be ensured.

Moreover, the tape 194 attached to the opening 167 of the through part 165 is pressed by the partition plate 161 for separating the cooling compartment 110 and the freezer compartment discharge air path 141, so that the tape 194 is kept from peeling. This ensures stable quality, and also ensures the cooling capacity for the atomization electrode 135 and the cooling pin 134 by heat conduction.

Though no cushioning material is provided around the cooling pin 134 in the ninth embodiment, a cushioning material may be provided. This allows for close contact between the through hole (through part 165) and the cooling pin cover 166, with it being possible to prevent cool air leakage.

Though the air path for cooling the cooling pin 134 as the heat transfer cooling member is the freezer compartment discharge air path 141 in this embodiment, the air path may instead be a low temperature air path such as a return air path of the freezer compartment 108 or a discharge air path of the ice compartment 106. This expands an area in which the electrostatic atomization apparatus 131 can be installed.

Though the cooling unit for cooling the cooling pin 134 as the heat transfer cooling member is the air cooled using the cooling source generated in the refrigeration cycle of the refrigerator 100 in this embodiment, it is also possible to utilize heat transmission from a cooling pipe that uses a cool temperature or cool air from the cooling source of the refrigerator 100. In such a case, by adjusting a temperature of the cooling pipe, the cooling pin 134 as the heat transfer cooling member can be cooled at an arbitrary temperature. This eases temperature control when cooling the atomization electrode 135 as the atomization tip.

### Tenth Embodiment

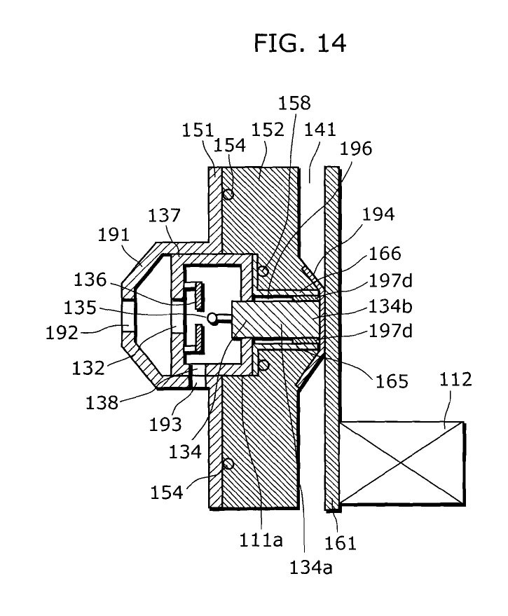

A longitudinal sectional view showing a section when a refrigerator in a tenth embodiment of the present invention is cut into left and right is approximately the same as FIG. 1, and a relevant part front view showing a back surface of a vegetable compartment in the refrigerator in the tenth embodiment of the present invention is the same as FIG. 2. FIG. 14 is a sectional view of an electrostatic atomization apparatus and its periphery included in the vegetable compartment in the refrigerator in the tenth embodiment of the present invention, as taken along line A-A in FIG. 2 and seen from the arrow direction.

In this embodiment, detailed description is given only for parts that differ from the structures described in the first to ninth embodiments, with description being omitted for parts that are the same as the structures described in the first to ninth embodiments or parts to which the same technical ideas are applicable.

In the drawing, the through part 165 is formed in a part of a storage compartment (vegetable compartment 107) side wall surface of the back partition wall 111, and the electrostatic atomization apparatus 131 as the mist spray apparatus is installed in the through part 165.

The projection 191 is formed on the back partition wall surface 151 where the electrostatic atomization apparatus 131 is installed, and the electrostatic atomization apparatus 131 is sandwiched between the projection 191 of the back partition wall surface 151 and the heat insulator 152.

The cooling pin 134 of the electrostatic atomization apparatus 131 is fit into the through part 165 of the heat insulator 152, in a state where its circumference is covered with the cooling pin cover 166 formed of a resin such as PS or PP having heat insulation properties and also high waterproof properties.

Here, the cooling pin cover 166 is pressed against the surrounding heat insulator 152. In this way, even when water adheres to the cooling pin 134, it is possible to prevent a situation where the water adheres to the heat insulator 152 and penetrates into the heat insulator 152, causing freezing or breakage.

Regarding the end 134b of the cooling pin 134, however, the cooling pin cover 166 is shaped as a cylinder in order to ensure the cooling capacity from the back, so that only the end 134b of the cooling pin 134 is in an open state. The tape 194 such as aluminum tape is attached to the opening 167 of the through part 165 to block cool air.

The tape 194 is attached so as to be in close contact with the end 134b of the cooling pin 134, thereby ensuring heat conductivity.

Here, the cooling pin cover 166 may be, for example, insulating tape having heat insulation properties.

Note that, due to some dimension error or the like, the void 196 of a certain extent is present between the cooling pin 134 and the cooling pin cover 166. To fill the void 196, a heat conduction retention member such as butyl or a heat transferable compound is buried between the cooling pin 134 and the cooling pin cover 166, as a void filling member 197d which is a member for filling the void and has relatively excellent heat conductivity.

An operation and working of the refrigerator 100 in this embodiment having the above-mentioned structure are described below.

The cooling pin 134 is cooled from the cooling air path or the partition plate 161 separating the cooling compartment 110, via the tape 194 and the void filling member 197d or via the heat insulator on the side of the cooling pin. When dual-structure indirect cooling is performed via the tape 194, there is a possibility that the void 196 occurs between the cooling pin cover 166 and the tape 194 due to processing accuracy. When the void 196 occurs, heat conductivity in that space deteriorates significantly, making it impossible to sufficiently cool the cooling pin 134. This causes temperature variations of the cooling pin 134 and the atomization electrode 135 and, in some cases, hampers dew condensation on the atomization electrode tip.

To prevent this, it is ensured during assembly that the tape 194 and the cooling pin 134 are in close contact with each other. In the case where there is still a possibility of an occurrence of a void, the void 196 is filled with a heat conduction retention member such as butyl or a heat transferable compound as the void filling member 197d, thereby ensuring heat conduction from the tape 194 to the cooling pin 134. Thus, the cooling capacity for the atomization electrode 135 can be ensured.

Furthermore, there is no clearance between the cooling pin cover 166 and the through part 165 and also the opening 167 of the through part 165 is sealed by the tape 194 to block the entry of cool air from the adjacent cooling air path, so that the low temperature cool air does not leak into the storage compartment. Accordingly, the storage compartment (vegetable compartment 107) and its peripheral components can be protected from dew condensation, low temperature anomalies, and so on.

Regarding heat conduction deterioration by a void that inevitably occurs between the cooling pin cover 166 and the cooling pin 134 due to processing accuracy and assembly accuracy, the void 196 is filled with a heat conductive member such as butyl to ensure heat conductivity, thereby ensuring the cooling capacity. The void 196 between the tape 194 and the cooling pin 134 can also be filled with a heat conductive member such as butyl to ensure heat conductivity.

Moreover, since there is no clearance between the cooling pin cover 166 and the through part 165, water is kept from entering the heat insulator made of styrene foam. By preventing a situation where water penetrates into the heat insulator and the penetrated portion is frozen and, due to a stress caused by water volume expansion, cracked and broken, it is possible to further ensure quality.

Besides, the opening 167 of the through part 165 is sealed by the tape 194 to block the entry of cool air from the adjacent cooling air path, so that the low temperature cool air does not leak into the storage compartment. Accordingly, the storage compartment (vegetable compartment 107) and its peripheral components can be protected from dew condensation, low temperature anomalies, and so on.

As a result of the cooling, dew condensation is formed on the atomization electrode 135. The fine mist generated by causing high-voltage discharge between the counter electrode 136 and the atomization electrode 135 passes through the spray port 132 formed in the external case 137 of the electrostatic atomization apparatus 131, and is sprayed into the vegetable compartment 107 from the hole (spray port) 192 formed in the back partition wall surface 151. The sprayed fine mist reaches throughout the vegetable compartment 107 because the fine mist is made up of extremely small particles and so has high diffusivity. The sprayed fine mist is generated by high-voltage discharge, and so is negatively charged. Meanwhile, vegetables and fruits stored in the vegetable compartment 107 are positively charged. Accordingly, the atomized mist tends to gather on vegetable surfaces. This contributes to enhanced freshness preservation.

Even in the case where unusual dew condensation occurs on the atomization electrode 135, it is possible to prevent an error caused by water accumulated in the atomization unit 139, because the moisture supply port 138 is located below the atomization electrode 135 and also the moisture supply port 193 is located in the back partition wall surface on the extension from the moisture supply port 138.

As described above, in the tenth embodiment, regarding the structure of the cooling pin cover 166 of the cooling pin 134 as the projection 134a of the atomization unit 139, the cooling pin cover 166 is designed to cover the circumference of the cooling pin 134 when the cooling pin 134 is inserted into the through part 165 as the through hole in the heat insulator 152, and the cooling pin cover 166 is buried so as to be pressed into the through part 165. Moreover, the surface of the cooling pin cover 166 on the side of the end 134b of the cooling pin 134 is in an open state, and the void between the cooling pin and the tape attached to the opening 167 of the through part 165 is eliminated by providing the heat conductive member. Thus, heat conduction from the cooling air path and the cooling compartment can be ensured.

As a result, the cooling capacity for the atomization electrode and the cooling pin by heat conduction can be ensured, too.

Moreover, the tape attached to the opening 167 of the through part 165 is pressed by the partition plate 161 for separating the cooling compartment 110 and the freezer compartment discharge air path 141, so that the tape 194 is kept from peeling. This ensures stable quality.

In addition, the cooling pin cover 166 is pressed into the through part 165. By keeping water from entering the heat insulator 152 made of styrene foam in this manner, the heat insulator can be prevented from cracking or breaking.

Though no cushioning material is provided around the cooling pin 134, a cushioning material may be provided. This allows for close contact between the through hole (through part 165) and the cooling pin cover 166, with it being possible to prevent cool air leakage.

### Eleventh Embodiment

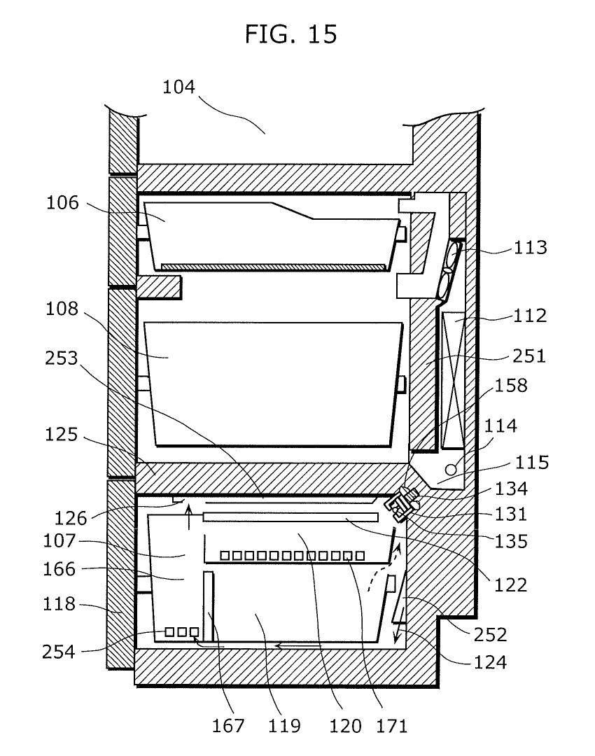

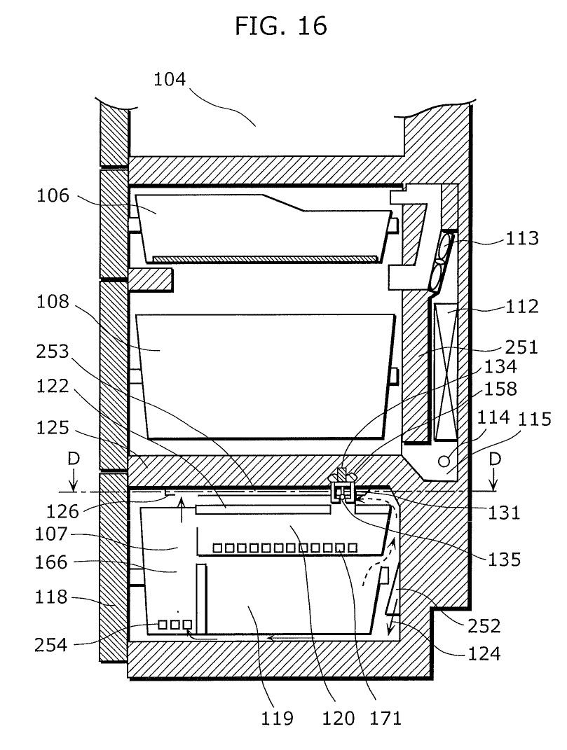

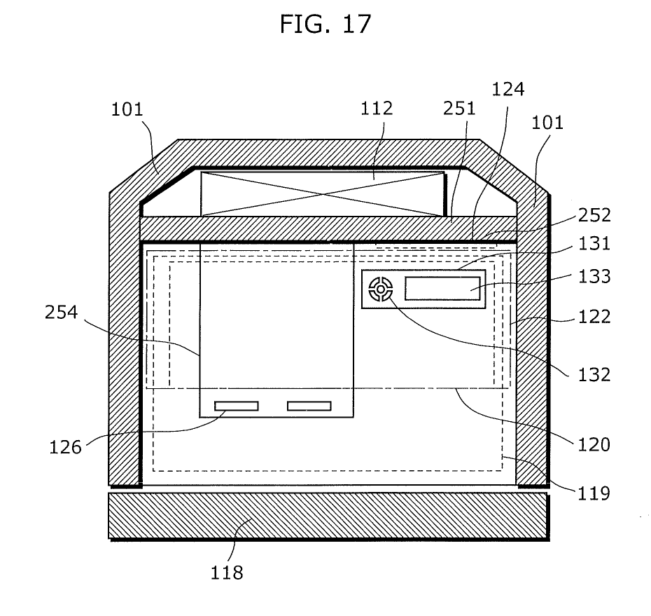

FIG. 15 is a sectional view of a vegetable compartment and its vicinity in a refrigerator in an eleventh embodiment of the present invention. FIG. 16 is a sectional view of a vegetable compartment and its vicinity in a refrigerator of another form in the eleventh embodiment of the present invention. FIG. 17 is a detailed plan view of an electrostatic atomization apparatus and its vicinity taken along line D-D in FIG. 16.

In this embodiment, detailed description is given only for parts that differ from the structures described in the first to tenth embodiments, with description being omitted for parts that are the same as the structures described in the first to tenth embodiments or parts to which the same technical ideas are applicable.

As shown in the drawings, in the refrigerator 100 of the eleventh embodiment, the refrigerator compartment 104 as the first storage compartment is located at the top, the switch compartment 105 as the fourth storage compartment and the ice compartment 106 as the fifth storage compartment are located side by side below the refrigerator compartment 104, the freezer compartment 108 is located below the switch compartment 105 and the ice compartment 106, and the vegetable compartment 107 is located below the freezer compartment 108.

The second partition wall 125 ensures heat insulation properties to separate the temperature zones of the vegetable compartment 107 and the freezer compartment 108. A partition wall 251 is formed at the back of the second partition wall 125 and at the back of the freezer compartment 108. The cooler 112 is installed between the partition wall 251 and the heat-insulating main body 101 of the refrigerator, and the radiant heater 114 for melting frost adhering to the cooler and the drain pan 115 for receiving melted water are disposed below the cooler 112. The cooler 112, the radiant heater 114, the drain pan 115, and the cooling fan 113 for conveying cool air to each compartment constitute the cooling compartment 110. As shown in FIG. 15, the electrostatic atomization apparatus 131 as the atomization apparatus which is the mist spray apparatus is installed in the second partition wall 125 separating the cooling compartment 110 and the vegetable compartment 107, so as to utilize the cooling source of the cooling compartment 110. In particular, a heat insulator of the second partition wall 125 has a depression for the cooling pin 134 as the heat transfer connection member of the atomization unit 139, and a cooling pin heater 158 is formed nearby.

As shown in FIG. 15, an air path structure for cooling the vegetable compartment 107 includes a vegetable compartment discharge air path 252 that is located on the back of the vegetable compartment 107 and uses an air path from the refrigerator compartment or an air path from the freezer compartment. Air of a little lower temperature than the vegetable compartment 107 passes through the vegetable compartment discharge air path 252 and is discharged from the vegetable compartment discharge port 124 in a direction from the back toward the bottom of the lower storage container 119 in the vegetable compartment 107. The stream of cool air then flows from the bottom to the front of the lower storage container 119, and flows into a beverage container 166 in a front part of the storage container. The cool air further flows into the vegetable compartment suction port 126 formed on the lower surface of the second partition wall 125, and circulates into the cooler 112 through a vegetable compartment suction air path 253.

A part of the upper storage container 120 at the bottom is located inside the lower storage container 119. A plurality of air flow holes 171 are provided in the upper storage container 120 located inside the lower storage container 119.

The bottom surface of the upper storage container 120 has a corrugated shape made up of depressions and projections.

The second partition wall 125 has an envelope mainly made of a resin such as ABS, and contains urethane foam, styrene foam, or the like inside to thermally insulate the vegetable compartment 107 from the freezer compartment 108 and the cooling compartment 110. In addition, the depression 111a is formed in a part of a storage compartment side wall surface of the second partition wall 125 so as to be lower in temperature than other parts, and the electrostatic atomization apparatus 131 as the atomization apparatus is installed in the depression 111a.

The cooling pin heater 158 for adjusting the temperature of the cooling pin 134 as the heat transfer connection member included in the electrostatic atomization apparatus 131 and preventing excessive dew condensation on a peripheral part including the atomization electrode 135 as the atomization tip is installed near the atomization unit 139, in the second partition wall 125 to which the electrostatic atomization apparatus 131 is fixed.

The cooling pin 134 as the heat transfer connection member is fixed to the external case 137, where the cooling pin 134 itself has the projection 134a that protrudes from the external case 137. The projection 134a of the cooling pin 134 is located opposite to the atomization electrode 135, and fit into a corner where the second partition wall 125 meets the partition wall 251 on the back of the storage compartment.

Thus, the electrostatic atomization apparatus 131 including the cooling pin 134 is disposed in the corner where the heat insulation wall is thickest. Since the corner has a thicker heat insulation wall than other parts, the electrostatic atomization apparatus 131 can be embedded more deeply into the heat insulation wall, with it being possible to reduce a decrease in storage compartment capacity caused by the installation of the atomization apparatus. This enables a larger-capacity storage compartment including the atomization apparatus to be realized. In addition, since sufficient heat insulation properties can be ensured, the electrostatic atomization apparatus 131 and its vicinity are protected from excessive cooling, so that quality deterioration due to peripheral dew condensation and the like can be avoided.

Accordingly, the back of the cooling pin 134 as the heat transfer connection member is positioned close to the cooling compartment 110.

Here, the cool air generated in the cooling compartment 110 is used to cool the cooling pin 134 as the heat transfer connection member, and the cooling pin 134 is formed of a metal piece having excellent heat conductivity. Accordingly, the cooling unit can perform necessary cooling just by heat conduction from the cool air generated by the cooler 112.

The atomization unit 139 of the electrostatic atomization apparatus 131 is positioned in a gap between the lid 122 and the upper storage container 120, with the atomization electrode tip being directed toward the upper storage container 120.

In some cases, the atomization electrode 135 may be vertically attached to the second partition wall 125 as shown in FIGS. 16 and 17.

In such a case, the cooling pin is cooled by heat conduction from the freezer compartment 108, and also a hole is formed in a part of the lid 122 so that the mist from the electrostatic atomization apparatus 131 can be sprayed into the upper storage container.

An operation and working of the refrigerator having the above-mentioned structure are described below.

The second partition wall 125 in which the electrostatic atomization apparatus 131 is installed needs to have a wall thickness for thermally insulating the vegetable compartment 107 from the freezer compartment 108 and the cooling compartment 110. Meanwhile, a cooling capacity for cooling the cooling pin 134 to which the atomization electrode 135 as the atomization tip is fixed is also necessary. Accordingly, the second partition wall 125 has a smaller wall thickness in a part where the electrostatic atomization apparatus 131 is disposed, than in other parts. Further, the second partition wall 125 has a still smaller wall thickness in a deepest depression where the cooling pin 134 is held. As a result, the cooling pin 134 can be cooled by heat conduction from the cooling compartment 110 which is lower in temperature, with it being possible to cool the atomization electrode 135. When the temperature of the tip of the atomization electrode 135 drops to the dew point or below, a water vapor near the atomization electrode 135 builds up dew condensation on the atomization electrode 135, thereby reliably generating water droplets.

An outside air temperature variation may cause the temperature control of the freezer compartment 108 to vary and lead to excessive cooling of the atomization electrode 135. In view of this, the amount of water on the tip of the atomization electrode 135 is optimized by adjusting the temperature of the atomization electrode 135 by the cooling pin heater 158 disposed near the atomization electrode 135.

Here, the cool air flows in the vegetable compartment 107 as follows. The cool air lower in temperature than the vegetable compartment passes through the vegetable compartment discharge air path 252 and is discharged from the vegetable compartment discharge port 124. The cool air flows in an air path at the bottom of the lower storage container 120, between the storage container and the heat-insulating main body, thus flowing toward the front door. The cool air then flows into the storage container from an air flow hole 254 formed in a part of the lower storage container 119, and cools beverages in the beverage container. At this time, a section at the back of the lower storage container is indirectly cooled. The cool air further flows into the vegetable compartment suction port 126 formed on the lower surface of the second partition wall 125, and circulates into the cooler 112 through the vegetable compartment suction air path 253. This reduces an influence of the cool air on the upper storage container, so that freshness preservation is maintained.

Thus, in this embodiment, the flow of cool air in the vegetable compartment is controlled in order to effectively use the cool air. First, dry cool air of a low temperature is supplied in a large quantity into the beverage container 166 in front of a beverage partition plate 167 where beverages such as PET bottled beverages are often stored, to cause the beverages to be in direct contact with the low temperature cool air to thereby ensure a cooling speed. Next, since the humidity increases as the cool air entering from the front of the vegetable compartment flows toward the back, the back side has a relatively high humidity when compared with the door side. This creates a high humidity atmospheric environment around the electrostatic atomization apparatus 131 located at the back, so that water in the air easily builds up dew condensation in the electrostatic atomization apparatus 131. Further, the mist sprayed by the electrostatic atomization apparatus 131 using water droplets generated by dew condensation of water in the storage compartment fills the upper storage container 120 and then flows into the lower storage container 119 for moisture retention, as a fine mist that is made up of fine particles of a nano-level particle diameter and so has high diffusivity.

By controlling the flow of cool air in this manner, when contents to be cooled speedily are stored in the beverage container 166 in the front part, ordinary vegetables and fruits relatively unsusceptible to low temperature damage and the like are stored in the lower storage container 119, and vegetables and fruits more susceptible to low temperature damage are stored in the upper storage container 120, it is possible to perform cooling suitable for each content. This enables a vegetable compartment of higher quality with improved freshness preservation to be provided.

This embodiment is based on the premise that the mist is sprayed. However, since the cooling speed of PET bottled beverages can be increased by releasing the cool air introduced from the vegetable compartment discharge port 124 first to the PET bottle container, even in the case where the mist spray apparatus is not installed, it is possible to, having increased the cooling speed of PET bottled beverages, improve the moisture retention of the upper storage container 120.

Therefore, even when the mist spray apparatus is not installed, by forming the air path as in this embodiment so that the low temperature dry cool air first enters into the beverage container 166 in the door side part of the lower storage container 119 and then passes through the lower storage container 119 storing vegetables and the like and flows into the upper storage container 120, an effect of achieving moisture retention and high temperature of the upper storage container to some extent can be attained. When mist spray is performed in addition to this structure, a synergistic effect of suppressing low temperature damage can be attained.

Though not shown, by installing an inside temperature detection unit, an inside humidity detection unit, an atomization electrode temperature detection unit, an atomization electrode peripheral humidity detection unit, and the like in the storage compartment, the dew point can be precisely calculated by a predetermined computation according to a change in storage compartment environment.

In this state, the voltage application unit 133 applies a high voltage (for example, 7.5 kV) between the atomization electrode 135 and the counter electrode 136, where the atomization electrode 135 is on a negative voltage side and the counter electrode 136 is on a positive voltage side. This causes an air insulation layer to be broken down and corona discharge to occur between the electrodes. Water on the atomization electrode 135 is atomized from the electrode tip, and a nano-level fine mist carrying an invisible charge less than 1 μm, accompanied by ozone, OH radicals, and so on, is generated.

The generated fine mist is sprayed into the upper storage container 120. The fine mist sprayed from the electrostatic atomization apparatus 131 is negatively charged. Meanwhile, vegetables and fruits are stored in the vegetable compartment. In particular, vegetables and fruits susceptible to low temperatures are often stored in the upper storage container. These vegetables and fruits usually tend to be in a rather wilted state as a result of transpiration on the way home from shopping or transpiration during storage, and so are usually positively charged. Accordingly, the sprayed fine mist carrying a negative charge tends to gather on vegetable surfaces. Thus, the sprayed fine mist increases the humidity of the vegetable compartment again and simultaneously adheres to surfaces of vegetables and fruits, thereby suppressing transpiration from the vegetables and fruits and enhancing freshness preservation. The fine mist also penetrates into tissues via intercellular spaces of the vegetables and fruits, as a result of which water is supplied into cells that have wilted due to moisture evaporation to resolve the wilting by cell turgor pressure, and the vegetables and fruits return to a fresh state. Moreover, radicals contained in the mist have functions such as microbial elimination, low temperature damage suppression, and nutrient increase, and also decompose agricultural chemicals by their strong oxidative power to facilitate removal of agricultural chemicals from the vegetable surfaces.

During defrosting of the cooling compartment 110 which is performed at a regular interval in refrigerator operation, the bottom of the cooling compartment is heated by radiation and convection by heat from the radiant heater. Since the cooling pin 134 is located near the cooling compartment, the cooling pin 134 and the atomization electrode 135 are heated at the regular interval. This allows the atomization unit 139 including the atomization electrode 135 to be dried. Even when unusual dew condensation on the atomization tip makes it impossible to perform atomization, the atomization tip can be dried after a predetermined time, and so can be easily returned to a normal atomization state.

As described above, in the eleventh embodiment, the partition wall for separating the storage compartment and the lower temperature storage compartment on the top side of the storage compartment are provided. The electrostatic atomization apparatus is attached to the partition wall at the top. Thus, in the case where a freezing temperature zone storage compartment such as the cooling compartment, the freezer compartment, or the ice compartment is located above the storage compartment, by installing the electrostatic atomization apparatus in the partition wall at the top separating these compartments, the cooling source of the freezing temperature zone storage compartment can be used to cool and build up dew condensation on the atomization electrode of the electrostatic atomization apparatus. This makes it unnecessary to provide any particular cooling apparatus. Moreover, since the mist is sprayed from the top, the mist can be easily diffused throughout the storage containers. In addition, the atomization unit is difficult to reach by hand, which contributes to enhanced safety.

In this embodiment, the atomization unit generates the mist according to the electrostatic atomization method, where water droplets are finely divided using electrical energy such as a high voltage to thereby form a fine mist. The generated mist is electrically charged. This being so, by causing the mist to carry an opposite charge to vegetables, fruits, and the like to which the mist is intended to adhere, for example, by spraying a negatively charged mist over positively charged vegetables, the adhesion of the mist to the vegetables and fruits increases, as a result of which the mist can adhere to the vegetable surfaces more uniformly. In this way, a mist adhesion ratio can be improved when compared with an uncharged mist. Moreover, the fine mist can be directly sprayed over the foods in the vegetable containers, and the potentials of the fine mist and the vegetables are exploited to cause the fine mist to adhere to the vegetable surfaces. This improves freshness preservation efficiently.

In addition, the cooling pin 134 is fit into the corner where the second partition wall 125 meets the partition wall 251 on the back of the storage compartment. That is, the electrostatic atomization apparatus 131 including the cooling pin 134 is disposed in the corner where the heat insulation wall is thickest. Since the corner has a thicker heat insulation wall than other parts, the electrostatic atomization apparatus 131 can be embedded more deeply into the heat insulation wall, with it being possible to reduce a decrease in storage compartment capacity caused by the installation of the atomization apparatus. This enables a larger-capacity storage compartment including the atomization apparatus to be realized. In addition, since sufficient heat insulation properties can be ensured, the electrostatic atomization apparatus 131 and its vicinity are protected from excessive cooling, so that quality deterioration due to peripheral dew condensation and the like can be avoided.

Furthermore, the cooling pin 134 is fit into the corner where the second partition wall 125 meets the partition wall 251 on the back of the storage compartment, where the bottom side of the cooling compartment 110 is used as the cooling unit for cooling the cooling pin. Because of a property that warm air rises and cold air falls, a lowest temperature part of the cooling compartment 110 can be used as the cooling source. Hence, the cooling pin 134 can be cooled more efficiently.

Besides, by using the bottom side of the cooling compartment 110 as the cooling unit for cooling the cooling pin, the bottom side of the cooling compartment with a smaller temperature variation among low temperature air paths can be employed as the cooling source, so that the cooling pin can be cooled stably.

In addition, during defrosting of the cooling compartment 110, the atomization electrode 135 can receive heat from the radiant heater in the vicinity. Thus, the atomization electrode 135 can be heated and dried at a regular interval. Accordingly, even when unusual dew condensation on the atomization tip makes it impossible to perform atomization, the atomization tip can be dried after a predetermined time, and so can be easily returned to a normal atomization state.

In this embodiment, not tap water supplied from outside but dew condensation water is used as makeup water. Since dew condensation water is free from mineral compositions and impurities, deterioration in water retentivity caused by deterioration or clogging of the tip of the atomization electrode can be prevented.

In this embodiment, the mist contains radicals, so that agricultural chemicals, wax, and the like adhering to the vegetable surfaces can be decomposed and removed with an extremely small amount of water. This benefits water conservation, and also achieves a low input.

### Twelfth Embodiment

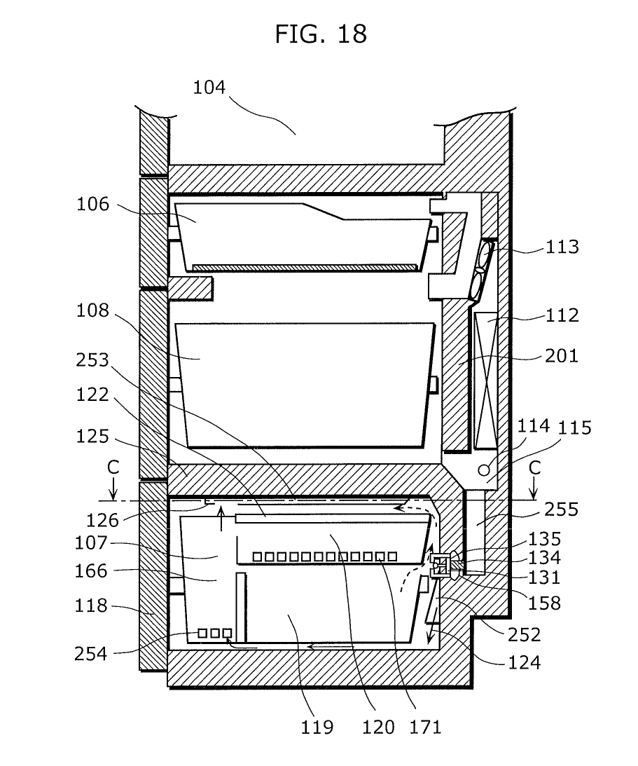

FIG. 18 is a sectional view of a vegetable compartment and its vicinity in a refrigerator in a twelfth embodiment of the present invention.

In this embodiment, detailed description is given only for parts that differ from the structures described in the first to eleventh embodiments, with description being omitted for parts that are the same as the structures described in the first to eleventh embodiments or parts to which the same technical ideas are applicable.

As shown in the drawing, in the refrigerator 100 of the twelfth embodiment, the refrigerator compartment 104 as the first storage compartment is located at the top, the switch compartment 105 as the fourth storage compartment and the ice compartment 106 as the fifth storage compartment are located side by side below the refrigerator compartment 104, the freezer compartment 108 is located below the switch compartment 105 and the ice compartment 106, and the vegetable compartment 107 is located below the freezer compartment 108.

The second partition wall 125 ensures heat insulation properties to separate the temperature zones of the vegetable compartment 107 and the freezer compartment 108. The partition wall 251 is formed at the back of the second partition wall 125 and at the back of the freezer compartment 108. The cooler 112 is installed between the partition wall 251 and the heat-insulating main body 101 of the refrigerator, and the radiant heater 114 for melting frost adhering to the cooler and the drain pan 115 for receiving melted water are disposed below the cooler 112. The cooler 112, the radiant heater 114, the drain pan 115, and the cooling fan 113 for conveying cool air to each compartment constitute the cooling compartment 110. An atomization apparatus cooling air path is formed below the cooling compartment 110. As shown in FIG. 18, the electrostatic atomization apparatus 131 as the mist spray apparatus is installed in a part of the atomization apparatus cooling air path. In particular, the cooling pin 134 as the heat transfer connection member of the atomization unit 139 is immediately adjacent to the air path, and the cooling pin heater 158 is formed nearby.

A part of the upper storage container 120 at the bottom is located inside the lower storage container 119. The plurality of air flow holes 171 are provided in the upper storage container 120 located inside the lower storage container 119.

The bottom surface of the upper storage container 120 has a corrugated shape made up of depressions and projections.

The atomization electrode cooling air path 255 is formed of a resin such as ABS or PP and a heat insulator such as styrene foam. Cool air flowing in the air path is at a relatively low temperature of −15° C. to −25° C. The electrostatic atomization apparatus including the cooling pin 134 is installed in the partition wall facing the atomization apparatus cooling air path at the back of the vegetable compartment 107, near a gap between the upper storage container and the lower storage container. Thus, the vegetable compartment has an approximately same structure as the first embodiment.

An operation and working of the refrigerator having the above-mentioned structure are described below.

When the atomization apparatus cooling air path 255 formed on the partition wall 251 side where the electrostatic atomization apparatus 131 is installed ensures a cooling capacity for cooling the cooling pin 134 to which the atomization electrode 135 as the atomization tip is fixed, the vicinity of the electrostatic atomization apparatus 131 is brought into a high humidity state by transpiration from stored vegetables and the like, and water droplets are reliably generated at the tip of the atomization electrode.

In this state, the voltage application unit 133 applies a high voltage (for example, 7.5 kV) between the atomization electrode 135 and the counter electrode 136, where the atomization electrode 135 is on a negative voltage side and the counter electrode 136 is on a positive voltage side. This causes an air insulation layer to be broken down and corona discharge to occur between the electrodes. Water on the atomization electrode 135 is atomized from the electrode tip, and a nano-level fine mist carrying an invisible charge less than 1 μm, accompanied by ozone, OH radicals, and so on, is generated.

The generated fine mist is sprayed between the upper storage container 120 and the lower storage container 119. The fine mist sprayed from the electrostatic atomization apparatus 131 is negatively charged. Meanwhile, vegetables and fruits are stored in the vegetable compartment. In particular, vegetables and fruits susceptible to low temperatures are often stored in the upper storage container. These vegetables and fruits usually tend to be in a rather wilted state as a result of transpiration on the way home from shopping or transpiration during storage, and so are usually positively charged. Accordingly, the sprayed fine mist carrying a negative charge tends to gather on vegetable surfaces. Thus, the sprayed fine mist increases the humidity of the vegetable compartment again and simultaneously adheres to surfaces of vegetables and fruits, thereby suppressing transpiration from the vegetables and fruits and enhancing freshness preservation. The fine mist also penetrates into tissues via intercellular spaces of the vegetables and fruits, as a result of which water is supplied into cells that have wilted due to moisture evaporation to resolve the wilting by cell turgor pressure, and the vegetables and fruits return to a fresh state. Moreover, radicals contained in the mist have functions such as bacteria elimination, low temperature damage suppression, and nutrient increase, and also decompose agricultural chemicals by their strong oxidative power to facilitate removal of agricultural chemicals from the vegetable surfaces.

As described above, in the twelfth embodiment, the partition wall for separating the storage compartment and the atomization apparatus cooling air path for cooling the atomization electrode are provided. The electrostatic atomization apparatus is attached to the air path. Thus, in the case where a freezing temperature zone storage compartment such as the cooling compartment, the freezer compartment, or the ice compartment is located above the storage compartment, the cold heat source of the freezing temperature zone storage compartment can be conveyed to the back of the vegetable compartment through the air path, and the cooling source of the freezing temperature zone storage compartment can be used to cool and build up dew condensation on the atomization electrode of the electrostatic atomization apparatus. This enables the spray to be performed stably. In addition, the atomization unit is difficult to reach by hand because it is attached to the back surface, which contributes to enhanced safety.

In this embodiment, the atomization unit generates the mist according to the electrostatic atomization method, where water droplets are finely divided using electrical energy such as a high voltage to thereby form a fine mist. The generated mist is electrically charged. This being so, by causing the mist to carry an opposite charge to vegetables, fruits, and the like to which the mist is intended to adhere, for example, by spraying a negatively charged mist over positively charged vegetables, the adhesion of the mist to the vegetables and fruits increases, as a result of which the mist can adhere to the vegetable surfaces more uniformly. In this way, a mist adhesion ratio can be improved when compared with an uncharged mist. Moreover, the fine mist can be directly sprayed over the foods in the vegetable containers, and the potentials of the fine mist and the vegetables are exploited to cause the fine mist to adhere to the vegetable surfaces. This improves freshness preservation efficiently.

Besides, by providing the atomization apparatus cooling air path independent of ordinary air paths for cooling the storage compartments as the cooling unit for cooling the cooling pin 134, a temperature variation from a state of the cooling air path can be suppressed more. The bottom side of the cooling compartment with a smaller temperature variation among low temperature air paths is employed as the cooling source, so that the cooling pin can be cooled stably.

In this embodiment, not tap water supplied from outside but dew condensation water is used as makeup water. Since dew condensation water is free from mineral compositions and impurities, deterioration in water retentivity caused by deterioration or clogging of the tip of the atomization electrode can be prevented.

In this embodiment, the mist contains radicals, so that agricultural chemicals, wax, and the like adhering to the vegetable surfaces can be decomposed and removed with an extremely small amount of water. This benefits water conservation, and also achieves a low input.

Though the atomization apparatus air path is used for conveying the cold heat source in this embodiment, heat conduction of a solid object such as aluminum or copper or a heat conveyance unit such as a heat pipe or a heat lane may be used. This saves an air path area, thereby reducing an influence on the storage compartment capacity.

### Thirteenth Embodiment

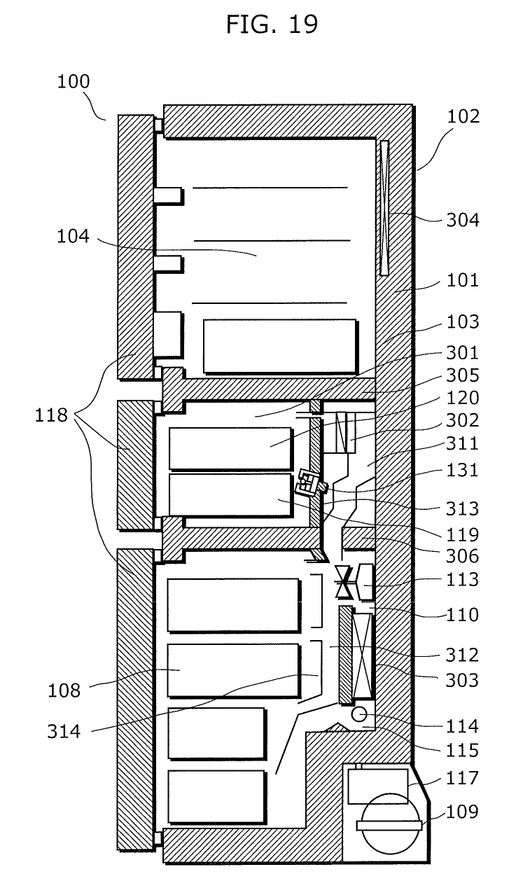

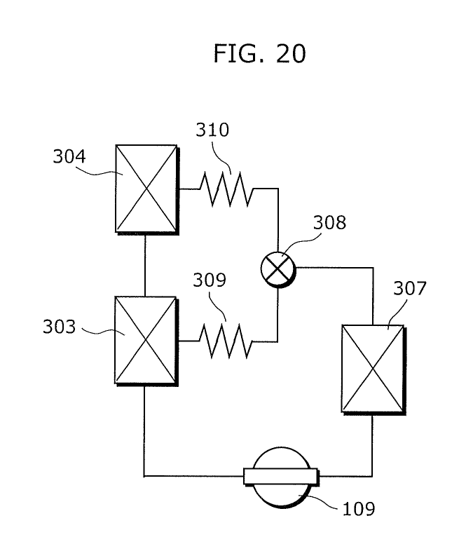

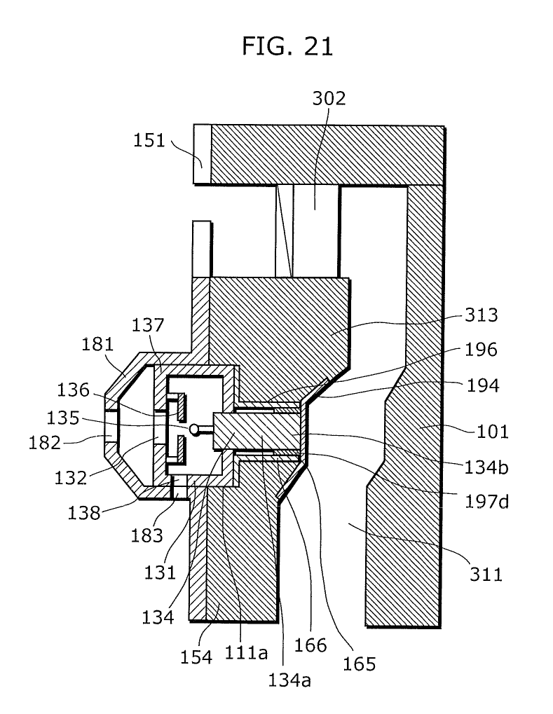

FIG. 19 is a sectional view of a refrigerator in a thirteenth embodiment of the present invention. FIG. 20 is a schematic view of a simplified cooling cycle in the refrigerator in the thirteenth embodiment of the present invention. FIG. 21 is a detailed sectional view of an electrostatic atomization apparatus and its periphery.

In this embodiment, detailed description is given only for parts that differ from the structures described in the first to twelfth embodiments, with description being omitted for parts that are the same as the structures described in the first to twelfth embodiments or parts to which the same technical ideas are applicable.

As shown in the drawings, in the refrigerator 100 of the thirteenth embodiment, the refrigerator compartment 104 as the first storage compartment is located at the top, a temperature changing compartment 301 that can be changed to a vegetable compartment temperature of about 5° C. is located below the refrigerator compartment 104, and the freezer compartment 108 is located below the temperature changing compartment 301. The temperature changing compartment 301 is defined by a first partition wall 305 ensuring heat insulation for separating the temperature zones of the refrigerator compartment 104 and the temperature changing compartment 301, a second partition wall 306 ensuring heat insulation for separating the temperature zone of the temperature changing compartment 301, a temperature changing compartment back partition wall 313 on the back of the temperature changing compartment 301, and the door 118.

The refrigerator compartment 104 uses a high temperature side evaporator 304 housed in an inner wall on the back of the refrigerator compartment as a cooling source. Meanwhile, the temperature changing compartment 301 and the freezer compartment 108 use a low temperature side evaporator 303 included in the cooling compartment 110 on the back of the freezer compartment 108 as a cooling source. The cooling fan 113 is installed above the low temperature side evaporator 303 to blow cool air generated by the low temperature side evaporator 303.

A temperature changing compartment cooling air path 311 is formed behind the temperature changing compartment 301, and a damper 302 is disposed in the air path, to adjust the temperature of the temperature changing compartment 301. The electrostatic atomization apparatus 131 as the mist spray apparatus for spraying a mist into the temperature changing compartment 301 is formed in the temperature changing compartment back partition wall 313.

In a cooling cycle according to the present invention, a refrigerant discharged from the compressor 109 is condensed by a condenser 307, and switched between a plurality of flow paths by a three way valve 308. One flow path constitutes a refrigerator compartment and freezer compartment simultaneous cooling cycle in which the refrigerant is reduced in pressure in a high temperature side capillary 310, undergoes heat exchange in the high temperature side evaporator 304, and then passes through the low temperature side evaporator 303 and an accumulator and returns to the compressor 109. The other flow path constitutes a freezer compartment individual cooling cycle in which the refrigerant is reduced in pressure in a low temperature side capillary 309, undergoes heat exchange in the low temperature side evaporator 303, and then passes through the accumulator and returns to the compressor 109.

This being so, through the use of the cool air of the low temperature side evaporator 303, the temperature of the temperature changing compartment 301 is optimally regulated by the operations of the cooling fan 113, the damper 302, the compressor 109, and the three way valve 308.

The partition wall on the back of the temperature changing compartment 301 has an envelope mainly made of a resin such as ABS, and contains styrene foam or the like inside to thermally insulate the temperature changing compartment 301 and the temperature changing compartment cooling air path 311. In addition, a depression is formed in a part of a temperature changing compartment side wall surface of the partition wall so as to be lower in temperature than other parts, and the electrostatic atomization apparatus 131 as the atomization apparatus is installed in the depression.

The cooling pin heater 158 for adjusting the temperature of the cooling pin 134 as the heat transfer connection member included in the electrostatic atomization apparatus 131 and preventing excessive dew condensation on a peripheral part including the atomization electrode 135 as the atomization tip is installed near the atomization unit 139, in the temperature changing compartment back partition wall 313 to which the electrostatic atomization apparatus 131 is fixed.

The cooling pin 134 as the heat transfer connection member is fixed to the external case 137, where the cooling pin 134 itself has the projection 134a that protrudes from the external case 137. The projection 134a of the cooling pin 134 is located opposite to the atomization electrode 135, and fit into the temperature changing compartment back partition wall 313.

Accordingly, the back of the cooling pin 134 as the heat transfer connection member is positioned close to the temperature changing compartment cooling air path 311 set to the freezing temperature zone.

Here, the cool air generated in the cooling compartment 110 and blown by the cooling fan 113 is used to cool the cooling pin 134 as the heat transfer connection member, and the cooling pin 134 is formed of a metal piece having excellent heat conductivity. Accordingly, the cooling unit can perform necessary cooling just by heat conduction from the cool air generated by the low temperature side evaporator 303.

The damper 302 is positioned downstream of the cooling compartment 110.

The atomization unit 139 of the electrostatic atomization apparatus 131 is situated in a gap between the lower storage container 119 and the upper storage container 120, with the tip of the atomization electrode being directed toward the gap.

The depression is formed in the temperature changing compartment back partition wall 313 in which the electrostatic atomization apparatus 131 is installed, and the electrostatic atomization apparatus 131 is disposed in the depression.

The cooling pin 134 of the electrostatic atomization apparatus 131 is fit into the through part 165 of the heat insulator 152, in a state where its circumference is covered with the cooling pin cover 166 formed of a resin such as PS or PP having heat insulation properties and also high waterproof properties.

Here, the cooling pin cover 166 is pressed against the surrounding heat insulator 152. In this way, even when water adheres to the cooling pin 134, it is possible to prevent a situation where the water adheres to the heat insulator 152 and penetrates into the heat insulator 152, causing freezing or breakage.

Regarding the end 134b of the cooling pin 134, however, the cooling pin cover 166 is shaped as a cylinder in order to ensure the cooling capacity from the back, so that only the end 134b of the cooling pin 134 is in an open state. The tape 194 such as aluminum tape is attached to the opening 167 of the through part 165 to block cool air.

The tape 194 is attached so as to be in close contact with the end 134b of the cooling pin 134, thereby ensuring heat conductivity.

Here, the cooling pin cover 166 may be, for example, insulating tape having heat insulation properties.

Note that, due to some dimension error or the like, the void 196 of a certain extent is present between the cooling pin 134 and the cooling pin cover 166. To fill the void 196, a heat conduction retention member such as butyl or a heat transferable compound is buried between the cooling pin 134 and the cooling pin cover 166, as the void filling member 197d which is a member for filling the void and has relatively excellent heat conductivity.

The temperature changing compartment 301 can be switched from the freezing temperature up to a wine storage temperature. This being so, for example, a temperature adjustment heater (not shown) may be disposed in its periphery.

An operation and working of the refrigerator having the above-mentioned structure are described below.

An operation of a refrigeration cycle is described first. The refrigeration cycle is activated by a signal from a control board (not shown) according to a set temperature inside the refrigerator, as a result of which a cooling operation is performed. A high temperature and high pressure refrigerant discharged by the operation of the compressor 109 is condensed into liquid to some extent by the condenser 307, is further condensed into liquid without causing dew condensation of the refrigerator main body (heat-insulating main body 101) while passing through a refrigerant pipe (not shown) and the like disposed on the side and back surfaces of the refrigerator main body (heat-insulating main body 101) and in a front opening of the refrigerator main body (heat-insulating main body 101), and reaches the three way valve 308. The flow path of the three way valve 308 is determined according to an operation signal from the control board of the refrigerator 100, and the refrigerant is flown to either the low temperature side capillary 309 or the high temperature side capillary 310, or to both the low temperature side capillary 309 and the high temperature side capillary 310. When the flow path of the three way valve 308 is open to the high temperature side capillary 310, the refrigerant becomes a low temperature and low pressure liquid refrigerant in the high temperature side capillary 310, and reaches the high temperature side evaporator 304.

The low temperature and low pressure liquid refrigerant in the high temperature side evaporator 304 reaches a temperature of about −10° C. to −20° C., and directly or indirectly undergoes heat exchange with the air in the refrigerator compartment 104. As a result, a part of the refrigerant in the high temperature side evaporator 304 evaporates. After this, the refrigerant further flows through the refrigerant pipe, and reaches the low temperature side evaporator 303.

The refrigerant then passes through the accumulator (not shown) and returns to the compressor 109. Thus, the operation of the cooling cycle is performed.

On the other hand, when the flow path of the three way valve 308 is open to the low temperature side capillary 309, the refrigerant becomes a low temperature and low pressure liquid refrigerant in the low temperature side capillary 309, and reaches the low temperature side evaporator 303.

Here, the low temperature and low pressure liquid refrigerant reaches a temperature of about −20° C. to −30° C., and undergoes heat exchange through convection of the air in the cooling compartment by the cooling fan 113. As a result, most of the refrigerant in the low temperature side evaporator 303 evaporates. The resulting cool air is blown by the cooling fan 113 into the freezer compartment 108 or the temperature changing compartment 301. The refrigerant which has undergone heat exchange then passes through the accumulator and returns to the compressor 109.

The low temperature side evaporator 303 in the cooling compartment 110 discharges the cool air by the cooling fan 113. The discharged cool air passes through a freezer compartment side cooling air path 312 in a freezer compartment back partition wall 314, and is discharged into the freezer compartment 108 from a discharge port. Having undergone heat exchange with a freezer compartment case, the discharged cool air is sucked from a lower part of the freezer compartment back partition wall 314, and returns to the cooling compartment 110 including the low temperature side evaporator 303.

Moreover, a part of the cool air discharged by the cooling fan 113 flows into the temperature changing compartment cooling air path 311 in the temperature changing compartment back partition wall 313. The cool air flowing in the temperature changing compartment cooling air path 311 passes through the damper 302, and is discharged into the temperature changing compartment 301 from a discharge port. Having undergone heat exchange with the inside of the temperature changing compartment 301, the cool air is sucked from a duct on the back surface, and returns to the cooling compartment 110. During this time, an opening/closing operation of the damper 302 is determined by a temperature detection unit installed in the temperature changing compartment 301. In so doing, the amount of cool air passing through the damper is controlled to thereby keep the temperature of the temperature changing compartment 301 constant.

Here, the temperature changing compartment 301 can be set to an arbitrary temperature, that is, the temperature changing compartment 301 can be switched from the freezing temperature zone of about −20° C. to the vegetable compartment temperature of about 5° C. and further to the wine compartment temperature of about 12° C. This being so, the temperature changing compartment 301 may be used as a vegetable compartment for storing vegetables and fruits.

In view of this, when the temperature of the temperature changing compartment 301 is set to about the vegetable storage temperature, for example, 2° C. or more, the electrostatic atomization apparatus 131 is operated to improve freshness preservation of stored contents.

In a part of the temperature changing compartment back partition wall 313 of the temperature changing compartment 301 that is in a relatively high humidity environment, the heat insulator has a smaller wall thickness than other parts. In particular, there is the deepest depression 111b behind the cooling pin 134. Thus, the depression 111a is formed in the temperature changing compartment back partition wall 313, and the electrostatic atomization apparatus 131 having the protruding projection 134a of the cooling pin 134 is fit into the deepest depression 111b on a backmost side of the depression 111a.

Cool air of about −15° C. to −25° C. generated by the low temperature side evaporator 303 and blown by the cooling fan 113 according to the operation of the cooling system flows in the temperature changing compartment cooling air path 311 behind the cooling pin 134, as a result of which the cooling pin 134 as the heat transfer cooling member is cooled to, for example, about 0° C. to −10° C. by heat conduction from the air path surface. Since the cooling pin 134 is a good heat conductive member, the cooling pin 134 transmits cold heat extremely easily, so that the atomization electrode 135 as the atomization tip is indirectly cooled to about 0° C. to −10° C. via the cooling pin 134.

When the damper 302 is open, the cool air directly flows into the temperature changing compartment 301, so that the temperature changing compartment is in a low humidity state. When the damper 302 is closed, the dry air does not flow into the temperature changing compartment, so that the temperature changing compartment is relatively high in humidity, and also the temperature changing compartment cooling air path behind the cooling pin 134 is kept at a low temperature to some extent.

Here, in the case where the temperature setting of the temperature changing compartment 301 is the vegetable compartment setting, the temperature changing compartment 301 is 2° C. to 7° C. in temperature and also in a relatively high humidity state due to transpiration from vegetables and the like. Accordingly, when the atomization electrode 135 as the atomization tip of the electrostatic atomization apparatus 131 decreases to the dew point temperature or below, water is generated and water droplets adhere to the atomization electrode 135 including its tip.

The voltage application unit 133 applies a high voltage (for example, 4 kV to 10 kV) between the atomization electrode 135 as the atomization tip to which the water droplets adhere and the counter electrode 136, where the atomization electrode 135 is on a negative voltage side and the counter electrode 136 is on a positive voltage side. This causes corona discharge to occur between the electrodes. The water droplets at the tip of the atomization electrode 135 as the atomization tip are finely divided by electrostatic energy. Furthermore, since the liquid droplets are electrically charged, a nano-level fine mist carrying an invisible charge of a several nm level, accompanied by ozone, OH radicals, and so on, is generated by Rayleigh fission. The voltage applied between the electrodes is an extremely high voltage of 4 kV to 10 kV. However, a discharge current value at this time is at a several μA level, and therefore an input is extremely low, about 0.5 W to 1.5 W.

In detail, suppose the atomization electrode 135 is on a reference potential side (0 V) and the counter electrode 136 is on a high voltage side (+7 kV). An air insulation layer between the atomization electrode 135 and the counter electrode 136 is broken down, and discharge is induced by an electrostatic force. At this time, the dew condensation water adhering to the tip of the atomization electrode 135 is electrically charged and becomes fine particles. Since the counter electrode 136 is on the positive side, the charged fine mist is attracted to the counter electrode 136, and the liquid droplets are more finely divided. Thus, the nano-level fine mist carrying an invisible charge of a several nm level containing radicals is attracted to the counter electrode 136, and sprayed toward the storage compartment (temperature changing compartment 301) by its inertial force.

Here, the cooling pin 134 is cooled from the temperature changing compartment cooling air path 311 via the tape 194 and the void filling member 197d or via the heat insulator on the side of the cooling pin. When dual-structure indirect cooling is performed via the tape 194, there is a possibility that the void 196 occurs between the cooling pin cover 166 and the tape 194 due to processing accuracy. When the void 196 occurs, heat conductivity in that space deteriorates significantly, making it impossible to sufficiently cool the cooling pin 134. This causes temperature variations of the cooling pin 134 and the atomization electrode 135 and, in some cases, hampers dew condensation on the atomization electrode tip.

To prevent this, it is ensured during assembly that the tape 194 and the cooling pin 134 are in close contact with each other. In the case where there is still a possibility of an occurrence of a void, the void 196 is filled with a heat conduction retention member such as butyl or a heat transferable compound as the void filling member 197d, thereby ensuring heat conduction from the tape 194 to the cooling pin 134. Thus, the cooling capacity for the atomization electrode 135 can be ensured.

Furthermore, there is no clearance between the cooling pin cover 166 and the through part 165 and also the opening 167 of the through part 165 is sealed by the tape 194 to block the entry of cool air from the adjacent cooling air path, so that the low temperature cool air does not leak into the storage compartment. Accordingly, the storage compartment (temperature changing compartment 301) and its peripheral components can be protected from dew condensation, low temperature anomalies, and so on.

Regarding heat conduction deterioration by a void that inevitably occurs between the cooling pin cover 166 and the cooling pin 134 due to processing accuracy and assembly accuracy, the void 196 is filled with a heat conductive member such as butyl to ensure heat conductivity, thereby ensuring the cooling capacity. The void 196 between the tape 194 and the cooling pin 134 can also be filled with a heat conductive member such as butyl to ensure heat conductivity.

Moreover, since there is no clearance between the cooling pin cover 166 and the through part 165, water is kept from entering the heat insulator made of styrene foam. By preventing a situation where water penetrates into the heat insulator and the penetrated portion is frozen and, due to a stress caused by water volume expansion, cracked and broken, it is possible to further ensure quality.

Besides, the opening 167 of the through part 165 is sealed by the tape 194 to block the entry of cool air from the adjacent cooling air path, so that the low temperature cool air does not leak into the storage compartment. Accordingly, the storage compartment (temperature changing compartment 301) and its peripheral components can be protected from dew condensation, low temperature anomalies, and so on.

As a result of the cooling, dew condensation is formed on the atomization electrode 135. The fine mist generated by causing high-voltage discharge between the counter electrode 136 and the atomization electrode 135 passes through the spray port 132 formed in the external case 137 of the electrostatic atomization apparatus 131, and is sprayed into the temperature changing compartment 301. The sprayed fine mist reaches throughout the temperature changing compartment 301 because the fine mist is made up of extremely small particles and so has high diffusivity. The sprayed fine mist is generated by high-voltage discharge, and so is negatively charged. Meanwhile, vegetables and fruits stored in the temperature changing compartment 301 are positively charged. Accordingly, the atomized mist tends to gather on vegetable surfaces. This contributes to enhanced freshness preservation.

Note that the temperature mentioned above is not a limit for the present invention, so long as it is possible to spray the mist. For example, even in the case where the temperature changing compartment is set to a partial temperature of about −2° C., an ice temperature of about 0° C., or a chilled temperature zone of about 1° C., when the electrostatic atomization apparatus 131 determines that it is possible to spray the mist, the mist can be sprayed. Since the fine mist adhering to perishable food surfaces enhances microbial elimination, long-term storage can be achieved.

When the temperature changing compartment 301 is set to the wine temperature, the damper 302 is mostly closed, and accordingly the storage compartment is in a relatively high humidity state. This raises a possibility of propagation of molds and the like. However, such propagation can be prevented by spraying the mist containing radicals with strong oxidative power.

When the temperature changing compartment 301 is set to a temperature zone, such as the freezing temperature zone, for which the mist spray can be determined to be impossible, or when the operation of the electrostatic atomization apparatus 131 can be arbitrarily stopped using a manual button or the like, the electrostatic atomization apparatus may be stopped.

Moreover, by determining the operation of the electrostatic atomization apparatus 131 by the damper opening/closing operation, the electrostatic atomization apparatus 131 can be operated efficiently.

In addition, by disposing the temperature adjustment heater near the cooling pin 134 of the electrostatic atomization apparatus 131, the temperature control of the atomization electrode and the water quantity adjustment of the atomization tip can be carried out, with it being possible to achieve a more stable atomization state.

As described above, in the thirteenth embodiment, the temperature changing compartment variable in temperature, the partition wall for separating the storage compartment, and the temperature changing compartment cooling air path for cooling the temperature changing compartment are provided in the refrigerator having a plurality of evaporators. By attaching the electrostatic atomization apparatus to the back partition wall separating the storage compartment and the air path, when the temperature setting of the temperature changing compartment is about the vegetable compartment temperature setting, the atomization electrode is cooled by heat conduction from the air path flowing into the temperature changing compartment to thereby form dew condensation. Thus, the mist can be sprayed stably. Additionally, the electrostatic atomization apparatus 131 is difficult to reach by hand because it is attached to the back surface, which contributes to enhanced safety.

In this embodiment, even when the damper is closed, the air path behind the temperature changing compartment can be kept at a relatively low temperature because it is situated upstream of the damper. This allows the atomization electrode to be cooled sufficiently, thereby forming dew condensation on the atomization electrode tip and generating the mist.

In this embodiment, the atomization unit generates a mist according to the electrostatic atomization method, where water droplets are finely divided using electrical energy such as a high voltage to thereby form a fine mist. The generated mist is electrically charged. This being so, by causing the mist to carry an opposite charge to vegetables, fruits, and the like to which the mist is intended to adhere, for example, by spraying a negatively charged mist over positively charged vegetables, the adhesion of the mist to the vegetables and fruits increases, as a result of which the mist can adhere to the vegetable surfaces more uniformly. In this way, a mist adhesion ratio can be improved when compared with an uncharged mist. Moreover, the fine mist can be directly sprayed over the foods in the vegetable containers, and the potentials of the fine mist and the vegetables are exploited to cause the fine mist to adhere to the vegetable surfaces. This improves freshness preservation efficiently.

Note that, by using an electrically powered damper as the damper in this embodiment, a setting temperature (operating temperature) constraint in the case of using a mechanical damper can be circumvented, so that the temperature changing compartment can be controlled at an arbitrary temperature. This enables temperatures suitable for various foods to be set. Furthermore, forced closing which cannot be performed with a mechanical damper becomes possible. When the temperature changing compartment is not in use, there is no need to circulate cool air to the temperature changing compartment. In such a case, by forcibly closing the electrically powered damper, needless cooling can be prevented, and power consumption can be reduced. Besides, by forcibly closing the electrically powered damper when defrosting the low temperature side evaporator in the cooling compartment, it is possible to prevent the entry of warm moisture into the temperature changing compartment. As a result, frosting prevention and also power consumption reduction by increased defrosting efficiency can be achieved. In addition, since the atomization electrode can be increased in temperature, it is possible to provide a means for drying the atomization electrode, which contributes to improved reliability.

Note that, by using a heat reserving compartment fan that can be varied in rotation frequency as the damper in this embodiment, the amount of cool air into the temperature changing compartment can be adjusted, and also the setting temperature (operating temperature) constraint in the case of a mechanical damper can be circumvented. Therefore, the temperature changing compartment 301 can be controlled to an arbitrary temperature, with it being possible to set temperatures suitable for various foods. Moreover, a cooling speed of rapid cooling, slow cooling, and the like can be controlled. This further contributes to enhanced food freshness preservation.

Though the storage compartment in which the electrostatic atomization apparatus is installed is the temperature changing compartment in this embodiment, the electrostatic atomization apparatus may be installed in the vegetable compartment that is more limited in temperature zone. This narrows the range of temperature variation, enabling control to be more simplified.

### Fourteenth Embodiment

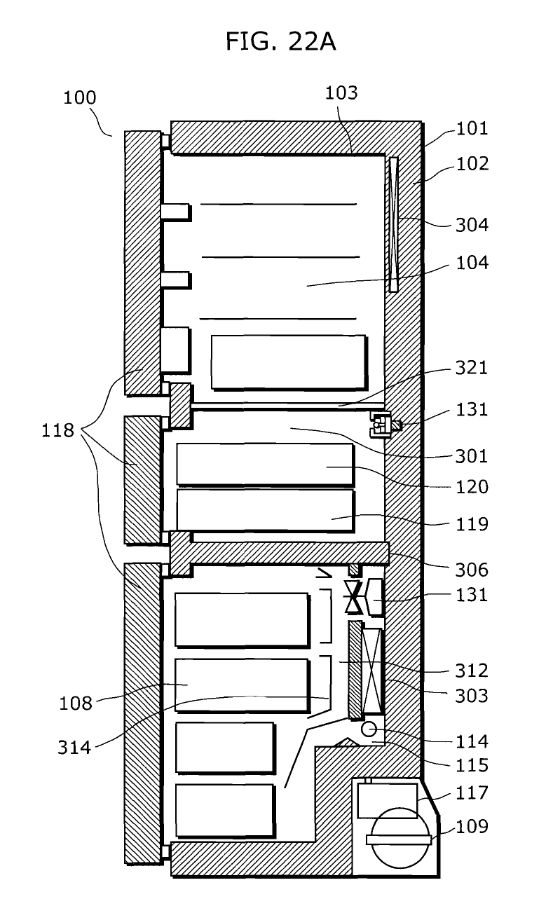

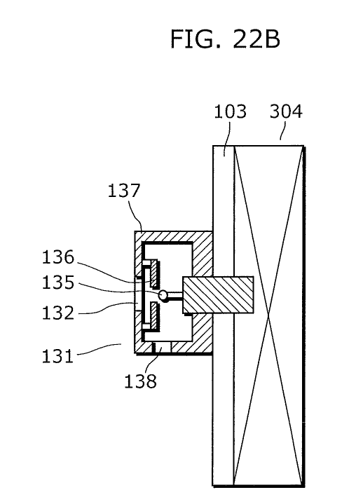

FIG. 22A is a sectional view of a refrigerator in a fourteenth embodiment of the present invention. FIG. 22B is a sectional view of an electrostatic atomization apparatus and its vicinity in the fourteenth embodiment of the present invention.

In this embodiment, detailed description is given only for parts that differ from the structures described in the first to thirteenth embodiments, with description being omitted for parts that are the same as the structures described in the first to thirteenth embodiments or parts to which the same technical ideas are applicable.

As shown in the drawings, in the refrigerator 100 of the fourteenth embodiment, the refrigerator compartment 104 as the first storage compartment is located at the top, the temperature changing compartment 301 that can be changed to the vegetable compartment temperature of about 5° C. is located below the refrigerator compartment 104, and the freezer compartment 108 is located below the temperature changing compartment 301. The temperature changing compartment 301 is defined by a partition plate 321 for separating the temperature zones of the refrigerator compartment 104 and the temperature changing compartment 301, a second partition wall ensuring heat insulation for separating the temperature zone of the temperature changing compartment 301, the inner case 103 on the back of the temperature changing compartment 301, and the door 118.

The refrigerator compartment 104 and the temperature changing compartment 301 use the high temperature side evaporator 304 housed in an inner wall on the back of the refrigerator compartment and the temperature changing compartment as a cooling source. Meanwhile, the freezer compartment 108 uses the low temperature side evaporator 303 included in the cooling compartment 110 on the back of the freezer compartment 108 as a cooling source. The cooling fan 113 is installed above the low temperature side evaporator 303 to blow cool air generated by the low temperature side evaporator 303.

The electrostatic atomization apparatus 131 as the mist spray apparatus for spraying a mist into the temperature changing compartment 301 is formed in the back surface of the temperature changing compartment 301.

In a cooling cycle according to the present invention, a refrigerant discharged from the compressor 109 is condensed by the condenser 307, and switched between a plurality of flow paths by the three way valve 308. One flow path constitutes the refrigerator compartment and freezer compartment simultaneous cooling cycle in which the refrigerant is reduced in pressure in the high temperature side capillary 310, undergoes heat exchange in the high temperature side evaporator 304, and then passes through the low temperature side evaporator 303 and the accumulator and returns to the compressor 109. The other flow path constitutes the freezer compartment individual cooling cycle in which the refrigerant is reduced in pressure in the low temperature side capillary 309, undergoes heat exchange in the low temperature side evaporator 303, and then passes through the accumulator and returns to the compressor 109.

This being so, through the use of the high temperature side evaporator 304, the temperature of the temperature changing compartment 301 is optimally regulated by a refrigerator compartment temperature detection unit (not shown) or a temperature changing compartment temperature detection unit (not shown), the compressor 109, and the three way valve 308.

The inner case 103 on the back of the temperature changing compartment 301 is mainly made of a resin such as ABS, and the electrostatic atomization apparatus 131 as the atomization apparatus is installed in a part of the inner case 103.

The cooling pin heater 158 for adjusting the temperature of the cooling pin 134 as the heat transfer connection member included in the electrostatic atomization apparatus 131 and preventing excessive dew condensation on a peripheral part including the atomization electrode 135 as the atomization tip is installed near the atomization unit 139, in the inner case 103 to which the electrostatic atomization apparatus 131 is fixed.

The cooling pin 134 as the heat transfer connection member is fixed to the external case 137, where the cooling pin 134 itself has the projection 134a that protrudes from the external case 137. The projection 134a of the cooling pin 134 is located opposite to the atomization electrode 135, and fit into a depression formed in a part of the inner case 103.

Accordingly, the back of the cooling pin 134 as the heat transfer connection member is positioned close to the high temperature side evaporator 304.

An operation and working of the refrigerator having the above-mentioned structure are described below.

An operation of a refrigeration cycle is described first. The refrigeration cycle is activated by a signal from a control board (not shown) according to a set temperature inside the refrigerator, as a result of which a cooling operation is performed. A high temperature and high pressure refrigerant discharged by the operation of the compressor 109 is condensed into liquid to some extent by the condenser 307, is further condensed into liquid without causing dew condensation of the refrigerator main body (heat-insulating main body 101) while passing through a refrigerant pipe (not shown) and the like disposed on the side and back surfaces of the refrigerator main body (heat-insulating main body 101) and in a front opening of the refrigerator main body (heat-insulating main body 101), and reaches the three way valve 308. The flow path of the three way valve 308 is determined according to an operation signal from the control board of the refrigerator 100, and the refrigerant is flown to either the low temperature side capillary 309 or the high temperature side capillary 310, or to both the low temperature side capillary 309 and the high temperature side capillary 310. When the flow path of the three way valve 308 is open to the high temperature side capillary 310, the refrigerant becomes a low temperature and low pressure liquid refrigerant in the high temperature side capillary 310, and reaches the high temperature side evaporator 304.

The low temperature and low pressure liquid refrigerant in the high temperature side evaporator 304 reaches a temperature of about −10° C. to −20° C., and directly or indirectly undergoes heat exchange with the air in the refrigerator compartment 104 or the temperature changing compartment 301. As a result, a part of the refrigerant in the high temperature side evaporator 304 evaporates. After this, the refrigerant further flows through the refrigerant pipe, and reaches the low temperature side evaporator 303.

The refrigerant then passes through the accumulator (not shown) and returns to the compressor 109. Thus, the operation of the cooling cycle is performed.

On the other hand, when the flow path of the three way valve 308 is open to the low temperature side capillary 309, the refrigerant becomes a low temperature and low pressure liquid refrigerant in the low temperature side capillary 309, and reaches the low temperature side evaporator 303.

Here, the low temperature and low pressure liquid refrigerant reaches a temperature of about −20° C. to −30° C., and undergoes heat exchange through convection of the air in the cooling compartment by the cooling fan 113. As a result, most of the refrigerant in the low temperature side evaporator 303 evaporates. The resulting cool air is blown by the cooling fan 113 into the freezer compartment 108. The refrigerant which has undergone heat exchange then passes through the accumulator and returns to the compressor 109.

The low temperature side evaporator 303 in the cooling compartment 110 discharges the cool air by the cooling fan 113. The discharged cool air passes through the freezer compartment side cooling air path 312 in the freezer compartment back partition wall 314, and is discharged into the freezer compartment 108 from a discharge port. Having undergone heat exchange with a freezer compartment case, the discharged cool air is sucked from a lower part of the freezer compartment back partition wall 314, and returns to the cooling compartment 110 including the low temperature side evaporator 303.

The flow path of the three way valve to the high temperature side capillary 310 is opened to cool the freezer compartment 104 and the temperature changing compartment 301. The opening/closing of the three way valve is determined by a temperature detection unit placed in the refrigerator compartment 104 or the temperature changing compartment 301, thereby keeping the temperature of each of the refrigerator compartment 104 and the temperature changing compartment 301 constant.

Here, the temperature changing compartment 301 can be set to an arbitrary temperature, that is, the temperature changing compartment 301 can be switched from the partial temperature zone of about −2° C. to the vegetable compartment temperature of about 5° C. and further to the wine compartment temperature of about 12° C. This being so, the temperature changing compartment 301 may be used as a vegetable compartment for storing vegetables and fruits.

In view of this, when the temperature of the temperature changing compartment 301 is set to about the vegetable storage temperature, for example, 2° C. or more, the electrostatic atomization apparatus 131 is operated to improve freshness preservation of stored contents.

The electrostatic atomization apparatus 131 is disposed in a part of the inner case 103 on the back of the temperature changing compartment 301 that is in a relatively high humidity environment, and especially the back of the cooling pin 134 is close to the high temperature side evaporator 304.

A heat conductive member such as a refrigerator pipe or a fin of the high temperature side evaporator 304 on the back of the cooling pin 134 becomes about −15° C. to −25° C. in temperature by the operation of the cooling system. Heat conduction from the heat conductive member causes the cooling pin 134 as the heat transfer cooling member to be cooled to, for example, about 0° C. to −10° C. Since the cooling pin 134 is a good heat conductive member, the cooling pin 134 transmits cold heat extremely easily, so that the atomization electrode 135 as the atomization tip is indirectly cooled to about 0° C. to −10° C. via the cooling pin 134.

Thus, the cooling pin 134 is cooled by direct heat conduction from the evaporator.

By using, as the cooling unit for cooling the cooling pin 134, not the low temperature cool air from the air path but the direct heat conduction from the evaporator whose evaporation temperature is roughly kept constant, the cooling pin can be cooled more stably, and also the heat capacity increases by the evaporator and the refrigerant and so a more stable temperature can be attained.

When the three way valve 308 is set so that the flow path to the high temperature side capillary is in an open state, the refrigerator compartment 104 and the temperature changing compartment 301 enter the cooling mode, so that the temperature changing compartment is in a low humidity state. When the three way valve 308 is set so that the flow path to the high temperature side capillary is in a closed state, the temperature changing compartment becomes relatively high in humidity, and the temperature of the high temperature side evaporator 304 behind the cooling pin 134 is kept at a low temperature to some extent.

Here, in the case where the temperature setting of the temperature changing compartment 301 is the vegetable compartment setting, the temperature changing compartment 301 is 2° C. to 7° C. in temperature and also in a relatively high humidity state due to transpiration from vegetables and the like. Accordingly, when the atomization electrode 135 as the atomization tip of the electrostatic atomization apparatus 131 decreases to the dew point temperature or below, water is generated and water droplets adhere to the atomization electrode 135 including its tip. Hence, a fine mist containing radicals can be generated by high voltage application.

The fine mist passes through the spray port 132 formed in the external case 137 of the electrostatic atomization apparatus 131, and is sprayed into the temperature changing compartment 301. The sprayed fine mist reaches throughout the temperature changing compartment 301 because the fine mist is made up of extremely small particles and so has high diffusivity. The sprayed fine mist is generated by high-voltage discharge, and so is negatively charged. Meanwhile, vegetables and fruits stored in the temperature changing compartment 301 are positively charged. Accordingly, the atomized mist tends to gather on vegetable surfaces. This contributes to enhanced freshness preservation.

Note that the temperature mentioned above is not a limit for the present invention, so long as it is possible to spray the mist. For example, even in the case where the temperature changing compartment is set to a partial temperature of about −2° C., an ice temperature of about 0° C., or a chilled temperature zone of about 1° C., when the electrostatic atomization apparatus 131 determines that it is possible to spray the mist, the mist can be sprayed. Since the fine mist adhering to perishable food surfaces enhances microbial elimination, long-term storage can be achieved.

Moreover, by linking the operation of the three way valve 308 and the operation of the electrostatic atomization apparatus 131, the mist can be sprayed more efficiently.

In addition, by disposing the temperature adjustment heater near the cooling pin 134 of the electrostatic atomization apparatus 131, the temperature control of the atomization electrode and the water quantity adjustment of the atomization tip can be carried out, with it being possible to achieve a more stable atomization state.

As described above, in the fourteenth embodiment, the temperature changing compartment variable in temperature and the evaporator for cooling the temperature changing compartment are provided in the refrigerator having a plurality of evaporators. In the case where the evaporator for cooling the refrigerator compartment is utilized to cool the temperature changing compartment, by attaching the electrostatic atomization apparatus to a part of the inner case behind the temperature changing compartment, the atomization electrode is cooled by heat conduction from the high temperature side evaporator to thereby form dew condensation when the temperature setting of the temperature changing compartment is about the vegetable compartment temperature setting. Thus, the mist can be sprayed stably. Additionally, the electrostatic atomization apparatus 131 is difficult to reach by hand because it is attached to the back surface, which contributes to enhanced safety. Furthermore, the number of components can be reduced, with it being possible to provide an inexpensive structure.

Though the cooling pin is cooled by direct heat conduction from the evaporator in this embodiment, an indirect arrangement via a resin or a heat insulator may instead be employed so long as the temperature of the atomization unit is appropriate. This allows for a reduction in man-hour and management for incorporating the electrostatic atomization apparatus in the vicinity of the evaporator to ensure heat conductivity.

### Fifteenth Embodiment

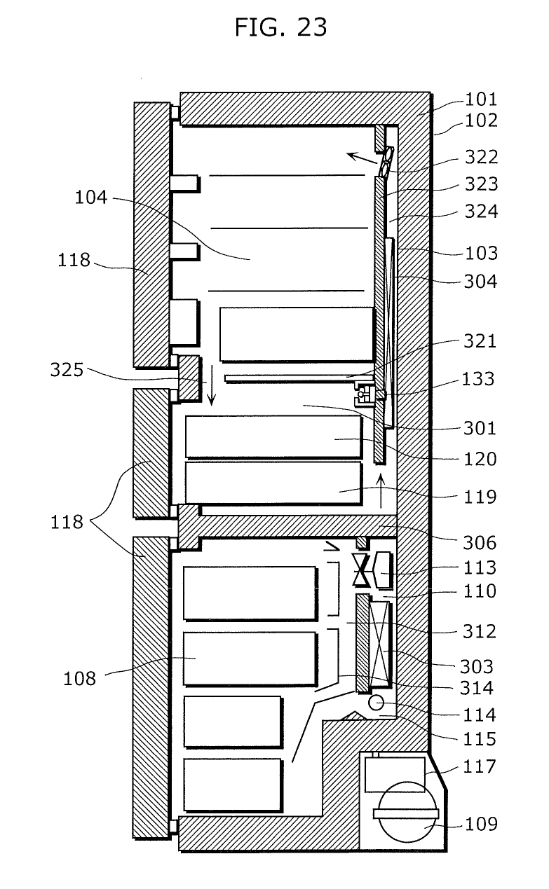

FIG. 23 is a sectional view of a refrigerator in a fifteenth embodiment of the present invention.

In this embodiment, detailed description is given only for parts that differ from the structures described in the first to fourteenth embodiments, with description being omitted for parts that are the same as the structures described in the first to fourteenth embodiments or parts to which the same technical ideas are applicable.

As shown in the drawings, in the refrigerator 100 of the fifteenth embodiment, the refrigerator compartment 104 as the first storage compartment is located at the top, the temperature changing compartment 301 that can be changed to a vegetable compartment temperature of about 5° C. is located below the refrigerator compartment 104, and the freezer compartment 108 is located below the temperature changing compartment 301.

The temperature changing compartment 301 is defined by the partition plate 321 for separating the temperature zones of the refrigerator compartment 104 and the temperature changing compartment 301, a second partition wall ensuring heat insulation for separating the temperature zone of the temperature changing compartment 301, the partition plate 321 on the back of the temperature changing compartment 301, and the door 118. A temperature changing compartment discharge port 325 is formed in a part of the partition plate 321.

A refrigerator compartment partition plate 323 is disposed on the back of the refrigerator compartment 104 and the temperature changing compartment 301. This partition extends to the back of the temperature changing compartment 301, and a refrigerator compartment air path 324 is separated by the partition. A temperature changing compartment suction port 326 is formed at one end of the refrigerator compartment air path 324. The high temperature side evaporator 304 is installed in the refrigerator compartment air path 324, and a refrigerator compartment fan 322 is located above the high temperature side evaporator 304 to send cool air into the refrigerator compartment.

The electrostatic atomization apparatus 131 as the mist spray apparatus for spraying a mist into the temperature changing compartment 301 is formed in a part of the partition plate 321 behind the temperature changing compartment 301.

The partition plate 321 behind the temperature changing compartment 301 is mainly formed of a resin such as ABS and a heat insulator such as styrene foam. The electrostatic atomization apparatus 131 as the atomization apparatus is installed in a part of the inner case of the partition plate 321.

The cooling pin heater 158 for adjusting the temperature of the cooling pin 134 as the heat transfer connection member included in the electrostatic atomization apparatus 131 and preventing excessive dew condensation on a peripheral part including the atomization electrode 135 as the atomization tip is installed near the atomization unit 139, in the partition plate 321 to which the electrostatic atomization apparatus 131 is fixed.

The cooling pin 134 as the heat transfer connection member is fixed to the external case 137, where the cooling pin 134 itself has the projection 134a that protrudes from the external case 137. The projection 134a of the cooling pin 134 is located opposite to the atomization electrode 135, and fit into a depression formed in a part of the partition plate 321.

Here, the back of the cooling pin 134 as the heat transfer connection member is positioned close to the high temperature side evaporator 304.

An operation and working of the refrigerator having the above-mentioned structure are described below.

When the flow path of the three way valve is open to the high temperature side capillary 310, the refrigerator compartment 104 and the temperature changing compartment 301 are cooled. At this time, the opening/closing of the three way valve and the operation of the refrigerator compartment fan 322 are determined by a temperature detection unit placed in the refrigerator compartment 104 or the temperature changing compartment 301, thereby keeping the temperature of each of the refrigerator compartment 104 and the temperature changing compartment 301 constant.

Here, the temperature changing compartment 301 can be set to an arbitrary temperature, that is, the temperature changing compartment 301 can be switched from the partial temperature zone of about −2° C. to the vegetable compartment temperature of about 5° C. and further to the wine compartment temperature of about 12° C. This being so, the temperature changing compartment 301 may be used as a vegetable compartment for storing vegetables and fruits.

In view of this, when the temperature of the temperature changing compartment 301 is set to about the vegetable storage temperature, for example, 2° C. or more, the electrostatic atomization apparatus 131 is operated to improve freshness preservation of stored contents.

The electrostatic atomization apparatus 131 is disposed in a part of the partition plate 321 on the back of the temperature changing compartment 301 that is in a relatively high humidity environment, and especially the back of the cooling pin 134 is close to the high temperature side evaporator 304.

A heat conductive member such as a refrigerator pipe or a fin of the high temperature side evaporator 304 on the back of the cooling pin 134 becomes about −15° C. to −25° C. in temperature by the operation of the cooling system. Heat conduction from the heat conductive member causes the cooling pin 134 as the heat transfer cooling member to be cooled to, for example, about 0° C. to −10° C. Since the cooling pin 134 is a good heat conductive member, the cooling pin 134 transmits cold heat extremely easily, so that the atomization electrode 135 as the atomization tip is indirectly cooled to about 0° C. to −10° C. via the cooling pin 134.

When the three way valve 308 is set so that the flow path to the high temperature side capillary is in an open state, the refrigerator compartment 104 and the temperature changing compartment 301 enter the cooling mode, so that the temperature changing compartment is in a low humidity state. When the three way valve 308 is set so that the flow path to the high temperature side capillary is in a closed state, the temperature changing compartment becomes relatively high in humidity, and frost adhering to the high temperature side evaporator can be melted for defrosting by operating the refrigerator compartment fan 322. During this time, the temperature changing compartment 301 becomes a relatively high humidity space. Therefore, atomization is possible even when the temperature of the high temperature side evaporator 304 behind the cooling pin 134 increases.

Here, in the case where the temperature setting of the temperature changing compartment 301 is the vegetable compartment setting, the temperature changing compartment 301 is 2° C. to 7° C. in temperature and also in a relatively high humidity state due to transpiration from vegetables and the like. Accordingly, when the atomization electrode 135 as the atomization tip of the electrostatic atomization apparatus 131 decreases to the dew point temperature or below, water is generated and water droplets adhere to the atomization electrode 135 including its tip. Hence, a fine mist containing radicals can be generated by high voltage application.

The fine mist passes through the spray port 132 formed in the external case 137 of the electrostatic atomization apparatus 131, and is sprayed into the temperature changing compartment 301. The sprayed fine mist reaches throughout the temperature changing compartment 301 because the fine mist is made up of extremely small particles and so has high diffusivity. The sprayed fine mist is generated by high-voltage discharge, and so is negatively charged. Meanwhile, vegetables and fruits stored in the temperature changing compartment 301 are positively charged. Accordingly, the atomized mist tends to gather on vegetable surfaces. This contributes to enhanced freshness preservation.

Note that the temperature mentioned above is not a limit for the present invention, so long as it is possible to spray the mist. For example, even in the case where the temperature changing compartment is set to a partial temperature of about −2° C., an ice temperature of about 0° C., or a chilled temperature zone of about 1° C., when the electrostatic atomization apparatus 131 determines that it is possible to spray the mist, the mist can be sprayed. Since the fine mist adhering to perishable food surfaces enhances microbial elimination, long-term storage can be achieved.

Moreover, by linking the operation of the refrigerator compartment fan 322 and the operation of the electrostatic atomization apparatus 131, the mist can be sprayed more efficiently.

In addition, by disposing the temperature adjustment heater near the cooling pin 134 of the electrostatic atomization apparatus 131, the temperature control of the atomization electrode and the water quantity adjustment of the atomization tip can be carried out, with it being possible to achieve a more stable atomization state.

As described above, in the fifteenth embodiment, the temperature changing compartment variable in temperature and the evaporator for cooling the temperature changing compartment are provided in the refrigerator having a plurality of evaporators. In the case where the evaporator for cooling the refrigerator compartment is utilized to cool the temperature changing compartment and cool air generated in the evaporator is conveyed by the refrigerator compartment fan, by attaching the electrostatic atomization apparatus to a part of the partition plate behind the temperature changing compartment, the atomization electrode is cooled by heat conduction from the high temperature side evaporator to thereby form dew condensation when the temperature setting of the temperature changing compartment is about the vegetable compartment temperature setting. Thus, the mist can be sprayed stably. Additionally, the electrostatic atomization apparatus is difficult to reach by hand because it is attached to the back surface, which contributes to enhanced safety. Furthermore, the number of components can be reduced, with it being possible to provide an inexpensive structure.

### Sixteenth Embodiment

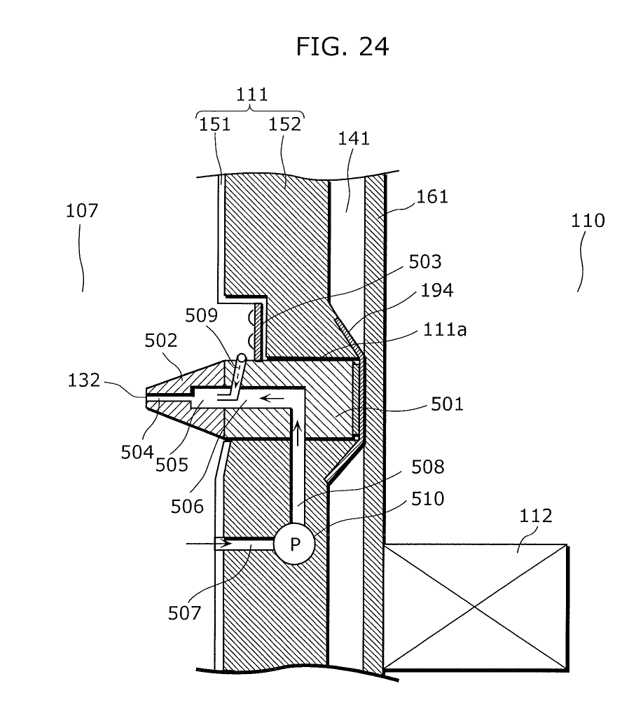

FIG. 24 is a sectional view of a vegetable compartment and its vicinity in a refrigerator in a sixteenth embodiment of the present invention.

In this embodiment, detailed description is mainly given for parts that differ from the structures described in the first to fifteenth embodiments, with detailed description being omitted for parts that are the same as the structures described in the first to fifteenth embodiments or parts to which the same technical ideas are applicable.

In the drawing, the back partition wall 111 includes the back partition wall surface 151 made of a resin such as ABS, and the heat insulator 152 made of styrene foam or the like for ensuring heat insulation between the vegetable compartment 107 and the freezer compartment discharge air path 141.

Here, the depression 111a is formed in a part of a vegetable compartment 107 side wall surface of the back partition wall 111 so as to be lower in temperature than other parts, and a cooling pin 501 which is a good heat conductive material is disposed in the depression 111a.

In this embodiment, the atomization unit is an atomization apparatus which is an ejector-type mist spray apparatus. The cooling pin 501 is mainly cooled by heat conduction from the freezer compartment discharge air path 141 on the back, and an atomization tip 502 of the cooling pin 501 is made of a resin. Cavities 504, 505, 506, 507, and 508 are formed in the cooling pin 501 and the atomization tip 502. That is, the flow path 504 of a narrow diameter formed on the spray port 132 side and the flow path 505 of a larger diameter communicating with the flow path 504 are formed in the atomization tip 502. A small pump 510 is disposed in the heat insulator 152 below the cooling pin 501, and the flow path 507 having one end open to the vegetable compartment 107 and the other end connected to the pump 510 is formed. In addition, the flow path 508 extending upward from the pump 510 and connected to the heat insulator 152 and the cooling pin 501 is formed. Further, the flow path 506 linking one end of the flow path 508 in the cooping pin 501 and the flow path 505 in the atomization tip 502 together is formed. Thus, from the vegetable compartment 107, the flow path 507, the pump 510, the flow path 508, the flow path 506, the flow path 505, and the flow path 504 of the narrower diameter than the other flow paths are formed to communicate with each other.

A water collection portion 503 that mainly collects water in the vegetable compartment 107 is formed above the cooling pin 501 on the vegetable compartment 107 side. The water collection portion 503 is made up of a metal plate formed on a vertical surface in the depression 111a formed in the heat insulator 152 above the cooling pin 501 on the vegetable compartment 107 side. The metal plate of the water collection portion 503 is thermally connected with the cooling pin 501.

A water channel 509 communicating with the flow path 506 is formed in the cooling pin 501, from a vegetable compartment 107 side upper surface of the cooling pin 501 exposed by the depression 111a.

One end of the cooling pin 501 on the cooling compartment 110 side is joined to the partition plate 161 via the tape 194 as the cool air blocking member, in the same way as the ninth embodiment shown in FIG. 13. The cooling pin 501 is surrounded by the heat insulator, and a void between the depression 111a and the cooling pin 501 is filled with a void filling member (not shown).

An operation and working of the refrigerator having the above-mentioned structure are described below. The cooling pin 501 as the heat transfer connection member is cooled via the heat insulator 152 as the cushioning material, so that high humidity air in the vegetable compartment 107 builds up dew condensation on the water collection portion 503 thermally connected to the cooling pin 501, thereby generating water 512. The water 512 is guided to the water channel 509 and flows into the flow path 505.

Meanwhile, as the pump 510 operates, air is sucked from the vegetable compartment 107 and relatively fast air flows to the flow path 505 and to the flow path 504 via the flow paths 507, 508, and 506. Since the water 512 is supplied in the flow path 505 from the water channel 509 as mentioned above, the water 512 is mixed with the fast air stream from the flow path 506, as a result of which a fluid in a mist form is sprayed from the spray port 132 of the atomization tip 502.

The generated mist is sprayed into the vegetable compartment 107, thereby moisturizing stored foods and enhancing freshness preservation.

As described above, in this embodiment, by cooling the cooling pin 501 as the heat conductive member by the freezer compartment discharge air path 141, water is generated in the water collection portion 503. The generated water is flown into the flow path 505 formed inside the cooling pin 501, air is flown by the pump from the other flow paths 506, 507, and 508, and the water and the air are mixed to generate a mist. The vegetable compartment 107 can be humidified by the generated mist, with it being possible to enhance vegetable freshness preservation.

### Seventeenth Embodiment

In the embodiments described above, the electrostatic atomization apparatus is applied to the refrigerator. However, the electrostatic atomization apparatus as the mist spray apparatus for spraying a mist as described in the above embodiments can be applied not only to the refrigerator but to an air conditioner and the like as a cooling apparatus including a cooling source. Moreover, the present invention is not limited to a cooling apparatus, as the same technical idea can be employed in the case where there is a large temperature difference between a space in which a mist is sprayed and a space in which a cooling pin is included. For example, the electrostatic atomization apparatus can be applied to various appliances such as a dish washer, a cloths washer, a rice cooker, a vacuum cleaner, and so on.

This embodiment describes an example where the electrostatic atomization apparatus is used in an air conditioner. The air conditioner is typically composed of an outdoor unit and an indoor unit interconnected by a refrigerant pipe. In this embodiment, the indoor unit of the air conditioner is taken as an example.

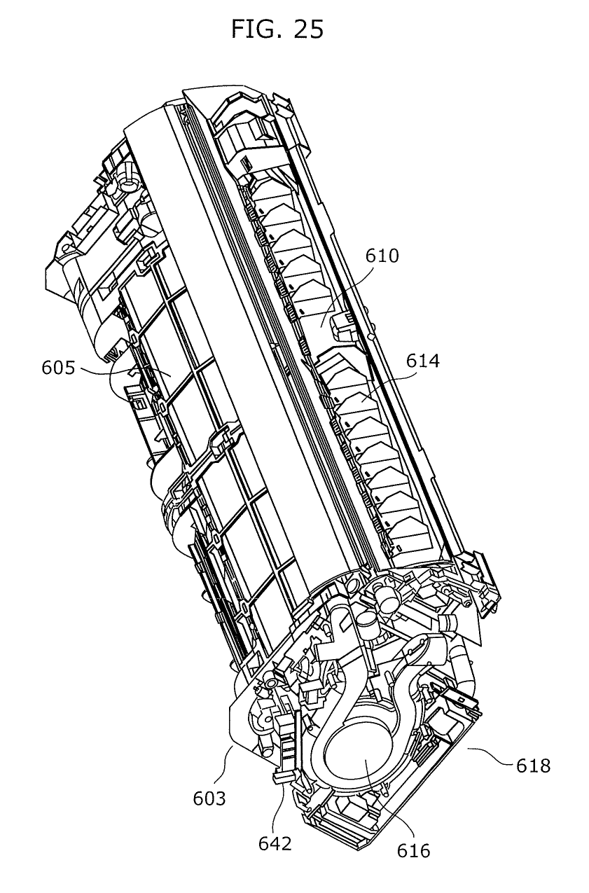

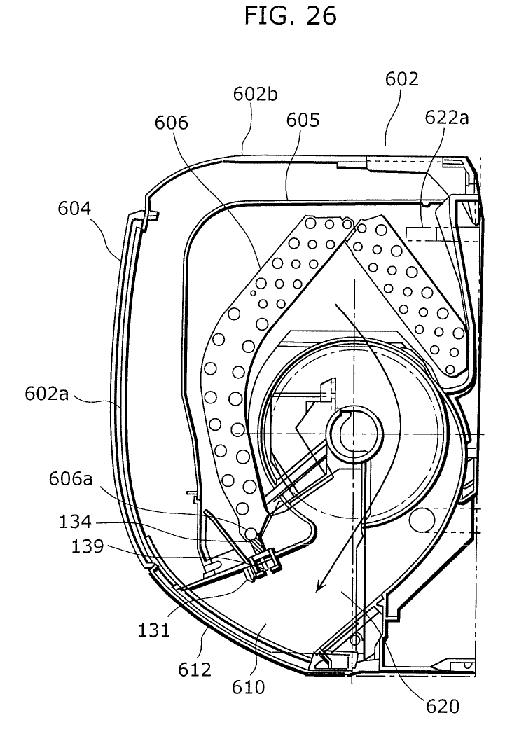

FIG. 25 is a partial cutaway perspective view showing an indoor unit of an air conditioner using an electrostatic atomization apparatus in the seventeenth embodiment of the present invention. FIG. 26 is a sectional structural view of the air conditioner shown in FIG. 25.

In this embodiment, detailed description is mainly given for parts that differ from the structures described in the first to sixteenth embodiments, with detailed description being omitted for parts that are the same as the structures described in the first to sixteenth embodiments or parts to which the same technical ideas are applicable.

The indoor unit has a front suction port 602a and an upper suction port 602b as suction ports for sucking indoor air into a main body 602. A movable front panel (hereafter simply referred to as a front panel) 604 that can be freely opened and closed is provided at the front suction port 602a. When the air conditioner is stopped, the front pane 604 is in close contact with the main body 602 to close the front suction port 602a. When the air conditioner is running, the front panel 604 moves away from the main body 602 to open the front suction port 602a.

The main body 602 includes a pre-filter 605 provided downstream of the front suction port 602a and the upper suction port 602b for removing dust contained in the air, a heat exchanger 606 provided downstream of the pre-filter 605 for heat exchange with the indoor air sucked from the front suction port 602a and the upper suction port 602b, an indoor fan 608 for conveying the air that has undergone heat exchange in the heat exchanger 606, a vertical vane 612 that opens and closes a blowout port 610 for blowing the air sent from the indoor fan 608 into the room and also vertically changes an air blowout direction, and a horizontal vane 614 that horizontal changes the air blowout direction. An upper part of the front panel 604 is connected to an upper part of the main body 602 via a plurality of arms (not shown) formed on both ends of the upper part of the front panel 604. When the air conditioner is running, by driving and controlling a drive motor (not shown) connected to one of the plurality of arms, the front panel 604 is moved forward from a position when the air conditioner is stopped (a position of closing the front suction port 602a). Likewise, the vertical vane 612 is connected to a lower part of the main body 602 via a plurality of arms (not shown) formed on both ends of the vertical vane 612.

The electrostatic atomization apparatus 131 having an air cleaning function for purifying indoor air by generating an electrostatic mist is disposed in a part of the heat exchanger 606.

As mentioned earlier, FIG. 25 shows a state where a main body cover (not shown) covering the front panel 604 and the main body 602 is removed, and FIG. 26 shows a connection position between the indoor unit main body 602 and the electrostatic atomization apparatus 131.

As shown in the drawing, the electrostatic atomization apparatus 131 is installed downstream of the heat exchange of the sucked air with the heat exchanger 606.

The electrostatic atomization apparatus 131 is mainly composed of the atomization unit 139 and the external case 137 formed of a resin such as ABS. The spray port 132 and a moisture supply port (not shown) are formed in the external case 137. The atomization unit 139 includes the atomization electrode as the atomization tip, the cooling pin 134 fixed to an approximate center of one end of the atomization electrode 135, and a voltage application unit (not shown) for applying a voltage to the atomization electrode 135. The cooling pin 134 is made up of a good heat conductive member such as aluminum, stainless steel, brass, or the like.

To efficiently conduct cold heat from one end to the other end of the cooling pin 134 by heat conduction, it is desirable that a heat insulator (not shown) covers a circumference of the cooling pin 134 as the heat transfer connection member.

Furthermore, the heat conduction of the atomization electrode 135 and the cooling pin 134 needs to be maintained for a long time. Accordingly, an epoxy material or the like is poured into the connection part to prevent moisture and the like from entering, thereby suppressing a heat resistance and fixing the atomization electrode 135 and the cooling pin 134 together. Here, the atomization electrode 135 may be fixed to the cooling pin 134 by pressing and the like, in order to reduce the heat resistance.

The cooling pin 134 as the heat transfer connection member is fixed to the external case 137, where the cooling pin 134 itself has a projection that protrudes from the external case 137. The projection of the cooling pin 134 is located opposite to the atomization electrode 135, and brought into contact with or fixed to a part of a pipe through which a refrigerant flows in the heat exchanger 606.

The cooling in the heat exchanger 606 is used as the cooling unit of the cooling pin 134, and the cooling pin 134 is formed of a metal piece having excellent heat conductivity. Accordingly, the cooling unit can perform cooling necessary for dew condensation of the atomization electrode 135, just by heat conduction from a pipe 606a through which a refrigerant flows in the heat exchanger 606. Hence, dew condensation can be formed on the tip of the atomization unit.

In this embodiment, the electrostatic atomization apparatus 131 is disposed on an air path of discharged cool air indicated by an arrow in FIG. 26. This allows an electrostatic mist to be mixed in blown cool air of a high flow velocity among cool air discharged into the room, and sprayed into the room. As a result, the mist exhibits higher diffusivity in the room. By spraying the electrostatic mist, that is, the mist containing OH radicals, as in this embodiment, sterilization and antimicrobial effects can be improved by enhanced humidity and diffusivity in the sprayed space such as the room.

It is more desirable that the electrostatic atomization apparatus 131 is located closer to the blowout port 610 as the cool air discharge port than the suction ports such as the front suction port 602a and the upper suction port 602a, on the air path in the indoor unit downstream of the discharged cool air. In so doing, the mist can be mixed with the high velocity cool air as noted earlier, thereby enhancing diffusivity in the room. Moreover, since there are fewer obstacles as air path resistances in the route up to the room, the mist can be sprayed as it is. In detail, in the case of this embodiment, the electrostatic mist, that is, the mist containing OH radicals, can be sprayed as it is, without losing OH radicals. Hence, sterilization and antimicrobial effects can be improved by enhanced humidity and diffusivity in the sprayed space such as the room.

Since the cooling unit can be realized by such a simple structure, highly reliable atomization with a low incidence of troubles can be achieved. Moreover, the cooling pin 134 as the heat transfer connection member and the atomization electrode 135 as the atomization tip can be cooled by using the cooling source of the refrigeration cycle, which contributes to energy-efficient atomization.

Furthermore, the voltage application unit is formed near the atomization unit 139. A negative potential side of the voltage application unit generating a high voltage is electrically connected to the atomization electrode 135, and a positive potential side of the voltage application unit is electrically connected to the counter electrode 136.

Discharge constantly occurs in the vicinity of the atomization electrode 135 for mist spray, which raises a possibility that the tip of the atomization electrode 135 wears out. As with the refrigerator, the air conditioner is typically intended to operate over a long period of 10 years or more. Therefore, a strong surface treatment needs to be performed on the surface of the atomization electrode 135. For example, the use of nickel plating, gold plating, or platinum plating is desirable.

The counter electrode 136 is made of, for example, stainless steel. Long-term reliability needs to be ensured for the counter electrode 136. In particular, to prevent foreign substance adhesion and contamination, it is desirable to perform a surface treatment such as platinum plating on the counter electrode 136.

The voltage application unit communicates with and is controlled by a control unit of the air conditioner main body, and switches the high voltage on or off according to an input signal from the air conditioner main body or the electrostatic atomization apparatus 131.

An operation and working of the air conditioner in this embodiment having the above-mentioned structure are described below. The electrostatic atomization apparatus 131 is fixed to the heat exchanger 606. The cooling pin 134 is cooled by heat transfer or heat conduction from the pipe 606a through which a refrigerant flows in the heat exchanger 606 as the cooling source of the cooling pin 134. As a result, the thermally connected atomization electrode 135 is cooled as well, and water droplets are generated at the tip of the atomization electrode 135. By applying a high voltage to the water droplets at the tip of the atomization electrode 135, a fine mist is generated. The mist generated by the electrostatic atomization apparatus 131 carries a charge. Accordingly, after the mist generation, the mist is released into the air conditioned room via a dedicated air path formed of a resin such as ABS serving also as a silencer, so as not to be attracted to the heat exchanger 606.

The released fine mist is convected and diffused in the air conditioned room. The diffused mist adheres to cloths, furniture, and the like in the air conditioned room. Radicals contained in the mist contribute to microbial elimination, deodorization, and the like, thereby making the room a comfortable space.

In the case of the air conditioner, during a cooling period, the low temperature air that has passed through the heat exchanger 606 in the indoor unit is relatively high in humidity, and dew condensation is formed on the atomization electrode 135 in the electrostatic atomization apparatus 131 so long as the atomization electrode 135 is a little lower in temperature than its surrounding environment. Hence, atomization requires an extremely small amount of power.

Moreover, by also using a heating unit in the vicinity of the electrostatic atomization apparatus 131, the temperature of the atomization electrode 135 can be adjusted. This achieves stable atomization.

In the case of the electrostatic atomization apparatus 131 of the type that cools the atomization electrode 135 as the atomization tip by the low temperature pipe of the heat exchanger 606 via the cooling pin 134 to induce dew condensation as in this embodiment, dew condensation occurs only during a cooling period when the heat exchanger is at a low temperature, so that the mist spray is limited to the cooling period. Since dew condensation does not occur on the atomization tip and the mist spray is not performed during a heating period, for example, the electrostatic atomization apparatus 131 may be stopped during the heating period. Alternatively, though no dew condensation occurs during the heating period, negative ion generation can still be performed by operating the electrostatic atomization apparatus 131, so that the electrostatic atomization apparatus 131 may be used as a negative ion generator during the heating period.

By stopping cooling and operating only the fan for a fixed period instead of using the heating unit, the atomization electrode is dried by dry air in the air conditioned room and as a result excessive dew condensation is prevented, which contributes to improved reliability. Hence, stable atomization can be achieved.

As described above, in this embodiment, by installing the electrostatic atomization apparatus 131 near the heat exchanger 606 of the air conditioner, the mist adheres to cloths, furniture, and so on in the air conditioned room. Radicals contained in the mist allow for microbial elimination, deodorization, and the like, thereby making the room a comfortable space.

By applying the electrostatic atomization apparatus to various appliances such as a dish washer, a cloths washer, a rice cooker, and a vacuum cleaner in the manner described above, effects of microbial elimination, sterilization, deodorization, and the like by mist spray can be attained energy-efficiently by a simple structure.

### Eighteenth Embodiment

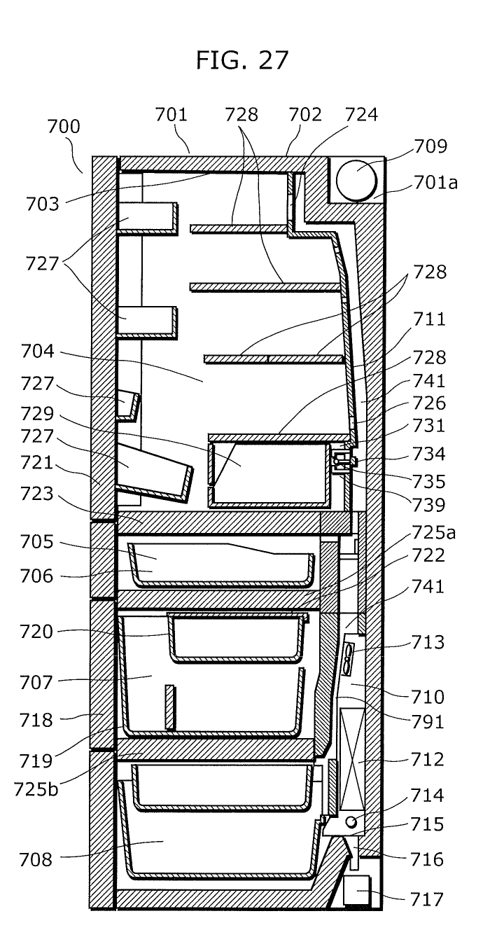

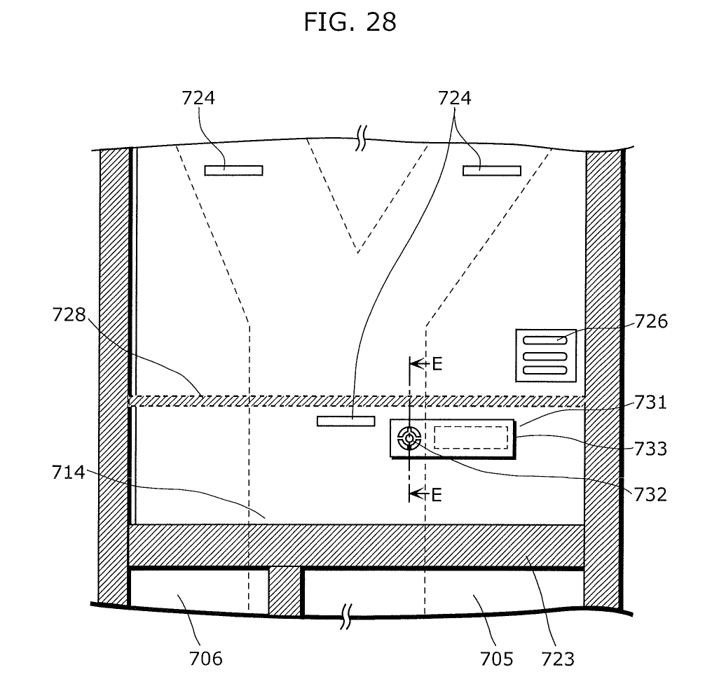

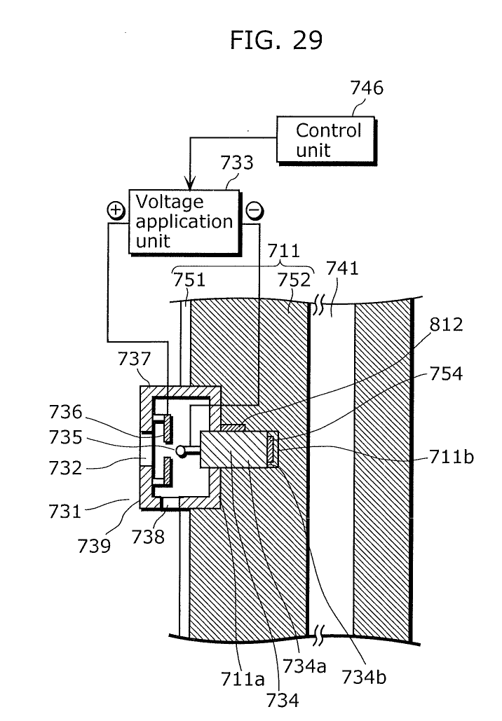

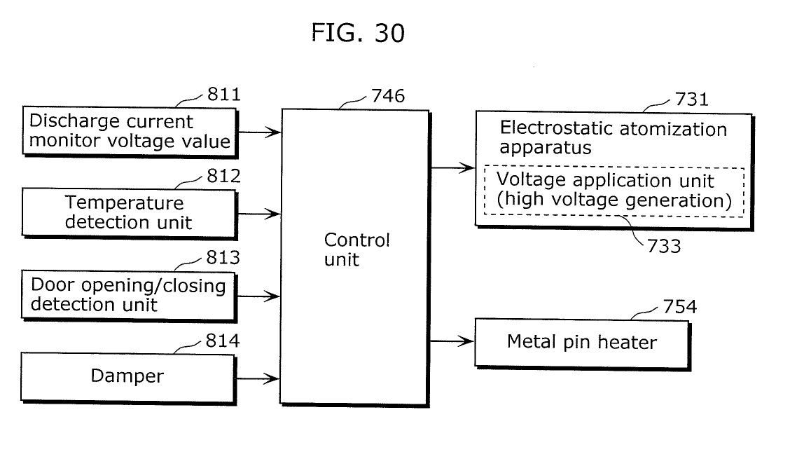

FIG. 27 is a longitudinal sectional view of a refrigerator in an eighteenth embodiment of the present invention. FIG. 28 is a front view of a refrigerator compartment and its vicinity in the refrigerator in the eighteenth embodiment of the present invention. FIG. 29 is a detailed sectional view of an electrostatic atomization apparatus and its vicinity taken along line E-E in FIG. 28. FIG. 30 is an example of a functional block diagram of the refrigerator in the eighteenth embodiment of the present invention. FIG. 31 is an example of a flowchart of a control flow in the eighteenth embodiment of the present invention.

In the drawings, a heat-insulating main body 701 of a refrigerator 700 is formed by an outer case 702 mainly composed of a steel plate and an inner case 703 molded with a resin such as ABS, with a vacuum heat insulation material or a foam heat insulation material such as rigid urethane foam being charged and buried between the outer case 702 and the inner case 703. This allows for heat insulation of a plurality of storage compartments obtained by partitioning the refrigerator 700. A refrigerator compartment 704 as a first storage compartment is located at the top in the refrigerator 700. A switch compartment 705 as a fourth storage compartment and an ice compartment 706 as a fifth storage compartment are located side by side below the refrigerator compartment 704. A vegetable compartment 707 as a second storage compartment is located below the switch compartment 705 and the ice compartment 706. A freezer compartment 708 as a third storage compartment is located at the bottom.

The refrigerator compartment 704 is typically set to 1° C. to 5° C., with a lower limit being a temperature low enough for refrigerated storage but high enough not to freeze. The vegetable compartment 707 is set to a temperature of 2° C. to 7° C. that is equal to or slightly higher than the temperature of the refrigerator compartment 704. The freezer compartment 708 is set to a freezing temperature zone. The freezer compartment 708 is typically set to −22° C. to −15° C. for frozen storage, but may be set to a lower temperature such as −30° C. and −25° C. for an improvement in frozen storage state. The switch compartment 705 is capable of switching to not only the refrigeration temperature zone of 1° C. to 5° C., the vegetable temperature zone of 2° C. to 7° C., and the freezing temperature zone of typically −22° C. to −15° C., but also a preset temperature zone between the refrigeration temperature zone and the freezing temperature zone. The switch compartment 705 is a storage compartment with an independent door arranged side by side with the ice compartment 706, and often has a drawer door. Note that, though the switch compartment 705 is a storage compartment including the refrigeration and freezing temperature zones in this embodiment, the switch compartment 705 may be a storage compartment specialized for switching to only the above-mentioned intermediate temperature zone between the refrigerated storage and the frozen storage, while leaving the refrigerated storage to the refrigerator compartment 704 and the vegetable compartment 707 and the frozen storage to the freezer compartment 708. Alternatively, the switch compartment 705 may be a storage compartment fixed to a specific temperature zone. The ice compartment 706 makes ice by an automatic ice machine (not shown) disposed in an upper part of the ice compartment 706 using water sent from a water storage tank (not shown) in the refrigerator compartment 704, and stores the ice in an ice storage container (not shown) disposed in a lower part of the ice compartment 706.

A top part of the heat-insulating main body 701 has a depression stepped toward the back of the refrigerator. A machinery compartment 701a is formed in this stepped depression, and high pressure components of a refrigeration cycle such as a compressor 709 and a dryer (not shown) for water removal are housed in the machinery compartment 701a. That is, the machinery compartment 701a including the compressor 709 is formed cutting into a rear area of an uppermost part of the refrigerator compartment 704.

By forming the machinery compartment 701a to dispose the compressor 709 in the rear area of the uppermost storage compartment in the heat-insulating main body 701 which is hard to reach and so used to be a dead space in a conventional refrigerator (a type of refrigerator in which the machinery compartment 701a is formed to dispose the compressor 709 in the rear area of the lowermost storage compartment in the heat-insulating main body 701), a space for the machinery compartment 701a at the bottom of the heat-insulating main body 701 can be effectively converted to a storage compartment capacity. This eases the use of the refrigerator, and significantly improves storability and usability.

Note that the matters relating to the relevant part of the present invention described below in this embodiment are also applicable to the conventional type of refrigerator in which the machinery compartment 701a is formed to dispose the compressor 709 in the rear area of the lowermost storage compartment in the heat-insulating main body 701.

Moreover, the matters relating to the relevant part of the present invention described below in this embodiment are also applicable to a type of refrigerator having such a storage compartment layout that positions the vegetable compartment 707 at the bottom of the heat-insulating main body 701 and positions the freezer compartment 708 above the vegetable compartment 707.

A cooling compartment 710 for generating cool air is provided behind the vegetable compartment 707 and the freezer compartment 708. An air path 741 for conveying cool air to each compartment having heat insulation properties and a back partition wall 711 formed by a heat insulator 752 for thermally insulating each storage compartment are formed between the cooling compartment 710 and each of the vegetable compartment 707 and the freezer compartment 708 and behind the refrigerator compartment 704. A cooler 712 is disposed in the cooling compartment 710 separated from the air path 741 by a cooling compartment partition plate 791, and a cooling fan 713 for blowing cool air generated by the cooler 712 into the refrigerator compartment 704, the switch compartment 705, the ice compartment 706, the vegetable compartment 707, and the freezer compartment 708 by a forced convection method is placed in a space above the cooler 712. A defrosting heater 714 made up of a glass tube for defrosting by removing frost or ice adhering to the cooler 72 and its periphery during cooling is provided in a space below the cooler 712. Furthermore, a drain pan 715 for receiving defrost water generated during defrosting and a drain tube 716 passing from a deepest part of the drain pan 715 through to outside the compartment are formed below the defrosting heater 714. An evaporation dish 717 is formed outside the compartment downstream of the drain tube 716.

A typical rotational door 721 is attached to the refrigerator compartment 704, and vertically-arranged multiple storage cases 727 are mounted to the inside of the rotational door 721. In addition, interchangeable storage trays 728 are installed in multiple tiers in the storage compartment. A case 729 which is an independent drawer section is disposed between the lowermost tray in the refrigerator compartment 704 and a partition wall 723, and a storage space in the case 729 is settable to an environment different from an environment of the refrigerator compartment 704. For example, the case 729 can be substantially sealed and set to a chilled temperature of about 1° C. slightly lower than a temperature in the refrigerator compartment 704 and a higher humidity than the refrigerator compartment 704, or to a partial temperature of −2° C. to −3° C. Thus, temperature zones suitable for stored foods can be provided.

Such a section that is set in a different environment from the environment of the storage compartment (refrigerator compartment 704) has a space (space in the case 729) in which not only the temperature zone is changed as mentioned above but also the humidity, air flow, enclosed cool air properties, and the like are different, thereby realizing a storage space of a different environment.

Moreover, setting a different environment from the environment of the storage compartment (refrigerator compartment 704) means to realize a storage space of a different environment where not only the temperature zone is changed as mentioned above but also the humidity, air flow, enclosed cool air properties, and the like are different.

An air path of cool air discharged from a refrigerator compartment discharge port 724 formed in the back partition wall 711 is provided approximately between the storage trays 728. A refrigerator compartment suction port 726 though which cool air, having cooled the inside of the refrigerator compartment 704 and undergone heat exchange, returns to the cooler 712 is disposed in a lower part of the back partition wall 711 above the lowermost tray 728.

Note that, regarding the refrigerator compartment discharge port, the suction port, and the air path structure, the matters relating to the relevant part of the present invention described below in this embodiment are optimized according to the storage container form and the cooling method.

The vegetable compartment 707 includes a lower storage container 719 that is mounted on a frame attached to a drawer door 718 of the vegetable compartment 707, and an upper storage container 720 mounted on the lower storage container 719.

A lid 722 for substantially sealing mainly the upper storage container 720 in a closed state of the drawer door 718 is held by the inner case 703 and a first partition wall 725a above the vegetable compartment 707. In the closed state of the drawer door 718, left, right, and back sides of an upper surface of the upper storage container 720 are in close contact with the lid 722, and a front side of the upper surface of the upper storage container 720 is substantially in close contact with the lid 722. In addition, a boundary between the lower storage container 719 and left, right, and lower sides of a back surface of the upper storage container 720 has a narrow gap so as to prevent moisture in the food storage unit from escaping, in a range of not interfering with the upper storage container 720 during operation.

An air path of cool air discharged from a vegetable compartment discharge port (not shown) formed in the back partition wall is provided between the lid 722 and the first partition wall 725a. Moreover, a space is provided between the lower storage container 719 and a second partition wall 725b, thereby forming a cool air path. A vegetable compartment suction port through which cool air, having cooled the inside of the vegetable compartment 707 and undergone heat exchange, returns to the cooler 712 is disposed in a lower part of the back partition wall on the back of the vegetable compartment 707.

Note that the matters relating to the relevant part of the present invention described below in this embodiment are also applicable to a conventional type of refrigerator that is opened and closed by a frame attached to a door and a rail formed on an inner case. Besides, the lid 722, the vegetable compartment discharge port, the suction port, and the air path structure are optimized according to the storage container form.

The freezer compartment 708 has an approximately same structure as the vegetable compartment 707.

The back partition wall 711 of the refrigerator compartment 704 includes a back partition wall surface 751 made of a resin such as ABS, and the heat insulator 752 made of styrene foam or the like for ensuring the heat insulation of isolating the air path 741 and the refrigerator compartment 704 from each other. Here, an electrostatic atomization apparatus 731 which is a mist spray apparatus, namely, an atomization apparatus, is installed on the back of the case 729 situated at the bottom of the refrigerator compartment 704. A depression 711a or a through hole is formed in a part of a storage compartment side wall surface of the back partition wall 711 so as to be lower in temperature than other parts, and the electrostatic atomization apparatus 731 as the atomization apparatus is installed in this part. By disposing the atomization apparatus in such an area where there is a temperature difference between a space in which the atomization apparatus is located and a thermally insulated adjacent space in which cool air of a lower temperature flows, it is possible to cause water from the space in which the atomization apparatus is located to build up dew condensation on the atomization apparatus using the cool temperature air in the adjacent space as a cooling unit, thereby supplying moisture. A moisture supply method by this dew condensation system will be described in more detail later, in the description about a metal pin 734.

The case 729 is typically used as a space independent of the other space of the refrigerator compartment 704 set to the chilled temperature zone.

The electrostatic atomization apparatus 731 as the atomization apparatus is mainly composed of an atomization unit 739, a voltage application unit 733, and an external case 737. A spray port 732 and a moisture supply port 738 are each formed in a part of the external case 737.

An atomization electrode 735 as an atomization tip is placed in the atomization unit 739. The atomization electrode 735 is electrically connected by a wire from the high voltage generation circuit 733, and securely connected to an approximate center of one end of a cylindrical metal pin 734 which is a heat transfer connection member made of a good heat conductive material such as brass.

A periphery of the electrical connection part is molded with a resin such as an epoxy resin. This maintains long-term heat conduction, prevents moisture and the like from entering the electrical connection part, suppresses a heat resistance, and further fixes the atomization electrode 735 and the metal pin 734 as the heat transfer connection member together. Here, the atomization electrode 735 may be fixed to the metal pin 734 as the heat transfer connection member by pressing and the like, in order to reduce the heat resistance.

The metal pin 734 as the heat transfer connection member is, for example, formed as a cylinder of about 10 mm in diameter and about 15 mm in length, and is preferably a high heat conductive member of aluminum, copper, or the like having a large heat capacity equal to or more than 50 times and preferably equal to or more than 100 times that of the atomization electrode 735 of about 1 mm in diameter and about 5 mm in length. To efficiently conduct cold heat from one end to the other end of the metal pin 734 as the heat transfer connection member by heat conduction, it is desirable that the heat insulator covers a circumference of the metal pin 734.

Furthermore, since the metal pin 734 needs to conduct cool temperature heat in the heat insulator for thermally insulating the storage compartment from the cooler 712 or the air path, it is desirable that the metal pin 734 has a length equal to or more than 5 mm and preferably equal to or more than 10 mm. Note, however, that a length equal to or more than 30 mm reduces effectiveness.

When the electrostatic atomization apparatus 731 placed in the storage compartment is in a high humidity environment, this humidity may affect the metal pin 734 as the heat transfer connection member. Accordingly, the metal pin 734 as the heat transfer connection member is preferably made of a metal material that is resistant to corrosion and rust, or a material that has been coated or surface-treated by, for example, alumite.

In this embodiment, the metal pin 734 is shaped as a cylinder. This being so, when fitting the metal pin 734 into the depression 711a of the heat insulator 752, the metal pin 734 can be press-fit while rotating the electrostatic atomization apparatus 731 even in the case where a fitting dimension is slightly tight. This enables the metal pin 734 to be attached with less clearance. Alternatively, the metal pin 734 may be shaped as a rectangular parallelepiped or a regular polyhedron. Such polygonal shapes allow for easier positioning than the cylinder, so that the atomization apparatus can be put in a proper position.

Furthermore, the atomization electrode 735 is attached on a central axis of the metal pin 734. Accordingly, when attaching the metal pin 734, a distance between the atomization electrode 735 and a counter electrode 736 can be kept constant even though the electrostatic atomization apparatus 731 is rotated. Hence, a stable discharge distance can be ensured.

The metal pin 734 as the heat transfer connection member is fixed to the external case 737, where the metal pin 734 as the heat transfer connection member itself protrudes from the external case 737. The counter electrode 736 shaped like a circular doughnut plate is installed in a position facing the atomization electrode 735 on the storage compartment side, so as to have the constant distance from the tip of the atomization electrode 735. The spray port 732 is formed on a further extension from the atomization electrode 735.

Discharge by high voltage application occurs in the vicinity of the atomization electrode 735 for mist spray, which raises a possibility that the tip of the atomization electrode 735 wears out. The refrigerator 700 is typically intended to operate over a long period of 10 years or more. Therefore, a strong surface treatment needs to be performed on the surface of the atomization electrode 735 to ensure a wear resistance. For example, the use of nickel plating, gold plating, or platinum plating is desirable. In addition, the electrical connection part between the atomization electrode 735 and the voltage application unit 733 is made by swaging, pressing, and the like, and the periphery of the electrical connection part is molded with a resin such as an epoxy resin. By doing so, leakage, unusual heat generation, and the like caused by poor attachment of the atomization electrode 735 and the electrical connection part and the like can be prevented, with it being possible to ensure safety. Moreover, material deterioration and the like due to moisture entry can be suppressed, so that component reliability can be improved.

Furthermore, the voltage application unit 733 is formed near the atomization unit 739. A negative potential side of the voltage application unit 733 generating a high-voltage potential difference is electrically connected to the atomization electrode 735, and a positive potential side of the voltage application unit 733 is electrically connected to the counter electrode 736.

The counter electrode 736 is made of, for example, stainless steel. Long-term reliability needs to be ensured for the counter electrode 736. In particular, to prevent foreign substance adhesion and contamination, it is desirable to perform a surface treatment such as platinum plating on the counter electrode 736.

The voltage application unit 733 communicates with and is controlled by a control unit 746 of the refrigerator main body, and switches the high voltage on or off according to an input signal from the refrigerator 700 or the electrostatic atomization apparatus 731.

The voltage application unit 733 is placed in the electrostatic atomization apparatus 731 and so is present in a low temperature and high humidity atmosphere in the storage compartment. Accordingly, a molding material or a coating material for moisture prevention is applied to a board surface of the voltage application unit 733.

However, in the case such as where the voltage application unit is placed in a high temperature part outside the storage compartment, where the high voltage application is substantially constantly in operation, or where the storage compartment is low in humidity, the coating material can be omitted.

A heater 754 which is a resistance heating element such as a chip resistor is integrally formed with the electrostatic atomization apparatus 731 at an end 734b on the projection 734a side of the metal pin 734 as the heat transfer connection member near the atomization unit 739, as a heating unit for adjusting the temperature of the metal pin 734 as the heat transfer connection member included in the electrostatic atomization apparatus 731 and preventing excessive dew condensation or freezing of a peripheral part including the atomization electrode 735 as the atomization tip. The heater 754 is separated from the air path 741 by the heat insulator 752 as a heat relaxation member, so as not to be directly affected by heat from the air path 741.

Moreover, a temperature detection unit such as a thermistor 812 is provided on a part of the metal pin 734 as the heat transfer connection member that is closer to the atomization electrode 735, in order to detect the temperature of the tip of the atomization electrode 735.

The metal pin 734 as the heat transfer connection member is fixed to the external case 737, where the metal pin 734 itself has the projection 734a that protrudes from the external case 737. The projection 734a of the metal pin 734 is located opposite to the atomization electrode 735, and fit into a deepest depression 711b that is deeper than the depression 711a of the back partition wall 711.

Thus, the deepest depression 711b deeper than the depression 711a is formed on the back of the metal pin 734 as the heat transfer connection member, so that this part of the heat insulator 752 on the air path 741 side is thinner than other parts in the partition wall 711 on the back of the refrigerator compartment 704. The thinner heat insulator 752 serves as the heat relaxation member, and the metal pin 734 is cooled by cool air or warm air from the back via the heat insulator 752 as the heat relaxation member.

Here, the cool air generated in the cooling compartment 710 is used to cool the metal pin 734 as the heat transfer connection member, and the metal pin 734 is formed of a metal piece having excellent heat conductivity. Accordingly, the cooling unit can perform necessary cooling just by heat conduction from the air path through which the cool air generated by the cooler 712 flows. Moreover, the heating unit heats the metal pin 734 as the heat transfer connection member using, as a heating source, the warm air generated during a defrosting operation of the refrigerator 700 and the heater 754 as the resistance heating element, and also controls the heater 754 as the resistance heating element by varying an input or a duty factor according to a detected temperature of the temperature detection unit such as the thermistor 812 provided for detecting the temperature of the tip of the atomization electrode 735. In this way, the peripheral part including the atomization electrode 735 as the atomization tip can be prevented from excessive dew condensation or freezing, and also the amount of dew condensation supplied to the atomization electrode 735 as the atomization tip can be adjusted, so that stable atomization can be achieved.

Since the adjustment unit can be provided by such a simple structure, a highly reliable atomization unit with a low incidence of troubles can be realized. Moreover, the metal pin 734 as the heat transfer connection member and the atomization electrode 735 can be cooled by using the cooling source of the refrigeration cycle, which contributes to energy-efficient atomization.

The metal pin 734 as the heat transfer connection member in this embodiment is shaped to have the projection 734a on the opposite side to the atomization electrode 735. This being so, in the atomization unit 739, the end 734b on the projection 734a side is closest to the cooling unit. Therefore, the metal pin 734 is cooled by the adjustment unit, from the end 734b farthest from the atomization electrode 735.

Moreover, the heater 754 as the resistance heating element such as a chip resistor is integrally formed with the electrostatic atomization apparatus 731 at the end 734b on the projection 734a side of the metal pin 734 as the heat transfer connection member near the atomization unit 739, as the heating unit for preventing excessive dew condensation or freezing of the peripheral part including the atomization electrode 735 as the atomization tip. Furthermore, the temperature detection unit such as the thermistor 812 is provided on a part of the metal pin 734 as the heat transfer connection member closer to the atomization electrode 735, in order to detect the temperature of the tip of the atomization electrode 735. This suppresses a temperature fluctuation of the metal pin 734 as an atomization electrode cooling unit in a refrigeration cycle state (temperature control state) of the refrigerator 700, so that the peripheral part including the atomization electrode 735 as the atomization tip can be prevented from excessive dew condensation or freezing, and also the amount of dew condensation supplied to the atomization electrode 735 as the atomization tip can be adjusted. Hence, more stable atomization can be achieved.

Though the heat insulator 752 as the heat relaxation member covers at least the cooling unit side part of the metal pin 734 in this example, it is preferable that the heat insulator 752 covers the entire surface of the projection 734a of the metal pin 734. In such a case, the entry of heat in a transverse direction orthogonal to a longitudinal direction of the metal pin 734 can be reduced. Since heat transfer is performed in the longitudinal direction from the end 734b on the projection 734a side, the metal pin 734 is cooled by the adjustment unit from the end 734b farthest from the atomization electrode 735.

The refrigerator in the eighteenth embodiment of the present invention also has a holding member that is included in the storage compartment and grounded to a reference potential part, and the voltage application unit 733 generates a potential difference between the atomization electrode 735 and the holding member.

An operation and working of the refrigerator having the above-mentioned structure are described below.

An operation of the refrigeration cycle is described first. The refrigeration cycle is activated by a signal from a control unit according to a set temperature inside the refrigerator, as a result of which a cooling operation is performed. A high temperature and high pressure refrigerant discharged by an operation of the compressor 709 is condensed into liquid to some extent by a condenser (not shown), is further condensed into liquid without causing dew condensation of the main body of the refrigerator 700 while passing through a refrigerant pipe (not shown) and the like disposed on the side and back surfaces of the main body of the refrigerator 700 and in a front opening of the main body of the refrigerator 700, and reaches a capillary (not shown). Subsequently, the refrigerant is reduced in pressure in the capillary while undergoing heat exchange with a suction pipe (not shown) leading to the compressor 709 to thereby become a low temperature and low pressure liquid refrigerant, and reaches the cooler 712. Here, the low temperature and low pressure liquid refrigerant undergoes heat exchange with the air in each storage compartment by an operation of the cooling fan 713, as a result of which the refrigerant in the cooler 712 evaporates. Hence, the cool air for cooling each storage compartment is generated in the cooling compartment 710. The low temperature cool air from the cooling fan 713 is branched into the refrigerator compartment 704, the switch compartment 705, the ice compartment 706, the vegetable compartment 707, and the freezer compartment 708 using air paths and dampers, and cools each storage compartment to a desired temperature zone. A circulation air path for the refrigerator compartment 704 is such that cool air of about −15° C. to −25° C. generated in the cooling compartment 710 passes through the cooling fan 713 and a damper (not shown) and is discharged from the refrigerator compartment discharge port 724 formed between the storage trays 728 to thereby cool the refrigerator compartment 704 to the set temperature (1° C. to 5° C.), and then returns to the cooler 712 from the refrigerator compartment suction port 726 formed above the lowermost storage tray 728.

Here, the case 729 is provided independent of the cooling air path in the refrigerator compartment in which the air is discharged from the refrigerator compartment discharge port 724 to cool the refrigerator compartment and then returns to the cooler 712 from the refrigerator compartment suction port 726. Accordingly, an environment different from the environment in the refrigerator compartment can be maintained in the case 729.

Meanwhile, a circulation air path for the vegetable compartment 707 is such that, after cooling the refrigerator compartment 704, the air returning from the refrigerator compartment 704 is partly or wholly discharged into the vegetable compartment 707 from a vegetable compartment discharge port formed in a refrigerator compartment return air path for circulating the air to the cooler 712, flows around the upper storage container 720 and the lower storage container 719 for indirect cooling, and then returns to the cooler 712 from a vegetable compartment suction port. Temperature control of the vegetable compartment 707 is conducted by cool air allocation and an on/off operation of a partition wall heater (not shown) formed in the partition wall, as a result of which the vegetable compartment 707 is adjusted to 2° C. to 7° C. Note that the vegetable compartment 707 usually does not have an inside temperature detection unit.

The depression is formed in the back partition wall 711 on the back of the refrigerator compartment 704, and the electrostatic atomization apparatus 731 is installed in the depression. There is the deepest depression 711b behind the metal pin 734 as the heat transfer connection member formed in the atomization unit 739, where the heat insulator is, for example, about 2 mm to 10 mm in thickness and the temperature is lower than in other parts. In the refrigerator 700 of this embodiment, such a thickness is appropriate for the heat relaxation member located between the metal pin and the adjustment unit. Thus, the depression 711a is formed in the back partition wall 711, and the electrostatic atomization apparatus 731 having the protruding projection 734a of the metal pin 734 is fit into the deepest depression 711b on a backmost side of the depression 711a.

Cool air of about −15° C. to −25° C. generated by the cooler 712 and blown by the cooling fan 713 according to the operation of the refrigeration cycle flows in the air path 741 behind the metal pin 734 as the heat transfer cooling member, as a result of which the metal pin 734 is cooled to, for example, about −5° C. to −15° C. by heat conduction using this cool air of the freezing temperature zone as a cooling source, via the surface of the air path 741. Since the metal pin 734 is a good heat conductive member, the metal pin 734 transmits cold heat extremely easily, so that the atomization electrode 735 fixed to the metal pin 734 is also cooled to about −5° C. to −15° C. via the metal pin 734.

Here, even though the refrigerator compartment 704 is typically in a low humidity environment, the temperature in the refrigerator compartment 704 is 1° C. to 5° C. Accordingly, the atomization electrode 735 as the atomization tip with the metal pin 734 drops to a dew point temperature or below, and as a result water is generated and water droplets adhere to the atomization electrode 735 including its tip.

Though not shown, by installing an inside temperature detection unit, an inside humidity detection unit, and the like in the storage compartment, the dew point can be precisely calculated by a predetermined computation according to a change in storage compartment environment.

The voltage application unit 733 applies a high voltage (for example, 4 kV to 10 kV) between the atomization electrode 735 to which the water droplets adhere and the counter electrode 736, where the atomization electrode 735 is on a negative voltage side and the counter electrode 736 is on a positive voltage side. This causes corona discharge to occur between the electrodes. The water droplets at the tip of the atomization electrode 735 are finely divided by electrostatic energy. Furthermore, since the liquid droplets are electrically charged, a nano-level fine mist carrying an invisible charge of a several nm level, accompanied by ozone, OH radicals, and so on, is generated by Rayleigh fission. The voltage applied between the electrodes is an extremely high voltage of 4 kV to 10 kV. However, a discharge current value at this time is at a several μA level, and therefore an input is extremely low, about 0.5 W to 1.5 W. Hence, there is little influence on the inside temperature.

In detail, suppose the atomization electrode 735 is on a reference potential side (0 V) and the counter electrode 736 is on a high voltage side (+7 kV). Dew condensation water adhering to the tip of the atomization electrode 735 is attracted to the tip of the atomization electrode 735 and forms an approximate conical shape called a Taylor cone, reducing the distance to the counter electrode 736. As a result, an air insulation layer is broken down, and discharge starts. At this time, the dew condensation water is electrically charged, and also an electrostatic force generated on the surfaces of the liquid droplets exceeds a surface tension, so that fine particles are generated. Since the counter electrode 736 is on the positive side, the charged fine mist is attracted to the counter electrode 736, and the fine particles are further ultra-finely divided by Rayleigh fission. Thus, the nano-level fine mist carrying an invisible charge of a several nm level containing radicals is attracted to the counter electrode 736, and sprayed toward the storage compartment by its inertial force.

Note that, when there is no water on the atomization electrode 735, the discharge distance increases and the air insulation layer cannot be broken down, and therefore no discharge phenomenon takes place. Moreover, when there is too much water because of excessive dew condensation, electrostatic energy for finely dividing water droplets cannot exceed a surface tension, and therefore no discharge phenomenon takes place. Hence, no current flows between the atomization electrode 735 and the counter electrode 736.

In the refrigerator 700, when the temperature of the cooler 712 begins to drop, that is, when the operation of the refrigeration cycle starts, the cooling of the refrigerator compartment 704 starts, too. At this time, cool air flows into the refrigerator compartment 704, creating a dry state. Accordingly, the atomization electrode 735 tends to dry.

Next, when a refrigerator compartment damper (not shown) is closed, the refrigerator compartment discharge air temperature rises, and so the refrigerator compartment 704 and the vegetable compartment 707 increase in temperature and humidity. During this time, since the cool air in the cooling compartment 710 gradually decreases in temperature, the metal pin 734 is further cooled, and dew condensation is more likely to occur on the atomization electrode 735 of the atomization unit 739 disposed in the refrigerator compartment 704 which has shifted to a high humidity environment. When liquid droplets grow at the tip of the atomization electrode 735 and the distance between the tip of the liquid droplets and the counter electrode 736 becomes a predetermined distance, the air insulation layer is broken down, the discharge phenomenon begins, and a fine mist is sprayed from the tip of the atomization electrode 735. After this, the compressor 709 is stopped and also the cooling fan 713 is stopped. As a result, the metal pin 734 increases in temperature, but the atomization unit 739 remains in a high humidity atmosphere. Moreover, the metal pin 734 as the heat transfer connection member has a large heat capacity and so does not have a rapid temperature fluctuation, that is, the metal pin 734 functions as the so-called cool storage. Accordingly, the atomization continues.

When the operation of the compressor 709 starts again, the refrigerator compartment damper (not shown) is opened, and cool air begins to be conveyed to each storage compartment by the cooling fan 713. The storage compartment shifts to a low humidity state, and so the atomization unit 739 also enters a low humidity state. As a result, the atomization electrode 735 becomes dry, and the liquid droplets at the atomization electrode 735 decrease or disappear.

Moreover, the metal pin 734 as the heat transfer connection member is heated by using, as a heating source, the heater 754 as the resistance heating element provided at the end 734b on the projection 734a side of the metal pin 734 as the heat transfer connection member near the atomization unit 739. Further, the heater 754 as the resistance heating element is controlled by varying an input or a duty factor according to a detected temperature of the temperature detection unit such as the thermistor 812 provided in order to detect the temperature of the tip of the atomization electrode 735. This suppresses a temperature fluctuation of the metal pin 734 as the atomization electrode cooling unit in a refrigeration cycle state (temperature control state) of the refrigerator 700, so that the peripheral part including the atomization electrode 735 as the atomization tip can be prevented from excessive dew condensation or freezing, and also the amount of dew condensation supplied to the atomization electrode 735 as the atomization tip can be adjusted. Hence, stable atomization can be achieved.

During normal cooling of the refrigerator 700, while periodically repeating such a cycle, the heater 754 as the resistance heating element is controlled by varying an input or a duty factor according to a detected temperature of the temperature detection unit such as the thermistor 812. By doing so, the liquid droplets at the atomization electrode tip are adjusted within a fixed range, with it being possible to achieve more stable atomization.

In addition, by exercising phase control of the input of the heater 754 as the resistance heating element, fine control can be carried out, allowing for more optimum temperature control.

During defrosting for melting and removing frost or ice adhering to the cooler 712, the temperature of the cooler 712 exceeds 0° C. At this time, the air path 741 behind the electrostatic atomization apparatus 731 also increases in temperature. This temperature increase causes the temperature of the metal pin 734 to rise, and also the temperature of the atomization electrode 735 to rise. As a result, dew condensation water adhering to the tip evaporates, and the atomization electrode dries.

Since the defrosting heater has a property of being switched off as the temperature of the cooler rises to some extent, there is an advantage that the atomization electrode 735 and the metal pin 734 as the heat transfer connection member can be reliably increased in temperature within an appropriate range without excessively increasing in temperature of the atomization electrode 735 and the metal pin 734 as the heat transfer connection member. Besides, by controlling the heater 754 as the resistance heating element through a variation in input or duty factor according to a detected temperature of the temperature detection unit such as the thermistor 812, more stable temperature control can be achieved.

Here, it is also possible to reset (dry) the dew condensation state of the tip of the atomization electrode 735 by periodically increasing the input or the duty factor of the heater 754 as the resistance heating element, for preventing excessive dew condensation or freezing.

Though the heating unit includes not only the defrosting heater but also the metal pin heater 754 in this embodiment, the heating unit of the adjustment unit may be composed of only the defrosting heater, without including the metal pin heater 754. Even when excessive dew condensation occurs, by heating the atomization electrode 735 as the atomization tip via the metal pin 734 as the heat transfer connection member in accordance with the timing of defrosting the cooler 712 in the above manner, excessive water droplets can be easily removed, with there being no need for a particular structure. Thus, by using the defrosting heater provided in the refrigeration cycle without using a particular heater as the adjustment unit, the need for any particular apparatus and power can be obviated. This enables the mist spray to be performed while saving materials and energy. Moreover, it is possible to deal with the case of defrosting the cooler 712, which further contributes to improved reliability.

When an actual usage state of the refrigerator 700 is taken into consideration, since the state of humidity and the amount of humidification in the storage compartment vary depending on a use environment, a door opening/closing operation, and a food storage state, excessive dew condensation can be expected to occur on the atomization electrode 735 as the atomization tip. In some cases, such liquid droplets that cover the entire atomization electrode 735 may be formed, as a result of which an electrostatic force by discharge cannot exceed a surface tension and atomization becomes impossible. In view of this, during an opening operation of the refrigerator compartment damper, the atomization electrode 735 is heated by energizing the metal pin heater 754 as the heating unit, in addition to dehumidification by cool air. This accelerates evaporation of the adhering water droplets to thereby prevent excessive dew condensation, so that atomization can be performed continuously and stably. Moreover, quality deterioration by water dripping on the back partition wall 711 and the like caused by growth of liquid droplets due to excessive dew condensation can be prevented.

Thus, the atomization electrode 735 repeats dew condensation and drying and intermittently performs mist spray, through the use of the refrigeration cycle of the refrigerator 700. In doing so, the amount of water at the atomization electrode tip is adjusted to prevent excessive dew condensation, thereby achieving continuous atomization.

Moreover, by cooling or heating the metal pin 734 as the heat transfer connection member instead of directly cooling or heating the atomization electrode 735, the atomization electrode 735 can be indirectly adjusted in temperature. Here, since the heat transfer connection member 734 has a larger heat capacity than the atomization electrode 735, the atomization electrode 735 can be adjusted in temperature while alleviating a direct significant influence of a temperature change of the adjustment unit on the atomization electrode 735. Therefore, a load fluctuation of the atomization electrode 735 can be suppressed, with it being possible to realize mist spray of a stable spray amount.

Besides, the counter electrode 736 is disposed at a position facing the atomization electrode 735, and the voltage application unit 733 generates a high-voltage potential difference between the atomization electrode 735 and the counter electrode 736 as a potential difference. This enables an electric field near the atomization electrode 735 to be formed stably. As a result, an atomization phenomenon and a spray direction are determined, and so accuracy of a fine mist sprayed into the storage container can be more enhanced, which contributes to improved accuracy of the atomization unit 739. Hence, the electrostatic atomization apparatus 731 of high reliability can be provided.

In addition, the metal pin 734 as the heat transfer connection member is cooled or heated via the heat insulator 752 as the heat relaxation member. This achieves dual-structure indirect temperature change, that is, the atomization electrode 735 is indirectly changed in temperature via the metal pin 734 and further via the heat insulator 752 as the heat relaxation member. In so doing, the atomization electrode 735 can be kept from being cooled or heated excessively. When the temperature of the atomization electrode 735 decreases by 1 K, a water generation speed of the tip of the atomization electrode 735 increases by about 10%. However, excessively cooling the atomization electrode 735 causes a large amount of dew condensation, and an increase in load of the atomization unit 739 raises concern about an input increase in the electrostatic atomization apparatus 731 and an atomization failure of the atomization unit 739. According to the above-mentioned structure, on the other hand, such problems due to the load increase of the atomization unit 739 can be prevented. Since an appropriate dew condensation amount can be ensured, stable mist spray can be achieved with a low input.

Moreover, by attaching the atomization electrode 735 on the central axis of the metal pin 734 as the heat transfer connection member, when attaching the metal pin 734 as the heat transfer connection member, the distance between the atomization electrode 735 and the counter electrode 736 can be kept constant even though the electrostatic atomization apparatus 731 is rotated. Hence, a stable discharge distance can be ensured.

Furthermore, excessively heating the atomization electrode 735 causes a sharp increase in storage compartment temperature around the voltage application unit 733 and the atomization unit 739, leading to problems such as an electrical component breakdown and a cooling failure due to a temperature increase of stored contents. However, such problems caused by the temperature increase of the atomization unit 739 can be prevented. Since an appropriate dew condensation amount can be ensured, stable mist spray can be achieved with a low input.

Moreover, by indirectly cooling the atomization electrode 735 in the dual structure via the metal pin 734 as the heat transfer connection member and the heat relaxation member 752, a direct significant influence of a temperature change of the adjustment unit on the atomization electrode 735 can be further alleviated. This suppresses a load fluctuation of the atomization electrode 735, so that mist spray of a stable spray amount can be achieved.

Besides, the temperature adjustment of the metal pin 734 as the heat transfer connection member is performed by cool air generated in the cooling compartment 710 and by controlling, as a heating source, the heater 754 as the resistance heating element through a variation in input or duty factor according to a detected temperature of the temperature detection unit such as the thermistor 812. Here, the metal pin 734 as the heat transfer connection member is formed of a metal piece having excellent heat conductivity. Accordingly, the temperature adjustment unit can perform necessary cooling just by heat conduction from the air path through which the cool air generated by the cooler 112 flows, and also perform heating control accompanied by temperature detection.

Since the cooling unit can be made by such a simple structure, a highly reliable atomization unit with a low incidence of troubles can be realized. Moreover, the atomization electrode 735 as the atomization tip can be cooled via the metal pin 734 as the heat transfer connection member by using the cooling source of the refrigeration cycle, which contributes to energy-efficient atomization.

The atomization unit of this embodiment is shaped to have the projection 734a on the opposite side to the atomization electrode 735, by the metal pin 734 as the heat transfer connection member. This being so, in the atomization unit 739, the end 734b on the projection 734a side is closest to the cooling unit. Therefore, the metal pin 734 is cooled by the cool air of the cooling unit, from the end 734b farthest from the atomization electrode 735.

Likewise, the heater 754 as the resistance heating element which is the heating unit is situated at the end 734b on the projection 734a side in the atomization unit 739. This being so, the metal pin 734 as the heat transfer connection member is heated by the heater 754 as the resistance heating element which is the heating unit, from the end 734b farthest from the atomization electrode 735.

Thus, the cooling unit and the heating unit which constitute the adjustment unit are both situated on the end 734b side farthest from the atomization electrode 735 in the metal pin 734 as the heat transfer connection member. This further alleviates a direct significant influence of a temperature change of the adjustment unit on the atomization electrode 735, with it being possible to realize stable mist spray with a smaller load fluctuation and adjust the temperature of the atomization electrode stably.

Moreover, the depression 711a is formed in a storage compartment side part of the back partition wall 711 to which the atomization unit 739 is attached, and the atomization unit 739 having the projection 734a is inserted into the deepest depression 711b deeper than the depression 711a. In this way, the heat insulator 752 constituting the partition wall of the storage compartment can be used as the heat relaxation member 752. Hence, the heat relaxation member 752 for properly cooling the atomization electrode 735 can be provided by adjusting the thickness of the heat insulator, with there being no need to prepare a particular heat relaxation member. This contributes to a more simplified structure of the atomization unit 739.

In addition, by inserting the atomization unit 739 into the depression 711a and the metal pin 734 having the projection 734a into the deepest depression 711b, the atomization unit 739 can be securely attached to the partition wall 711 without looseness by the two-tier depression, and also a protuberance toward the refrigerator compartment 704 as the storage compartment can be prevented. Such an atomization unit 739 is difficult to reach by hand, so that safety can be improved.

Besides, the atomization unit 739 does not extend through and protrude out of the back partition wall 711 of the refrigerator compartment 704 as the storage compartment. Accordingly, an air path area is unaffected, and a decrease in cooling amount caused by an increased air path resistance can be prevented.

Moreover, the depression is formed in a part of the refrigerator compartment 704 and the atomization unit 739 is inserted into this depression, so that a storage capacity for storing vegetables, fruits, and other foods is unaffected. In addition, while reliably cooling the heat transfer connection member 734, a wall thickness enough for ensuring heat insulation properties is secured for other parts. This prevents dew condensation in the storage compartment, thereby enhancing reliability.

Additionally, the metal pin 734 as the heat transfer connection member has a certain level of heat capacity and is capable of lessening a response to heat conduction from the cooling air path, so that a temperature fluctuation of the atomization electrode 735 can be suppressed. The metal pin 734 also functions as a cool storage member, thereby ensuring a dew condensation time for the atomization electrode 735 and also preventing freezing. Furthermore, by combining the good heat conductive metal pin 734 and the heat insulator 752, the cold heat can be conducted favorably without loss. Besides, by suppressing a heat resistance at the connection part between the metal pin 734 and the atomization electrode 735, temperature fluctuations of the atomization electrode 735 and the metal pin 734 follow each other favorably. In addition, thermal bonding can be maintained for a long time because moisture cannot enter into the connection part.

In the case where the storage compartment is in a high humidity environment, this humidity may affect the metal pin 734. Accordingly, the metal pin 734 is made of a metal material that is resistant to corrosion and rust or a material that has been coated or surface-treated by, for example, alumite. This prevents rust and the like, suppresses an increase in surface heat resistance, and ensures stable heat conduction.

Further, nickel plating, gold plating, or platinum plating is used on the surface of the atomization electrode 735, which enables the tip of the atomization electrode 735 to be kept from wearing due to discharge. Thus, the tip of the atomization electrode 735 can be maintained in shape, as a result of which spray can be performed over a long period of time and also a stable liquid droplet shape at the tip can be attained.

When the fine mist is sprayed from the atomization electrode 735, an ion wind is generated. During this time, high humidity air newly flows into the atomization unit 739 from the moisture supply port 738. This allows the spray to be performed continuously.

The generated fine mist is made up of extremely small particles and so has high diffusivity. The fine mist is diffusively sprayed in the storage compartment according to natural convection in the storage compartment, so that the effect of the fine mist spreads throughout the storage compartment.

The sprayed fine mist is generated by high-voltage discharge, and so is negatively charged. Meanwhile, green leafy vegetables, fruits, and the like stored in the storage compartment tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces, thereby enhancing freshness preservation. Besides, many processed foods such as hams and sandwiches also tend to deteriorate as a result of drying. Since the storage compartment space becomes high in humidity by the atomized mist, such drying can be suppressed, enhancing freshness preservation.

The nano-level fine mist sufficiently contains radicals such as OH radicals, a small amount of ozone, and the like. Such a nano-level fine mist is effective in sterilization, antimicrobial activity, microbial elimination, and so on. The nano-level fine mist also has effects of stimulating increases in nutrient such as vitamin C through agricultural chemical removal and antioxidation by oxidative decomposition, and decomposing pollutants.

When there is no water on the atomization electrode 735, the discharge distance increases and the air insulation layer cannot be broken down, and therefore no discharge phenomenon takes place. Moreover, when there is too much water because of excessive dew condensation, electrostatic energy for finely dividing water droplets cannot exceed a surface tension, and therefore no discharge phenomenon takes place. Hence, no current flows between the atomization electrode 735 and the counter electrode 736. This phenomenon may be detected by the control unit 746 of the refrigerator 700 to control on/off of the high voltage of the voltage application unit 733.

In this embodiment, the voltage application unit 733 is installed at a position that has a possibility of becoming a relatively low temperature and high humidity position in the storage compartment. Accordingly, a dampproof and waterproof structure by a potting material or a coating material is employed for the voltage application unit 733 for circuit protection. However, in the case such as where the voltage application unit 733 is placed in a high temperature part outside the storage compartment, where the high voltage application is substantially constantly in operation, or where the storage compartment is low in humidity, the coating material can be omitted.

As the heating unit for preventing excessive dew condensation or freezing of the peripheral part including the atomization electrode 735 as the atomization tip, the heater 754 as the resistance heating element such as a chip resistor is integrally formed with the electrostatic atomization apparatus 731 at the end 734b on the projection 734a side of the metal pin 734 as the heat transfer connection member near the atomization unit 739, and also separated from the air path 741 by the heat insulator 752. The heater 754 controls the temperature of the tip of the atomization electrode 735, and adjusts the amount of dew condensation supplied to the atomization electrode 735 as the atomization tip. By installing the electrostatic atomization apparatus 731 in the refrigerator 700, there is no need to provide a particular heat source, allowing the structure to be simplified.

Though the heater 754 as the resistance heating element is described as being installed at the end 734b on the projection 734a side of the metal pin 734 as the heat transfer connection member, the same advantages can be attained even when the heater 754 is installed in other manners such as by winding the heater 754 around the body of the metal pin 734.

Next, in FIG. 29, a discharge current monitor voltage value outputted from the electrostatic atomization apparatus 731 and an output signal from the atomization electrode temperature detection unit 812 are supplied to the control unit 746 of the main body of the refrigerator 700, to determine the operations of the voltage application unit 733 for applying the high voltage in the electrostatic atomization apparatus 731 and the heater 754 as the resistance heating element. For example, when the control unit 746 determines that the atomization electrode temperature detected by the atomization electrode temperature detection unit 812 is equal to or less than the dew point, the control unit 746 causes the voltage application unit 733 in the electrostatic atomization apparatus 731 to generate the high voltage. In the case where the atomization electrode 735 is expected to be in an excessive dew condensation state because the atomization electrode 735 is at such a temperature that can lead to freezing, the door opening/closing operation is frequently performed, and the refrigerator compartment 704 is extremely high in humidity, the heater 754 as the resistance heating element is energized to perform heating, thereby melting/evaporating dew condensation water adhering to the surface of the atomization electrode 735 and thus adjusting the amount of water of the atomization electrode 735.

By controlling the heater 754 as the resistance heating element through a variation in input or duty factor according to a detected temperature of the temperature detection unit such as the thermistor 812, more stable temperature control can be performed. It is also possible to reset (dry) the dew condensation state of the tip of the atomization electrode 735 by periodically increasing the input or the duty factor of the heater 754 as the resistance heating element, for preventing excessive dew condensation or freezing. Though the atomization electrode temperature detection unit 812 is used in this way, the temperature detection unit may be omitted in the case where a temperature behavior can be easily estimated from the refrigeration cycle of the refrigerator 700. Moreover, since the humidity in the storage compartment varies according to the behavior of the refrigerator compartment damper, the voltage application unit 733 may be switched on or off in conjunction with the refrigerator compartment damper.

The following describes a functional block diagram as an example of this embodiment shown in FIG. 30.

A discharge current monitor voltage value 811 outputted from the electrostatic atomization apparatus 731 and signals of the atomization electrode temperature detection unit 812 and the door opening/closing detection unit 813 are supplied to the control unit 746 of the main body of the refrigerator 700, to determine the operations of the voltage application unit 733 for applying the high voltage in the electrostatic atomization apparatus 731 and the metal pin heater 754. For example, when the control unit 746 determines that the atomization electrode temperature detected by the atomization electrode temperature detection unit 812 is equal to or less than the dew point, the control unit 746 causes the voltage application unit 733 in the electrostatic atomization apparatus 731 to generate the high voltage. In the case where the atomization electrode 735 is expected to be in an excessive dew condensation state because the atomization electrode 735 is at such a temperature that can lead to freezing, the door opening/closing operation is frequently performed, and the refrigerator compartment 704 is extremely high in humidity, the partition wall heater 754 or the metal pin heater 754 is energized to perform heating, thereby melting/evaporating dew condensation water adhering to the surface of the atomization electrode 735 and thus adjusting the amount of water of the atomization electrode 735.

Though the atomization electrode temperature detection unit 812 is used in this way, the temperature detection unit may be omitted in the case where it is easy to estimate a temperature behavior from the refrigeration cycle of the refrigerator 700. Moreover, since the humidity in the storage compartment varies according to the behavior of a refrigerator compartment damper 814, the voltage application unit 733 may be switched on or off in conjunction with the damper 814.

The following describes a control flow as an example of this embodiment shown in FIG. 31.

Atomization electrode temperature determination is performed to control the temperature of the atomization electrode 735. An atomization electrode temperature adjustment mode begins in Step S850. When an atomization electrode temperature T_{f} is higher than a preprogrammed first value T₁ (for example, T₁=6° C.) in step S851, it is determined that the atomization electrode 735 is high in temperature and so does not have dew condensation or that the storage compartment is high in temperature. Control then moves to Step S852 where the high voltage generation of the electrostatic atomization apparatus 731 is stopped and the energization of the metal pin heater 754 or the like for heating the metal pin 734 is stopped. When the atomization electrode temperature T_{f} is lower than the preprogrammed first value T₁, control moves to Step S853. When the atomization electrode temperature T_{f} is higher than a preprogrammed second value T₂ (for example, T₂=−6° C.) in Step S853, it is determined that the atomization electrode 735 is at a proper temperature. Control then moves to Step S854 where the high voltage generation of the electrostatic atomization apparatus 731 is activated but the unit for heating the metal pin 734 is not activated. When the atomization electrode temperature T_{f} is lower than the preprogrammed second value T₂, control moves to Step S855. When the atomization electrode temperature T_{f} is higher than a preprogrammed third value T₃ (for example, T₃=−10° C.) in Step S855, it is determined that the atomization electrode 735 is in an excessively cooled state. Control then moves to Step S856 where, though the discharge of the atomization electrode 735 is continued, the heating unit such as the metal pin heater 754 is activated for freezing prevention. When the atomization electrode temperature T_{f} is lower than the preprogrammed third value T₃ in Step S855, it is assumed that the atomization electrode is frozen. Accordingly, the discharge is stopped, and the heating unit such as the metal pin heater 754 is activated to heat the atomization electrode 735 so as to increase in temperature, thereby melting frost or ice adhering to the atomization electrode 735 with higher priority.

After Steps S852, S854, S856, and S857, control returns to the initial step after a predetermined time, and repeats the process to adjust the water amount of the atomization electrode 735.

Here, the heater 754 as the resistance heating element may be operated to reduce a heating period and attain an energy saving effect.

Though on/off control is performed as the operation of controlling the heater 754 as the resistance heating element, fine control can be achieved by exercising phase control of the input of the heater 754 as the resistance heating element. This enables temperature control to be performed with a more optimum input.

As described above, in the eighteenth embodiment, the thermally insulated storage compartment and the electrostatic atomization apparatus that sprays a mist into the storage compartment are provided. The atomization unit includes the atomization electrode electrically connected to the voltage application unit for generating a high voltage, and the counter electrode disposed facing the atomization electrode. The resistance heating element as the temperature adjustment heat source for the atomization electrode tip and the temperature detection unit for detecting the temperature of the atomization electrode tip are integrally formed with the electrostatic atomization apparatus. By causing water in the air to build up dew condensation on the atomization electrode and to be sprayed as a mist into the storage compartment, the dew condensation is formed on the atomization electrode easily and reliably from a water vapor in the storage compartment. Moreover, by adjusting the water amount of the atomization electrode tip, corona discharge is induced between the atomization electrode and the counter electrode stably and continuously, as a result of which a nano-level fine mist is generated. The fine mist is sprayed to uniformly adhere to vegetables and fruits, processed foods such as hams and sandwiches, and so on, thereby suppressing transpiration from the vegetables and fruits and drying of the foods, and thus enhancing freshness preservation. The fine mist also penetrates into tissues via intercellular spaces, stomata, and the like on the surfaces of the vegetables and fruits, as a result of which water is supplied into wilted cells and the vegetables and fruits return to a fresh state.

Here, since the discharge is induced between the atomization electrode and the counter electrode, an electric field can be formed stably to determine a spray direction. This eases the spray of the fine mist into the storage container.

Moreover, ozone and OH radicals generated simultaneously with the mist contribute to enhanced effects of deodorization, removal of harmful substances from food surfaces, contamination prevention, and the like.

Besides, the mist can be directly sprayed over the stored foods to adhere to the food surfaces. This improves freshness preservation efficiency, and also further enhances the effects of deodorization, removal of harmful substances from food surfaces, contamination prevention, and the like.

Furthermore, the mist is sprayed by causing an excess water vapor in the storage compartment to build up dew condensation on the atomization electrode and water droplets to adhere to the atomization electrode. This makes it unnecessary to provide any of a defrost hose for supplying mist spray water, a purifying filter, a water supply path directly connected to tap water, a water storage tank, and so on. A water conveyance unit such as a pump or a capillary is not used, either. Hence, the fine mist can be supplied to the storage compartment by a simple structure, with there being no need for a complex mechanism.

Since the fine mist is supplied to the storage compartment stably by a simple structure, the possibility of troubles of the refrigerator can be significantly reduced. This enables the refrigerator to exhibit higher quality in addition to higher reliability.

Here, dew condensation water having no mineral compositions or impurities is used instead of tap water, so that deterioration in retentivity caused by water retainer deterioration or clogging in the case of using a water retainer can be prevented.

Further, the atomization performed here is not ultrasonic atomization by ultrasonic vibration, and so there is no concern that a piezoelectric element is broken due to a loss of water and its peripheral member is deformed. Since no water storage tank is needed and also the input is small, a temperature effect in the storage compartment is insignificant.

Besides, the atomization performed here is not ultrasonic atomization by ultrasonic vibration, with there being no need to take noise and vibration of resonance and the like associated with ultrasonic frequency oscillation into consideration.

In addition, the part accommodating the voltage application unit is also buried in the back partition wall and cooled, with it being possible to suppress a temperature increase of the board. This allows for a reduction in temperature effect in the storage compartment, and contributes to improved reliability of the board.

In this embodiment, the partition wall for thermally insulating the storage compartment is provided, and the electrostatic atomization apparatus is attached to the partition wall. By such installing the electrostatic atomization apparatus in the gap in the storage compartment, a reduction in storage capacity can be avoided. Additionally, the electrostatic atomization apparatus is difficult to reach by hand because it is attached to the back surface, which contributes to enhanced safety.

In this embodiment, the adjustment unit capable of adjusting the dew condensation amount of the atomization electrode tip by cooling and heating the atomization electrode in the electrostatic atomization apparatus is a metal pin made up of a metal piece having good heat conductivity, and the means for cooling and heating the metal piece is the heat conduction from the air path through which the cool air generated by the cooler flows and the heating unit such as the heater. By adjusting the wall thickness of the heat insulator and the input of the heater, it is possible to easily set the temperatures of the metal pin and the atomization electrode. In addition, frost formation and dew condensation of the external case and the like that lead to lower reliability can be prevented because leakage of cool air is suppressed by interposing the heat insulator and also because of the provision of the heating unit such as the heater.

In this embodiment, the depression is formed in a storage compartment side part of the back partition wall to which the electrostatic atomization apparatus is attached, and the metal piece as the water amount adjustment unit of the electrostatic atomization apparatus is inserted into this depression. Accordingly, the storage capacity for storing vegetables, fruits, and other foods is unaffected. In addition, a wall thickness enough for ensuring heat insulation properties is secured for parts other than the part in which the electrostatic atomization apparatus is attached. This prevents dew condensation in the case, thereby enhancing reliability.

In this embodiment, at least one air path for conveying cool air to the storage compartment or the cooler and the heat insulator thermally insulated so as to suppress a heat effect between the storage compartment and other air paths are provided in the partition wall for thermally insulating the cooler and the storage compartment. The unit for varying the temperature of the atomization electrode of the electrostatic atomization apparatus is the metal piece having good heat conductivity, and the unit for adjusting the temperature of the metal piece performs the adjustment using the cool air generated by the cooler and the heating unit such as the heater. In this way, the temperature of the atomization electrode can be adjusted reliably.

Furthermore, by providing the heating unit such as the heater as one of the water amount adjustment unit in order to prevent the atomization electrode tip from excessive dew condensation, the size and amount of the liquid droplets at the tip can be adjusted through the tip temperature control. This allows for stable spray, and also achieves an improvement in antimicrobial capacity.

Note that, though a small amount of ozone is generated together with the fine mist, an ozone concentration is not perceptible to human beings because the discharge current is extremely small and also the discharge is induced where the reference potential is 0 V and the counter electrode is on the positive side of +7 kV. Furthermore, the ozone concentration in the storage compartment can be adjusted by on/off operation control of the electrostatic atomization apparatus. By properly adjusting the ozone concentration, deterioration such as yellowing of vegetables due to excessive ozone can be prevented, and sterilization and antimicrobial activity on vegetable surfaces can be enhanced.

Though a high-voltage potential difference is generated between the atomization electrode on the reference potential side (0 V) and the counter electrode (+7 kV) in this embodiment, a high-voltage potential difference may be generated by setting the counter electrode on the reference potential side (0 V) and applying a potential (−7 kV) to the atomization electrode. In this case, the counter electrode closer to the storage compartment is on the reference potential side, and therefore an electric shock or the like can be avoided even when a person comes near the counter electrode. Moreover, in the case where the atomization electrode is at −7 kV, the counter electrode may be omitted by setting the storage compartment on the reference potential side.

Though the air path for cooling the metal pin is the freezer compartment discharge air path in this embodiment, the air path may instead be a low temperature air path such as a freezer compartment return air path or a discharge air path of the ice compartment. This expands an area in which the electrostatic atomization apparatus can be installed.

Though a resistance heating element such as a chip resistor is used as the heating source in this embodiment, it is also possible to use a typical sheathed heater, PTC heater, and the like. Moreover, the heating source may be attached to or wound around the body of the metal pin. Alternatively, the heating source may be disposed on the external case of the electrostatic atomization apparatus near the metal pin.

Though the cooling unit for cooling the metal pin as the heat transfer connection member is the air cooled using the cooling source generated in the refrigeration cycle of the refrigerator in this embodiment, it is also possible to utilize heat transmission from a cooling pipe that uses a cool temperature or cool air from the cooling source of the refrigerator. In such a case, by adjusting a temperature of the cooling pipe, the electrode cooling unit can be cooled at an arbitrary temperature. This eases temperature control when cooling the atomization electrode.

Though no water retainer is provided around the atomization electrode of the electrostatic atomization apparatus in this embodiment, a water retainer may be provided. In such a case, warm moisture entering when opening/closing the door or high humidity air generated during a defrosting operation can be effectively retained. This enables dew condensation water generated near the atomization electrode to be retained around the atomization electrode, with it being possible to timely supply the water to the atomization electrode. Even when the storage compartment is in a low humidity environment, the water can be supplied. The provision of the water retainer is not limited to around the atomization electrode, as the water retainer may be provided in the entire storage compartment or a part of the storage compartment and further in the entire case or a part of the case, thereby securing moisture.

Though the storage compartment in the refrigerator is the refrigerator compartment in this embodiment, the storage compartment may be any of the storage compartments of other temperature zones such as the vegetable compartment and the switch compartment. In such a case, various applications can be developed. Though the electrostatic atomization apparatus is disposed on the back of the case positioned at the lowermost part of the refrigerator compartment in this embodiment, the electrostatic atomization apparatus is not limited to this position. The electrostatic atomization apparatus may be disposed on the back of an upper part of the refrigerator compartment to thereby spray the mist throughout the refrigerator compartment.

Though the metal pin is used in this embodiment, this is not a limit for the present invention, as any good heat conductive member is applicable. For example, a high polymer material having high heat conductivity may be used. This benefits weight saving and processability, enabling an inexpensive structure to be provided.

### Nineteenth Embodiment

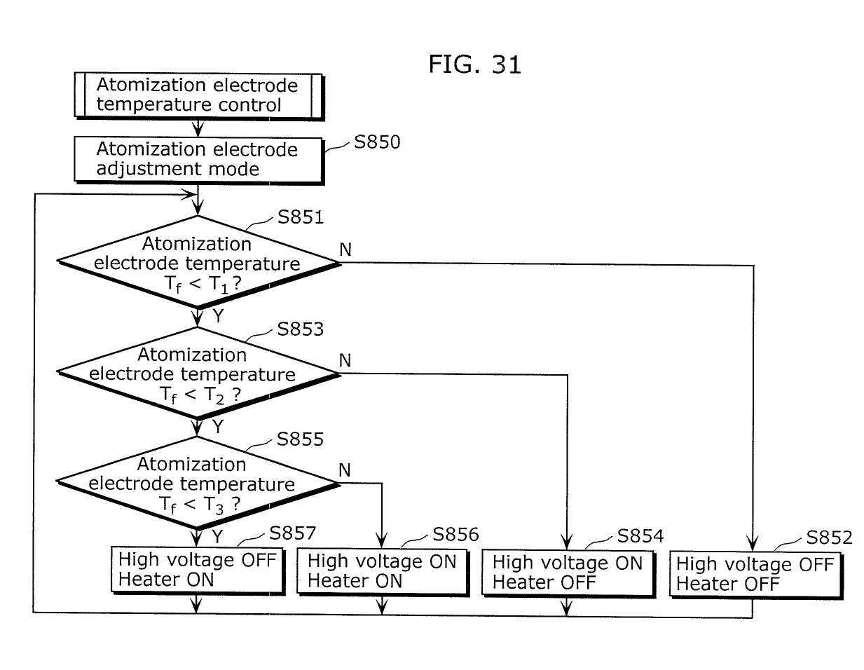

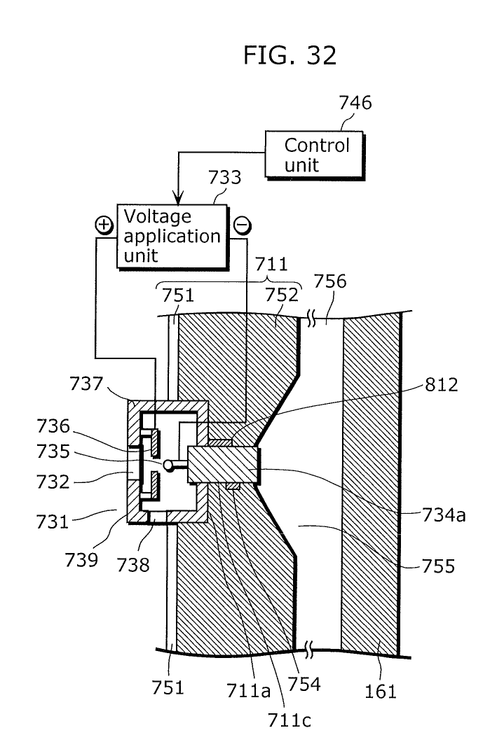

FIG. 32 is a detailed sectional view of an electrostatic atomization apparatus and its vicinity in a nineteenth embodiment of the present invention taken along line E-E in FIG. 28.

In this embodiment, detailed description is mainly given for parts that differ from the structure described in the eighteenth embodiment, with detailed description being omitted for parts that are the same as the structure described in the eighteenth embodiment or parts to which the same technical idea is applicable.

In the drawing, the back partition wall 711 includes the back partition wall surface 751 made of a resin such as ABS, and the heat insulator 752 made of styrene foam or the like. The depression 711a and a through part 711c are formed in a part of a storage compartment side wall surface of the back partition wall 711. By the metal pin 734 as the heat transfer connection member being inserted into the through part 711c, the electrostatic atomization apparatus 731 as the atomization apparatus which is the mist spray apparatus is installed.

Here, a part of the metal pin 734 as the heat transfer connection member passes through the heat insulator and is exposed to a part of an air path 756. A heat insulator depression 755 is formed in the air path 756 near the through part 711c on the back of the metal pin 734. Thus, the air path is partly widened.

The metal pin heater 754 which is a resistance heating element such as a chip resistor is formed near the atomization unit 739 of the electrostatic atomization apparatus 731, as the heating unit for adjusting the temperatures of the atomization electrode 735 as the atomization tip and the metal pin 734. The heater 754 is separated from the air path by the heat insulator 752 as the heat relaxation member, so as not to be directly affected by heat from the air path 756.

Moreover, the temperature detection unit such as the thermistor 812 is provided on a part of the metal pin 734 as the heat transfer connection member that is closer to the atomization electrode 735, in order to detect the temperature of the tip of the atomization electrode 735.

Note that the metal pin 734 is preferably made of a metal material that is resistant to corrosion and rust, or a material that has been coated or surface-treated by, for example, alumite.

An operation and working of the refrigerator having the above-mentioned structure are described below.

In a part of the back partition wall 711, the heat insulator 752 is smaller in wall thickness than other parts. In particular, the heat insulator 752 near the side wall of the metal pin 734 has a thickness of, for example, about 2 mm to 10 mm. Accordingly, the depression 711a is formed in the back partition wall 711, and the electrostatic atomization apparatus 731 is attached in this location.

The metal pin 734 is partly exposed to the air path 756 located behind. The metal pin 734 is adjusted to, for example, about −5° C. to −15° C., by low temperature cool air generated by the cooler 712 and blown by the cooling fan 713 according to an operation of a refrigeration cycle, and the metal pin heater 754 or the like as the heating unit. Since the metal pin 734 is a good heat conductive member, the metal pin 734 transmits cold heat extremely easily, so that the atomization electrode 735 is also adjusted to about −5° C. to −15° C.

Here, the air path 756 is gradually widened toward the vicinity of the heat insulator depression 755, thereby decreasing an air path resistance. This allows an increased amount of air to be blown from the cooling fan 713. Hence, refrigeration cycle efficiency can be improved.

The voltage application unit 733 applies a high voltage (for example, 4 kV to 10 kV) between the atomization electrode 735 to which water droplets adhere and the counter electrode 736, where the atomization electrode 735 is on a negative voltage side and the counter electrode 736 is on a positive voltage side. This causes corona discharge to occur between the electrodes. The water droplets at the tip of the atomization electrode 735 are finely divided by electrostatic energy. Furthermore, since the liquid droplets are electrically charged, a nano-level fine mist carrying an invisible charge of a several nm level, accompanied by ozone, OH radicals, and so on, is generated by Rayleigh fission. The voltage applied between the electrodes is an extremely high voltage of 4 kV to 10 kV. However, a discharge current value at this time is at a several μA level, and therefore an input is extremely low, about 0.5 W to 1.5 W.

The generated fine mist is made up of extremely small particles and so has high diffusivity. The fine mist is diffusively sprayed in the storage compartment according to natural convection in the storage compartment, so that the effect of the fine mist spreads throughout the storage compartment.

The sprayed fine mist is generated by high-voltage discharge, and so is negatively charged. Meanwhile, green leafy vegetables, fruits, and the like stored in the storage compartment tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces, thereby enhancing freshness preservation. Besides, many processed foods such as hams and sandwiches also tend to deteriorate as a result of drying. Since the storage compartment space becomes high in humidity by the atomized mist, such drying can be suppressed, enhancing freshness preservation.

The nano-level fine mist sufficiently contains radicals such as OH radicals, a small amount of ozone, and the like. Such a nano-level fine mist is effective in sterilization, antimicrobial activity, microbial elimination, and so on. The nano-level fine mist also has effects of stimulating increases in nutrient such as vitamin C through agricultural chemical removal and antioxidation by oxidative decomposition, and decomposing pollutants.

As described above, in the nineteenth embodiment, the heat insulator is provided in the partition wall for thermally insulating the cooler and the storage compartment. The unit for adjusting the temperature of the atomization electrode (atomization tip) of the electrostatic atomization apparatus to the dew point or below is the metal pin 734 as the heat transfer connection member made up of a metal piece having good heat conductivity, and the adjustment unit for adjusting the temperature of the metal pin 734 includes the cooling unit of the cool air generated by the cooler and the heating unit disposed near the metal pin. In this way, the temperature of the atomization electrode can be adjusted reliably.

Though not shown, by installing an inside temperature detection unit, an inside humidity detection unit, and the like in the storage compartment, the dew point can be precisely calculated by a predetermined computation according to a change in storage compartment environment.

In the nineteenth embodiment, the depression is formed in a storage compartment side part of the partition wall to which the electrostatic atomization apparatus is attached, and the metal piece as the cooling unit of the electrostatic atomization apparatus is inserted in the depression. This allows the metal piece to be cooled reliably. In addition, because of a gradually widening air path area, the air path resistance can be lowered or made equal, so that a decrease in cooling amount can be prevented. Furthermore, the temperature of the atomization electrode can be adjusted easily, on the basis of an exposed surface area of the metal pin to the air path and a heater input.

Though the metal pin is disposed in the depression of the air path in this embodiment, the depression need not be formed in the air path when the metal pin can attain a proper temperature. In this case, the air path can be processed easily.

### Twentieth Embodiment

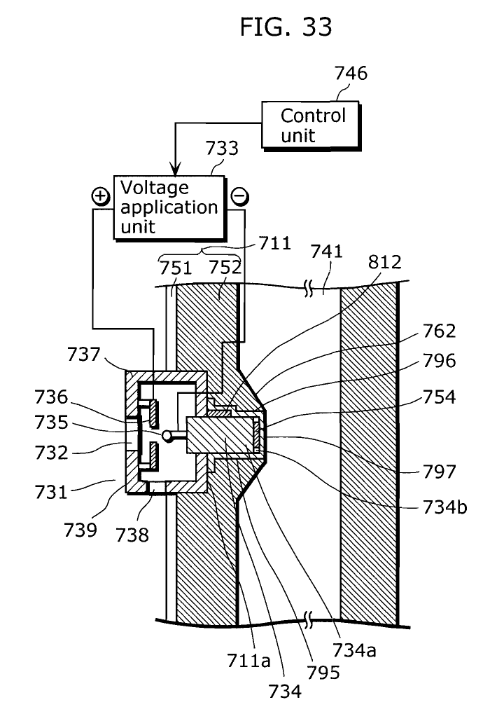

FIG. 33 is a detailed sectional view of an electrostatic atomization apparatus and its vicinity in a twentieth embodiment of the present invention taken along line E-E in FIG. 28.

In this embodiment, detailed description is given only for parts that differ from the structures described in the eighteenth and nineteenth embodiments, with description being omitted for parts that are the same as the structures described in the eighteenth and nineteenth embodiments or parts to which the same technical ideas are applicable.

In the drawing, the back partition wall 711 includes the back partition wall surface 751 made of a resin such as ABS and the heat insulator 752 made of styrene foam or the like for ensuring heat insulation between the refrigerator compartment 704 and the air path 741. Here, the depression 711a is formed in a part of a storage compartment side wall surface of the back partition wall 711 so as to be lower in temperature than other parts, and the electrostatic atomization apparatus 731 as the mist spray apparatus is installed in the depression 711a.

The through part 795 is formed behind the depression 711a, and the projection 734a of the metal pin 734 as the heat transfer connection member is placed in the through part 795.

In the case where the through part 795 in which the metal pin 734 as the heat transfer connection member is provided is formed as in this embodiment, in molding of styrene foam or the like, the heat insulating wall decreases in rigidity, which raises a possibility of problems such as a crack and a hole caused by insufficient strength or defective molding. Thus, there is concern about quality deterioration.

In view of this, in this embodiment, the heat insulator near the through part 795 is provided with a protrusion 762, thereby enhancing rigidity around the through part 795 when compared with a flat part, and further enhancing rigidity by securing the wall thickness of the heat insulator. In addition, by forming the protrusion 762, the metal pin can be cooled both from its back and its side.

When the metal pin 734 is directly placed in the air path, there is a possibility of excessive cooling that may cause an excessive amount of dew condensation or freezing of the atomization electrode 735. To suppress an increase in air path resistance, the protrusion 762 is shaped like a cone.

Moreover, the through part 795 as a through hole is formed in the heat insulator near the back of the metal pin 734. The metal pin 734 is inserted in the through part 795, and a metal pin cover 796 is provided around the metal pin 734, thereby ensuring heat insulation.

Though not shown, a cushioning material may be provided between the through part 795 and the metal pin cover 796 to ensure sealability.

Furthermore, though not shown, tape or the like may be attached to an opening 797 of the hole to block cool air.

The metal pin heater 754 which is a resistance heating element such as a chip resistor is formed near the atomization unit 739 of the electrostatic atomization apparatus 731, as the heating unit for adjusting the temperatures of the atomization electrode 735 as the atomization tip and the metal pin 734. The heater 754 is separated from the air path 741 by the heat insulator 752 as the heat relaxation member, so as not to be directly affected by heat from the air path 741. The heater 754 is situated between the metal pin 734 and the metal pin cover 796.

Moreover, the temperature detection unit such as the thermistor 812 is provided on a part of the metal pin 734 as the heat transfer connection member that is closer to the atomization electrode 735 so as to be situated between the metal pin 734 and the metal pin cover 796, in order to detect the temperature of the tip of the atomization electrode 735.

An operation and working of the refrigerator having the above-mentioned structure are described below.

The metal pin 734 as the heat transfer connection member is cooled via the metal pin cover 796. This achieves dual-structure indirect cooling, that is, the atomization electrode 735 is indirectly cooled via the metal pin 734 and further via the metal pin cover 796 as the heat relaxation member. In so doing, the atomization electrode 735 can be kept from being cooled excessively. Excessively cooling the atomization electrode 735 causes a large amount of dew condensation, and an increase in load of the atomization unit 739 raises concern about an increase in input of the electrostatic atomization apparatus 731 and an atomization failure of the atomization unit 739 due to freezing and the like. According to the above-mentioned structure, however, such problems due to the load increase of the atomization unit 739 can be prevented. Since an appropriate dew condensation amount can be ensured, stable mist spray can be achieved with a low input.

Moreover, by indirectly cooling the atomization electrode 735 in the dual structure via the heat transfer connection member and the heat relaxation member, a direct significant influence of a temperature change of the cooling unit on the atomization electrode can be further alleviated. This suppresses a load fluctuation of the atomization electrode, so that mist spray of a stable spray amount can be achieved.

Besides, the cool air generated in the cooling compartment 710 is used to cool the metal pin 734 as the heat transfer connection member, and the metal pin 734 is formed of a metal piece having excellent heat conductivity. Accordingly, the cooling unit can perform necessary cooling just by heat conduction from the air path through which the cool air generated by the cooler 712 flows.

The metal pin 734 as the heat transfer connection member in this embodiment is shaped to have the projection 734a on the opposite side to the atomization electrode. This being so, in the atomization unit, the end 734b on the projection 734a side is closest to the cooling unit. Therefore, the metal pin 734 is cooled by the cool air as the cooling unit, from the end 734b farthest from the atomization electrode 735.

Thus, in this embodiment, the protrusion 762 is formed on the heat insulator near the through part 795, thereby enhancing rigidity around the through part 795. Even in such a case, the surface area for heat conduction can be increased because the metal pin 734 can be cooled both from its back and its side. Hence, the rigidity around the metal pin 734 can be enhanced without a decrease in cooling efficiency of the metal pin 734.

Moreover, by shaping the protrusion 762 to be sloped in a conical shape, the cool air flows along the outer periphery of the protrusion 762 that is curved with respect to the cool air flow direction, so that an increase in air path resistance can be suppressed. Besides, by uniformly cooling the metal pin 734 from the outer periphery of the side wall, the metal pin 734 can be cooled evenly, as a result of which the atomization electrode 735 can be cooled efficiently via the metal pin 734.

In addition, the through part 795 as a hole is formed only in one part of the heat insulator 152 behind the metal pin 734, with there being no thin walled part. This eases molding of styrene foam, and prevents problems such as a breakage during assembly.

Furthermore, according to the structure of this embodiment, the back surface part of the metal pin cover 796 in contact with the cooling unit (low temperature cool air) serves as the heat relaxation member. Since a heat relaxation state of the heat relaxation member can be adjusted by changing in thickness of the part of the metal pin cover 796 in contact with the cool air, it is possible to easily change a cooling state of the metal pin. For example, this structure can be applied to refrigerators of various storage capacities, by changing the thickness of the metal pin cover 796 according to a corresponding cooling load.

Besides, there is no clearance between the metal pin cover 796 and the through part 795 and also the opening 797 of the through part 795 is sealed by tape or the like to block the cool air, so that there is no communicating part and the low temperature cool air does not leak into the storage compartment. Accordingly, the storage compartment and its peripheral components can be protected from dew condensation, low temperature anomalies, and so on.

The cooling by the cooling unit is performed from the end 734b which is a part of the metal pin 734 as the heat transfer connection member farthest from the atomization electrode 735. In doing so, after the large heat capacity of the metal pin 734 is cooled, the atomization electrode 735 is cooled by the metal pin 734. This further alleviates a direct significant influence of a temperature change of the cooling unit on the atomization electrode 735, with it being possible to realize stable mist spray with a smaller load fluctuation.

The generated fine mist is made up of extremely small particles and so has high diffusivity. The fine mist is diffusively sprayed in the storage compartment according to natural convection in the storage compartment, so that the effect of the fine mist spreads throughout the storage compartment.

The sprayed fine mist is generated by high-voltage discharge, and so is negatively charged. Meanwhile, green leafy vegetables, fruits, and the like stored in the storage compartment tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces, thereby enhancing freshness preservation. Besides, many processed foods such as hams and sandwiches also tend to deteriorate as a result of drying. Since the storage compartment space becomes high in humidity by the atomized mist, such drying can be suppressed, enhancing freshness preservation.

The nano-level fine mist sufficiently contains radicals such as OH radicals, a small amount of ozone, and the like. Such a nano-level fine mist is effective in sterilization, antimicrobial activity, microbial elimination, and so on. The nano-level fine mist also has effects of stimulating increases in nutrient such as vitamin C through agricultural chemical removal and antioxidation by oxidative decomposition, and decomposing pollutants.

As described above, in the twentieth embodiment, regarding the structure of the metal pin as the projection of the atomization unit, the through part 795 as the through hole is formed in the heat insulator, the metal pin is inserted into the through part, and the metal pin cover is provided around the metal pin. This eases the molding of the heat insulator, while ensuring the cooling capacity for the metal pin.

Moreover, by covering the side and back of the metal pin with the integrally formed metal pin cover 796, it is possible to effectively prevent the cool air from the air path 741 situated at the back from entering around the metal pin.

Though no cushioning material is provided around the metal pin in the twentieth embodiment, a cushioning material may be provided. This allows for close contact between the hole and the metal pin cover, with it being possible to prevent cool air leakage.

Though a shield such as tape is not disposed at the opening of the hole in the twentieth embodiment, a shield may be disposed. This makes it possible to further prevent cool air leakage.

Though the air path for cooling the metal pin is the freezer compartment discharge air path in the twentieth embodiment, the air path may instead be a low temperature air path such as a freezer compartment return air path or an ice compartment discharge air path. This expands an area in which the electrostatic atomization apparatus can be installed.

Though the cooling unit for cooling the metal pin as the heat transfer connection member is the air cooled using the cooling source generated in the refrigeration cycle of the refrigerator in the twentieth embodiment, it is also possible to utilize heat transmission from a cooling pipe that uses a cool temperature or cool air from the cooling source of the refrigerator. In such a case, by adjusting a temperature of the cooling pipe, the metal pin can be cooled at an arbitrary temperature. This eases temperature control when cooling the atomization electrode.

In this embodiment, the cooling unit for cooling the metal pin as the heat transfer connection member may use a Peltier element that utilizes a Peltier effect as an auxiliary component. In such a case, the temperature of the tip of the atomization electrode can be controlled very finely by a voltage supplied to the Peltier element.

Though no cushioning material is used between the external case of the electrostatic atomization apparatus and the depression of the heat insulator in this embodiment, a cushioning material such as urethane foam may be disposed on the external case of the electrostatic atomization apparatus or the depression of the heat insulator, in order to prevent the entry of moisture into the metal pin and suppress rattling. In so doing, moisture can be kept from entering into the metal pin, and dew condensation on the heat insulator can be prevented.

### Twenty-First Embodiment

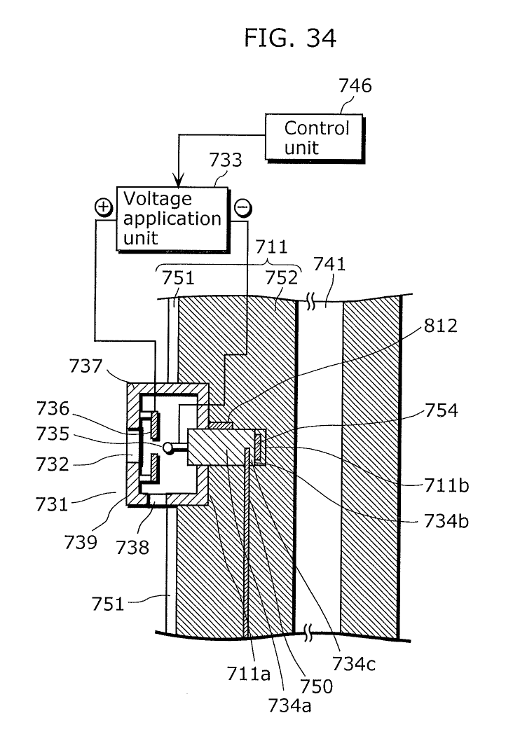

FIG. 34 is a detailed sectional view of an electrostatic atomization apparatus and its vicinity in a twenty-first embodiment of the present invention taken along line E-E in FIG. 28.

In this embodiment, detailed description is given only for parts that differ from the structures described in the eighteenth to twentieth embodiments, with description being omitted for parts that are the same as the structures described in the eighteenth to twentieth embodiments or parts to which the same technical ideas are applicable.

The back partition wall 711 of the refrigerator compartment 704 includes the back partition wall surface 751 made of a resin such as ABS and the heat insulator 752 made of styrene foam or the like for ensuring the heat insulation of isolating the air path 741 and the refrigerator compartment 704 from each other. The depression 711a is formed in a part of a storage compartment side wall surface of the back partition wall 711 so as to be lower in temperature than other parts, and the electrostatic atomization apparatus 731 as the atomization apparatus which is the mist spray apparatus is installed in the depression 711a.

The electrostatic atomization apparatus 731 as the atomization apparatus is mainly composed of the atomization unit 739, the voltage application unit 733, and the external case 737. The spray port 732 and the moisture supply port 738 are each formed in a part of the external case 737.

The heater 754 which is a resistance heating element such as a chip resistor is integrally formed with the electrostatic atomization apparatus 731 on the end 734b of the projection 734a side of the metal pin 734 as the heat transfer connection member near the atomization unit 739, as a heating unit for adjusting the temperature of the metal pin 734 as the heat transfer connection member included in the electrostatic atomization apparatus 731 and preventing excessive dew condensation or freezing of a peripheral part including the atomization electrode 735 as the atomization tip. The heater 754 is separated from the air path 741 by the heat insulator 752 as the heat relaxation member, so as not to be directly affected by heat from the air path 741.

Moreover, the temperature detection unit such as the thermistor 812 is provided on a part of the metal pin 734 as the heat transfer connection member that is closer to the atomization electrode 735, in order to detect the temperature of the tip of the atomization electrode 735.

The metal pin 734 as the heat transfer connection member is fixed to the external case 737, where the metal pin 734 itself has the projection 734a that protrudes from the external case 737. The projection 734a of the metal pin 734 is located opposite to the atomization electrode 735, and fit into the deepest depression 711b that is deeper than the depression 711a of the back partition wall 711.

Thus, the deepest depression 711b deeper than the depression 711a is formed on the back of the metal pin 734 as the heat transfer connection member, so that this part of the heat insulator 752 on the air path 741 side is thinner than other parts in the partition wall 711 on the back of the refrigerator compartment 704. The thinner heat insulator 752 serves as the heat relaxation member, and the metal pin 734 is cooled by cool air or warm air from the back via the heat insulator 752 as the heat relaxation member.

Furthermore, a fitting hole 734c is formed in the metal pin 734, and a heat pipe 750 as a cold heat conveyance unit is installed in the fitting hole 734c. In the installation, the heat pipe 750 and the fitting hole 734c are joined so as to reduce a contact heat resistance therebetween. In detail, the heat pipe 750 is fit into the fitting hole 734c via epoxy or a heat diffusion compound without leaving a gap. Pressing, soldering, or the like is employed to fix the heat pipe 750.

The heat pipe 750 is a metal pipe having a capillary structure on its inner wall. The inside of the heat pipe 750 is under vacuum, where a small amount of water, hydrochlorofluorocarbon, or the like is enclosed. When one end of the heat pipe 750 is brought into contact with a heat source and heated or cooled, a liquid inside the heat pipe 750 evaporates. At this time, heat is taken in as latent heat (vaporization heat). The heat moves at high speed (approximately at a sonic speed), and then is cooled and returns to a liquid, emitting heat (heat dissipation by condensed latent heat). The liquid returns to the original position by passing through the capillary structure (or by gravitation). Thus, the heat can be continuously moved with high efficiency.

The heat pipe 750 is covered with the heat insulator 752 as the heat relaxation member, so as not to be directly affected by cool air from the air path 741. Here, a through hole is formed in the heat insulator 752, and the heat pipe 750 is inserted in the through hole. Note that, to facilitate assembly, the heat insulator 752 may be divided and arranged so as to sandwich the heat pipe 750.

The end of the heat pipe 750 opposite to the metal pin 734 is thermally attached to the cooler 712 directly or indirectly.

In this way, heat can be conveyed from a lowest cold heat source in the refrigeration cycle from the cooler 712, with it being possible to attain an improved cooling speed of the metal pin 734 and the atomization electrode 735.

In the cooling of the metal pin 734 as the heat transfer connection member, the cool air generated in the cooling compartment 710 is used, too. Hence, as the cooling unit, it is possible to not only use the heat conduction from the air path through which the cool air generated by the cooler 712 flows, but also directly use the heat at or in the vicinity of the cooler 712.

Note that, since there is a possibility of electric corrosion due to dew condensation at a connection part between the heat pipe 750 and the metal pin 734 or the cooler 712, it is desirable to use the same metal.

Moreover, the heating unit heats the metal pin 734 as the heat transfer connection member using, as a heating source, the warm air generated during a defrosting operation of the refrigerator 700 and the heater 754 as the resistance heating element, and also controls the heater 754 as the resistance heating element by varying an input or a duty factor according to a detected temperature of the temperature detection unit such as the thermistor 812 provided for detecting the temperature of the tip of the atomization electrode 735. In this way, the peripheral part including the atomization electrode 735 as the atomization tip can be prevented from excessive dew condensation or freezing, and also the amount of dew condensation supplied to the atomization electrode 735 as the atomization tip can be adjusted, so that stable atomization can be achieved.

Since the adjustment unit can be provided by such a simple structure, a highly reliable atomization unit with a low incidence of troubles can be realized. Moreover, the metal pin 734 as the heat transfer connection member and the atomization electrode 735 can be cooled by two cooling methods using the cooling source of the refrigeration cycle, enabling energy-efficient atomization to be performed efficiently.

Though the fitting hole is formed in the metal pin in the twenty-first embodiment, a through hole may be formed to install the heat pipe in consideration of processability of the metal pin.

Though the end of the heat pipe opposite to the metal pin 734 is thermally attached to the cooler 712 directly or indirectly in the twenty-first embodiment, the end may be exposed to cool air immediately after heat exchange in the cooler 712, that is, the end may be exposed in the cooling compartment 710. Moreover, the end may be exposed in a cooling air path of a storage compartment that is directly below the refrigerator compartment and has a lower temperature zone than the refrigerator compartment temperature zone, such as a cooling air path of the ice compartment or the switch compartment set to a temperature other than the refrigeration temperature. This allows the heat pipe to be shortened, resulting in miniaturization, cost reduction, and improved assembly.

Though the metal pin heater provided for the temperature adjustment of the atomization electrode is positioned on the metal pin heater side in the twenty-first embodiment, the metal pin heater may be attached to the end of the heat pipe opposite to the metal pin 734. This enables the temperature adjustment to be performed on a heat conveyance upstream side, so that the temperature adjustment can be performed efficiently while reducing the input to the heater.

Though a resistance heating element such as a chip resistor is used as the metal pin heater in the twenty-first embodiment, it is also possible to use a typical sheathed heater, PTC heater, and the like. Moreover, the metal pin heater may be attached to or wound around the body of the metal pin or the heat pipe.

### Twenty-Second Embodiment

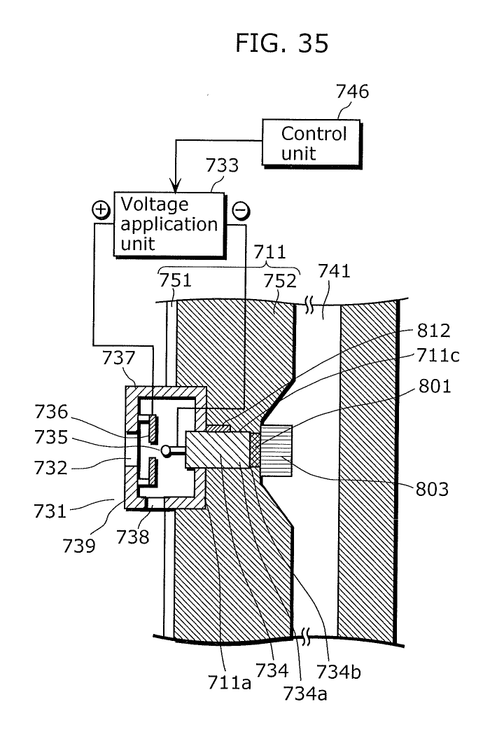

FIG. 35 is a detailed sectional view of an electrostatic atomization apparatus and its vicinity in a twenty-second embodiment of the present invention taken along line E-E in FIG. 28.

In this embodiment, detailed description is mainly given for parts that differ from the structures described in the eighteenth to twenty-first embodiments, with detailed description being omitted for parts that are the same as the structures described in the eighteenth to twenty-first embodiments or parts to which the same technical idea is applicable.

In the drawing, the back partition wall 711 includes the back partition wall surface 751 made of a resin such as ABS and the heat insulator 752 made of styrene foam or the like for ensuring heat insulation. The depression 711a is formed in a part of a storage compartment side wall surface of the back partition wall 711 so as to be lower in temperature than other parts, and the electrostatic atomization apparatus 731 as the atomization apparatus which is the mist spray apparatus is installed in the depression 711a.

The electrostatic atomization apparatus 731 is mainly composed of the atomization unit 739, the voltage application unit 733, and the external case 737. The spray port 732 and the moisture supply port 738 are each formed in a part of the external case 737. The atomization electrode 735 as the atomization tip is disposed in the atomization unit 739, and fixed by the metal pin 734 made of a good heat conductive material.

The through part 711c is formed in the heat insulator 752, and the metal pin 734 and a Peltier module 801 including a Peltier element for adjusting the temperature of the atomization electrode 735 are inserted in the through part 711c. The end 734b of the metal pin 734 and one side of the Peltier module 801 are thermally connected. The other side of the Peltier module 801 is thermally connected to an air path side heat conductive member 803 made of a good heat conductive material.

An operation and working of the refrigerator having the above-mentioned structure are described below.

Cool air generated by the cooler 712 according to an operation of a refrigeration cycle is conveyed in the air path 741 behind the atomization electrode 735. During this time, when a voltage is applied to the Peltier module 801 including the Peltier element, the atomization electrode 735 can be adjusted to the dew point or below by a voltage application direction and an applied voltage value. For example, when the atomization electrode 735 needs to be cooled, a voltage is applied where a heat absorption surface of the Peltier module 801 is on the atomization electrode side and a heat dissipation surface of the Peltier module 801 is on the air path side. When the atomization electrode 735 needs to be heated, on the other hand, a voltage is applied where the heat absorption surface of the Peltier module 801 is on the air path side and the heat dissipation surface of the Peltier module 801 is on the atomization electrode 735 side. In so doing, water can be timely secured at the tip of the atomization electrode 735, as a result of which stable atomization can be performed.

As described above, in the twenty-second embodiment, by using the Peltier module 801 as the temperature adjustment unit of the atomization electrode 735 of the electrostatic atomization apparatus 731, the temperature of the atomization electrode 735 can be adjusted just by the voltage applied to the Peltier module 801. Moreover, both cooling and heating can be carried out simply by voltage inversion or the like, with there being no need to add a heater and the like.

In the twenty-second embodiment, extremely fine temperature control is possible through fine adjustment of the voltage applied to the Peltier module 801. This allows the amount of water at the tip of the atomization electrode to be finely controlled.

In the twenty-second embodiment, the Peltier module serves as both the heating unit and the cooling unit. This makes it unnecessary to provide a particular heating unit, contributing to simplified components.

Note that, by providing the temperature detection unit 812 situated near the atomization unit 739 and further by providing a humidity sensor not shown in the twenty-second embodiment, more precise control becomes possible, and stable spray can be achieved.

Thus, the temperature of the atomization electrode can be adjusted just by the voltage applied to the Peltier element, so that the atomization electrode can be individually adjusted to an arbitrary temperature.

Moreover, both cooling and heating can be carried out simply by voltage inversion or the like, with there being no need to add a particular apparatus such as a heater as a cooling unit or a heating unit. Since both cooling and heating are performed by a simple structure and also temperature responsiveness is accelerated, the temperature can be arbitrarily adjusted with enhanced responsiveness of the water amount adjustment unit. This contributes to improved accuracy of the atomization unit.

### Twenty-Third Embodiment

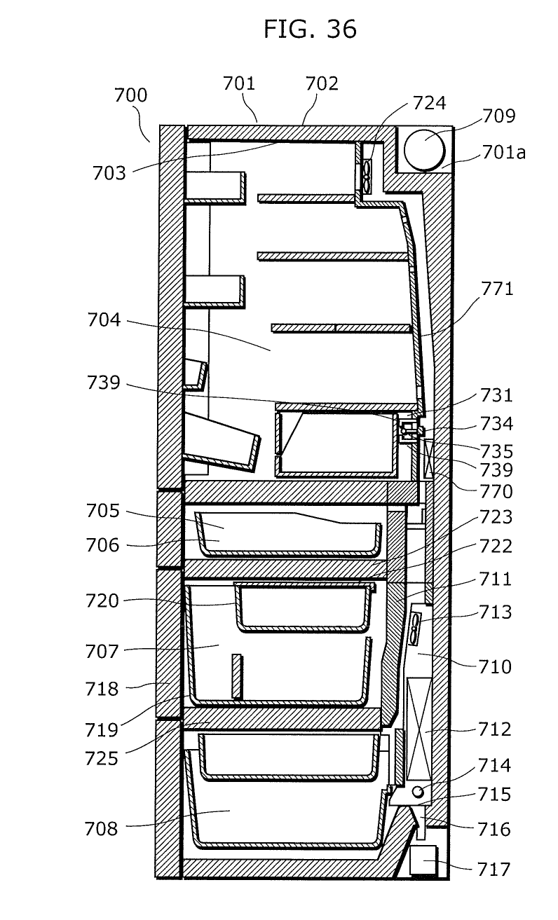

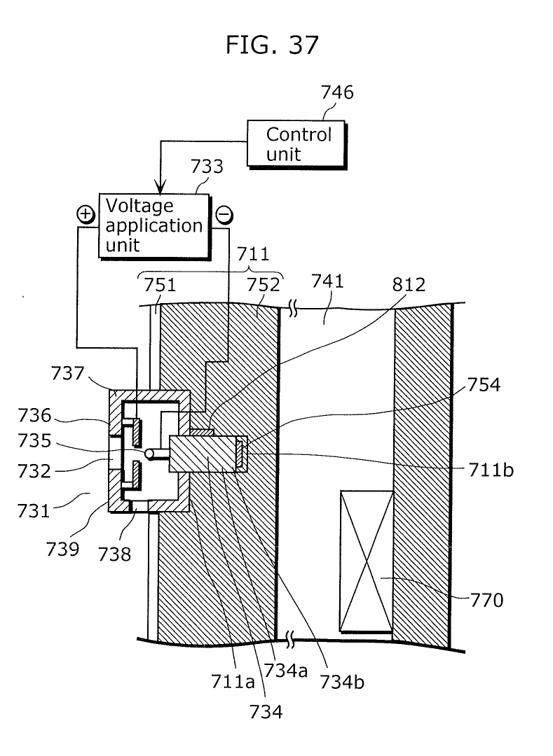

FIG. 36 is a longitudinal sectional view of a refrigerator in a twenty-third embodiment of the present invention. FIG. 37 is a detailed sectional view of an electrostatic atomization apparatus and its vicinity in the refrigerator in the twenty-third embodiment of the present invention taken along line E-E in FIG. 28.

In this embodiment, detailed description is mainly given for parts that differ from the structures described in the eighteenth to twenty-second embodiments, with detailed description being omitted for parts that are the same as the structures described in the eighteenth to twenty-second embodiments or parts to which the same technical idea is applicable.

In the drawing, the refrigerator 700 includes two coolers for cooling each storage compartment. On is the cooler 712 for freezing temperature zone storage compartments, and the other is a cooler 770 for refrigeration temperature zone storage compartments. These coolers are connected by a refrigerant pipe, but have independent cooling air paths.

An operation and working of the refrigerator having the above-mentioned structure are described below.

A high temperature and high pressure refrigerant discharged by an operation of the compressor 709 is condensed into liquid to some extent by a condenser (not shown), is further condensed into liquid without causing dew condensation of the main body of the refrigerator 700 while passing through a refrigerant pipe (not shown) and the like disposed on the side and back surfaces of the main body of the refrigerator 700 and in a front opening of the main body of the refrigerator 700, and reaches a capillary (not shown). Subsequently, the refrigerant is reduced in pressure in the capillary while undergoing heat exchange with a suction pipe (not shown) leading to the compressor 709 to thereby become a low temperature and low pressure liquid refrigerant, and reaches the cooler 712. Here, the low temperature and low pressure liquid refrigerant undergoes heat exchange with the air in each storage compartment by an operation of the cooling fan 713, as a result of which the refrigerant in the cooler 712 evaporates. Hence, cool air (−15° C. to −25° C.) for cooling each storage compartment is generated in the cooling compartment 710. The low temperature cool air from the cooling fan 713 is branched into the switch compartment 705, the ice compartment 706, and the freezer compartment 708 using air paths and dampers, and cools each storage compartment to a desired temperature zone. Meanwhile, the refrigerant flow path is switched or branched to the second cooler 770 by a flow path regulation valve (not shown) or the like. After this, an evaporation temperature of the cooler 770 is adjusted using an expansion valve (not shown) or the like capable of adjusting a pressure reduction amount, and the low temperature and low pressure liquid refrigerant undergoes heat exchange with the air in the refrigerator compartment 704 or the vegetable compartment 707 by an operation of a cooling fan 772, as a result of which the refrigerant in the cooler 770 evaporates. Hence, cool air (−15° C. to −25° C.) for cooling each storage compartment is generated.

The depression is formed in the back partition wall 711 on the back of the refrigerator compartment 704, and the electrostatic atomization apparatus 731 as the mist spray apparatus is installed in the depression. There is the deepest depression 711b behind the metal pin 734 as the heat transfer connection member formed in the atomization unit 739, where the heat insulator is, for example, about 2 mm to 10 mm in thickness and the temperature is lower than in other parts. In the refrigerator 700 of this embodiment, such a thickness is appropriate for the heat relaxation member located between the metal pin and the adjustment unit. Thus, the depression 711a is formed in the back partition wall 711, and the electrostatic atomization apparatus 731 having the protruding projection 734a of the metal pin 734 is fit into the deepest depression 711b on a backmost side of the depression 711a.

Cool air of about −15° C. to −25° C. generated by the cooler 712 and blown by the cooling fan 713 according to the operation of the refrigeration cycle flows in the air path 741 behind the metal pin 734 as the heat transfer cooling member, as a result of which the metal pin 734 is cooled to, for example, about −5° C. to −15° C. by heat conduction from the air path surface. Since the metal pin 734 is a good heat conductive member, the metal pin 734 transmits cold heat extremely easily, so that the atomization electrode 735 fixed to the metal pin 734 is also cooled to about −5° C. to −15° C. via the metal pin 734.

Here, even though the refrigerator compartment 704 is typically in a low humidity environment, the atomization electrode 735 as the atomization tip decreases to the dew point or below, and as a result water is generated and water droplets adhere to the atomization electrode 735 including its tip.

Though not shown, by installing an inside temperature detection unit, an inside humidity detection unit, and the like in the storage compartment, the dew point can be precisely calculated by a predetermined computation according to a change in storage compartment environment.

In the twenty-third embodiment, since the independent cooler is used for cooling the refrigerator compartment 704, a high humidity environment can be more easily obtained than in the eighteenth to twenty-second embodiments. This eases water collection, and allows for efficient mist spray.

Though a high humidity environment can be easily created, such an environment is also susceptible to bacteria propagation. However, extremely high reactive radicals contained in the fine mist in the present invention deliver antimicrobial activity, so that cleanness of the storage compartment space and the food itself can be improved.

### Twenty-Fourth Embodiment

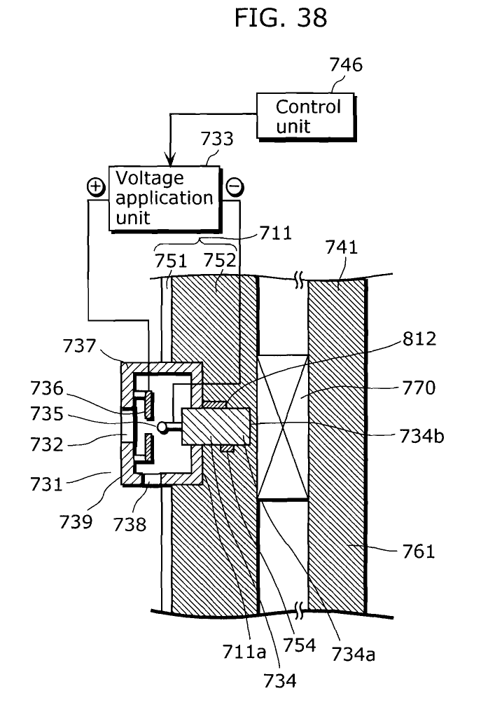

FIG. 38 is a detailed sectional view of an electrostatic atomization apparatus and its vicinity in a twenty-fourth embodiment of the present invention taken along line E-E in FIG. 28.

In this embodiment, detailed description is mainly given for parts that differ from the structures described in the eighteenth to twenty-third embodiments, with detailed description being omitted for parts that are the same as the structures described in the eighteenth to twenty-third embodiments or parts to which the same technical idea is applicable.

In the drawing, the electrostatic atomization apparatus 731 as the atomization apparatus which is the mist spray apparatus is mainly composed of the atomization unit 739, the voltage application unit 733, and the external case 737. The spray port 732 and the moisture supply port 738 are each formed in a part of the external case 737. The atomization electrode 735 as the atomization tip in the atomization unit 739 is fixed to the external case 737. The metal pin 734 as the heat transfer connection member is attached to the atomization electrode 735, and the metal pin heater 754 as the heating unit for adjusting the temperature of the atomization electrode 735 is formed in the vicinity of the metal pin 734. The counter electrode 736 shaped like a circular doughnut plate is installed in a position facing the atomization electrode 735 on the storage compartment side, so as to have a constant distance from the tip of the atomization electrode 735. The spray port 732 is formed on a further extension from the atomization electrode 735.

The cooler 770 for cooling the storage compartment is set adjacent to the back of the electrostatic atomization apparatus 731, and the electrostatic atomization apparatus 731 is fixed in the depression 711a of the back partition wall 711.

An operation and working of the refrigerator having the above-mentioned structure are described below.

The cooler 770 is in a relatively low temperature state, and the atomization electrode 735 decreases to the dew point or below by heat conduction from the cooler 770 and as a result dew condensation occurs at the tip of the atomization electrode 735. This being the case, by applying a high voltage generated by the voltage application unit between the atomization electrode 735 and the counter electrode 736, a fine mist is generated and sprayed into the refrigerator compartment 704.

As described above, in the twenty-fourth embodiment, the cooler 770 for cooling the storage compartment as the cooling unit is used as the temperature adjustment unit for causing dew condensation on the atomization tip (atomization electrode 735) of the electrostatic atomization apparatus 731 as the atomization apparatus. In this way, the atomization tip (atomization electrode 735) can be directly cooled by the cooler 770 which is the cooling source of the refrigerator 700, thereby enhancing temperature responsiveness.

Thus, the temperatures of the heat transfer connection member and the atomization electrode 735 can be adjusted by the temperature adjustment unit through the use of the refrigeration cycle. Hence, the temperature adjustment of the atomization electrode can be performed more energy-efficiently.

### Twenty-Fifth Embodiment

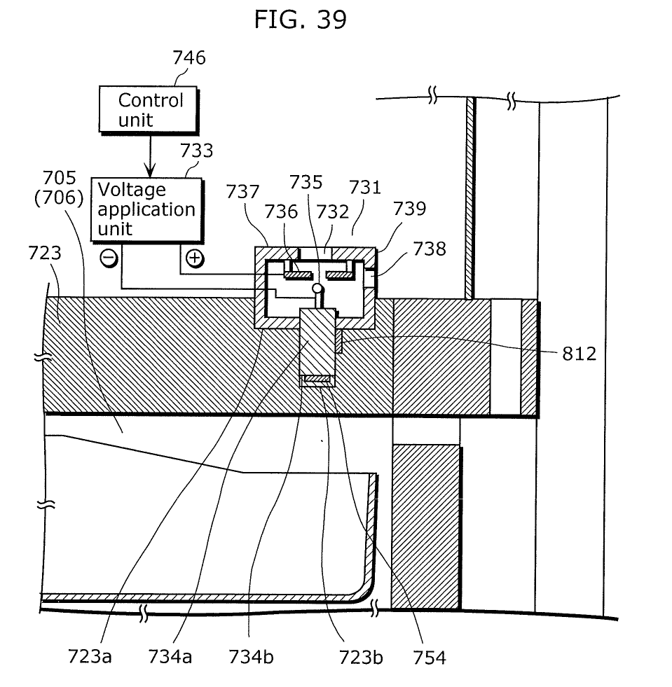

FIG. 39 is a detailed sectional view of an electrostatic atomization apparatus and its vicinity in a twenty-fifth embodiment of the present invention taken along line E-E in FIG. 28.

In this embodiment, detailed description is mainly given for parts that differ from the structures described in the eighteenth to twenty-fourth embodiments, with detailed description being omitted for parts that are the same as the structures described in the eighteenth to twenty-fourth embodiments or parts to which the same technical idea is applicable.

As shown in the drawing, the electrostatic atomization apparatus 731 as the atomization apparatus which is the mist spray apparatus is incorporated in the partition wall 723 that secures heat insulation in order to separate the temperature zone of the refrigerator compartment 704 from the temperature zones of the switch compartment 705 and the ice compartment 706. In particular, the heat insulator has a depression in a part corresponding to the metal pin 734 as the heat transfer connection member of the atomization unit 739. The metal pin heater 754 is formed in the vicinity of the metal pin 734.

An operation and working of the refrigerator having the above-mentioned structure are described below.

The partition wall 723 in which the electrostatic atomization apparatus 731 is installed needs to have such a thickness that allows the metal pin 734 to which the atomization electrode 735 as the atomization tip is fixed, to be cooled. Accordingly, the partition wall 723 has a smaller wall thickness in a depression 723a where the electrostatic atomization apparatus 731 is disposed, than in other parts. Further, the partition wall 723 has a smaller wall thickness in a deepest depression 723b where the metal pin 734 is held, than in the depression 723a. As a result, the metal pin 734 can be cooled by heat conduction from the ice compartment which is relatively low in temperature, with it being possible to cool the atomization electrode 735. When the temperature of the tip of the atomization electrode 735 drops to the dew point or below, a water vapor near the atomization electrode 735 builds up dew condensation on the atomization electrode 735, thereby reliably generating water droplets.

An outside air temperature variation or fast ice making may cause the temperature control of the ice compartment 106 to vary and lead to excessive cooling of the atomization electrode 735. In view of this, the amount of water on the tip of the atomization electrode 735 is optimized by adjusting the temperature of the atomization electrode 735 by the metal pin heater 754 disposed near the atomization electrode 735.

Though not shown, by installing an inside temperature detection unit, an inside humidity detection unit, and the like in the storage compartment, the dew point can be precisely calculated by a predetermined computation according to a change in storage compartment environment.

The sprayed fine mist is generated by high-voltage discharge, and so is negatively charged. Meanwhile, green leafy vegetables, fruits, and the like stored in the storage compartment tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces, thereby enhancing freshness preservation. Besides, many processed foods such as hams and sandwiches also tend to deteriorate as a result of drying. Since the storage compartment space becomes high in humidity by the atomized mist, such drying can be suppressed, enhancing freshness preservation.

The nano-level fine mist sufficiently contains radicals such as OH radicals, a small amount of ozone, and the like. Such a nano-level fine mist is effective in sterilization, antimicrobial activity, microbial elimination, and so on. The nano-level fine mist also has effects of stimulating increases in nutrient such as vitamin C through agricultural chemical removal and antioxidation by oxidative decomposition, and decomposing pollutants.

As described above, in the twenty-fifth embodiment, the refrigerator main body has a plurality of storage compartments. The lower temperature storage compartment maintained at a lower temperature than the storage compartment including the atomization unit is provided on the bottom side of the storage compartment including the atomization unit, and the atomization unit is attached to the partition wall on the bottom side of the storage compartment including the atomization unit.

In this way, a member such as a refrigerant pipe or a pipe that utilizes cool air of the cooling compartment having a lowest temperature among air cooled using a cooling source generated in the refrigeration cycle of the refrigerator or utilizes heat conduction from the cool air can be set as the cooling unit. Since the cooling unit can be provided by such a simple structure, a highly reliable atomization unit with a low incidence of troubles can be realized. Moreover, the heat transfer connection member and the atomization electrode can be cooled by using the cooling source of the refrigeration cycle, which contributes to energy-efficient atomization.

Moreover, by attaching the atomization unit to the partition wall, the atomization unit can be positioned using the gap effectively without greatly bulging into the storage compartment. Hence, a reduction in storage capacity can be avoided. In addition, the atomization unit is difficult to reach by hand because it is attached to the back surface, which contributes to enhanced safety.

In this embodiment, not tap water supplied from outside but dew condensation water is used as makeup water. Since dew condensation water is free from mineral compositions and impurities, deterioration in water retentivity caused by deterioration or clogging of the tip of the atomization electrode can be prevented.

In this embodiment, the mist contains radicals, so that agricultural chemicals, wax, and the like adhering to the vegetable surfaces can be decomposed and removed with an extremely small amount of water. This benefits water conservation, and also achieves a low input.

### Twenty-Sixth Embodiment

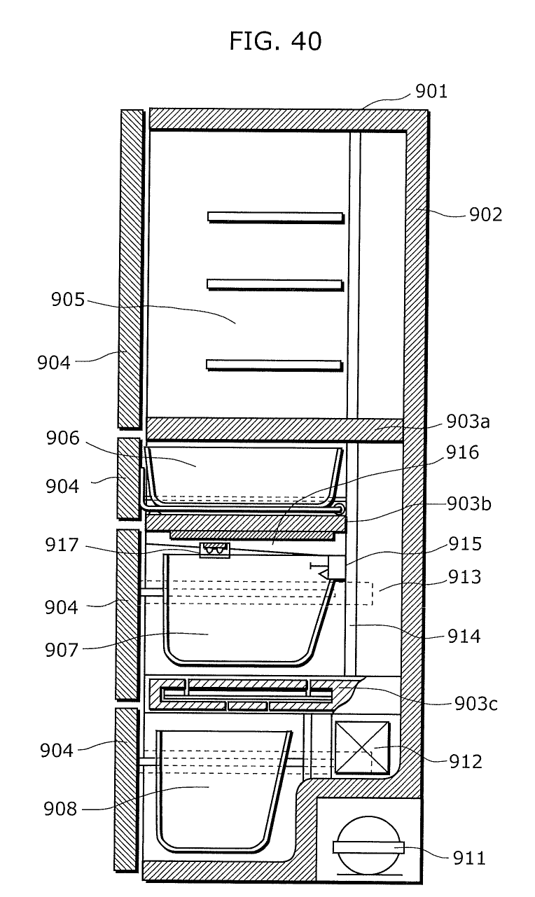

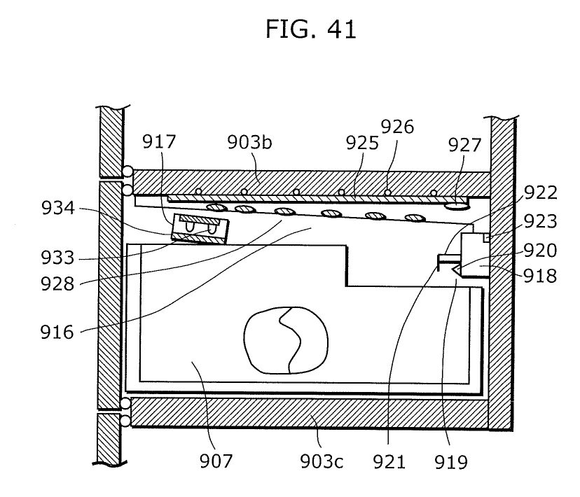

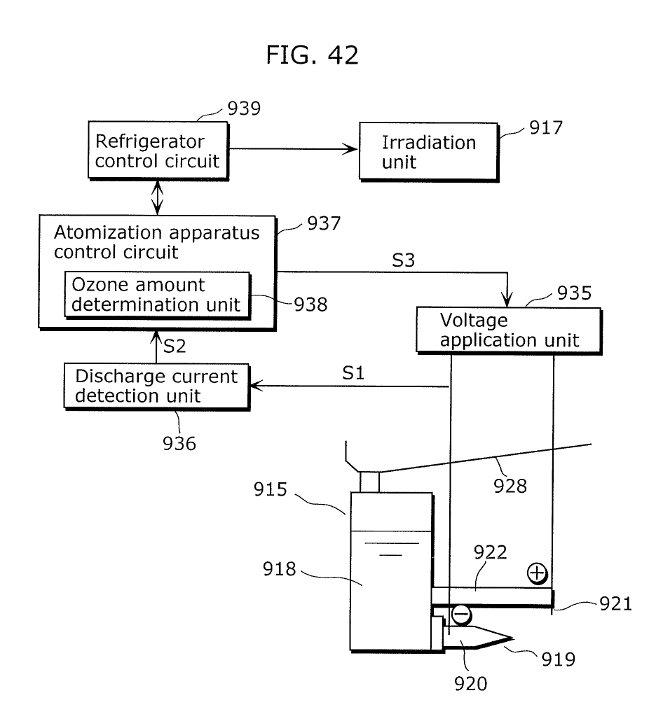

FIG. 40 is a longitudinal sectional view when a refrigerator in a twenty-sixth embodiment of the present invention is cut into left and right. FIG. 41 is a relevant part enlarged sectional view of a vegetable compartment in the refrigerator in this embodiment which is cut into left and right. FIG. 42 is a block diagram showing a control structure related to an electrostatic atomization apparatus in the refrigerator in this embodiment.

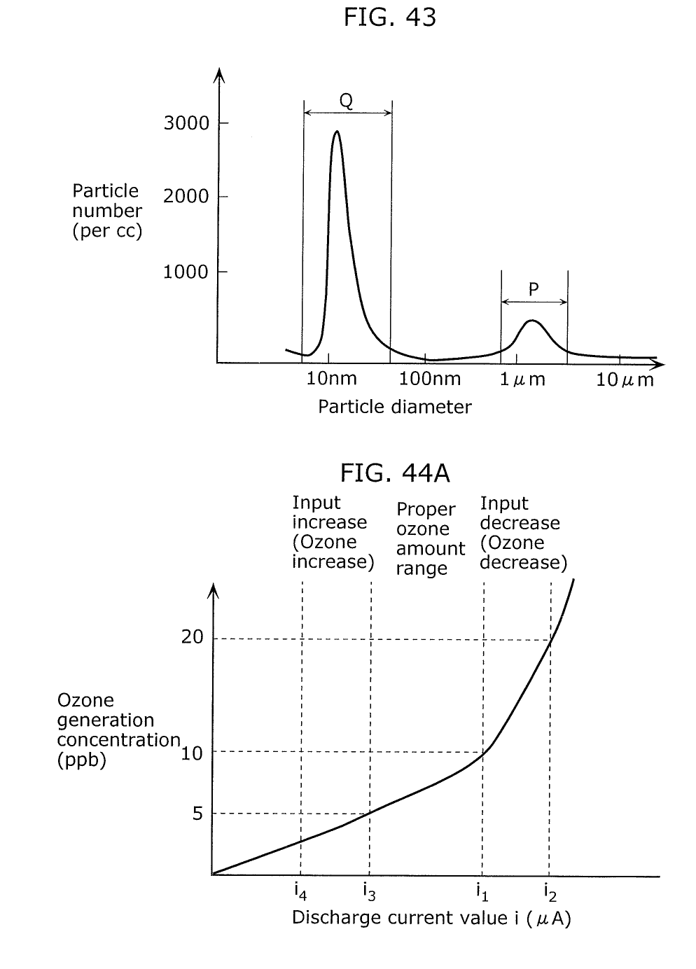

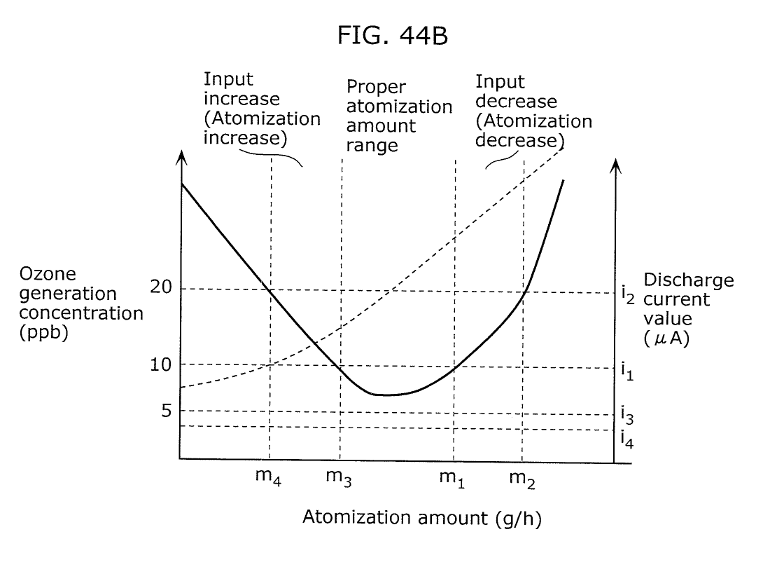

FIG. 43 is a characteristic chart showing a relation between a particle diameter and a particle number of a mist generated by a spray unit in the refrigerator in this embodiment. FIG. 44A is a characteristic chart showing a relation between a discharge current value and an ozone generation concentration in an ozone amount determination unit of the electrostatic atomization apparatus in the refrigerator in this embodiment. FIG. 44B is a characteristic chart showing a relation between an atomization amount and each of an ozone concentration and a discharge current value in the electrostatic atomization apparatus in the refrigerator in this embodiment.

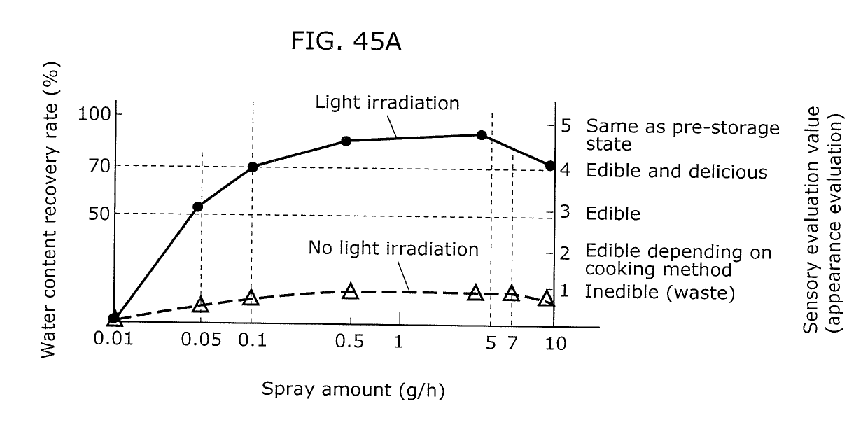

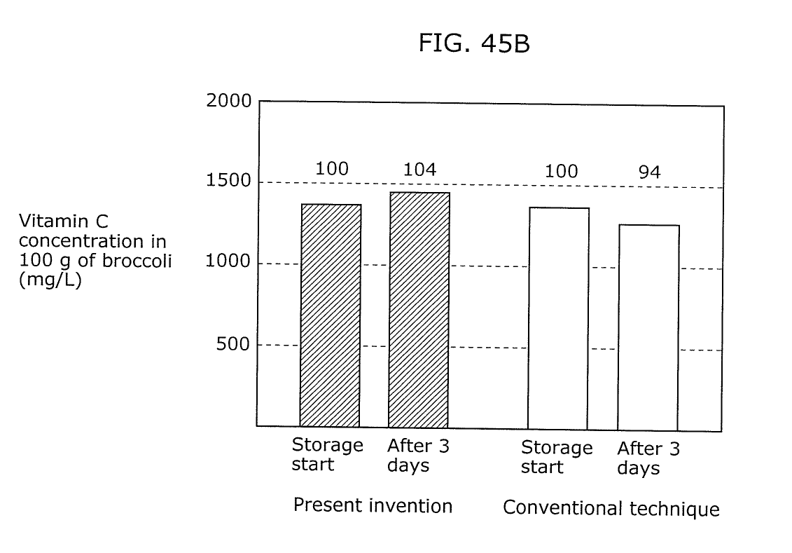

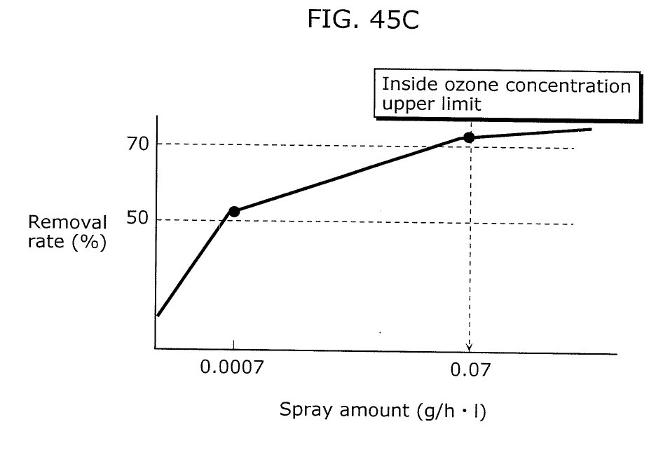

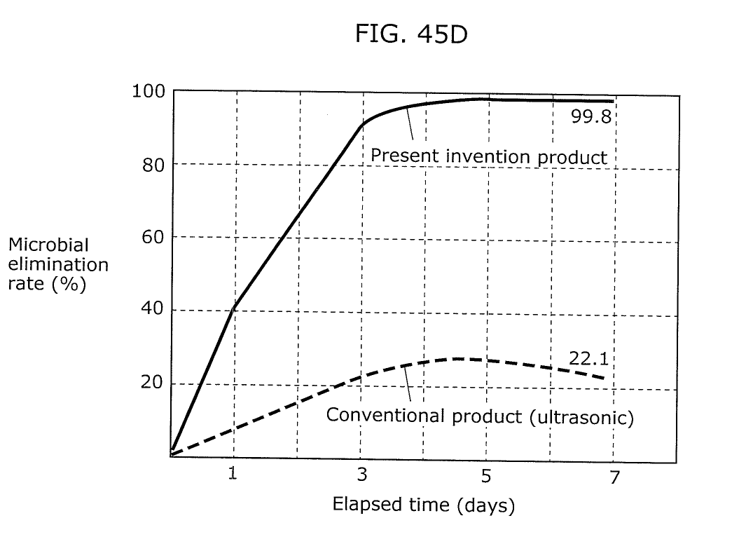

FIG. 45A is a characteristic chart showing a water content recovery effect for a wilting vegetable in the refrigerator in this embodiment. FIG. 45B is a characteristic chart showing a change in vitamin C quantity in the refrigerator in this embodiment, as compared with a conventional example. FIG. 45C is a characteristic chart showing agricultural chemical removal performance of the electrostatic atomization apparatus in the refrigerator in this embodiment. FIG. 45D is a characteristic chart showing microbial elimination performance of the electrostatic atomization apparatus in the refrigerator in this embodiment.

In FIGS. 40, 41, and 42, a refrigerator 901 is thermally insulated by a main body (heat-insulating main body) 902, partitions 903a, 903b, and 903c for creating sections for storage compartments, and doors 904 for making these sections closed spaces. A refrigerator compartment 905, a switch compartment 906, a vegetable compartment 907, and a freezer compartment 908 are arranged from above as storage compartments, forming storage spaces of different temperatures. Of these storage compartments, the vegetable compartment 907 is cooled at 4° C. to 6° C. with a humidity of about 80% RH or more (when storing foods), when there is no opening/closing operation of the door 904.

A refrigeration cycle for cooling the refrigerator 901 is made by sequentially connecting, by piping, a compressor 911, a condenser, a pressure reduction device (not shown) such as an expansion valve and a capillary tube, and an evaporator 912 in a loop so that a refrigerant is circulated.

There is also an air path 913 for conveying low temperature air generated by the evaporator 912 to each storage compartment space or collecting the air heat-exchanged in the storage compartment space to the evaporator 912. The air path 913 is thermally insulated from each storage compartment by a partition 914.

Moreover, an electrostatic atomization apparatus 915 which is a second spray unit as a mist spray apparatus, a water connection unit 916 for supplying water to the spray unit, and an irradiation unit 917 for controlling stomata of vegetables are formed in the vegetable compartment 907.

The electrostatic atomization apparatus 915 includes an atomization tank 918 for holding water from the water collection unit 916, a tip 919 in a nozzle form for spraying to the vegetable compartment 907, and an application electrode 920 disposed at a position near the tip that is in contact with water. A counter electrode 921 is disposed near an opening of the atomization tip 919 so as to maintain a constant distance, and a holding member 922 is disposed to hold the counter electrode 921. A negative pole of a voltage application unit 935 generating a high voltage is electrically connected to the application electrode 920, and a positive pole of the voltage application unit 935 is electrically connected to the counter electrode 921. The electrostatic atomization apparatus 915 is attached to a water collection cover 928 or the partition 914 by an attachment member connection part 923.

Water droplets of a liquid supplied and adhering to the nozzle tip 919 are finely divided by electrostatic energy of a high voltage applied between the application electrode 920 and the counter electrode 921. Since the liquid droplets are electrically charged, the liquid droplets are further atomized into particles of several nm to several μm by Rayleigh fission, and sprayed into the vegetable compartment 907.

The water collection unit 916 is installed at the bottom of the partition 903b and in an upper part of the vegetable compartment 907. A cooling plate 925 is made of a high heat conductive metal such as aluminum or stainless steel or a resin, and a heating unit 926 such as a PTC heater, a sheet heating element, or a heater formed of, for example, a nichrome wire is brought into contact with one surface of the cooling plate 925. For adjusting the temperature of the cooling plate 925, a duty factor of the heating unit 926 is determined by a temperature detected by a cooling plate temperature detection unit 927. Thus, temperature control of the cooling plate 925 is performed. The water collection cover 928 for receiving dew condensation water generated on the cooling plate 925 is installed underneath.

The irradiation unit 917 is, for example, a blue LED 933, and applies light including blue light with a center wavelength of 470 nm. The irradiation unit 917 also includes a diffusion plate 934 for light diffusivity enhancement and component protection.

In FIG. 42, in the electrostatic atomization apparatus 915, a high voltage is applied between the application electrode 920 and the counter electrode 921 by the voltage application unit 935. A discharge current detection unit 936 detects a current value at the time of application as a signal S1, and supplies the signal to an atomization apparatus control circuit 937 which is a control unit as a signal S2. An ozone amount determination unit 938 grasps an atomization state, and the atomization apparatus control circuit 937 outputs a signal S3 to adjust the output voltage of the voltage application unit 935 and the like. The control unit also performs communication between the atomization apparatus control circuit 937 and a control circuit 939 of the main body of the refrigerator 901, and determines the operation of the irradiation unit 917.

An operation and working of the refrigerator having the above-mentioned structure are described below.

Usually, some of vegetables and fruits stored in the vegetable compartment 907 are in a rather wilted state as a result of transpiration on the way home from shopping or transpiration during storage. Their storage environment varies according to an outside air temperature variation, a door opening/closing operation, and a refrigeration cycle operation state. As the storage environment becomes more severe, transpiration is accelerated and the vegetables and fruits are more likely to wilt.

In view of this, by operating the electrostatic atomization apparatus 915, the fine mist is sprayed into the vegetable compartment 907 to quickly humidify the inside of the storage compartment.

An excess water vapor in the vegetable compartment 907 builds up dew condensation on the cooling plate 925. Water droplets adhering to the cooling plate 925 grow and drop on the water collection cover 928 under its own weight, flow on the water collection cover 928, and are retained in the atomization tank 918 of the electrostatic atomization apparatus 915. The dew condensation water is then atomized from the tip 919 of the electrostatic atomization apparatus 915, and sprayed into the vegetable compartment 907.

At this time, the voltage application unit 935 applies a high voltage (for example, 10 kV) between the application electrode 920 near the tip 919 of the electrostatic atomization apparatus 915 and the counter electrode 921, where the application electrode 920 is on a negative voltage side and the counter electrode 921 is on a positive voltage side. This causes corona discharge to occur between the electrodes that are apart from each other by, for example, 15 mm. As a result, atomization occurs from the tip of the nozzle near the application electrode 920, and a nano-level fine mist carrying an invisible charge of about 1 μm or less, accompanied by ozone, OH radicals, and so on, is generated. The voltage applied between the electrodes is an extremely high voltage of 10 kV. However, a discharge current value at this time is at a μA level, and therefore an input is extremely low, about 1 W to 3 W. Nevertheless, the generated fine mist is about 1 g/h, so that the vegetable compartment 907 can be sufficiently atomized and humidified.

When the discharge current value is inputted in the discharge current detection unit 936 as the signal S1, the discharge current detection unit 936 converts the current value to the digital or analog voltage signal S2 that can be easily operated in a CPU and the like, and outputs the signal to the ozone amount determination unit 938. Following this, the ozone amount determination unit 938 converts the discharge current value to an ozone concentration (it has been experimentally found that a discharge current and ozone generation are directly proportional), and outputs the control signal S3 to the voltage application unit 935 so that the ozone concentration is limited to not more than a predetermined ozone generation concentration). Lastly, the voltage application unit 935 changes the voltage value to be applied, and generates the high voltage. Subsequently, feedback control is performed while monitoring the discharge current value.

As shown in FIG. 43, the mist sprayed from the nozzle tip 919 has two peaks at about several tens of nm and several μm. The nano-level fine mist adhering to the vegetable surfaces contains a large amount of OH radicals and the like. Such a nano-level fine mist is effective in sterilization, antimicrobial activity, microbial elimination, and so on, and also stimulates increases in nutrient of the vegetables such as vitamin C through agricultural chemical removal and antioxidation by oxidative decomposition. Moreover, though not containing a large amount of radicals, a micro-level fine mist can adhere to the vegetable surfaces and humidify around the vegetable surfaces.

During this time, though fine water droplets adhere to the vegetable surfaces, respiration is not obstructed because there are also surfaces in contact with the air, so that no water rot occurs. Accordingly, the vegetable compartment 907 becomes high in humidity, and at the same time the humidity of the vegetable surfaces and the humidity in the storage compartment 907 are brought into a condition of equilibrium. Hence, transpiration from the vegetable surfaces can be prevented. In addition, the adhering mist penetrates into tissues via intercellular spaces of the surfaces of the vegetables and fruits, as a result of which water is supplied into wilted cells to resolve the wilting by cell turgor pressure, and the vegetables and fruits return to a fresh state.

During the operation of the electrostatic atomization apparatus 915, the irradiation unit 917 is turned on and irradiates the vegetables and fruits stored in the vegetable compartment 907. The irradiation unit 917 is, for example, the blue LED 933 or a lamp covered with a material allowing only blue light to pass through, and applies light including blue light with a center wavelength of 470 nm. The blue light applied here is weak light with light photons of about 1 μmol/(m²·s).

Stomata on the epidermis surfaces of the vegetables and fruits irradiated with the weak blue light increase in stomatal aperture when compared with a normal state, due to light stimulation of the blue light. This being so, spaces in the stomata expand, apparent relative humidity in the spaces decreases, and the equilibrium condition is lost, creating a state where water can be easily absorbed. Therefore, the mist adhering to the surfaces of the vegetables and fruits penetrates into tissues from the surfaces of the vegetables and fruits in a stomata open state, as a result of which water is supplied into cells that have wilted due to moisture evaporation, and the vegetables return to a fresh state. Thus, freshness can be recovered.

As shown in FIG. 44A, when the discharge current value is high, the ozone generation amount is high. In the case of low concentration, ozone has the effects of microbial elimination and sterilization, and also increases in nutrient such as vitamin C through agricultural chemical removal and antioxidation by oxidative decomposition can be expected. In the case where the concentration exceeds 30 ppb, however, an ozone odor produces discomfort to human beings, and also ozone acts to accelerate deterioration of resin components included in the storage compartment. Therefore, the ozone concentration adjustment is important. Hence, the concentration is controlled by the discharge current value.

As shown in FIG. 44B, when the atomization amount increases, the current value increases. This causes an increase in air discharge magnitude, so that the ozone generation amount increases, too. Likewise, when there is no water near the application electrode 920, the ozone concentration increases due to an increase in air discharge magnitude. Accordingly, it is important to adjust the water amount of the atomization tank 918 and the atomization amount, as well as the ozone concentration.

FIG. 45A is a characteristic chart showing a relation between a water content recovery effect and a mist spray amount for a wilting vegetable, and a relation between a vegetable appearance sensory evaluation value and a mist spray amount. This experiment was conducted in a vegetable compartment of 70 liters, and so each spray amount mentioned below is a spray amount per 70 liters.

As shown in FIG. 45A, in the case of performing light irradiation, the vegetable water content recovery effect was 50% or more in a range of 0.05 g/h to 10 g/h (per liter=0.0007 to 0.14 g/h·l).

When the mist spray amount is excessively small, the amount of water released to outside from stomata of the vegetable cannot be exceeded, and therefore water cannot be supplied to the inside of the vegetable. In addition, a contact frequency of the mist and the stomata in an open state decreases, so that water cannot penetrate into the vegetable easily.

The experiment demonstrates that a lower limit of the spray amount is 0.05 g/h.

When the mist spray amount is excessively large, on the other hand, a water content tolerance in the vegetable is exceeded, and water which cannot be taken in the vegetable will end up adhering to the outside of the vegetable. Such water causes water rot from a part of the vegetable surface, thereby damaging the vegetable.

A range of 10 g/h or more induced such a phenomenon where excess water adheres to the vegetable surface and causes quality deterioration of the vegetable such as water rot, which is unsuitable as the experiment. Accordingly, experimental results of 10 g/h (per liter: 0.15 g/h·l) or more are omitted because they cannot be adopted due to vegetable quality deterioration.

In the case of performing light irradiation, the vegetable water content recovery effect was 70% or more in a range of 0.1 g/h to 10 g/h (per liter=0.0015 to 0.14 g/h·l). When the lower limit of the mist spray amount is increased to about 0.1 g/h in this way, the contact frequency with the stomata in an open state becomes sufficiently high, as a result of which the mist actively penetrates into the vegetable.

In the case of not performing light irradiation, there is no range where the vegetable water content recovery effect was 50% or more, and the water content recovery rate is below 10% in every spray amount. This indicates that, in the case of not performing light irradiation, the stomata are not sufficiently open, and therefore water cannot penetrate into the vegetable unless it has a sufficiently small particle diameter.

FIG. 45B is a characteristic chart showing a change in vitamin C quantity when the fine mist according to the present invention is sprayed, where a vitamin C concentration upon storage start is set to 100. This experiment observed a change in vitamin C quantity of broccoli when an average amount of vegetables (about 6 kg, 15 kinds of vegetables) were stored in a vegetable compartment of 70 liters for three days and then a fine mist of about 0.5 g/h was sprayed, as compared with an existing refrigerator.

Typically, a decrease in vitamin C quantity can be suppressed by high humidity and low temperature in an environment of a vegetable compartment of a refrigerator, but the vitamin C quantity decreases in proportion to the number of days elapsed. To maintain or increase the vitamin C quantity, there is a method of stimulating vitamin C production by performing photosynthesis inside vegetables. There is also a method of increasing the vitamin C quantity using an antioxidative effect which is one of the defense reactions of vegetables, by providing a stimulus such as a small amount of oxidizer or a small amount of light.

In the former method, a large amount of water and a high light intensity equivalent to sunlight are necessary in order to perform photosynthesis. Such a method cannot be implemented in refrigerators. Even if the method can be implemented, the method is unsuitable for refrigerators for the following reason. Since photosynthesis accelerates growth, harvested vegetables are accelerated in aging, though there is no such problem with pre-harvest vegetables which are still in a growing stage.

Therefore, the latter method is suitable in order to maintain or increase the vitamin C quantity in refrigerators.

In view of this, in the present invention, vegetables are stimulated by OH radicals or low concentration ozone generated in electrostatic atomization, thereby increasing the vitamin C quantity.

As shown in FIG. 45B, while the vitamin C quantity decreased by about 6% after three days from the storage start in a conventional product, the vitamin C concentration of broccoli increased by about 4% after three days in a present invention product. From this, it can be understood that the stimulation of OH radicals or ozone enables the vegetable to increase in vitamin C quantity.

FIG. 45C is a characteristic chart showing a relation between an agricultural chemical removal effect and a mist spray amount when a fine mist is sprayed. In this experiment, the fine mist according to the present invention was sprayed over 10 grape tomatoes to which malathion of about 3 ppm is attached, in about 0.5 g/h for 12 hours, thereby performing a removal process. A remaining malathion concentration after the process was measured by gas chromatography (GC) to calculate a removal rate.

As is clear from FIG. 45C, a spray amount of 0.0007 g/h·L or more is needed to achieve a malathion removal rate of about 50%, and the agricultural chemical removal effect increases with the spray amount.

When the spray amount exceeds 0.07 g/h·L, though the agricultural chemical removal effect can be attained, the generated ozone concentration exceeds 0.03 ppm, making it difficult to apply to household refrigerators in terms of human safety. Note that the ozone concentration of 0.03 ppm does not have a significant ozone odor, and is an upper limit of the ozone concentration that achieves the agricultural chemical decomposition effect without causing any adverse effect such as tissue damage on vegetables. Hence, a proper spray amount range is 0.0007 g/h·L to 0.07 g/h·L.

FIG. 45D is a characteristic chart showing a microbial elimination effect when a fine mist is sprayed. In this experiment, a Petri dish where Escherichia coli of a predetermined initial organism number was cultured was placed in a container of 70 L at 5° C. in advance, the fine mist according to the present invention was sprayed in 1 g/h, and a change in reduction rate of the Escherichia coli number was measured over time.

A result when a mist of the same amount was sprayed by an ultrasonic atomization apparatus is shown as a comparison.

As is clear from the drawing, the present invention exhibits a higher microbial elimination rate, achieving 99.8% elimination after seven days. This can be attributed to the microbial elimination effect by ozone contained in the mist.

In this way, vegetables, containers, and the like can be kept clean.

As described above, in the twenty-sixth embodiment, the electrostatic atomization apparatus (spray unit) 915 for generating a mist of a micro-size particle diameter and a mist of a nano-size particle diameter which differ in particle diameter and the water supply unit (water collection unit 916) for supplying a liquid to the electrostatic atomization apparatus (spray unit) 915 are provided in the storage compartment (vegetable compartment 907). The electrostatic atomization apparatus (spray unit) 915 includes the application electrode 920 for applying a voltage to the liquid, the counter electrode 921 positioned facing the application electrode 920, and the voltage application unit 935 for applying a high voltage between the application electrode 920 and the counter electrode 921 as the voltage. Thus, the micro-size particle diameter mist and the nano-size particle diameter mist can be generated simultaneously. The micro-size mist makes it possible to ensure a spray amount necessary for food freshness preservation. Moreover, the nano-size mist allows for uniform spray in the storage compartment, and enters into even small depressions and projections in the foods and the storage compartment to thereby achieve microbial elimination and agricultural chemical removal.

In the twenty-sixth embodiment, the maintenance and increase in vitamin C quantity by an antioxidative effect of vegetables can be accomplished by ozone or radicals generated by electrostatic atomization.

Moreover, by specifying the ozone generation amount at the nozzle tip 919 as the atomization unit using the current value and controlling the current value, the ozone generation amount can be optimized, with it being possible to achieve stabilization of the atomization amount sprayed in the storage compartment (vegetable compartment 907), improved vegetable freshness preservation, microbial elimination of the storage compartment (vegetable compartment 907) and vegetables, decomposition of agricultural chemicals on vegetable surfaces, and increases of nutrients such as vitamin C. Besides, no other detection unit is used, which contributes to a smaller size and a lower cost.

In the twenty-sixth embodiment, when the current value detected by the discharge current detection unit 936 exceeds the predetermined first value, the voltage applied between the application electrode 920 and the counter electrode 921 is forcibly decreased. This enables the ozone generation amount to be reduced, thereby enhancing safety.

In the twenty-sixth embodiment, dew condensation water is used. Since minerals present in tap water and the like are hardly contained in dew condensation water, there is no factor that can cause clogging of the nozzle tip 919, which contributes to improved lifetime reliability.

### Twenty-Seventh Embodiment

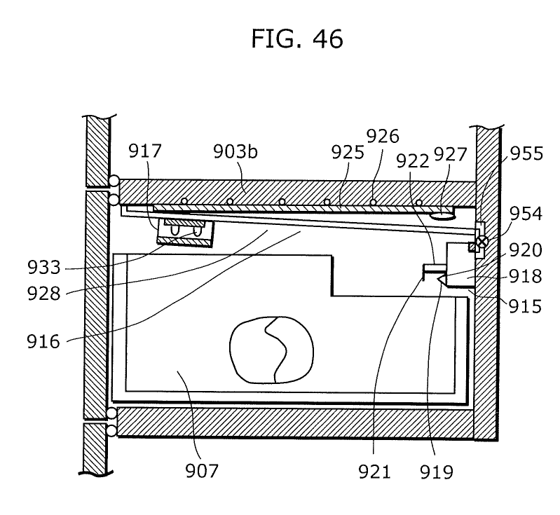

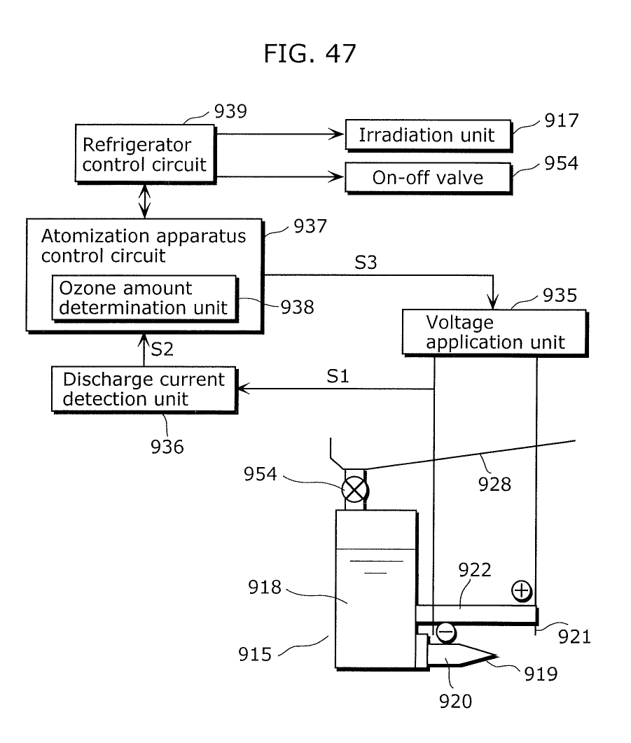

FIG. 46 is a relevant part enlarged sectional view of a vegetable compartment in a refrigerator in a twenty-seventh embodiment of the present invention which is cut into left and right. FIG. 47 is a block diagram showing a control structure related to an electrostatic atomization apparatus in the refrigerator in this embodiment.

In FIG. 46, the electrostatic atomization apparatus 915 as the mist spray apparatus includes the atomization tank 918. The atomization tank 918 and the water collection cover 928 which is a part of the water collection unit 916 are connected by a pipe-like flow path 955 made of a resin or the like, via an on-off valve 954 such as an electromagnetic valve for adjusting the amount of water sent to the atomization tank 918.

In FIG. 47, a high voltage is applied between the application electrode 920 and the counter electrode 921 by the voltage application unit 935. The discharge current detection unit 936 detects a current value at the time of application as the signal 51, and supplies the signal to the atomization apparatus control circuit 937 as the control unit as the signal S2. The ozone amount determination unit 938 grasps an ozone generation amount, and the atomization apparatus control circuit 937 outputs the signal S3 to adjust the output voltage of the voltage application unit 935 and the like. The control unit also performs communication between the atomization apparatus control circuit 937 and the control circuit 939 of the main body of the refrigerator 901, and determines the operations of the irradiation unit 917 and the on-off valve 954.

An operation and working of the refrigerator having the above-mentioned structure are described below.

Water droplets collected by the water collection cover 928 grow gradually, and flow along an inner surface of the water collection cover 928 into the flow path 955. When the on-off valve 954 is open, the water retained in the water collection cover 928 flows into the atomization tank 918. By applying a high voltage between the application electrode 920 near the nozzle tip 919 as the atomization unit and the counter electrode 921, the water droplets are divided into fine particles. Since the water droplets are electrically charged, the water droplets are divided into finer particles by Rayleigh fission, and a fine mist having extremely small nano-level particles is sprayed into the vegetable compartment 907. Here, the amount of water can be adjusted by an opening/closing time interval of the on-off valve 954. Since the water supply amount can be adjusted in this manner, the ozone generation amount can be adjusted.

Green leafy vegetables, fruits, and the like stored in the vegetable compartment 907 tend to wilt more by transpiration. Usually, some of vegetables and fruits stored in the vegetable compartment 907 are in a rather wilted state as a result of transpiration on the way home from shopping or transpiration during storage. The vegetable surfaces are moistened by the atomized fine mist.

The sprayed fine mist increases the humidity of the vegetable compartment 907 again and simultaneously adheres to the surfaces of the vegetables and fruits in a stomata open state in the vegetable compartment 907. The fine mist penetrates into tissues via stomata, as a result of which water is supplied into cells that have wilted due to moisture evaporation to resolve the wilting by cell turgor pressure, and the vegetables and fruits return to a fresh state. In particular, the fine mist is negatively charged by electrostatic atomization whilst the vegetables are usually positively charged, so that the fine mist tends to adhere to the surfaces. Moreover, since the nano-level particles are also present, water can be absorbed even from intercellular spaces. Since the particles are 1 μm or less, they are extremely lightweight and exhibit enhanced diffusivity. Accordingly, the fine mist spreads throughout the vegetable compartment, thereby improving freshness preservation. In addition, quality can be maintained because the fine mist is inconspicuous even when adhering to containers.

The stomata of the vegetables irradiated with the weak blue light by the irradiation unit 917 increase in stomatal aperture when compared with a normal state, due to light stimulation of the blue light. Therefore, the fine mist adhering to the surfaces of the vegetables and fruits penetrates into tissues from the surfaces of the vegetables and fruits in a stomata open state, as a result of which water is supplied into cells that have wilted due to moisture evaporation, and the vegetables and fruits return to a fresh state. Thus, freshness can be recovered.

As described above, in the twenty-seventh embodiment, the electrostatic atomization apparatus (mist spray apparatus) 915 for generating a mist of a micro-size particle diameter and a mist of a nano-size particle diameter which differ in particle diameter, the water supply unit (water collection unit 916) for supplying a liquid to the electrostatic atomization apparatus (mist spray apparatus) 915, and the on-off valve 954 for adjusting the amount of water sent by the water supply unit (water collection unit 916) are provided in the storage compartment (vegetable compartment 907). The electrostatic atomization apparatus (mist spray apparatus) 915 includes the application electrode 920 for applying a voltage to the liquid, the counter electrode 921 positioned facing the application electrode 920, the voltage application unit 935 for applying a high voltage between the application electrode 920 and the counter electrode 921, the discharge current detection unit 936 for detecting a current when the voltage application unit 935 applies the high voltage, the atomization apparatus control circuit 937 for controlling these components, and the ozone amount determination unit 938 for determining an ozone generation amount from the current value detected by the discharge current detection unit 936. Thus, the ozone generation amount can be controlled by grasping the ozone generation amount on the basis of the current value and optimizing the water amount by the on-off valve 954. As a result, improved vegetable freshness preservation, improved antimicrobial performance, increases of nutrients such as vitamin C, and prevention of water rot caused by dew condensation in the vegetable compartment can be achieved.

In the twenty-seventh embodiment, the micro-size particle diameter mist and the nano-size particle diameter mist can be generated simultaneously by one device. The micro-size mist makes it possible to ensure a spray amount necessary for food freshness preservation. Moreover, the ionized nano-size particle diameter mist allows for uniform spray in the storage compartment, and enters into even small depressions and projections in the foods and the storage compartment to thereby achieve microbial elimination and agricultural chemical removal.

In the twenty-seventh embodiment, the maintenance and increase in vitamin C quantity by an antioxidative effect of vegetables can be accomplished by ozone or radicals generated by electrostatic atomization.

In the twenty-seventh embodiment, the mist is extremely fine with a particle diameter of 1 μm or less, exhibiting enhanced diffusivity. This reduces dew condensation in the vegetable compartment, and also leads to a cost reduction by reducing the number of members.

Though a spray direction of the electrostatic atomization apparatus (spray unit) 915 is a horizontal direction in the twenty-seventh embodiment, the electrostatic atomization apparatus (spray unit) 915 may be directed downward. In such a case, the fine mist is sprayed from above, enabling the fine mist to be diffused uniformly. Since the fine mist can be sprayed throughout the storage space, the storage space can be cooled by latent heat of the mist (water). Accordingly, a cooler capacity for a refrigeration temperature zone can be reduced, with it being possible to achieve a smaller size and a lower cost.

### Twenty-Eighth Embodiment

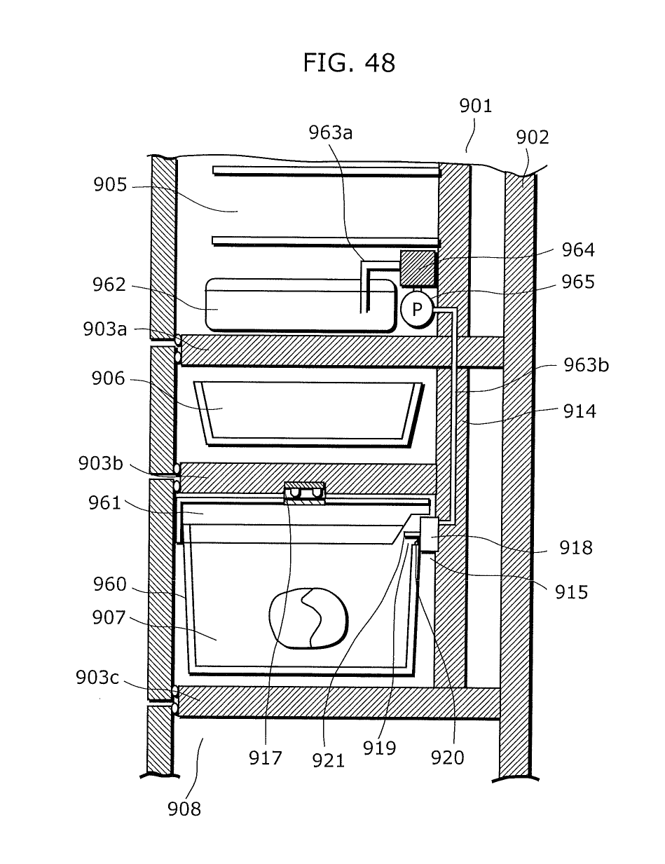

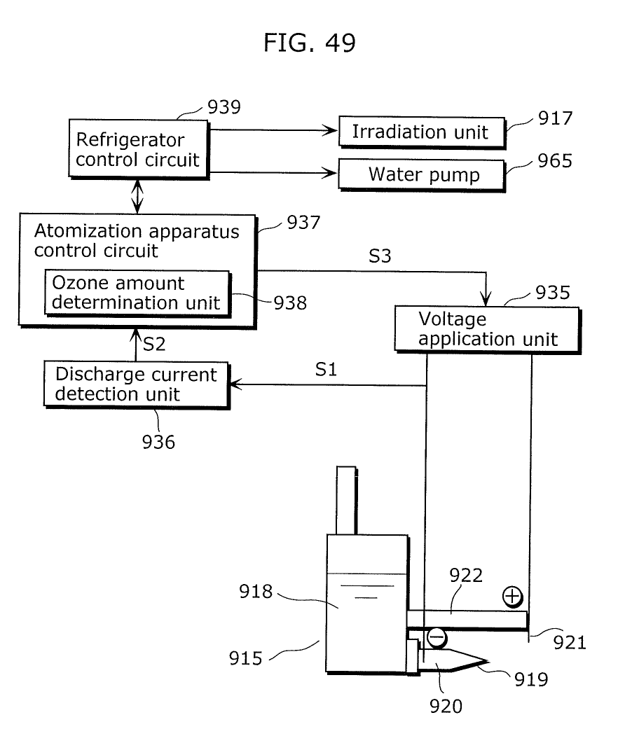

FIG. 48 is a relevant part enlarged sectional view of a portion from a periphery of a water supply tank in a refrigerator compartment to a vegetable compartment in a refrigerator in a twenty-eighth embodiment of the present invention which is cut into left and right. FIG. 49 is a block diagram showing a control structure related to an electrostatic atomization apparatus in the refrigerator in this embodiment.

In FIGS. 48 and 49, in the vegetable compartment 907, foods such as vegetables and fruits are stored in a vegetable case 960, and a lid 961 for maintaining a storage compartment humidity to suppress transpiration from the foods stored in the vegetable case 960 is provided above the vegetable case 960. The nozzle tip 919 as the atomization unit of the electrostatic atomization apparatus 915 as the spray unit which is the mist spray apparatus is disposed in a gap between the vegetable case 960 and the lid 961 so as to be directed into the storage compartment.

The irradiation unit 917 is attached to the partition 903b. A part of the lid 961 is cut away or made of a transparent material so that the foods in the case can be irradiated.

A water supply tank 962 is formed in the refrigerator compartment 905 to supply water to the electrostatic atomization apparatus 915. The water supply tank 962 and the atomization tank 918 included in the electrostatic atomization apparatus 915 are connected via a filter 964 and a water pump 965 that uses any of a stepping motor, a gear, a tube, a piezoelectric element, and the like, by a flow path 963a and a narrow flow path 963b with the water pump 965 therebetween. Water is supplied to the nozzle tip 919 through the narrow flow path 963b and the atomization tank, with a part of the narrow flow path 963b being buried in the partitions 903a, 903b, and 914 or the refrigerator main body 902.

The electrostatic atomization apparatus 915 detects a discharge current value at the application electrode 920 by the discharge current detection unit 936, and transmits an output of the ozone amount determination unit 938 in the atomization apparatus control circuit 937 to the refrigerator control circuit 939 of the refrigerator main body, thereby determining the operations of the water pump 965 and the irradiation unit 917. Note that the atomization apparatus control circuit 937 and the refrigerator control circuit 939 may be implemented on the same board.

An operation and working of the refrigerator having the above-mentioned structure are described below.

The operation of the water pump 965 determines whether or not water stored in the water supply tank 962 is supplied to the electrostatic atomization apparatus 915 from the flow path 963. When the water pump 965 is on, water supplied by a user beforehand flows toward the electrostatic atomization apparatus 915. Here, impurities such as dirt and foreign substances are removed from the water flowing through the flow path, by the filter 964 installed in advance. Moreover, since the narrow flow path 963b is sealed, dust and bacteria invasion can be prevented while suppressing clogging of the nozzle tip 919 of the electrostatic atomization apparatus 915. Thus, hygiene can be ensured.

The narrow flow path 963b is buried in a heat insulator such as the partition 914, and prevents freezing of water flowing therein. Though not shown, a temperature compensation heater may be placed around the flow path in close contact with the flow path. Water is supplied from the flow path 963b to the atomization tank 918 in the electrostatic atomization apparatus 915. By applying a high voltage between the application electrode 920 near the nozzle tip 919 as the atomization unit and the counter electrode 921, the water droplets are divided into fine particles. Since the water droplets are electrically charged, the water droplets are divided into finer particles by Rayleigh fission, and a fine mist having extremely small nano-level particles is sprayed into the vegetable compartment 907.

Here, by making the narrow flow path 963b narrower than the flow path 963a, it is possible to easily control a small amount of water and thereby improve spray amount accuracy in the vegetable compartment 907. Moreover, by using the water pump 965, the number of steps, the number of motor revolutions, and the like can be adjusted easily. For example, the amount of water to be conveyed can be controlled using a voltage applied to the water pump 965. This contributes to improved spray amount accuracy in the vegetable compartment 907, with it being possible to control the ozone generation amount.

As described above, in the twenty-eighth embodiment, by using the water pump 965 as the water supply unit, the amount of water can be adjusted easily. In addition, since water can be piped up, the water source such as the water supply tank 962 can be disposed at a lower position than the electrostatic atomization apparatus 915. This increases design flexibility.

In the twenty-eighth embodiment, a flow path cross-sectional area from the water pump 965 to the atomization tank 918 is smaller than a flow path cross-sectional area from the water supply tank 962 to the water pump 965. Hence, it is possible to easily control a small amount of water and thereby improve spray amount accuracy in the vegetable compartment 907. Moreover, by using the water pump 965, the number of steps, the number of motor revolutions, and the like can be adjusted easily. For example, the amount of water to be conveyed can be controlled using a voltage applied to the water pump 965. This contributes to improved spray amount accuracy in the vegetable compartment 907.

In the twenty-eighth embodiment, the use of the water pump 965 allows for adjustment in very small amount, by linearly varying the water conveyance amount by the number of revolutions and the like. Hence, accurate spray amount adjustment can be achieved.

In the twenty-eighth embodiment, the water supply tank 962 can be placed outside the vegetable compartment 907. This ensures the capacity of the vegetable compartment 907, allowing for sufficient food storage.

In the twenty-eighth embodiment, the water supply tank 962 is disposed in the refrigerator compartment 905, with there being no risk of freezing and no need for a temperature compensation heater. Since the water supply tank 962 can also be used as an ice freezing tank, there is no decrease in storage capacity of the refrigerator.

Furthermore, in the twenty-eighth embodiment, by providing the nozzle tip 919 above the counter electrode 921, the mist is attracted upward and so the spray distance is extended. Moreover, the mist can be sprayed while avoiding foods near the nozzle tip 919.

Though the counter electrode 921 accompanies the electrostatic atomization apparatus 915 in the twenty-eighth embodiment, the counter electrode 921 may be provided in a part of the lid at the top or a part of the container. In such a case, an unwanted protrusion can be eliminated, resulting in an increase in storage capacity.

### Twenty-Ninth Embodiment

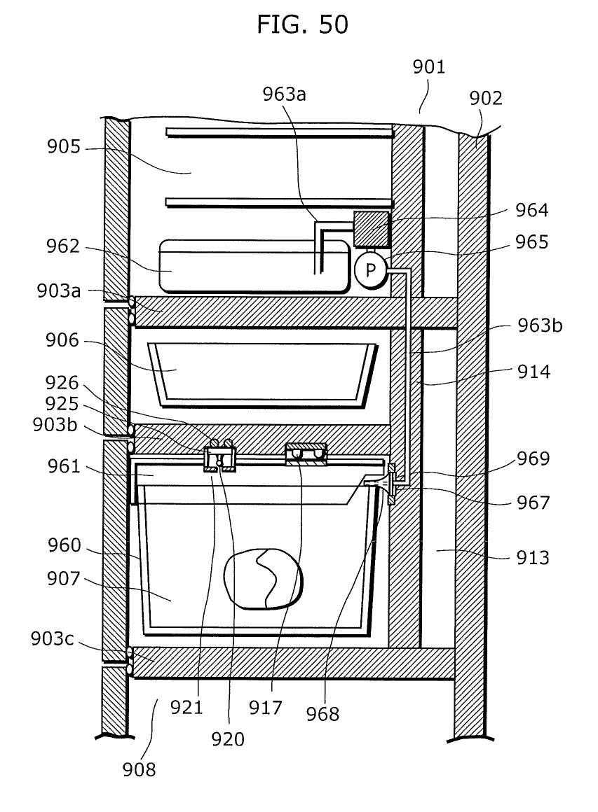

FIG. 50 is a relevant part enlarged sectional view of a portion from a periphery of a water supply tank in a refrigerator compartment to a vegetable compartment in a refrigerator in a twenty-ninth embodiment of the present invention which is cut into left and right.

In FIG. 50, in the vegetable compartment 907, foods such as vegetables and fruits are stored in the vegetable case 960, and the lid 961 for maintaining a storage compartment humidity to suppress transpiration from the foods stored in the vegetable case 960 is provided above the vegetable case 960. A horn-type ultrasonic atomization apparatus 967 as a first spray unit which is a mist spray apparatus is disposed in a gap between the vegetable case 960 and the lid 961, and pores 968c are approximately linearly formed from a bottom 968a toward a tip 968b of a horn 968 in the ultrasonic atomization apparatus 967.

The water supply tank 962 is formed in the refrigerator compartment 905 to supply water to the ultrasonic atomization apparatus 967. Water is supplied to the horn tip 968b via the water pump 965 connecting the water supply tank 962 and the ultrasonic atomization apparatus 967. The horn tip 968b as an atomization unit is directed toward the storage compartment.

The horn 968 is made of a high heat conductive material. Examples of the material include metals such as aluminum, titanium, and stainless steel. In particular, a material having aluminum as a main component is preferable in terms of light weight, high heat conduction, and amplitude amplification performance during ultrasonic propagation. For longer service life, on the other hand, a material having stainless steel as a main component is desirable.

An ultrasonic vibration amplitude is set so that an amplitude node is formed at a flange (not shown) and an amplitude loop is formed at the tip of the horn 968, with vibration being performed at a quarter wavelength between the flange (not shown) and the horn 968. A length of the horn 968 is determined on the basis of an atomization particle diameter of a generated mist, an oscillation frequency of a piezoelectric element 969, and a material of the horn 968. For example, in the case where the atomization particle diameter is about 10 μm, a length B of the horn 968 is about 6 mm when the material of the horn 968 is aluminum and the oscillation frequency of the piezoelectric element 969 is about 270 kHz. In the case where the atomization particle diameter is about 15 μm, the length B of the horn 968 is about 11 mm when the material of the horn 968 is aluminum and the oscillation frequency of the piezoelectric element 969 is about 146 kHz. These theoretical calculation values are summarized in Table 1.

TABLE 1

| | Atomization | | |
|---|---|---|---|
| | particle | Oscillation | Horn length |
| Material | diameter (μm) | frequency (kHz) | (mm) |
| Aluminum | 8.0 | 375 | 4.2 |
| | 10.0 | 270 | 5.8 |
| | 12.0 | 205 | 7.7 |
| | 15.0 | 146 | 10.8 |
| | 21.5 | 85 | 18.6 |
| Stainless steel | 8.0 | 375 | 3.3 |
| | 10.0 | 270 | 4.6 |
| | 12.0 | 205 | 6.0 |
| | 15.0 | 146 | 8.4 |
| | 21.5 | 85 | 12.3 |

The filter 964 and the water pump 965 that uses any of a stepping motor, a gear, a tube, a piezoelectric element, and the like are installed in a path between the water supply tank 962 and the ultrasonic atomization apparatus 967, and the flow path 963a and the narrow flow path 963b are formed with the water pump 965 therebetween. Water is supplied to the horn tip 968b through the narrow flow path 963b and the pores formed in the horn unit 968, with a part of the narrow flow path 963b being buried in the partition 914 or the refrigerator main body 902.

Water droplets adhere to the horn tip 968b, and a mist is generated from this adhering water and sprayed into the vegetable compartment 907. The sprayed fine mist increases the humidity of the vegetable compartment 907 and simultaneously adheres to the surfaces of the vegetables and fruits in a stomata open state in the vegetable compartment 907. The fine mist penetrates into tissues via stomata, as a result of which water is supplied into cells that have wilted due to moisture evaporation to resolve the wilting by cell turgor pressure, and the vegetables and fruits return to a fresh state.

The irradiation unit 917 for irradiating the foods constantly or irradiating the foods at least during ultrasonic mist spray and the electrostatic atomization apparatus 915 as a second spray unit which is a mist spray apparatus are attached to the partition 903b. A part of the lid 961 is cut away or made of a transparent material so that the irradiation unit 917 can irradiate the inside of the case. In addition, a part of the lid 961 is cut away so that the electrostatic atomization apparatus 915 can spray a mist over the foods in the case.

The electrostatic atomization apparatus 915 includes the cooling plate 925 on the back of which the heating unit 926 is disposed, the needle-like application electrode 920 having a spherical tip, and the counter electrode 921 located below the application electrode.

An operation and working of the refrigerator having the above-mentioned structure are described below.

The operation of the water pump 965 determines whether or not water stored in the water supply tank 962 is supplied to the ultrasonic atomization apparatus 967 from the flow path 963. When the water pump 965 is on, water supplied by a user beforehand flows toward the ultrasonic atomization apparatus 967. Here, impurities such as dirt and foreign substances are removed from the water flowing through the flow path, by the filter 964 installed in advance. Moreover, since the narrow flow path 963b is sealed, dust and bacteria invasion can be prevented while suppressing clogging of the horn tip 968b of the ultrasonic atomization apparatus 967. Thus, hygiene can be ensured. The narrow flow path 963b is buried in a heat insulator such as the partition 914, and prevents freezing of water flowing therein. Though not shown, a temperature compensation heater may be placed around the flow path in close contact with the flow path. Water is supplied from the flow path 963b to the horn 968 in the ultrasonic atomization apparatus 967, and a micro-size mist made up of fine particles is sprayed into the vegetable compartment 907 from the horn tip 968b as the atomization unit.

Here, by making the narrow flow path 963b narrower than the flow path 963a, it is possible to easily control a small amount of water and thereby improve spray amount accuracy in the vegetable compartment. Moreover, by using the water pump 965, the number of steps, the number of motor revolutions, and the like can be adjusted easily. For example, the amount of water to be conveyed can be controlled using a voltage applied to the water pump. This contributes to improved spray amount accuracy in the vegetable compartment.

Meanwhile, water of a mist sprayed from the electrostatic atomization apparatus 915 is collected in the following manner. Typically, in the refrigerator 901, cool air heat-exchanged by an evaporator is allocated to the refrigerator compartment 905, the switch compartment 906, the vegetable compartment 907, a freezer compartment (not shown), an ice compartment (not shown), and the like by a stirring fan (not shown) or the like, and an on/off operation is performed to maintain a predetermined temperature. The vegetable compartment 907 is adjusted to 4° C. to 6° C. by cool air allocation and an on/off operation of the heating unit and the like, and usually does not have an inside temperature detection unit. The vegetable compartment 907 is also high in humidity, due to moisture evaporation from foods, water vapor entry caused by door opening/closing, and so on. Since a certain level of cooling capacity is necessary, the compartment partition 903b is thinner in this part than other parts. When the surface temperature of the cooling plate 925 drops to the dew point or below, a water vapor near the cooling plate 925 builds up dew condensation on the cooling plate 925, thereby reliably generating water droplets. In detail, the surface temperature is grasped by a temperature detection unit (not shown) installed on the cooling plate 925, and on/off control or duty factor control is exercised on the heating unit 926 by the control unit, thereby adjusting the surface temperature of the cooling plate 925 to the dew point or below and causing water contained in high humidity air in the storage compartment to build up dew condensation on the cooling plate 925.

The water droplets forming dew condensation on the surface of the cooling plate 925 gradually grow, flow downward under its own weight without using power of a pump or the like, and gather at the tip of the application electrode 920 in the electrostatic atomization apparatus 915. By applying a high voltage between the application electrode 920 and the counter electrode 921, the gathered dew condensation water becomes an ionized nano-size mist, which is sprayed into the vegetable compartment 907 together with a small amount of ozone generated at the same time.

Here, by applying a negative charge to the application electrode 920, the mist scatters toward positively charged vegetables and the wall surfaces of the storage compartment, and uniformly adheres to the vegetables and the inside of the storage compartment.

Thus, the micro-size mist sprayed form the ultrasonic atomization apparatus 967 increases the humidity of the vegetable compartment 907 again and simultaneously adheres to the surfaces of the vegetables and fruits in a stomata open state in the vegetable compartment 907. The fine mist penetrates into tissues via stomata, as a result of which water is supplied into cells that have wilted due to moisture evaporation to resolve the wilting by cell turgor pressure, and the vegetables and fruits return to a fresh state. The atomization particle diameter is preferably 4 μm to 20 μm. Since an average size of stomata of typical vegetables is about 15 μm, a mist of a particle diameter equal to or less than 15 μm is more preferable in order to restore wilting vegetables.

On the other hand, the nano-size mist sprayed from the electrostatic atomization apparatus 915 contains radicals and ozone generated simultaneously with the mist. These radicals and ozone effect microbial elimination of the foods and the storage compartment and removal of agricultural chemicals remaining on the vegetables.

As described above, in the twenty-ninth embodiment, by disposing the horn-type ultrasonic atomization apparatus 967 and the electrostatic atomization apparatus 915 in the storage compartment (vegetable compartment 907), a micro-size mist and a nano-size mist can each be sprayed depending on the application. This allows the spray apparatus to be operated efficiently, contributing to longer life of the spray apparatus.

Moreover, by disposing the horn-type ultrasonic atomization apparatus 967 and the electrostatic atomization apparatus 915 in the storage compartment (vegetable compartment 907), the ultrasonic atomization apparatus 967 and the electrostatic atomization apparatus 915 can also be alternately operated. This prevents a situation where the nano-size mist is absorbed in the micro-size mist and as a result the effect of the nano-size mist is reduced.

In addition, since the particle diameter atomized in the ultrasonic atomization apparatus 967 is 4 μm to 20 μm, water can be forcibly supplied into the foods, with it being possible to improve water content of the foods.

Besides, the particle diameter atomized in the electrostatic atomization apparatus 915 is a nano size equal to or less than 1 μm, which exhibits enhanced diffusivity. This reduces dew condensation in the vegetable compartment 907, and also leads to a cost reduction by reducing the number of members.

Furthermore, by providing the water supply tank 962 for supplying water to the ultrasonic atomization apparatus 967, water can be supplied to the horn tip 968 efficiently and stably. Accordingly, the mist is always stably sprayed from the ultrasonic atomization apparatus 967, thereby maintaining the storage compartment (vegetable compartment 907) space at a high humidity. Moreover, by stably supplying water to the horn tip 968b, a water shortage at the horn tip 968b can be avoided. This contributes to longer life and improved reliability of the ultrasonic atomization apparatus 967.

Additionally, the ultrasonic atomization apparatus 967 has a structure of vibrating at the length between the horn tip 968b and the flange in a quarter wavelength mode. Since not a plurality of loops and a plurality of nodes but only one loop and one node are present between the tip of the horn 968 as an atomization surface and the flange formed on the horn 968 as a connection part, the horn 968 can be reduced in size, and also energy dispersion and attenuation can be reduced, with it being possible to improve efficiency. Besides, since the horn 968 can be reduced in size, there is no significant placement constraint. This benefits design flexibility, with it being possible to increase the storage space.

Moreover, by setting the length of the horn 968 to 1 mm to 20 mm, the horn 968 is made smaller. This benefits flexibility in refrigerator design, with it being possible to increase the storage space.

In addition, by providing a cover member around the ultrasonic atomization apparatus 967, the ultrasonic atomization apparatus 967 can be kept from being touched directly, so that safety can be improved.

Besides, the electrostatic atomization apparatus 915 sprays dew condensation water collected by causing water in the air in the storage compartment (vegetable compartment 907) to build up dew condensation on the cooling plate 925. Since no water storage unit is necessary, a large storage space of the vegetable compartment 907 can be maintained.

Furthermore, the dew condensation water used by the electrostatic atomization apparatus 915 is collected by causing water in the air in the storage compartment (vegetable compartment 907) that contains moisture invading in the storage compartment (vegetable compartment 907) due to vegetable transpiration or opening/closing of the door 904, to build up dew condensation on the cooling plate 925. Hence, dew condensation in the storage compartment can be suppressed.

### Thirtieth Embodiment

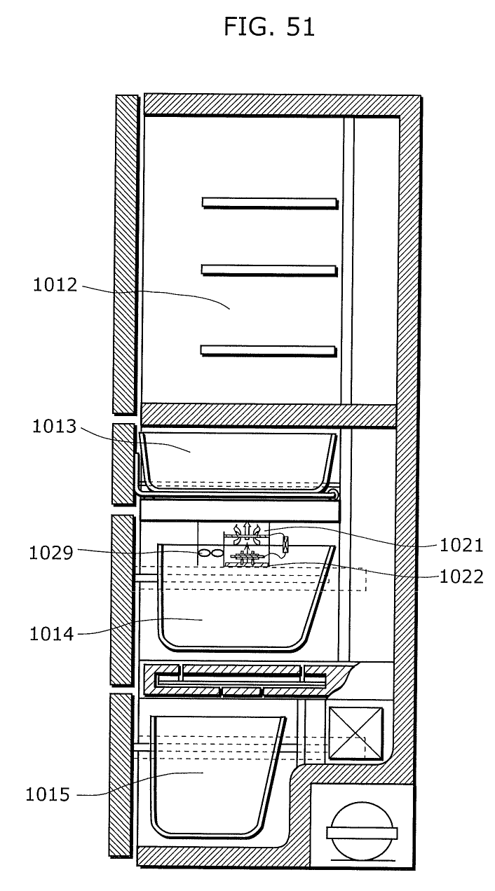

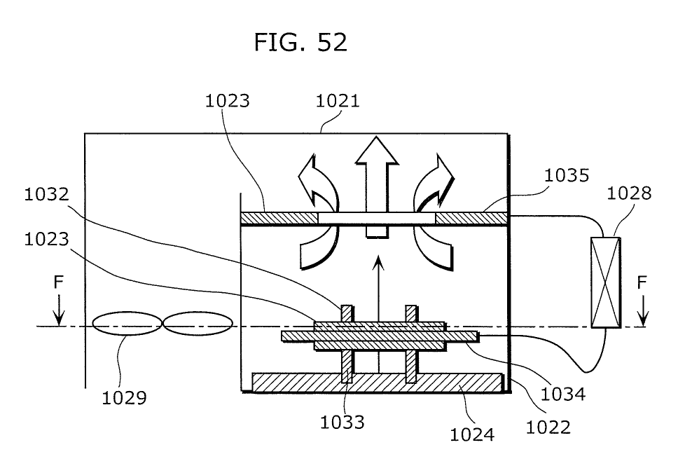

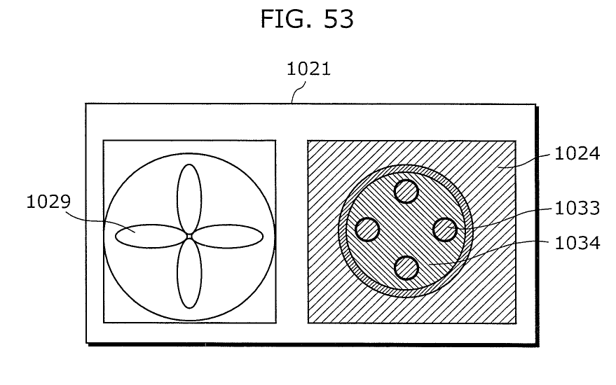

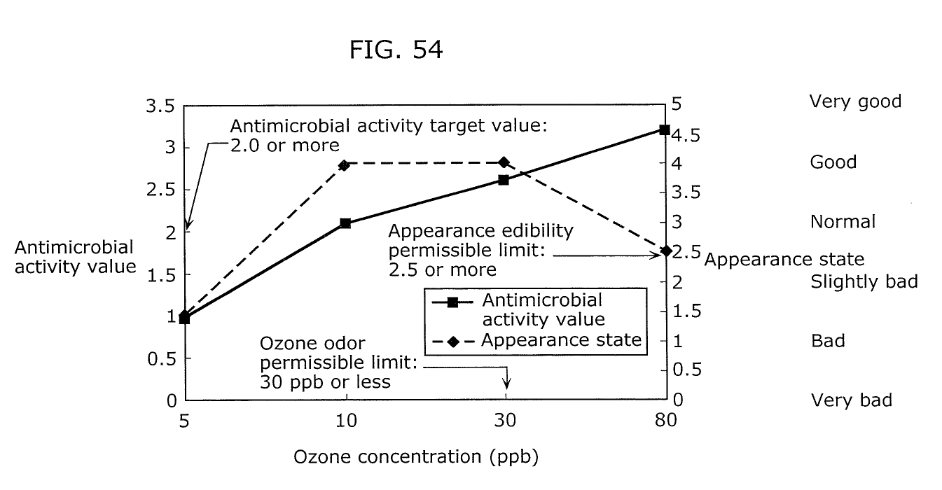

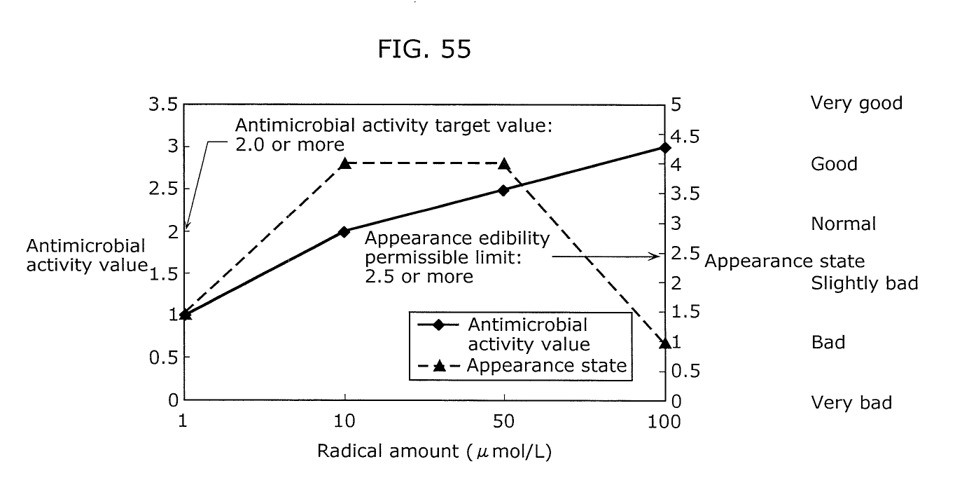

FIG. 51 is a side sectional view of a refrigerator in a thirtieth embodiment of the present invention. FIG. 52 is a side sectional view of a mist spray apparatus in the thirtieth embodiment of the present invention. FIG. 53 is a sectional view of the mist spray apparatus in the thirtieth embodiment of the present invention taken along line F-F. FIG. 54 is a chart showing vegetable preservability and an ozone concentration in the thirtieth embodiment of the present invention. FIG. 55 is a chart showing vegetable preservability and a radical amount in the thirtieth embodiment of the present invention.

In the drawings, a refrigerator 1000 is partitioned by partition plates 1016 into a refrigerator compartment 1012, a switch compartment 1013, a vegetable compartment 1014, and a freezer compartment 1015 as storage compartments from above. The vegetable compartment 1014 is cooled at 4° C. to 6° C. with a humidity of about 90% RH or more (when storing foods) by indirect cooling.

A water supply unit 1021 is provided at the top of the vegetable compartment 1014. The water supply unit 1021 is disposed at the top of the vegetable compartment 1014, and includes a water storage tank 1022 storing water, a spray unit 1023, and an air blow unit 1029 for blowing a mist generated by the spray unit 1023 into the vegetable compartment 1014.

The spray unit 1023 which is a mist spray apparatus is positioned inside the water storage tank 1022 so as to be partially immersed in water retained in the water storage tank 1022. The spray unit 1023 includes: a capillary supply structure 1033 one end of which is immersed in water retained in the water storage tank 1022 and the other end of which forms a spray tip 1032 as a spray unit in the water storage tank 1022; a cathode 1034 installed in one section of the water storage tank 1022 and applying a negative high voltage to the retained water in the water storage tank 1022; an anode 1035 positioned in one section of the water storage tank so as to face the cathode 1034; and a high voltage source 1028 applying a high voltage to the cathode 1034.

An operation and working of the mist spray apparatus in the refrigerator having the above-mentioned structure are described below.

First, water is retained in the water storage tank 1022. Defrost water is used as this retained water 1024. Next, when a negative high voltage is applied to the cathode 1034 in the water storage tank 1022, a plurality of liquid threads are extracted from the spray tip 1032 by an electric field present between the spray tip 1032 and the anode 1035, and further broken up into electrically charged liquid droplets, thereby forming a fine mist of a nano-size particle diameter, that is, a nanometer particle diameter. The fine mist is then sprayed into the storage compartment as a mist.

During electrostatic atomization, discharge occurs, as a result of which a small amount of ozone is generated simultaneously with the mist. The generated ozone immediately mixes with the mist, forming a low concentration ozone mist. The low concentration ozone mist is sprayed into the vegetable compartment 1014 by the air blow unit 1029.

The following describes proper values of the ozone concentration and the radical amount in the vegetable compartment 1014, with reference to FIGS. 54 and 55. FIG. 54 is a chart showing vegetable preservability and the ozone concentration. An antimicrobial activity value and an appearance sensory evaluation value at each ozone concentration are shown. When the ozone concentration is 10 ppb or more, a target antimicrobial activity value of 2.0 or more (the number of microorganisms is 1/100 or less with respect to a comparison) is satisfied. Moreover, when the ozone concentration is 10 ppb to 80 ppb, the vegetable appearance state is equal to more than an edibility permissible limit of 2.5. When the ozone concentration is 10 ppb or less, the decay of vegetables progresses due to the effect of bacteria grown on the vegetable surfaces, and the state deteriorates. When vegetables are stored in an ozone concentration of 80 ppb or more, on the other hand, cells of spinach, tomatoes, green onions, lettuces, and the like having high ozone sensitivity are destroyed by ozone, and quality deterioration due to damage such as leaf bleaching ensues. Therefore, an ozone concentration of 80 ppb or more is not suitable for vegetable preservation.

In terms of odor, in household refrigerators, when the ozone concentration is 30 ppb or more, an ozone odor is perceivable to human beings and produces discomfort. Hence, the ozone concentration needs to be controlled to 30 ppb or less.

In view of the above, an ozone concentration suitable for vegetable preservation is 10 ppb to 80 ppb. This range of concentration is effective in microbial growth inhibition in the vegetable compartment, without causing damage to vegetable tissues. Furthermore, in this range of concentration, it can be expected that vegetables detect a small amount of ozone as a harmful substance, and activate their biological defense reactions to promote production of antioxidants such as carotene and vitamin, thereby increasing nutrients. In household refrigerators, however, it is desirable to set the ozone concentration to 30 ppb or less so that an ozone odor does not cause discomfort to users. Hence, an appropriate ozone concentration in household refrigerators is in a range of 10 ppb to 30 ppb.

The amount of radicals generated simultaneously with ozone is controlled to be 10 μmol/L to 50 μmol/L. Like ozone, radicals in large amount are harmful to living things, but radicals in small amount activate biological defense reactions and allows for production of antioxidants such as carotene and vitamin, thereby contributing to a stronger resistance. A concentration in the range of 10 μmol/L to 50 μmol/L causes tissue destruction for microorganisms but does not adversely affect vegetables. Rather, nutrient increase by biological defense reactions can be expected.

It has been experimentally confirmed that, when the radical amount is 100 μmol/L or more, lettuces suffer cell damage and deteriorate in quality. It has also been confirmed that, for microbial suppression, an antimicrobial activity value of 2.0 or more is satisfied when the radical amount is 10 μmol/L or more. Accordingly, in terms of both antimicrobial effect and vegetable preservability, the radical amount is desirably about 10 μmol/L to 50 μmol/L.

Note that the result shown in FIG. 55 is the proper radical amount calculated on the basis of confirmation using lettuces which have relatively high sensitivity. Since the proper range is expected to differ depending on the type of vegetable, this proper range is not necessarily limited to such. However, by setting the range on the basis of the result obtained using lettuces which are most sensitive to tissue damage in preservation in household refrigerators, sufficient safety for vegetable preservation can be ensured while enhancing the antimicrobial effect.

Since the ozone mist sprayed in the vegetable compartment 1014 is electrostatically charged, the ozone mist electrically adhere to the surfaces of positively charged vegetables and fruits in the vegetable compartment 1014 and to the wall surfaces of the storage compartment. The ozone mist even enters into fine depressions on the surfaces of the vegetables and fruits, peels off molds, bacteria, yeasts, and viruses adhering to the depressions by internal pressure energy of the fine mist, and oxidative-decomposes and removes them by oxidative decomposition of ozone and radicals. The ozone mist also enters into fine holes on the wall surfaces, equally causes dirt and harmful substances in the holes to emerge, and decomposes and removes them by ozone oxidative decomposition.

By electrostatically charging the mist, water molecules in the mist are converted to radicals, thereby generating OH radicals. This being so, decomposition performance of microorganisms such as bacteria, molds, yeasts, and viruses can be enhanced not only by oxidative power of ozone but also by oxidative power of OH radicals.

### Thirty-First Embodiment

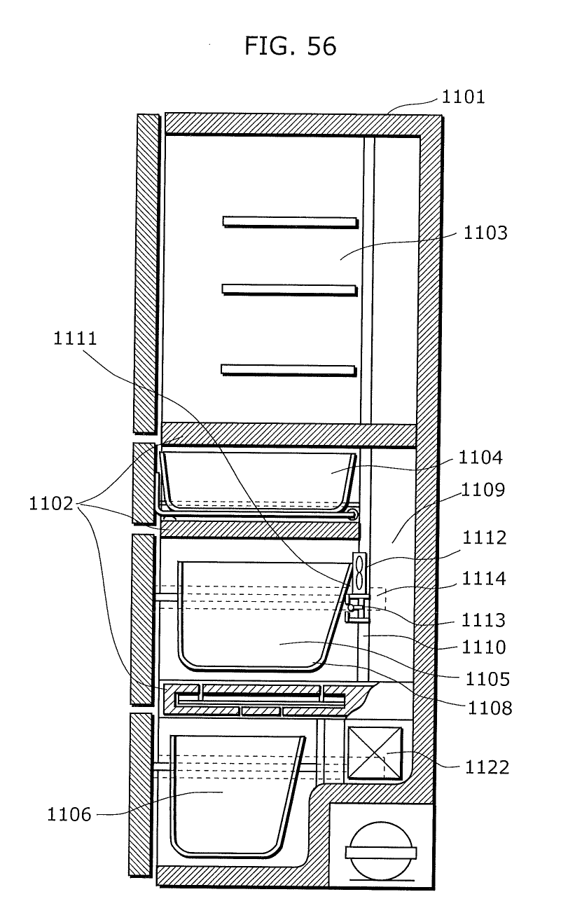

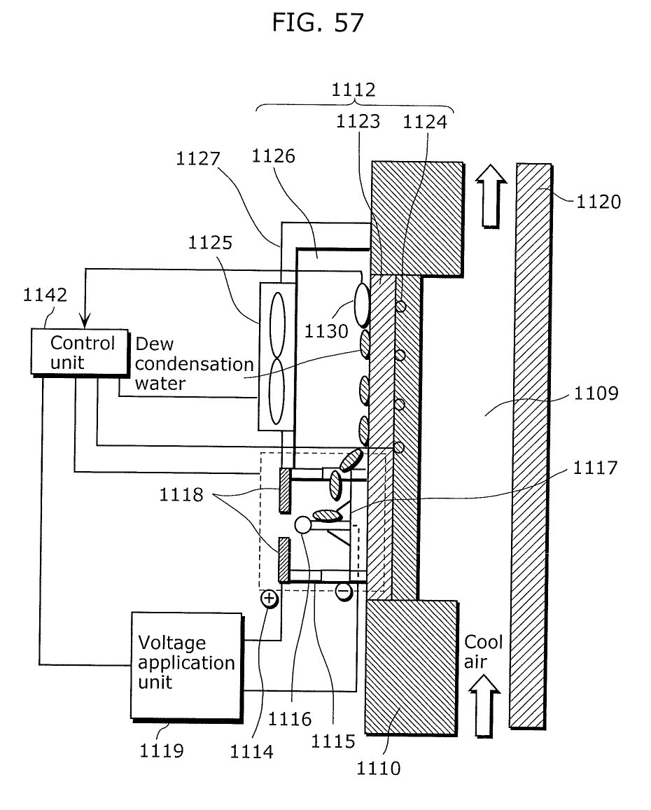

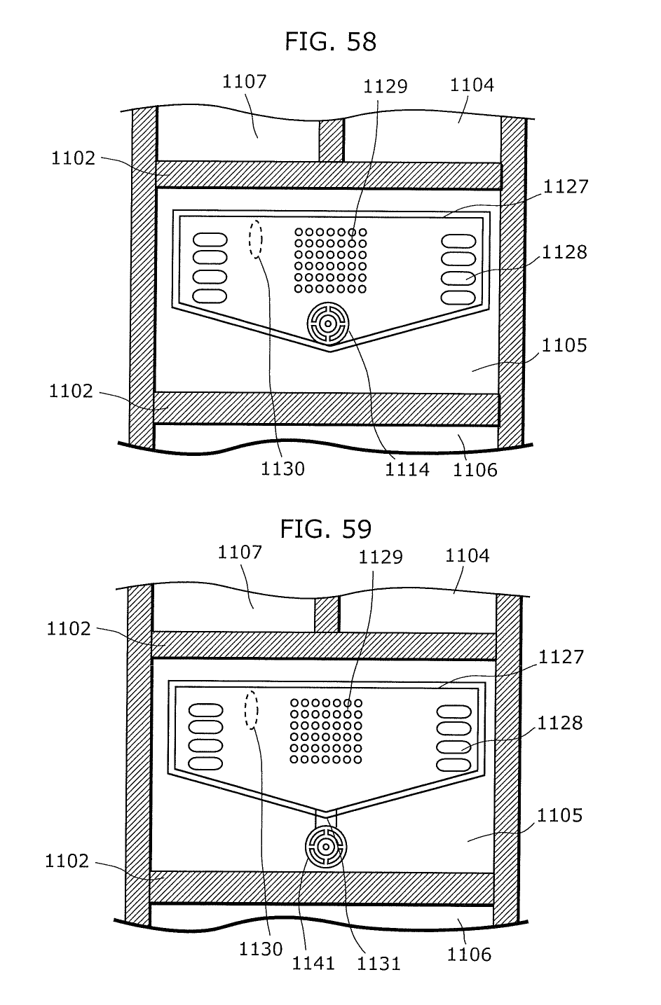

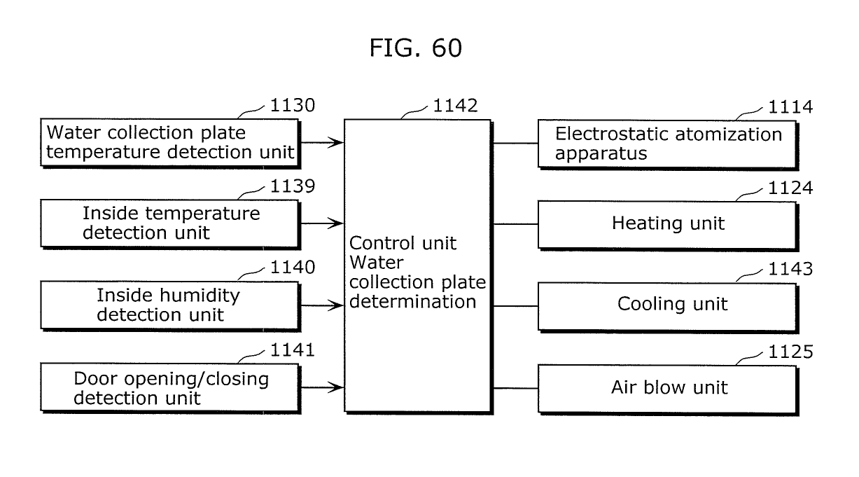

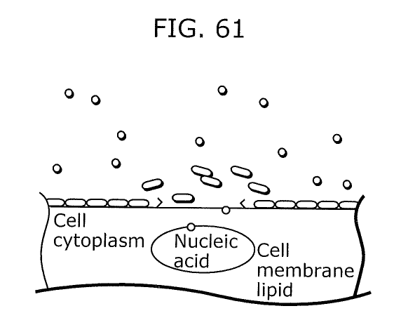

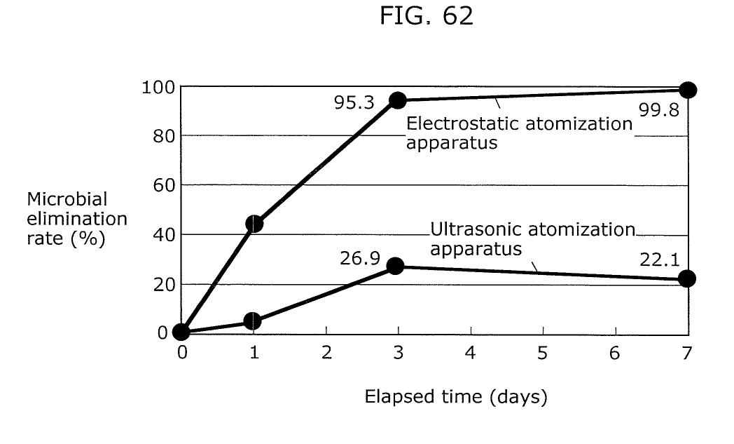

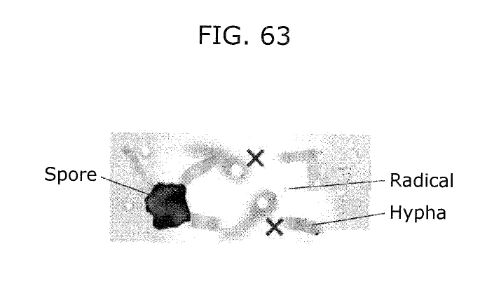

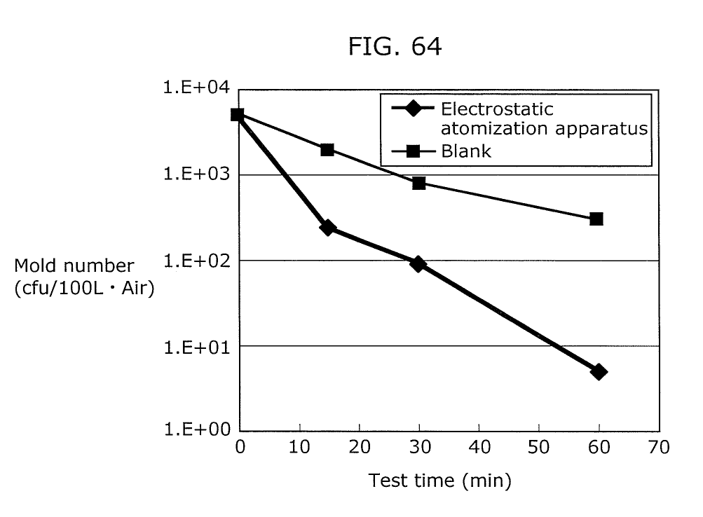

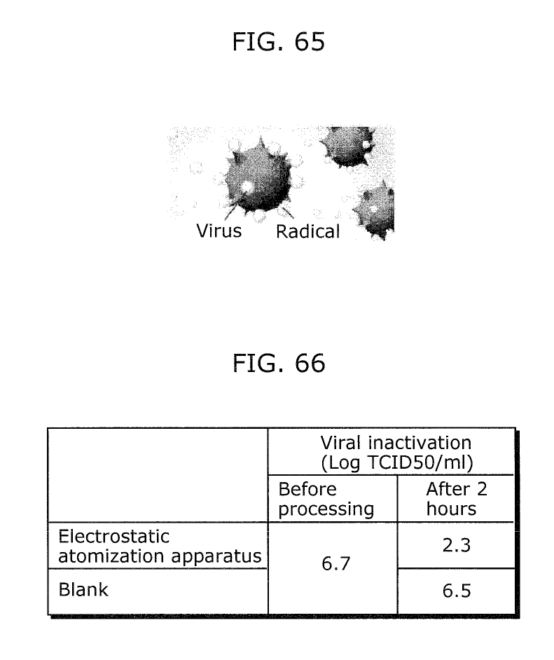

FIG. 56 is a side sectional view of a refrigerator in a thirty-first embodiment of the present invention. FIG. 57 is a longitudinal sectional view of a water collection unit and its vicinity in the refrigerator in the thirty-first embodiment of the present invention. FIGS. 58 and 59 are each a front view of the water collection unit and its vicinity in the refrigerator in the thirty-first embodiment of the present invention. FIG. 60 is a functional block diagram of the refrigerator in the thirty-first embodiment of the present invention. FIG. 61 is a microbial elimination image diagram in the thirty-first embodiment of the present invention. FIG. 62 is a chart showing a bacteria elimination effect in a box assumed to be the refrigerator in the thirty-first embodiment of the present invention. FIG. 63 is a mold suppression image diagram of the refrigerator in the thirty-first embodiment of the present invention. FIG. 64 is a chart showing a mold elimination effect in a box assumed to be the refrigerator in the thirty-first embodiment of the present invention. FIG. 65 is an antivirus image diagram of the refrigerator in the thirty-first embodiment of the present invention. FIG. 66 is a chart showing an antiviral effect in a box assumed to be the refrigerator in the thirty-first embodiment of the present invention.

In the drawings, a refrigerator 1101 is partitioned by partitions 1102 into a refrigerator compartment 1103, a switch compartment 1104, a vegetable compartment 1105, and a freezer compartment 1106 from above. The vegetable compartment 1105 includes a vegetable container 1108 in which foods are stored, and is cooled at 4° C. to 6° C. with a humidity of about 80% RH or more (when storing foods) by indirect cooling. A storage compartment partition 1110 for separating the vegetable compartment 1105 from an air path 1109 is formed on the back of the vegetable compartment 1105.

An atomization unit 1111 is provided in the storage compartment partition 1110. The atomization unit 1111 is divided into a water collection unit 1112 and a mist generation unit 1113. The mist generation unit 1113 includes an electrostatic atomization apparatus 1114 as a mist spray apparatus. The vegetable container has a hole (not shown) in front of the electrostatic atomization apparatus 114 so that a mist is sprayed into the vegetable container from the electrostatic atomization apparatus 1114.

A cylindrical holder 1115 is provided in the electrostatic atomization apparatus 1114. An application electrode 1116 is installed in the cylindrical holder 1115, and a circumference of the application electrode 1116 is covered with a water retainer 1117, where up to a spherical tip of the application electrode 1116 is in a water-containing state by dew condensation water.

Moreover, a counter electrode 1118 shaped like a circular doughnut plate is installed in a storage compartment side opening of the holder 1115 so as to have a constant distance from the tip of the application electrode 1116. Further, a negative pole of a voltage application unit 1119 generating a high voltage is electrically connected to the application electrode 1116, and a positive pole of the voltage application unit 1119 is electrically connected to the counter electrode 1118.

The air path 1109 is provided between the storage compartment partition 1110 and a main body outer wall 1120, for conveying cool air generated by, for example, a cooler 1122 to each storage compartment or conveying air heat-exchanged in each storage compartment to the cooler. The atomization unit 1111 including the electrostatic atomization apparatus 1114 is incorporated in the storage compartment partition 1110.

The storage compartment partition 1110 is mainly made of a heat insulator such as styrene foam. The storage compartment partition 1110 is about 30 mm in wall thickness, but 5 mm to 10 mm in wall thickness on the back of the water collection unit 1112.

A water collection plate 1123 is installed in the water collection unit 1112 on a storage compartment side. A heating unit 1124 such as a heater composed of, for example, a nichrome wire is brought into contact with one surface of the water collection plate 1123. An air blow unit 1125 such as a box fan and a cover 1127 for forming a circulation air path 1126 are provided on the storage compartment side.

In addition, a first circulation air path opening 1128 and a second circulation air path opening 1129 relating to the circulation air path 1126 are formed in the cover 1127. Further, at least one temperature detection unit 1130 for detecting a water collection plate surface temperature is provided on the water collection plate 1123.

Water collected by dew condensation on the storage compartment side surface of the water collection plate 1123 is poured into the electrostatic atomization apparatus 1114 via a water conveyance unit 1131 located below the water collection plate 1123.

An operation and working of the refrigerator having the above-mentioned structure are described below.

Typically, in the refrigerator, cool air heat-exchanged by the cooler 1122 is allocated to the refrigerator compartment 1103, the switch compartment 1104, the vegetable compartment 1105, the freezer compartment 1106, an ice compartment 1107, and the like by a stirring fan (not shown) or the like, and an on/off operation is performed to maintain a predetermined temperature.

The vegetable compartment 1105 is adjusted to 4° C. to 6° C. by cool air allocation and an on/off operation of a heating unit and the like, and usually does not have an inside temperature detection unit 1139. The vegetable compartment 1105 is also high in humidity, due to transpiration from foods, water vapor entry caused by door opening/closing, and so on.

Since a certain level of cooling capacity is necessary, the thickness of the storage compartment partition 1110 corresponding to the water collection unit 1112 is smaller than other parts. When the surface temperature of the water collection plate 1123 drops to the dew point or below, a water vapor near the water collection plate 1123 builds up dew condensation on the water collection plate 1123, thereby reliably generating water droplets.

In detail, the surface temperature is detected by the temperature detection unit 1130 installed on the water collection plate 1123, and on/off control or duty factor control is exercised on the air blow unit 1125 and the heating unit 1124 by a control unit 1142 as a temperature adjustment unit, thereby adjusting the surface temperature of the water collection plate 1123 to the dew point or below and causing water contained in high humidity air sent from the storage compartment by the air blow unit 1125 to build up dew condensation on the water collection plate 1123.

By installing the inside temperature detection unit 1139, an inside humidity detection unit 1140, and the like in the storage compartment, the dew point can be precisely calculated by a predetermined computation according to a change in storage compartment environment.

Even when ice or frost is formed on the surface of the water collection plate 1123, the heating unit 1124 can increase the surface temperature of the water collection unit 1123 to a melting temperature, so that water can be generated properly.

When the air blow unit 1125 is in operation, the surface temperature of the water collection plate 1123 increases due to the effect of the air in the vegetable compartment 1105. When the air blow unit 1125 is stopped, the surface temperature of the water collection plate 1123 decreases. In the case where the water thickness is 10 mm or more, during the operation of the air blow unit 1125, the surface temperature of the water collection plate 1123 becomes the dew point or more even when the heating unit 1124 is off, making it impossible to adjust the dew condensation amount. Conversely, in the case where the wall thickness is 5 mm or less, the heating unit 1124 is constantly on, which is not energy-efficient.

In view of this, by setting the thickness of the storage compartment partition 1110 behind the water collection plate 1123 to 5 mm to 10 mm, the surface temperature of the water collection plate 1123 can be controlled while minimizing energy consumed by the heating unit 1124. This is summarized in Table 2.

TABLE 2

| | | Inside humidity detection unit 1140 | | | |
|---|---|---|---|---|---|
| | | 99% | 95% | 90% | 80% |
| Inside | 10° C. | 9.9° C. | 9.2° C. | 8.4° C. | 6.7° C. |
| temperature | 6° C. | 5.9° C. | 5.3° C. | 4.5° C. | 2.8° C. |
| detection unit | 5° C. | 4.9° C. | 4.3° C. | 3.5° C. | 1.8° C. |
| 1139 | 4° C. | 3.9° C. | 3.3° C. | 2.5° C. | 0.9° C. |
| | 2° C. | 1.9° C. | 1.3° C. | 0.5° C. | −1.0° C. |

In order to accelerate dew condensation in the water collection unit 1112, it is necessary to circulate air in the vegetable compartment. Accordingly, the air is taken in by the air blow unit 1125. For example, high humidity air is taken in via the first circulation air path opening 1129 by the air blow unit 1125 to cause dew condensation on the water collection plate 1123, and then the air is discharged into the storage compartment via the second circulation air path opening 1128. By circulating the air in the vegetable compartment 1105 in such a manner, dew condensation is accelerated.

Water droplets forming dew condensation on the surface of the water collection plate 1123 gradually grow, flow downward under their own weight without using power of a pump or the like, and gather near the electrostatic atomization apparatus 1114 through an inclined bottom surface of the cover 1126. The gathered dew condensation water is absorbed by the water retainer. Alternatively, the dew condensation water is timely supplied to the electrostatic atomization apparatus 1114 through the water conveyance unit 1131.

In the electrostatic atomization apparatus 1114, since the application electrode 1116 is covered with the water retainer 1117, the application electrode 1116 is in a state of containing a predetermined amount of water. In this state, the voltage application unit 1119 applies a high voltage (for example, 4.6 kV) between the application electrode 1116 and the counter electrode 1118, where the application electrode 1116 is on a negative voltage side and the counter electrode 1118 is on a positive voltage side. This causes corona discharge to occur at an electrode gap length (for example, 3 mm). Water in the application electrode 1116 is atomized from the electrode surface, and a mist carrying a charge of a nano-size particle diameter is generated.

Since the high voltage is applied during this mist spray, it is desirable that the mist spray is not performed while a user is opening the door. This being so, a door opening/closing detection unit 1141 detects a door opening/closing state to control the operation of the electrostatic atomization apparatus 1114.

The generated mist is sprayed into the vegetable container via the hole (not shown) formed in the vegetable container. The sprayed mist is negatively charged. Meanwhile, green leafy vegetables, fruits, and the like stored in the vegetable compartment tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces.

FIG. 61 is an image diagram of microbial elimination by the mist generated by the electrostatic atomization apparatus 1114.

The generated mist contains ozone, OH radicals, and the like that have strong oxidative power. Bacterial cell membrane protein in bacterial tissues is partly oxidative-decomposed and lysed by these ozone and OH radicals, as a result of which bacteria are inactivated. By using such amounts of ozone and OH radicals that are not strong enough to instantly kill bacteria themselves but are just enough to destroy bacterial cell membranes to thereby stimulate bacterial inactivation, that is, bacterial death, it is possible to perform bacterial inactivation in a range where vegetable preservability mentioned above is unaffected. Accordingly, the generated mist can effect antimicrobial activity, microbial elimination, and sterilization on the vegetables surfaces and the inside of the vegetable compartment, and also oxidative-decompose harmful substances adhering to the vegetable surfaces.

FIG. 62 is a result of evaluating a microbial elimination effect for Escherichia coli which is a representative bacterial species, in a box assumed to be the vegetable compartment of the refrigerator.

Test conditions are as follows. Having set a box capacity to about 70 L, a box inside temperature to about 5° C., and a box inside relative humidity to 90% RH or more, the electrostatic atomization apparatus 1114 of the thirty-first embodiment was placed in the box and operated at an operation rate of being on for 30 minutes and being off for 30 minutes. For comparison, having assumed a conventional vegetable compartment, the same test was conducted under the above-mentioned box conditions, with a mist being sprayed by an ultrasonic atomization apparatus instead of the electrostatic atomization apparatus 1114.

As shown in FIG. 62, while the microbial elimination effect of the ultrasonic atomization apparatus is less than 30%, the atomization of the electrostatic atomization apparatus 1114 in the thirty-first embodiment exhibits a high microbial elimination effect of 95% or more after three days and 99% or more after seven days.

FIG. 63 is an image diagram of mold suppression by the mist generated by the electrostatic atomization apparatus 1114. Typically, molds grow with spores germinating and extending hyphae. As shown in FIG. 63, germinated hyphae are removed by ozone or radicals contained in the generated mist, and so molds are unable to extend hyphae any longer and are inactivated, as a result of which mold growth is suppressed. By using such amounts of ozone and OH radicals that are not strong enough to instantly kill molds themselves but are just enough to destroy mold hyphae to thereby stimulate bacterial inactivation, that is, bacterial death, it is possible to suppress mold growth in a range where vegetable preservability mentioned above is unaffected.

FIG. 64 shows a result of evaluating a microbial elimination effect for a black mold which is a representative mold species, in a box assumed to be the vegetable compartment of the refrigerator.

Test conditions are as follows. Having set a box capacity to about 70 L, a box inside temperature to about 5° C., and a box inside relative humidity to 90% RH or more, the electrostatic atomization apparatus 1114 of the thirty-first embodiment was placed in the box. As a comparison, the same test was conducted with the electrostatic atomization apparatus 1114 being omitted, assuming a conventional vegetable compartment. A test mold was sprayed with the number of initial floating molds equal to or more than 100/100 L·Air. The microbial number was measured by an air sampler suction method.

As shown in FIG. 64, a microbial elimination effect of 99% is obtained after operating the electrostatic atomization apparatus of the thirty-first embodiment for 60 minutes, as compared to control conditions. The microbial elimination effect can be recognized not only for vegetables and storage compartment surfaces, but also for floating microorganisms in the refrigerator.

FIG. 65 is an image diagram of antivirus activity by the mist generated by the electrostatic atomization apparatus 1114. Typically, viruses reproduce whereby protein called spike present on viral surfaces are parasitic on a nutritive substance such as saliva. As shown in FIG. 65, the generated ultrafine mist containing radicals locks onto viruses and decomposes spike (protein), and so the viruses are unable to be parasitic on the nutritive substance and are inactivated, as a result of which the reproduction is suppressed. By using such amounts of ozone and OH radicals that are not strong enough to instantly kill viruses themselves but are just enough to destroy protein on viral surfaces to thereby stimulate viral inactivation, that is, viral death, it is possible to suppress viral growth in a range where vegetable preservability mentioned above is unaffected.

FIG. 66 shows a result of evaluating an antiviral effect of the electrostatic atomization apparatus in the thirty-first embodiment by box testing.

Test conditions are as follows. Having set a box capacity to about 30 L, a box inside temperature to about a room temperature, and a box inside relative humidity to 90% RH or more, the electrostatic atomization apparatus 1114 of the thirty-first embodiment was placed in the box and operated at an operation rate of being on for 30 minutes and being off for 30 minutes. As a comparison, the same test was conducted with the electrostatic atomization apparatus 1114 being omitted, assuming a conventional vegetable compartment. Viral inactivation was compared by a logarithmic value of median tissue culture infective doze (TCID50). When the TCID50 logarithmic value is smaller, the viral inactivation rate is higher. A difference of 2 or more in Log TCID50 can be considered as a significant difference.

From the test result, the viral inactivation effect can be confirmed when the electrostatic atomization apparatus 1114 of the thirty-first embodiment is operated for two hours, as there is a difference of 2 or more in Log TCID50/ml versus initial and control (blank).

Though not shown, a microbial elimination effect similar to that of Escherichia coli is obtained for staphylococcus aureus which is resistant to drying and lives in refrigerators via human hand. A high microbial elimination effect is equally obtained for pathogens such as O-157, MRSA, and the Influenza virus. This demonstrates that a high microbial elimination effect can be attained for a wide variety of microorganisms such as bacteria, molds, and viruses.

As described above, in the thirty-first embodiment, the electrostatic atomization apparatus including the application electrode for applying a voltage to water, the counter electrode positioned facing the application electrode, and the voltage application unit for applying a high voltage between the application electrode and the counter electrode, and the water collection unit attached to the storage compartment partition on the back of the vegetable compartment are provided. The water collection plate is cooled by heat conduction from the air path side of the storage compartment partition on the back of the vegetable compartment, using low temperature cool air generated by the cooler as a cooling source. Meanwhile, the surface temperature of the water collection plate is adjusted to the dew point or below by the heating unit and the air blow unit. This reliably causes water in the air to build up dew condensation on the water collection plate. The collected water is conveyed to the electrostatic atomization apparatus by the water conveyance unit, and sprayed into the vegetable compartment by the electrostatic atomization apparatus so that the mist reliably adheres to vegetable surfaces. Hence, it is possible to enhance moisture retention of vegetables, thereby improving freshness preservation. Moreover, ozone and OH radicals generated simultaneously with the mist contribute to enhanced effects of elimination of molds, bacteria, yeasts, viruses, and so on that are present on the inside of the storage compartment and food surfaces and in the air in the storage compartment, deodorization in the storage compartment, removal of harmful substances from food surfaces, contamination prevention, and the like.

Besides, air is not likely to directly flow to the water retainer itself, so that the water retainer can be kept from drying and as a result sufficient water can be supplied to the tip of the application electrode.

In addition, the mist can be directly sprayed over the foods in the vegetable container, and the potentials of the mist and the vegetables are exploited to cause the mist to adhere to the vegetable surfaces. This improves freshness preservation efficiency.

Furthermore, the water collection plate is located above the electrostatic atomization apparatus and dew condensation water acquired on the water collection plate is let to fall by gravitation. Thus, water can be supplied to the electrostatic atomization apparatus at low cost, without using a water conveyance unit such as a pump or a capillary.

Moreover, by disposing the water retainer around the application electrode of the electrostatic atomization apparatus, dew condensation water generated on the water collection plate can be retained around the application electrode. This allows the application electrode to be timely supplied with water.

Besides, since the water retainer is not directly vibrated by an ultrasonic vibrator, deterioration due to material contraction can be prevented.

Furthermore, dew condensation water having no mineral compositions or impurities is used instead of tap water, so that deterioration in water retentivity caused by water retainer deterioration or clogging can be prevented.

Note that, by widely varying the control temperature of the water collection plate in this embodiment, it is also possible to let the water collection plate function as a dehumidifier to thereby adjust the humidity in the storage compartment and make the storage compartment suitable for root vegetables.

### Thirty-Second Embodiment

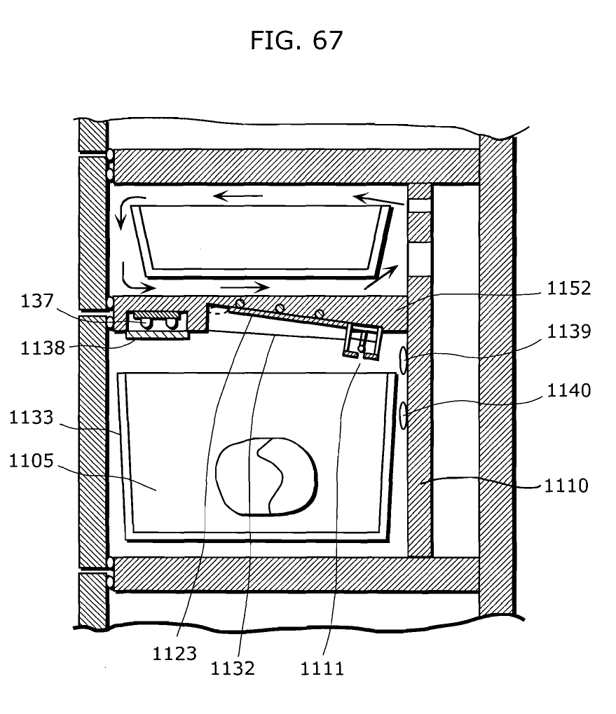

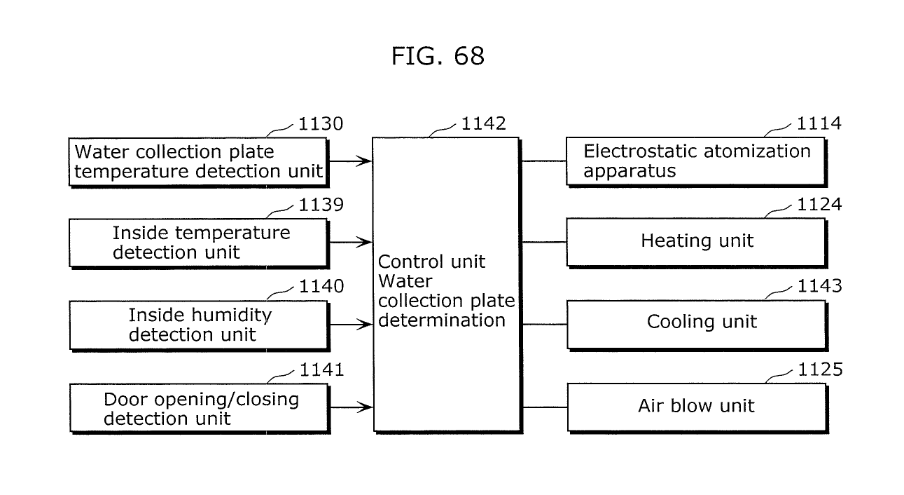

FIG. 67 is a longitudinal sectional view of a water collection unit and its vicinity in a refrigerator in a thirty-second embodiment of the present invention. FIG. 68 is a functional block diagram of the refrigerator in the thirty-second embodiment of the present invention.

In FIG. 67, the atomization unit 1111, a luminous body 1137 for irradiating the inside of the storage compartment with blue light or the like, and a diffusion plate 1138 for diffusing the light throughout the storage compartment are installed in a partition 1152 at the top of the vegetable compartment. The inside temperature detection unit 1139 and the inside humidity detection unit 1140 are provided in the vegetable compartment 1105.

An operation and working of the refrigerator having the above-mentioned structure are described below.

First, the dew point temperature of the vegetable compartment 1105 can be predicted by the inside temperature detection unit 1139 and the inside humidity detection unit 1140. This being so, the water collection plate surface temperature detection unit detects the surface temperature of the water collection plate, and the heating unit 1124 and the air blow unit 1125 adjust the surface temperature of the water collection plate to the dew point or below. For example, the water collection plate surface temperature is adjusted as shown in Table 3.

TABLE 3

| | Thickness of storage | | | | | |
|---|---|---|---|---|---|---|
| | compartment partition 1110 | | | | | |
| | 5 mm | 10 mm | 15 mm | 20 mm | 25 mm | 30 mm |
| Air blow unit | −0.3 | 1.7 | 2.6 | 3.4 | 3.5 | 3.7 |
| 1125 ON | | | | | | |
| Air blow unit | −10.9 | −7.5 | −5.2 | −3.7 | −2.5 | −1.6 |
| 1125 OFF | | | | | | |

As an example, when the inside temperature is 5° C. and the inside humidity is 90%, the dew point temperature is 3.5° C., at or below which a water vapor in the storage compartment builds up dew condensation on the water collection plate 1123. Dew condensation water is conveyed to the electrostatic atomization unit along the water collection plate 1123 or a cover 1132.

After this, a mist is sprayed from the electrostatic atomization apparatus as the mist spray apparatus into a container 1133 in which vegetables are stored. The sprayed mist adheres to microorganisms present on the surfaces of vegetables and fruits, and ozone and OH radicals contained in the mist oxidative-decompose the microorganisms and suppress their growth.

When the inside temperature detection unit 1139 detects the inside temperature to be 5° C. or more, the luminous body 1137 lights up and irradiates the vegetables and fruits stored in the vegetable compartment 1105. The luminous body 1137 is, for example, a blue LED, and applies light including blue light with a center wavelength of 470 nm. An illumination of about 10 lux to 1500 lux on the surfaces of the irradiated objects such as vegetables is sufficient as the blue light applied here. When the microorganisms on the surfaces of the vegetables and fruits which have been prevented from growth by the mist and weakened are irradiated with blue light, light stimulation by the blue light acts upon photoreceptors of the microorganisms, as a result of which the microorganisms die.

As described above, in the thirty-second embodiment, an appropriate amount of fine mist is sprayed over vegetables and fruits stored in the container 1133 by the mist spray apparatus, and further blue light is applied to the vegetables and fruits, thereby killing microorganisms present on the surfaces of the vegetables and fruits.

By electrostatically charging the mist, the negatively charged fine mist adheres to the surfaces of positively charged vegetables and fruits and wall surfaces of the storage compartment. The mist enters into fine holes on the surfaces of the vegetables and fruits and the wall surfaces of the storage compartment, as a result of which the water content recovery effect of the vegetables can be improved, and also the removal effect can be improved by causing dirt and harmful substances in the fine holes to emerge.

### Thirty-Third Embodiment

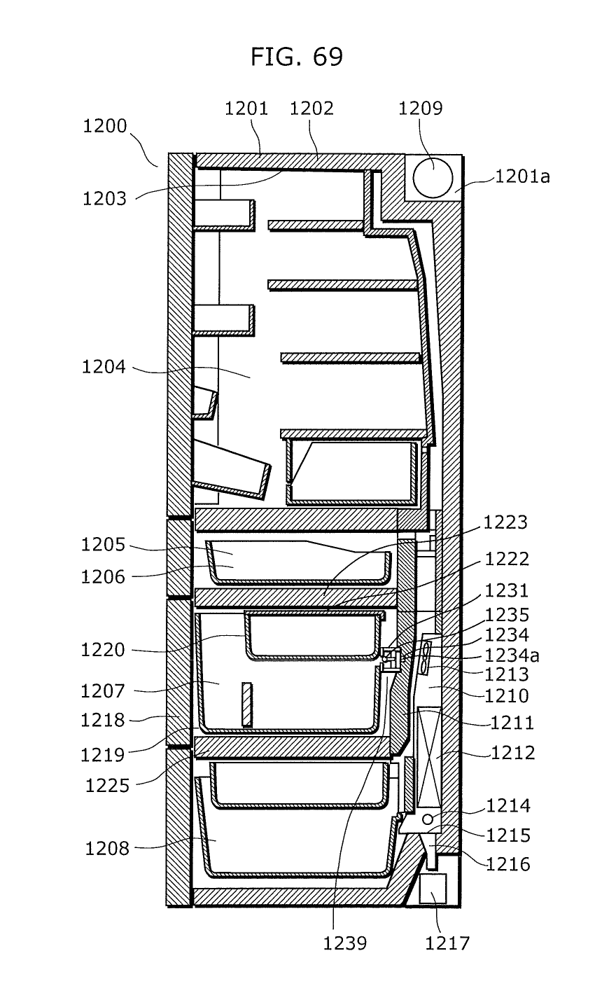

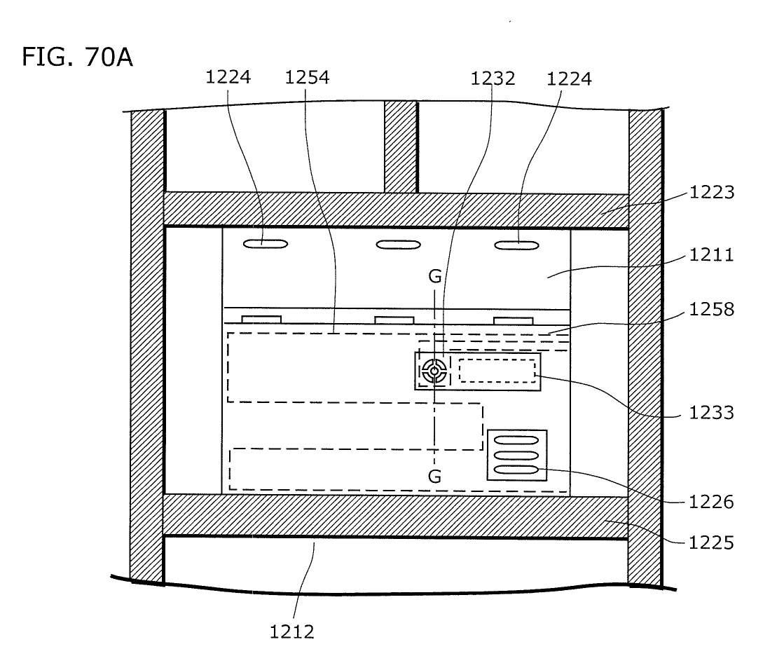

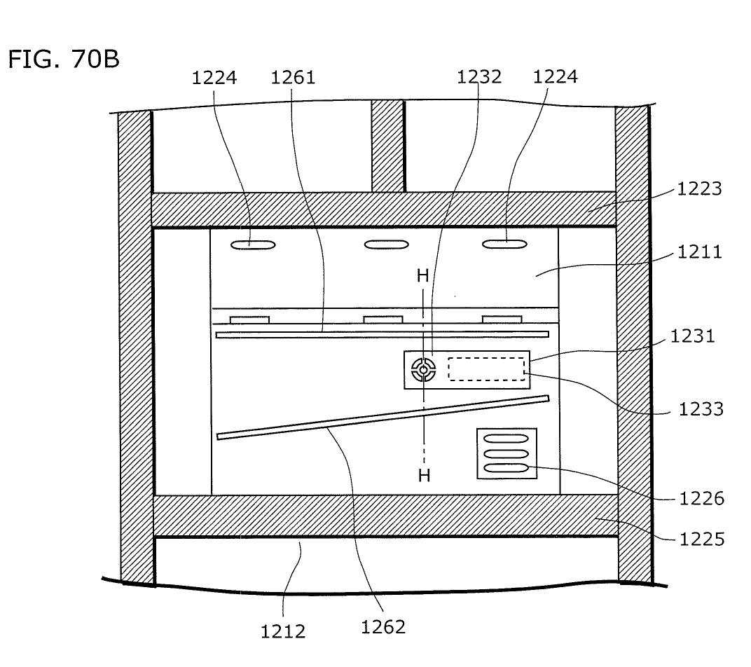

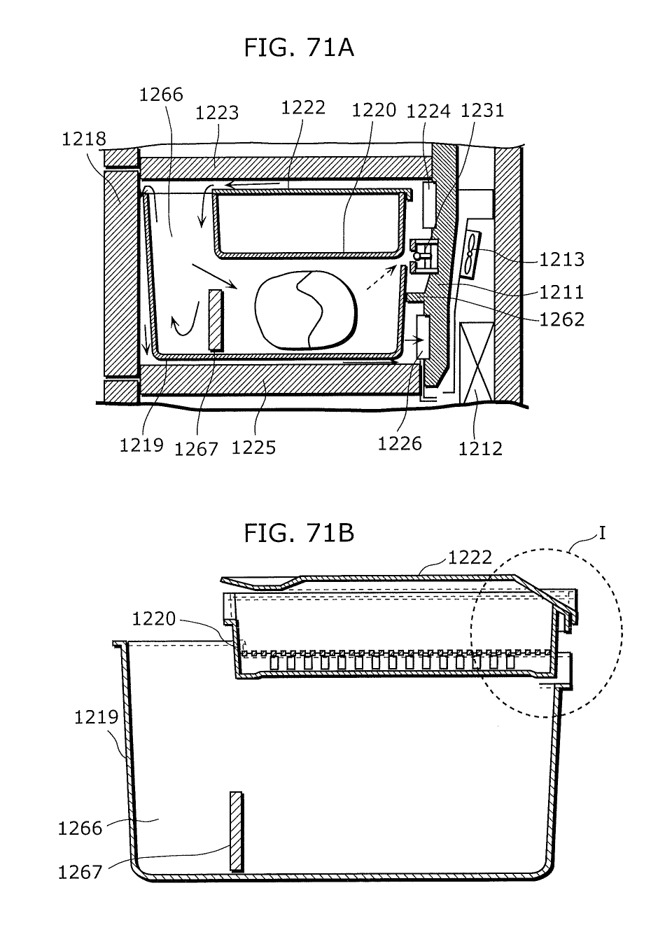

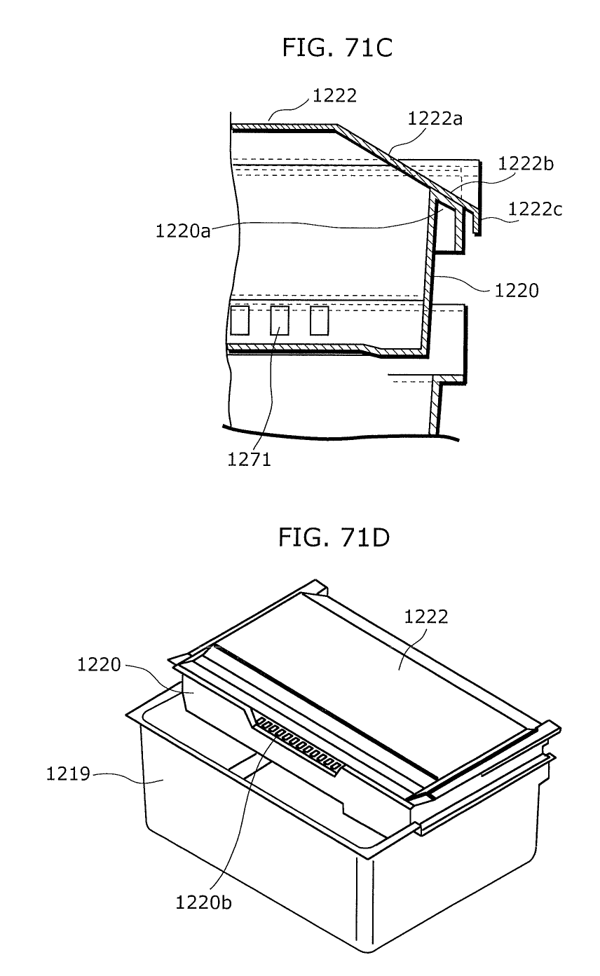

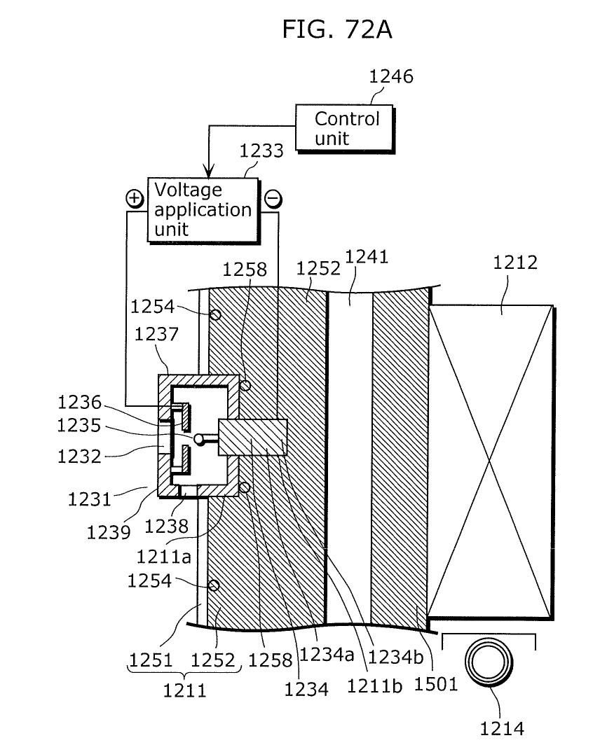

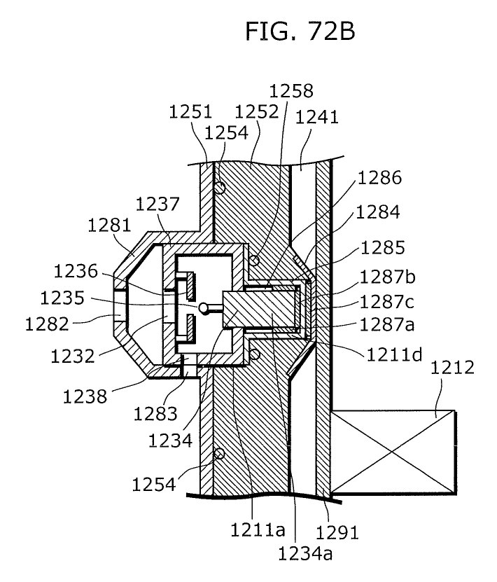

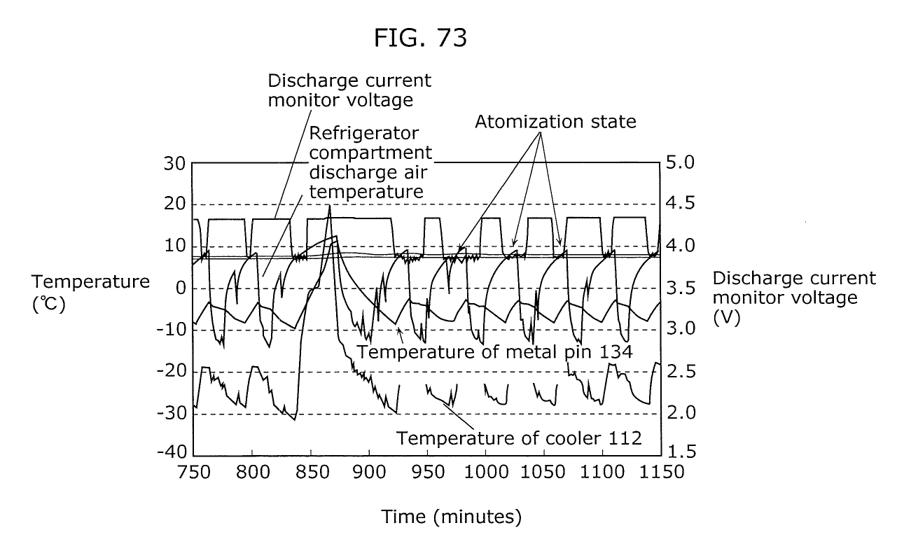

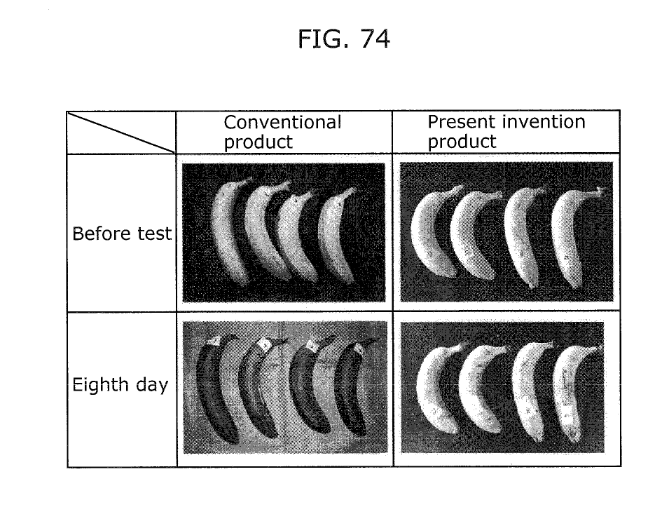

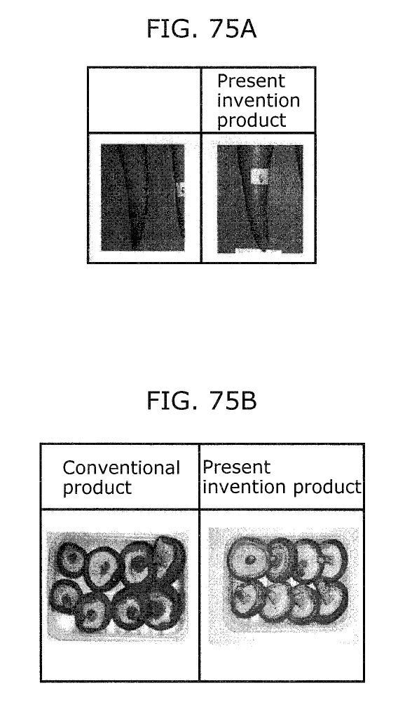

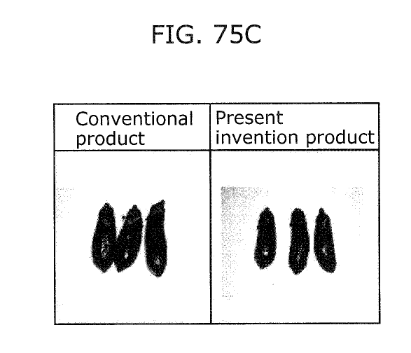

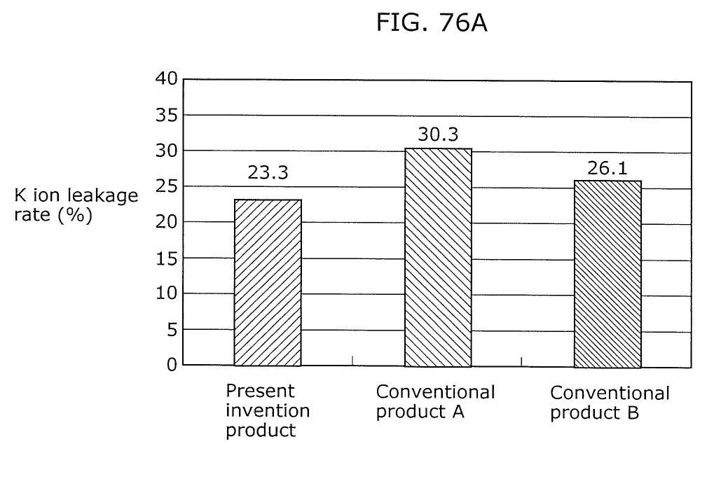

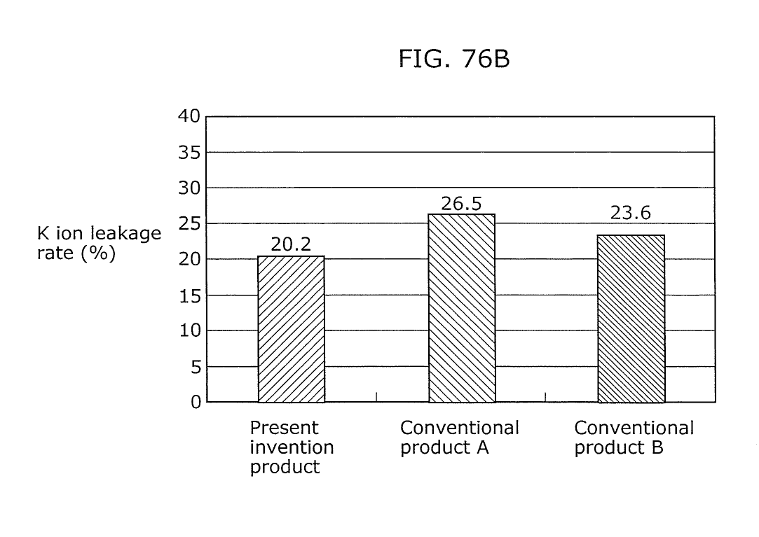

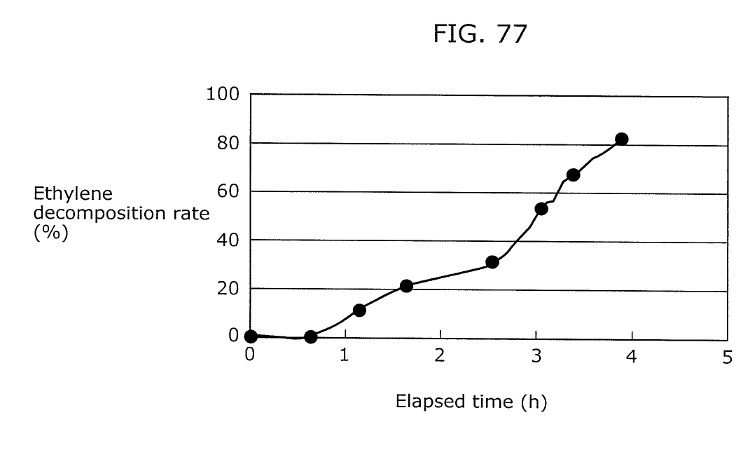

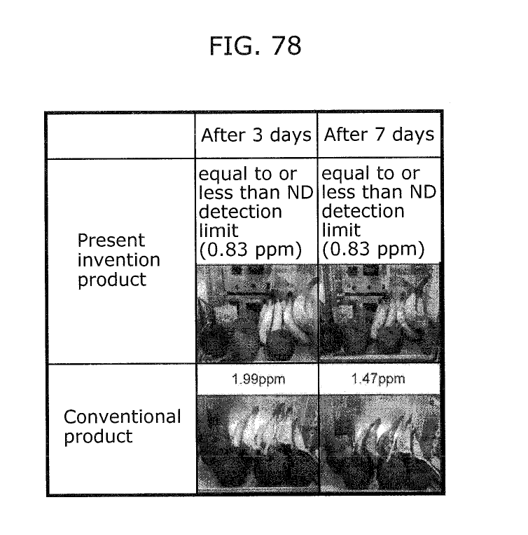

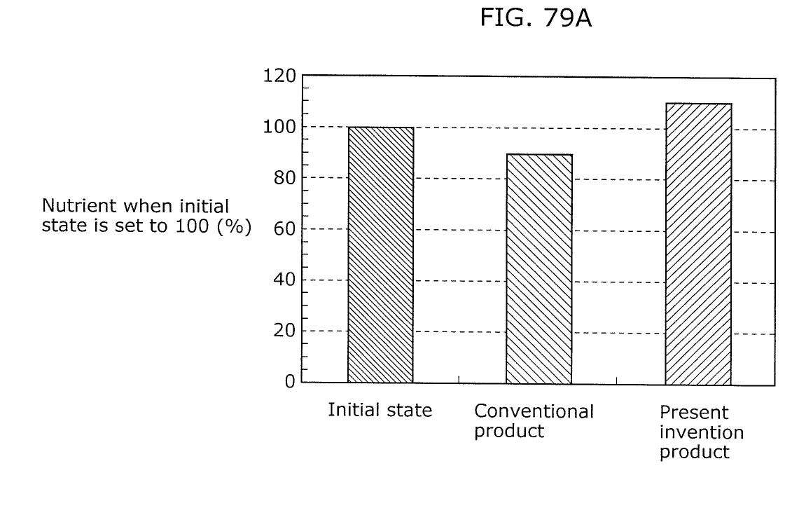

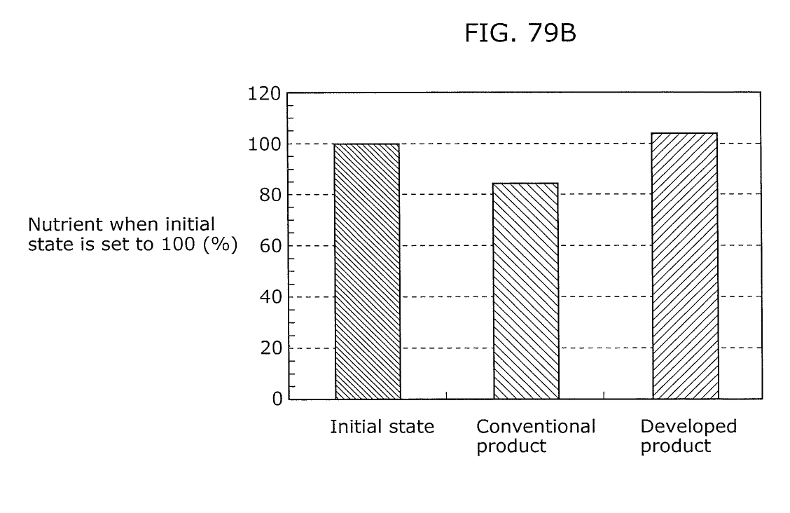

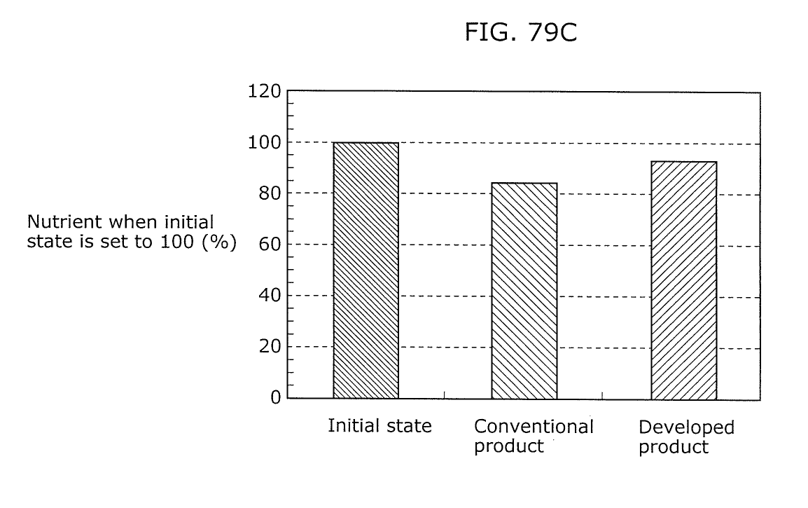

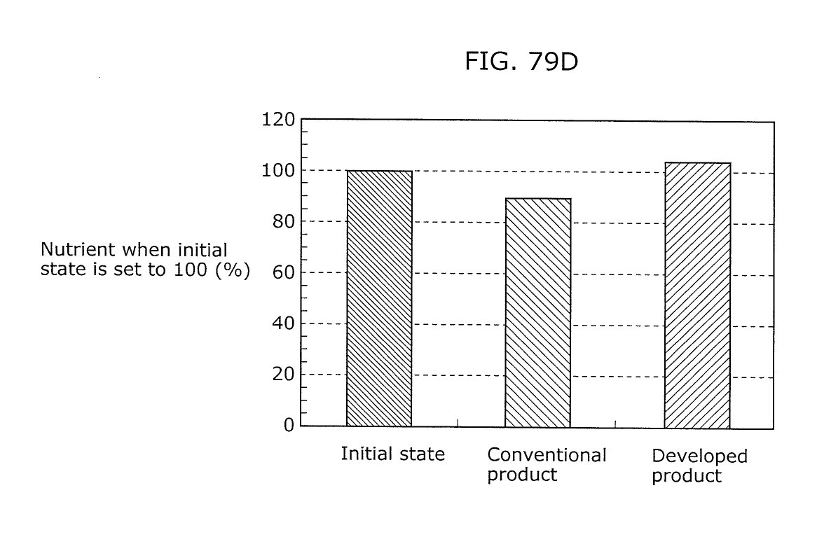

FIG. 69 is a longitudinal sectional view of a refrigerator in a thirty-third embodiment of the present invention. FIG. 70A is a front view of a vegetable compartment and its vicinity in the refrigerator in the thirty-third embodiment of the present invention. FIG. 70B is a front view of another form of the vegetable compartment and its vicinity in the refrigerator in the thirty-third embodiment of the present invention. FIG. 71A is a sectional view of the vegetable compartment and its vicinity in the refrigerator in the thirty-third embodiment of the present invention. FIG. 71B is a side view of the vegetable compartment in the thirty-third embodiment of the present invention. FIG. 71C is an enlarged view of an I part in FIG. 71B. FIG. 71D is a perspective view of the vegetable compartment in the thirty-third embodiment of the present invention, as seen from its front. FIG. 72A is a detailed sectional view of an electrostatic atomization apparatus and its vicinity taken along line G-G in FIG. 70A. FIG. 72B is a detailed sectional view of another form of the electrostatic atomization apparatus and its vicinity taken along line G-G in FIG. 70A. FIG. 73 is a chart showing an experimental result of a discharge current monitor voltage value indicating an atomization state and a temperature behavior of an atomization electrode in the thirty-third embodiment of the present invention. FIG. 74 is a photographic comparison view of an experimental result using bananas in the thirty-third embodiment of the present invention. FIGS. 75A, 75B, and 75C are respectively photographic comparison views of experimental results using carrots, shiitake mushrooms, and eggplants in the thirty-third embodiment of the present invention. FIG. 76 is a chart showing potassium ion leakage that indicates a degree of low temperature damage in the thirty-third embodiment of the present invention. FIG. 77 is an ethylene gas decomposition capacity chart in the thirty-third embodiment of the present invention. FIG. 78 is a view showing an ethylene gas concentration measurement result in a vegetable and fruit preservation environment in the thirty-third embodiment of the present invention. FIGS. 79A, 79B, 79C, and 79D are respectively charts showing experimental results of a vitamin C content of broccoli sprouts, a vitamin A content of mulukhiyas, a vitamin E content of mulukhiyas, and a vitamin E content of watercresses in the thirty-third embodiment of the present invention.

In the drawings, a heat-insulating main body 1201 of a refrigerator 1200 is formed by an outer case 1202 mainly composed of a steel plate and an inner case 1203 molded with a resin such as ABS, with a foam heat insulation material such as rigid urethane foam being charged between the outer case 1202 and the inner case 1203. This allows for heat insulation of a plurality of storage compartments obtained by partitioning the refrigerator 1200. A refrigerator compartment 1204 as a first storage compartment is located at the top in the refrigerator 1200. A switch compartment 1205 as a fourth storage compartment and an ice compartment 1206 as a fifth storage compartment are located side by side below the refrigerator compartment 1204. A vegetable compartment 1207 as a second storage compartment is located below the switch compartment 1205 and the ice compartment 1206. A freezer compartment 1208 as a third storage compartment is located at the bottom.

The refrigerator compartment 1204 is typically set to 1° C. to 5° C., with a lower limit being a temperature low enough for refrigerated storage but high enough not to freeze. The vegetable compartment 1207 is set to a temperature of 2° C. to 7° C. that is equal to or slightly higher than the temperature of the refrigerator compartment 1204. The freezer compartment 1208 is set to a freezing temperature zone. The freezer compartment 1208 is typically set to −22° C. to −15° C. for frozen storage, but may be set to a lower temperature such as −30° C. and −25° C. for an improvement in frozen storage state. The switch compartment 1205 is capable of switching to not only the refrigeration temperature zone of 1° C. to 5° C., the vegetable temperature zone of 2° C. to 7° C., and the freezing temperature zone of typically −22° C. to −15° C., but also a preset temperature zone between the refrigeration temperature zone and the freezing temperature zone. The switch compartment 1205 is a storage compartment with an independent door arranged side by side with the ice compartment 1206, and often has a drawer door. Note that, though the switch compartment 1205 is a storage compartment including the refrigeration and freezing temperature zones in this embodiment, the switch compartment 1205 may be a storage compartment specialized for switching to only the above-mentioned intermediate temperature zone between the refrigerated storage and the frozen storage, while leaving the refrigerated storage to the refrigerator compartment 1204 and the vegetable compartment 1207 and the frozen storage to the freezer compartment 1208. Alternatively, the switch compartment 1205 may be a storage compartment fixed to a specific temperature zone. The ice compartment 1206 makes ice by an automatic ice machine (not shown) disposed in an upper part of the ice compartment 1206 using water sent from a water storage tank (not shown) in the refrigerator compartment 1204, and stores the ice in an ice storage container (not shown) disposed in a lower part of the ice compartment 1206.

A top part of the heat-insulating main body 1201 has a depression stepped toward the back of the refrigerator. A machinery compartment is formed in this stepped depression, and high pressure components of a refrigeration cycle such as a compressor 1209 and a dryer (not shown) for water removal are housed in the machinery compartment. That is, the machinery compartment including the compressor 1209 is formed cutting into a rear area of an uppermost part of the refrigerator compartment 1204. By forming the machinery compartment to dispose the compressor 1209 in the rear area of the uppermost storage compartment in the heat-insulating main body 1201 which is hard to reach and so used to be a dead space, a machinery compartment space provided at the bottom of the heat-insulating main body 1201 in a conventional refrigerator so as to be easily accessible by users can be effectively converted to a storage compartment capacity. This significantly improves storability and usability. Note that the matters relating to the relevant part of the present invention described below in this embodiment are also applicable to a conventional type of refrigerator in which the machinery compartment is formed to dispose the compressor 1209 in the rear area of the lowermost storage compartment in the heat-insulating main body 1201.

A cooling compartment 1210 for generating cool air is provided behind the vegetable compartment 1207 and the freezer compartment 1208. An air path for conveying cool air to each compartment having heat insulation properties and a back partition wall 1211 made of a heat insulation material for heat insulating partition from each compartment are formed between the cooling compartment 1210 and each of the vegetable compartment 1207 and the freezer compartment 1208. A cooler 1212 is disposed in the cooling compartment 1210, and a cooling fan 1213 for blowing air cooled by the cooler 1212 into the refrigerator compartment 1204, the switch compartment 1205, the ice compartment 1206, the vegetable compartment 1207, and the freezer compartment 1208 by a forced convection method is placed in a space above the cooler 1212. A radiant heater 1214 made up of a glass tube for defrosting by removing frost or ice adhering to the cooler 1212 and its periphery during cooling is provided in a space below the cooler 1212. Further, a drain pan 1215 for receiving defrost water generated during defrosting and a drain tube 1216 passing from a deepest part of the drain pan 1215 through to outside the compartment are formed below the radiant heater 1214. An evaporation dish 1217 is formed outside the compartment downstream of the drain tube 1216.

The vegetable compartment 1207 includes a lower storage container 1219 that is mounted on a frame attached to a drawer door 1218 of the vegetable compartment 1207, and an upper storage container 1220 mounted on the lower storage container 1219.

A beverage container 1266 for storing PET bottled beverages, canned beverages, glass bottled beverages, and the like on the door 1218 side of a partition 1267 and the partition 1267 for separating a beverage storage space and a food storage space are formed in the lower storage container 1219.

A lid 1222 for substantially sealing mainly the upper storage container 1220 in a closed state of the drawer door 1218 is held by the inner case 1203 and a first partition wall 1223 above the vegetable compartment. In the closed state of the drawer door 1218, left, right, and back sides of an upper surface of the upper storage container 1220 are in close contact with the lid 1222, and a front side of the upper surface of the upper storage container 1220 is substantially in close contact with the lid 1222. In addition, a boundary between the lower storage container 1219 and left, right, and lower sides of a back surface of the upper storage container 1220 has a narrow gap so as to prevent moisture in the food storage unit from escaping, in a range of not interfering with the upper storage container 1220 during operation.

In detail, as shown in FIGS. 71B and 71C, a part of the lid 1222 facing a vegetable compartment discharge port 1224 has a slope 1222a so that cool air flowing in from the vegetable compartment discharge port 1224 easily moves forward. It is preferable to form such a shape that, by forming an obtuse angle with respect to a stream of cool air flowing in from the vegetable compartment discharge port 1224, guides the cool air more forward and upward.

In addition, when closing the door, a back lid engagement portion 1222b on the back of the lid 1222 and an upper storage container engagement portion 1220a of the upper storage container 1220 that engages with the back lid engagement portion 1222b are mutually sloped. Only when the door is completely closed, the back lid engagement portion 1222b and the upper storage container engagement portion 1220a engage with each other.

Further, one end of the lid 1222 on the vegetable compartment discharge port 1224 side has a flange 1222c extending downward.

A part of the upper storage container 1220 at the bottom is located inside the lower storage container 1219. A plurality of air flow holes 1271 are provided in the upper storage container 1220 located inside the lower storage container 1219.

The bottom surface of the upper storage container 1220 has a corrugated shape made up of depressions and projections.

An air path of cool air discharged from the vegetable compartment discharge port 1224 formed in the back partition wall 1211 is provided between the lid 1222 and the first partition wall 1223. Moreover, a space is provided between the lower storage container 1219 and a second partition wall 1225, thereby forming a cool air path. A vegetable compartment suction port 1226 through which cool air, having cooled the inside of the vegetable compartment 1207 and undergone heat exchange, returns to the cooler 1212 is disposed in a lower part of the back partition wall 1211 on the back of the vegetable compartment 1207.

Note that the matters relating to the relevant part of the present invention described below in this embodiment are also applicable to a conventional type of refrigerator that is opened and closed by a frame attached to a door and a rail formed on an inner case. Besides, the lid 1222, the vegetable compartment discharge port, the suction port, and the air path structure are optimized according to the storage compartment structure and the storage container form.

The back partition wall 1211 includes a back partition wall surface 1251 mainly made of a resin such as ABS, and a heat insulator 1252 made of styrene foam or the like for ensuring heat insulation by isolating the vegetable compartment 1207 from the air path for circulating cool air to each compartment and the cooling compartment 1210. Here, a depression 1211a is formed in a part of a storage compartment side wall surface of the back partition wall 1211 so as to be lower in temperature than other parts, and an electrostatic atomization apparatus 1231 as an atomization apparatus which is a mist spray apparatus is installed in the depression 1211a.

The electrostatic atomization apparatus 1231 as the atomization apparatus is mainly composed of an atomization unit 1239, a voltage application unit 1233, and an external case 1237. A spray port 1232 and a moisture supply port 1238 are each formed in a part of the external case 1237. An atomization electrode 1235 as an atomization tip is placed in the atomization unit 1239. The atomization electrode 1235 is fixed to an approximate center of one end of a cylindrical metal pin 1234 as an electrode cooling member made of a good heat conductive material such as aluminum, stainless steel, brass, or the like, and also electrically connected including one end wired from the voltage application unit 1233.

The metal pin 1234 as a heat transfer connection member is, for example, formed as a cylinder of about 10 mm in diameter and about 15 mm in length, and is preferably a high heat conductive member of aluminum, copper, or the like having a large heat capacity equal to or more than 50 times and preferably equal to or more than 100 times that of the atomization electrode 1235 of about 1 mm in diameter and about 5 mm in length. To efficiently conduct cold heat from one end to the other end of the metal pin 1234 heat conduction, it is desirable that the heat insulator covers a circumference of the metal pin 1234.

Furthermore, the heat conduction of the atomization electrode 1235 and the metal pin 1234 needs to be maintained for a long time. Accordingly, an epoxy material or the like is poured into the connection part to prevent moisture and the like from entering, thereby suppressing a heat resistance and fixing the atomization electrode 1235 and the metal pin 1234 together. Here, the atomization electrode 1235 may be fixed to the metal pin 1234 by pressing and the like, in order to reduce the heat resistance.

In addition, since the metal pin 1234 needs to conduct cool temperature heat in the heat insulator for thermally insulating the storage compartment from the cooler 1212 or the air path, it is desirable that the metal pin 1234 has a length equal to or more than 5 mm and preferably equal to or more than 10 mm. Note, however, that a length equal to or more than 30 mm reduces effectiveness.

Note that the electrostatic atomization apparatus 1231 placed in the storage compartment is in a high humidity environment and this humidity may affect the metal pin 1234. Accordingly, the metal pin 1234 is preferably made of a metal material that is resistant to corrosion and rust, or a material that has been coated or surface-treated by, for example, alumite.

In this embodiment, the metal pin 1234 is shaped as a cylinder. This being so, when fitting the metal pin 1234 into the depression of the heat insulator, the metal pin 1234 can be press-fit while rotating the electrostatic atomization apparatus 1231 even in the case where a fitting dimension is slightly tight. This enables the metal pin 1234 to be attached with less clearance. Alternatively, the metal pin 1234 may be shaped as a rectangular parallelepiped or a regular polyhedron. Such polygonal shapes allow for easier positioning than the cylinder, so that the atomization apparatus can be put in a proper position.

Furthermore, the atomization electrode 1235 is attached on a central axis of the metal pin 1234. Accordingly, when attaching the metal pin 1234, a distance between the atomization electrode 1235 and a counter electrode 1236 can be kept constant even though the electrostatic atomization apparatus 1231 is rotated. Hence, a stable discharge distance can be ensured.

The metal pin 1234 is fixed to the external case 1237, where the metal pin 1234 itself protrudes from the external case 1237. The counter electrode 1236 shaped like a circular doughnut plate is installed in a position facing the atomization electrode 1235 on the storage compartment side, so as to have the constant distance from the tip of the atomization electrode 1235. The spray port 1232 is formed on a further extension from the atomization electrode 1235.

Discharge occurs in the vicinity of the atomization electrode 1235 by high voltage application for mist spray, which raises a possibility that the tip of the atomization electrode 1235 wears out. The refrigerator 1200 is typically intended to operate over a long period of 10 years or more. Therefore, a strong surface treatment needs to be performed on the surface of the atomization electrode 1235. For example, the use of nickel plating, gold plating, or platinum plating is desirable.

Furthermore, the voltage application unit 1233 is formed near the atomization unit 1239. A negative potential side of the voltage application unit 1233 generating a high voltage is electrically connected to the atomization electrode 1235, and a positive potential side of the voltage application unit 1233 is electrically connected to the counter electrode 1236.

The counter electrode 1236 is made of, for example, stainless steel. Long-term reliability needs to be ensured for the counter electrode 1236. In particular, to prevent foreign substance adhesion and contamination, it is desirable to perform a surface treatment such as platinum plating on the counter electrode 1236.

The voltage application unit 1233 communicates with and is controlled by a control unit 1246 of the refrigerator main body, and switches the high voltage on or off according to an input signal from the refrigerator 1200 or the electrostatic atomization apparatus 1231.

The voltage application unit 1233 is placed in the electrostatic atomization apparatus 1231 and so is present in a low temperature and high humidity atmosphere in the storage compartment. Accordingly, a molding material or a coating material for moisture prevention is applied to a board surface of the voltage application unit 1233.

In the case where the voltage application unit 1233 is placed in a high temperature part outside the storage compartment or in the case where the board of the voltage application unit 1233 can be maintained at a higher temperature than the storage compartment by continuous application, however, no coating is needed because dew condensation does not occur on the voltage application unit 1233 and its board.

A partition wall heater 1254 for adjusting the temperature of the storage compartment or preventing surface dew condensation is disposed between the back partition wall surface 1251 and the heat insulator 1252 to which the electrostatic atomization apparatus 1231 is fixed. In addition, a metal pin heater 1258 for adjusting the temperature of the metal pin 1234 as the heat transfer connection member included in the electrostatic atomization apparatus 1231 and preventing excessive dew condensation on a peripheral part including the atomization electrode 1235 as the atomization tip is installed near the atomization unit 1239.

The metal pin 1234 as the heat transfer connection member is fixed to the external case 1237, where the metal pin 1234 itself has a projection 1234a that protrudes from the external case 1237. The projection 1234a of the metal pin 1234 is located opposite to the atomization electrode 1235, and fit into a deepest depression 1211b that is deeper than the depression 1211a of the back partition wall 1211.

Thus, the deepest depression 1211b deeper than the depression 1211a is formed on the back of the metal pin 1234 as the heat transfer connection member, and this part of the heat insulator 1252 on the cooling compartment 1210 side is thinner than other parts in the partition wall on the back of the vegetable compartment 1207. The thinner heat insulator 152 serves as a heat relaxation member, and the metal pin 1234 is cooled from the back by cool air or warm air of the cooling compartment 1210 via the heat insulator 1252 as the heat relaxation member.

Depending on the situation, the deepest depression 1211b deeper than the depression 1211a on the back of the metal pin 1234 as the heat transfer connection member, that is, the deepest depression 1211b of the heat insulator 1252 in the back partition wall of the vegetable compartment 1207 on the cooling compartment 1210 side, is a through hole, where the metal pin 1234 is cooled via a seal, a cover, or the like so as to keep the metal pin from direct contact with cool air.

Here, the cool air generated in the cooling compartment 1210 is used to cool the metal pin 1234 as the heat transfer connection member, and the metal pin 1234 is formed of a metal piece having excellent heat conductivity. Accordingly, a cooling unit can perform necessary cooling just by heat conduction from the air path through which the cool air generated by the cooler 1212 flows.

Since an adjustment unit can be made by such a simple structure, a highly reliable atomization unit with a low incidence of troubles can be realized. Moreover, the heat transfer connection member and the atomization electrode 1235 can be cooled by using a cooling source of a refrigeration cycle, which contributes to energy-efficient atomization.

The metal pin 1234 as the heat transfer connection member in this embodiment is shaped to have the projection 1234a on the opposite side to the atomization electrode 1235. This being so, in the atomization unit, an end 1234b on the projection 1234a side is closest to the cooling unit. Therefore, the metal pin 1234 is cooled from the end 1234b that is, in the metal pin 1234, farthest from the atomization electrode 1235. Regarding heating, the atomization electrode itself can be heated, so that the metal pin heater 1258 is located near the atomization electrode.

Though the heat insulator 1252 as the heat relaxation member covers at least the cooling unit side part of the metal pin 1234 in this example, it is preferable that the heat insulator 1252 covers the entire surface of the projection 1234a of the metal pin 1234. In such a case, the entry of heat in a transverse direction orthogonal to a longitudinal direction of the metal pin 1234 can be reduced. Since heat transfer is performed in the longitudinal direction from the end 1234b on the projection 1234a side, the metal pin 1234 is cooled by the adjustment unit from the end 1234b farthest from the atomization electrode 1235.

Here, the metal pin 1234 is heated in order to heat the atomization electrode 1235. Accordingly, the metal pin heater 1258 is installed in the vicinity. For example, by changing an applied voltage or a duty factor, the temperature of the atomization electrode can be varied via the metal pin 1234.

As another form shown in FIG. 70B, an upper rib 1261 is formed on the surface of the back partition wall 1211 between the vegetable compartment discharge port 1224 formed in the back partition wall 1211 and the spray port 1232 of the electrostatic atomization apparatus 1231, and a lower rib 1262 is formed on the surface of the back partition wall 1211 between the spray port 1232 and the vegetable compartment suction port 1226.

The upper rib 1261 is continuously formed in a left-right direction of the electrostatic atomization apparatus 1231, and positioned as high as or higher than a back upper end of the lower storage container 1219, thereby dividing a space on the back of the storage container above and below. The lower rib 1262 is provided below the upper rib 1261 in a cooling duct. The lower rib 1262 is continuously formed above the vegetable compartment suction port 1226 so as to be inclined to the left or to the right, thereby dividing a space on the back of the lower storage container 1219 above and below. Such a clearance that avoids contact when opening/closing the door in a front-back direction is provided between each of the upper rib 1261 and the lower rib 1262 and the upper storage container 1220 and the lower storage container 1219.

Thus, the lower rib 1262 is continuously formed in the left-right direction in an inclined form below the back wall in which the electrostatic atomization apparatus 1231 is installed, and the upper rib 1261 is formed in the left-right direction of the electrostatic atomization apparatus 1231. As a result, the electrostatic atomization apparatus 1231 is situated in such a space on the back wall surrounded by the upper rib 1261 and the lower rib 1262 that is kept at a high humidity.

As another form of the electrostatic atomization apparatus 1231 and its periphery shown in FIG. 72B, the depression 1211a is formed in the heat insulator 1252 and the electrostatic atomization apparatus 1231 as the atomization apparatus is installed in the depression 1211a, and also the back partition wall surface 1251 provided so as to cover the vegetable compartment 1207 side of the heat insulator 1252 covers the electrostatic atomization apparatus 1231. The back partition wall 1211 on an extension from the spray port 1232 of the electrostatic atomization apparatus 1231 has a hole 1282 as a spray port, and the back partition wall surface 1251 around the hole 1282 forms a projection 1281.

Moreover, a moisture supply port 1283 is formed in a part of the back partition wall surface 1251 so that moisture can be supplied from the storage compartment to the moisture supply port 1238 formed in a part of the external case 1237 of the electrostatic atomization apparatus 1231 or, when excessive dew condensation occurs on the atomization electrode 1235, water can be drained toward the storage compartment.

The atomization electrode 1235 as the atomization tip is placed in the atomization unit 1239. The atomization electrode 1235 is directly fixed to an approximate center of one end of the cylindrical metal pin 1234 as the electrode cooling member made of a good heat conductive material such as aluminum, stainless steel, brass, or the like with there being no insulator in between, and also electrically connected including one end wired from the voltage application unit 1233.

The metal pin 1234 is fixed to the external case 1237, where the metal pin 1234 itself has the projection 1234a that protrudes from the external case 1237. The projection 1234a of the metal pin 1234 is located opposite to the atomization electrode 1235, and fit into a depression 1211d as a through hole that is smaller than the depression 1211a of the heat insulator 1252 in the back partition wall 1211. Tape 1284 such as aluminum tape is attached to the heat insulator 1252 to block the through hole from cool air in a freezer compartment air path 1241.

The projection 1234a of the metal pin 1234 is covered with a metal pin cover 1285 made of a material such as ABS, PP, or PS for preventing water adhesion caused by a metal pin temperature variation or a surrounding environment variation. Note here that, due to some dimension error or the like, a void 1286 of a certain extent is present between the metal pin 1234 and the metal pin cover 1285. When the void 1286 is present, an air layer is generated in this area and shows heat insulation properties, making it difficult to cool the metal pin 1234. In view of this, a member such as butyl or a heat transferable compound is buried between the metal pin 1234 and the metal pin cover 1285 and between the metal pin cover 1285 and the tape 1284, as void filling members 1287a, 1287b, and 1287c for filling the void 1286. Besides, a foam material or the like may be provided on the circumference of the metal pin cover 1285 for stronger sealing, in order to prevent leakage of cool air from the freezer compartment air path 1241 into the vegetable compartment 1207 via the through hole 1211d.

Thus, the storage compartment is sealed and provided with a mechanism of retaining humidity.

An operation and working of the refrigerator having the above-mentioned structure are described below.

An operation of the refrigeration cycle is described first. The refrigeration cycle is activated by a signal from a control unit according to a set temperature inside the refrigerator, as a result of which a cooling operation is performed. A high temperature and high pressure refrigerant discharged by an operation of the compressor 1209 is condensed into liquid to some extent by a condenser (not shown), is further condensed into liquid without causing dew condensation of the refrigerator main body while passing through a refrigerant pipe (not shown) and the like disposed on the side and back surfaces of the refrigerator main body and in a front opening of the refrigerator main body, and reaches a capillary (not shown). Subsequently, the refrigerant is reduced in pressure in the capillary while undergoing heat exchange with a suction pipe (not shown) leading to the compressor 1209 to thereby become a low temperature and low pressure liquid refrigerant, and reaches the cooler 1212. Here, the low temperature and low pressure liquid refrigerant undergoes heat exchange with the air in each storage compartment by an operation of the cooling fan 1213, as a result of which the refrigerant in the cooler 1212 evaporates. Hence, the cool air for cooling each storage compartment is generated in the cooling compartment 1210. The low temperature cool air from the cooling fan 1213 is branched into the refrigerator compartment 1204, the switch compartment 1205, the ice compartment 1206, the vegetable compartment 1207, and the freezer compartment 1208 using air paths and dampers, and cools each storage compartment to a desired temperature zone. In particular, a circulation air path for the vegetable compartment 1207 is such that, after cooling the refrigerator compartment 1204, the air is discharged into the vegetable compartment 1207 from the vegetable compartment discharge port 1224 formed in a refrigerator compartment return air path for circulating the air to the cooler 1212, flows around the upper storage container 1220 and the lower storage container 1219 for indirect cooling, and then returns to the cooler 1212 from the vegetable compartment suction port 1226. Temperature control of the vegetable compartment 1207 is conducted by cool air allocation and an on/off operation of the partition wall heater 1254 formed in the partition wall, as a result of which the vegetable compartment 1207 is adjusted to 2° C. to 7° C. Note that the vegetable compartment 1207 usually does not have an inside temperature detection unit.

The depression is formed in the back partition wall 1211 on the back of the vegetable compartment 1207, and the electrostatic atomization apparatus 1231 is installed in the depression. There is the deepest depression 1211b behind the metal pin 1234 formed in the atomization unit 1239, where the heat insulator is, for example, about 2 mm to 10 mm in thickness and the temperature is lower than in other parts. In the refrigerator of this embodiment, such a thickness is appropriate for the heat relaxation member located between the metal pin 1234 and the adjustment unit. Thus, the depression 1211a is formed in the back partition wall 1211, and the electrostatic atomization apparatus 1231 having the protruding projection 1234a of the metal pin 1234 is fit into the deepest depression 1211b on a backmost side of the depression 1211a.

In another form shown in FIG. 72B, to cool the metal pin 1234 as the heat transfer cooling member, it is desirable that the heat insulator 1252 on the cooling compartment 1210 side, i.e., on the back side of the metal pin 1234 of the electrostatic atomization apparatus 1231 installed in the depression of the heat insulator 1252 of the back partition wall 1211 is made thinner (as in FIG. 72A). However, when there is an extremely thin walled part in molding of styrene foam or the like, the thin walled part decreases in rigidity, which raises a possibility of problems such as a crack and a hole caused by insufficient strength or defective molding. Thus, there is concern about quality deterioration.

In view of this, the through hole is formed in the heat insulator 1252 in the vicinity of the back of the metal pin 1234, and the opening of the heat insulator on the air path side is blocked from cool air by the tape 1284. By doing so, excessive cooling caused by leakage of cool air into the vegetable compartment is prevented.

Moreover, by covering the metal pin 1234 with the metal pin cover 1285, the metal pin is protected from excessive cooling.

There is a possibility that the void 1286 occurs between the metal pin 1234 and the metal pin cover 1285 or between the metal pin cover 1285 and the tape 1284 due to processing accuracy. When the void 1286 occurs, heat conductivity in that space deteriorates significantly, making it impossible to sufficiently cool the metal pin 1234. This hampers dew condensation on the atomization electrode tip.

To prevent this, the void 1286 is filled with the void filling members 1287a, 1287b, and 1287c such as butyl or a heat transferable compound, thereby ensuring heat conduction from the tape 1284 to the metal pin cover 1285 and from the metal pin cover 1285 to the metal pin 1234.

Cool air of about −15° C. to −25° C. generated by the cooler 1212 and blown by the cooling fan 1213 according to the operation of the refrigeration cycle flows in the freezer compartment discharge air path 1241 behind the metal pin 1234, as a result of which the metal pin 1234 is cooled to about 0° C. to −10° C. by heat conduction from the air path surface. Since the metal pin 1234 is a good heat conductive member, the metal pin 1234 transmits cold heat extremely easily, so that the atomization electrode 1235 fixed to the metal pin 1234 is also cooled to about 0° C. to −10° C. via the metal pin 1234.

A part of cool air flowing into the vegetable compartment 1207 from the vegetable compartment discharge port 1224 enters the lower storage container 1219 from a gap between the bottom of the upper storage container 1220 and the back upper end of the lower storage container 1219 and cools the foods stored inside. However, this flow is merely one part. The foods stored inside are mainly cooled by cool air that passes through the space above the lid 1222, i.e., the space between the lid 1222 and the first partition wall 1223, and enters into a front part of the lower storage container 1219 from a front part of the upper storage container 1220 on the door side.

A part of the lid 1222 facing the vegetable compartment discharge port 1224 has the slope 1224a so that cool air flowing in from the vegetable compartment discharge port 1224 easily moves forward. By forming an obtuse angle with respect to a stream of cool air flowing in from the vegetable compartment discharge port 1224, the cool air is guided more forward and upward. Accordingly, the cool air flowing in from the vegetable compartment discharge port 1224 passes through the space between the lid 1222 and the first partition wall 1223 more easily, as a result of which a large amount of cool air enters into the beverage container 1266 in the front part of the lower storage container 1219 from the front part of the upper storage container 1220 on the door side.

That is, the path for introducing cool air into the storage containers from the vegetable compartment discharge port 1224 is as follows. Dry cool air mainly enters into the beverage container 1266 on the door side of the lower storage container 1219, thereby cooling beverages such as PET bottled beverages stored in the front part of the lower storage container 1219. Next, the cool air which has become relatively high in humidity after passing through the lower storage container 1219 flows into the upper storage container 1220 and near the electrostatic atomization apparatus 1231. Accordingly, a relatively high humidity can be attained on the back side of the vegetable compartment as compared with the front side, i.e., the door side, or the vegetable compartment. This creates a high humidity atmospheric environment around the electrostatic atomization apparatus 1231 located at the back, so that water in the air easily builds up dew condensation in the electrostatic atomization apparatus 1231.

Meanwhile, a water vapor generated by transpiration of foods relatively high in water content stored in the lower storage container 1219 such as Chinese cabbage, spinach, and lettuce flows toward the back partition wall 1211 from the gap between the bottom of the upper storage container 1220 and the top of the lower storage container 1219. Since the upper rib 1261 and the lower rib 1262 are continuously formed above and below in the left-right direction. The flowing water vapor is kept from escaping. As a result, the vicinity of the electrostatic atomization apparatus 1231 is maintained relatively high in humidity.

Here, the vegetable compartment is 2° C. to 7° C. in temperature, and also a relatively high humidity state is maintained in the storage containers and near the electrostatic atomization apparatus due to the air path structure and transpiration from vegetables and the like. Accordingly, the atomization electrode 1235 as the atomization tip drops to the dew point or below, and as a result water is generated and water droplets adhere to the atomization electrode 1235 including its tip.

Since the back lid engagement portion 1222b on the back of the lid 1222 and the upper storage container engagement portion 1220a of the upper storage container 1220 that engages with the back lid engagement portion 1222b are mutually sloped, a collision sound of closing the door occurs only when the door is completely closed. In the case where the back lid engagement portion 1222b and the upper storage container engagement portion 1220a are not sloped, the collision starts to occur before the door is completely closed. This may cause deterioration such as wear of the engagement portions, and also the collision sound may disturb a user. In view of this, in this embodiment, by sloping the engagement portions, the back lid engagement portion 1222b and the upper storage container engagement portion 1220a engage with each other only when the door is completely closed. Since no collision sound occurs during a process of closing the door, the door can be closed smoothly without disturbing the user.

Moreover, by providing the downward extending flange 1222c at the end of the lid 1222 on the vegetable compartment discharge port 1224 side, dry cool air of a low temperature flowing from the vegetable compartment discharge port 1224 is kept from directly flowing into the upper storage container 1220, so that the upper storage container 1220 is maintained in a high humidity environment.

Cool air flowing in the vegetable compartment flows out of the vegetable compartment via the vegetable compartment suction port 1226 located extreme downstream.

When cool air does not flow into the vegetable compartment 1207 from the vegetable compartment discharge port 1224, water evaporates from the foods stored in the lower storage container 1219 as time passes from when the foods are stored into the lower storage container 1219. During this, along the flow of cool air flowing into the lower storage container 1219, air containing evaporated water flows out of the storage container from a cool air flow part that is a largest part of the gap between the side wall of the lower storage container 1219 where the electrostatic atomization apparatus 1231 is located (the back side wall of the lower storage container 1219 in this embodiment) and the bottom surface of the upper storage container 1220 and, having been changed in direction by the upper rib 1261 as a humidity introduction unit continuously formed in the left-right direction of the electrostatic atomization apparatus 1231, reaches the vicinity of the electrostatic atomization apparatus 1231.

Here, since the electrostatic atomization apparatus 1231 is located on the right side where the vegetable compartment suction port 1226 of the vegetable compartment 1207 is provided whereas the upper rib 1261 is located on the left side of the electrostatic atomization apparatus 1231, cool air is pulled from the vegetable compartment suction port 1226, and so the right side which is the vegetable compartment suction port 1226 side is relatively high in humidity than the left side. This being so, by disposing the electrostatic atomization apparatus 1231 near the vegetable compartment suction port 1226 of the vegetable compartment 1207, the periphery of the electrostatic atomization apparatus 1231 can be put in a higher humidity state. This eases dew condensation of water in the air. Moreover, it is desirable that the upper rib 1261 is situated on both sides of the electrostatic atomization apparatus 1231. In so doing, high humidity cool air is prevented from leaking upward, with it being possible to further make the periphery of the electrostatic atomization apparatus 1231 higher in humidity.

Thus, the metal pin 1234 and the atomization electrode 1235 of the electrostatic atomization apparatus 1231 situated in a high humidity atmosphere are cooled lower than an ambient temperature by heat conduction from cool air of a lower temperature than the vegetable compartment, as compared with its adjacent section. Accordingly, water in the electrostatic atomization apparatus 1231 in a relatively high humidity atmosphere builds up dew condensation on the atomization electrode 1235. This dew condensation water is sprayed in a mist form into the containers where vegetables and the like are stored. As a result, water evaporated from the stored foods will end up being returned to the stored foods themselves by the electrostatic atomization apparatus 1231. To do so, a cooling unit for cooling the metal pin 1234 and the atomization electrode 1235 of the electrostatic atomization apparatus 1231 needs to be in a space in which lower temperature cool air than the storage compartment including the electrostatic atomization apparatus 1231 flows. In the case where the cooling unit does not use such an air path, the cooling unit uses, for example, cool air of an adjacent storage compartment of a lower temperature zone (such as the freezing temperature zone).

The fine mist sprayed by the electrostatic atomization apparatus 1231 not only fills the space in the lower storage container 1219 into which the mist is directly sprayed, but also reaches the space in the upper storage container 1220 located above the lower storage container 1219.

This is because a part of the upper storage container 1220 at the bottom is located inside the lower storage container 1219, and the plurality of air flow holes 1271 are provided in the upper storage container 1220 located inside the lower storage container 1219.

The fine mist generated by the electrostatic atomization apparatus 1231 has an extremely small particle diameter in nano-size, and so is lightweight and exhibits high diffusivity. Accordingly, an especially diffusive part of the fine mist filling the lower storage container 1219 flows into the space in the upper storage container 1220 via the air flow holes 1271 and fills the space in the lower storage container 1220 the top of which is blocked by the lid 1222. This increases a probability of the fine mist adhering to the food surfaces, thereby enhancing the effect of the fine mist.

As shown in FIG. 71D, a handle 1220b is provided in the upper storage container 1220, forming an opening. In the cool air path in the vegetable compartment shown in FIG. 71A, this part is apart from both the discharge port and the suction port of the vegetable compartment, and so the flow is relatively slow in this part. Besides, as a result of being pulled by cool air flowing downward from the upper side of the lid 1222, cool air exits from the upper storage container 1220 more than enters into the upper storage container 1220 via the handle 1220b as the opening. Hence, the handle 1220b substantially serves as a cool air outlet from the upper storage container 1220.

Therefore, high humidity cool air flows in from the plurality of air flow holes 1271 formed on the side or bottom surface of the upper storage container 1220 and gradually flows out from the handle 1220b. With such a structure in which dry cool air is less likely to flow into the upper storage container 1220 even when the handle 1220b by the opening is provided, it is possible to maintain a high humidity.

Furthermore, the lid 1222 is put on the upper storage container 1220, thereby preventing relatively low temperature cool air from directly flowing into the storage container. In addition, since the space in the upper storage container 1220 is cooled by relatively high temperature air containing a mist and so retaining relative humidity that flows upward from the lower storage container 1219 as mentioned above, not only freshness preservation can be improved but also low temperature damage can be suppressed. By storing vegetables and fruits especially susceptible to low temperature damage in the upper storage container 1220, the vegetables and fruits can last for a long time in a fresher state.

In other words, the upper storage container 1220 mainly storing vegetables, fruits, and so on has the lid 1222 on its top and so is kept in a high humidity space. Besides, the upper storage container 1220 has openings only in its bottom or side surface. The mist is not directly sprayed into the upper storage container 1220 from the atomization apparatus. Rather, the mist sprayed into the lower storage container 1219 diffuses upward and flows into the upper storage container 1220, as a result of which the mist is directly sprayed into the upper storage container 1220.

Accordingly, a more diffusive mist with a smaller particle diameter in the mist sprayed into the lower storage container 1219 enters into the upper storage container 1220 via the air flow holes 1271, so that the mist evenly reaches the stored vegetables. This enables vegetables and fruits to last for a long time in a fresh state.

Thus, the upper storage container 1220 is indirectly cooled by cool air, and also indirectly sprayed with a mist. Since the space in the upper storage container 1220 is cooled by high humidity cool air of a relatively high temperature flowing upward from the lower storage container 1219, not only excessive cooling can be prevented and freshness preservation can be improved, but also low temperature damage can be suppressed. By storing vegetables and fruits especially susceptible to low temperature damage in the upper storage container 1220, the vegetables and fruits can last for a long time in a fresher state.

In addition, the bottom surface of the upper storage container 1220 has a corrugated shape made up of depressions and projections. Accordingly, the mist particles evenly adhere to the surfaces of vegetables and fruits in the upper storage container 1220 not only on the top and the sides but also from around the bottom. Hence, the mist particles can fill around the vegetables and fruits more multidirectionally, which contributes to improved freshness preservation.

Furthermore, in this embodiment, continuous depressions or projections are formed across the left-right direction of the upper storage container 1220 so that the corrugated shape is substantially in parallel with the flow of air entering from the air flow holes 1271 formed on the side. This allows mist-containing cool air flowing in from the air flow holes 1271 to move around the bottom more easily. As a result, freshness preservation can be further improved.

Thus, in this embodiment, the flow of cool air in the vegetable compartment is controlled in order to effectively use the cool air. First, dry cool air of a low temperature is supplied in a large quantity into the beverage container 1266 in front of the beverage partition plate 1267 where beverages such as PET bottled beverages are often stored, to cause the beverages to be in direct contact with the low temperature cool air to thereby ensure a cooling speed. Next, since the humidity increases as the cool air entering from the front of the vegetable compartment flows toward the back, the back side has a relatively high humidity when compared with the door side. This creates a high humidity atmospheric environment around the electrostatic atomization apparatus 1231 located at the back, so that water in the air easily builds up dew condensation in the electrostatic atomization apparatus 1231. The mist sprayed by the electrostatic atomization apparatus 1231 using water droplets generated by dew condensation of water in the storage compartment fills the lower storage container 1219 as a fine mist of a nano-level particle diameter having high diffusivity. Further, a mist of a smaller particle diameter having more intense intensity in the mist sprayed into the lower storage container 1219 flows into the upper storage container 1220 located in an upper area that is higher in temperature than a lower area, for humidification.

By controlling the flow of cool air in this manner, when contents to be cooled speedily are stored in the beverage container 1266 in the front part, ordinary vegetables and fruits relatively unsusceptible to low temperature damage and the like are stored in the lower storage container 1219, and vegetables and fruits more susceptible to low temperature damage are stored in the upper storage container 1220, it is possible to perform cooling suitable for each content. This enables a vegetable compartment of higher quality with improved freshness preservation to be provided.

In this embodiment, based on the premise that the mist is sprayed, the lid is provided on the upper storage container 1220 for preventing low temperature damage caused by low temperature dry cool air flowing into the upper storage container 1220. However, since the cooling speed of PET bottled beverages can be increased by releasing the cool air introduced from the vegetable compartment discharge port 1224 first to the PET bottle container, even in the case where the mist spray apparatus is not installed, it is possible to, having increased the cooling speed of PET bottled beverages, improve the freshness preservation of the upper storage container 1220.

Therefore, even when the mist spray apparatus is not installed, by forming the air path as in this embodiment so that the low temperature dry cool air first enters into the beverage container 1266 in the door side part of the lower storage container 1219 and then passes through the lower storage container 1219 storing vegetables and the like and flows into the upper storage container 1220, an effect of achieving moisture retention and high temperature of the upper storage container to some extent can be attained. When mist spray is performed in addition to this structure, a synergistic effect of suppressing low temperature damage can be attained.

In the case where cool air does not flow in from the vegetable compartment discharge port 1224 as mentioned above, even when a damper located upstream of the vegetable compartment discharge port 1224 in the air path is closed, cool air flows from the inside of the lower storage container 1219 toward the vegetable compartment suction port 1226 though only gradually because no damper is typically disposed downstream of the vegetable compartment suction port 1226. However, by providing the lower rib 1262 above the vegetable compartment suction port 1226, air containing evaporated water does not directly flow toward the vegetable compartment suction port 1226 but is held in the space defined by the upper rib 1261 and the lower rib 1262. Accordingly, high humidity cool air stays in the space defined by the upper rib 1261 and the lower rib 1262 and gathers in the vicinity of the electrostatic atomization apparatus 1231, allowing the electrostatic atomization apparatus 1231 to collect moisture easily.

This eases dew condensation on the atomization electrode 1235 of the electrostatic atomization apparatus 1231 situated in a high humidity atmosphere, with it being possible to enhance mist generation efficiency.

A principle of fine mist generation is described below.

The voltage application unit 1233 applies a high voltage (for example, 4 kV to 10 kV) between the atomization electrode 1235 to which water droplets adhere and the counter electrode 1236, where the atomization electrode 1235 is on a negative voltage side and the counter electrode 1236 is on a positive voltage side. This causes corona discharge to occur between the electrodes. The water droplets at the tip of the atomization electrode 1235 are finely divided by electrostatic energy. Furthermore, since the liquid droplets are electrically charged, a nano-level fine mist carrying an invisible charge of a several nm level, accompanied by ozone, OH radicals, and so on, is generated by Rayleigh fission. The voltage applied between the electrodes is an extremely high voltage of 4 kV to 10 kV. However, a discharge current value at this time is at a several μA level, and therefore an input is extremely low, about 0.5 W to 1.5 W. Hence, there is little influence on the inside temperature.

There is also a method of ionizing water droplets by using the Lenard effect or the like. In such a case, however, the amount of radicals generated is extremely small when compared with the present invention, and also a large-size apparatus is required in order to use Coriolis forces or centrifugal forces. Accordingly, this method is not suitable for household refrigerators.

In detail, suppose the atomization electrode 1235 is on a reference potential side (0 V) and the counter electrode 1236 is on a high voltage side (+7 kV). Dew condensation water adhering to the tip of the atomization electrode 1235 reduces the distance to the counter electrode 1236. As a result, an air insulation layer is broken down, and discharge starts. At this time, the dew condensation water is electrically charged, and also an electrostatic force generated on the surfaces of the liquid droplets exceeds a surface tension, so that fine particles are generated. Since the counter electrode 1236 is on the positive side, the charged fine mist is attracted to the counter electrode 1236, and the fine particles are further ultra-finely divided by Rayleigh fission. Thus, the nano-level fine mist carrying an invisible charge of a several nm level containing highly reactive radicals is attracted to the counter electrode 1236, and sprayed toward the storage compartment by its inertial force.

Note that, when there is no water on the atomization electrode 1235, the discharge distance increases and the air insulation layer cannot be broken down, and therefore no discharge phenomenon takes place. Hence, no current flows between the atomization electrode 1235 and the counter electrode 1236.

Relatively dry, low temperature cool air which is a part of cool air heat-exchanged and generated in the cooler 1212 flows into the vegetable compartment 1207 from the vegetable compartment discharge port 1224. Most of the cool air does not flow downward but flows forward from the upper side of the lid 1222, due to the presence of the upper rib 1261. The cool air does not directly flow into the case, as most of the cool air passes above the lid 1222, and flows into the beverage container 1266 storing typical PET-bottled beverages, glass-bottled beverages, canned beverages, and so on from an upper part of the lower storage container 1219 on the door side. As a result, beverages such as PET-bottled beverages are cooled. During this time, the cool air does not directly flow into the upper storage container 1220 below the lid 1222. Since the upper storage container 1220 is indirectly cooled, the humidity can be kept relatively easily. Moreover, since the cool air tends not to directly flow into the upper storage container 1220, the temperature is kept relatively high.

In the case where the compartment located above is a storage compartment, such as the ice compartment 1206 or the switch compartment (not shown), held at a lower temperature zone, e.g., the freezing temperature zone, than the vegetable compartment 1207, cool air on the vegetable compartment 1207 side is cooled by heat conduction through the first partition wall. The lid 1222 prevents this cooled air of a relatively low temperature from directly flowing into the upper storage container 1220, so that the storage space in the upper storage container 1220 can be kept relatively high in temperature.

The cool air further flows toward the back of the lower storage container 1219, absorbs water evaporated from vegetables stored therein, and flows out from the back surface of the lower storage container 1219.

Even when the cooling fan 1213 is stopped, the water vapor in the lower storage container 1219 flows out from the above-mentioned part.

This further eases supply of moisture to the atomization unit in the electrostatic atomization apparatus 1231.

The mist generated in the electrostatic atomization apparatus 1231 is sprayed into the lower storage container 1219. However, since the mist has an extremely small particle diameter and so has relatively high intensity, the mist is diffused not only throughout the lower storage container 1219 but also in the upper storage container 1220. That is, the fine mist containing radicals is sprayed throughout the vegetable compartment 1207.

FIG. 73 shows an experimental result indicating the state of the refrigerator described above.

In FIG. 73, a horizontal axis represents time, and a vertical axis represents a discharge current monitor voltage value. The discharge current monitor voltage value is set to decrease only when a current flows between the electrodes, that is, a discharge phenomenon occurs and a fine mist is generated, and outputted.

In the refrigerator 1200, when the temperature of the cooler 1212 begins to drop, that is, when the operation of the refrigeration cycle starts, the cooling of the vegetable compartment 1207 starts, too. At this time, cool air flows into the vegetable compartment 1207, creating a dry state. Accordingly, the atomization electrode 1235 tends to dry.

Next, when a refrigerator compartment damper (not shown) is closed, the refrigerator compartment discharge air temperature rises, and so the refrigerator compartment 1204 and the vegetable compartment 1207 increase in temperature and humidity. During this time, since the freezer compartment discharge cool air temperature gradually decreases, the metal pin 1234 is further cooled, and dew condensation is more likely to occur on the atomization electrode 1235 of the atomization unit 1239 disposed in the vegetable compartment 1207 which has shifted to a high humidity environment. When liquid droplets grow at the tip of the atomization electrode 1235 and the distance between the tip of the liquid droplets and the counter electrode 1236 becomes a predetermined distance, the air insulation layer is broken down, the discharge phenomenon begins, and the fine mist is sprayed from the tip of the atomization electrode 1235. At this time, a very small current flows between the electrodes, so that the discharge current monitor voltage value decreases as shown in the waveform in the drawing. After this, the compressor 1209 is stopped and also the cooling fan 1213 is stopped. As a result, the metal pin 1234 increases in temperature, but the atomization unit 1239 remains in a high humidity atmosphere. Moreover, the metal pin 1234 has a large heat capacity and so does not have a rapid temperature fluctuation, that is, the metal pin 1234 functions as the so-called cool storage. Furthermore, an increase in water temperature of the liquid droplets causes a decrease in surface tension of the liquid droplets, thereby creating an environment in which atomization is easily performed by applying the same electrostatic energy. Accordingly, the atomization continues.

When the operation of the compressor 1209 starts again, the refrigerator compartment damper (not shown) is opened, and cool air begins to be conveyed to each storage compartment by the cooling fan 1213. The storage compartment shifts to a low humidity state, and so the atomization unit 1239 also enters a low humidity state. As a result, the atomization electrode 1235 becomes dry, and the liquid droplets at the atomization electrode 1235 decrease or disappear.

During normal cooling of the refrigerator, by repeating such a cycle, the liquid droplets at the atomization electrode tip are adjusted within a fixed range.

During defrosting for melting and removing frost or ice adhering to the cooler 1212, the temperature of the cooler 1212 exceeds 0° C., and typically becomes 10° C. or more. At this time, the freezer compartment discharge air path 1241 behind the electrostatic atomization apparatus also increases in temperature. This temperature increase causes the temperature of the metal pin 1234 to rise, and also the temperature of the atomization electrode 1235 to rise. As a result, the dew condensation water adhering to the tip is easily atomized because the surface tension decreases due to an increase in water temperature. After this, the dew condensation water evaporates, and the atomization electrode 1235 dries.

Since the radiant heater 1214 has a property of being switched off as the temperature of the cooler rises to some extent, there is an advantage that the electrode and the heat transfer connection member can be reliably increased in temperature within an appropriate range without excessively increasing in temperature of the electrode and the heat transfer connection member.

Besides, the counter electrode 1236 is disposed at a position facing the atomization electrode 1235, and the voltage application unit 1233 generates a high-voltage potential difference between the atomization electrode 1235 and the counter electrode 1236. This enables an electric field near the atomization electrode 1235 to be formed stably. As a result, an atomization phenomenon and a spray direction are determined, and so accuracy of a fine mist sprayed into the storage container and a spray amount of the fine mist can be more enhanced.

Though the mist sprayed here is diffused, the mist containing radicals hardly escapes because the storage containers have small opening areas due to the lid 1222 and the like. The mist sprayed by the electrostatic atomization apparatus 1231 using water droplets generated by dew condensation of water in the storage compartment fills the lower storage container 1219 as a fine mist of a small particle diameter having high diffusivity. Further, a mist of a smaller particle diameter having higher intensity in the mist sprayed into the lower storage container 1219 flows into the upper storage container 1220 located in an upper area that is higher in temperature than a lower area.

Since the cooling unit can be made by such a simple structure, a highly reliable atomization unit with a low incidence of troubles can be realized. Moreover, the metal pin 1234 as the heat transfer connection member and the atomization electrode 1235 as the atomization tip can be cooled by using the cooling source of the refrigeration cycle, which contributes to energy-efficient atomization.

Besides, the atomization unit 1239 does not extend through and protrude out of the back partition wall 1211 of the vegetable compartment 1207 as the storage compartment. Accordingly, an air path area is unaffected, and a decrease in cooling amount caused by an increased air path resistance can be prevented.

Moreover, the depression is formed in a part of the back partition wall 1211 and the atomization unit 1239 is inserted into this depression, so that a storage capacity for storing vegetables, fruits, and other foods is unaffected. In addition, while reliably cooling the heat transfer connection member, a wall thickness enough for ensuring heat insulation properties is secured for other parts. This prevents dew condensation in the case, thereby enhancing reliability.

Additionally, the metal pin 1234 as the heat transfer connection member has a certain level of heat capacity and is capable of lessening a response to heat conduction from the cooling air path, so that a temperature fluctuation of the atomization electrode 1235 can be suppressed. The metal pin 1234 also functions as a cool storage member, thereby ensuring a dew condensation time for the atomization electrode 1235 and also preventing freezing. Furthermore, by combining the good heat conductive metal pin 1234 and the heat insulator, the cold heat can be conducted favorably without loss. Besides, the metal pin 1234 and the atomization electrode 1235 are directly connected with there being no heat insulator such as an insulation material, so that a heat resistance at the connection part is suppressed. Therefore, temperature fluctuations of the atomization electrode 1235 and the metal pin 1234 follow each other favorably. In addition, thermal bonding can be maintained for a long time because moisture cannot enter into the connection part.

Moreover, even in the case of using the metal pin cover 1285, the heat resistance from the cooling surface to the metal pin 1234 can be reduced by filling the void 1286 between the metal pin 1234 and the metal pin cover 1285 with the heat conductive member. Hence, the atomization electrode 1235 can be sufficiently cooled.

The generated fine mist containing OH radicals and O2 radicals is sprayed into the lower storage container 1219, but also reaches the upper storage container 1220 because the fine mist is made up of extremely small fine particles and so has high diffusivity. Here, the fine mist hardly escapes as the lid 1222 is provided on the upper storage container.

The sprayed fine mist is generated by high-voltage discharge, and so is negatively charged. Meanwhile, green leafy vegetables, fruits, and the like stored in the vegetable compartment 1207 tend to wilt more by transpiration or by transpiration during storage. Usually, some of vegetables and fruits stored in the vegetable compartment are in a rather wilted state as a result of transpiration on the way home from shopping or transpiration during storage, and these vegetables and fruits are positively charged. Accordingly, the atomized mist tends to gather on vegetable surfaces, thereby enhancing freshness preservation.

Regarding fungi that adhere to vegetables and fruits and accelerate deterioration, the fine mist containing OH radicals having oxidative power exhibits microbial elimination and suppression effects by directly acting upon cell membranes or hyphae of the fungi themselves. This is not limited to bacteria, but also effectively suppresses molds, viruses, and the like. Hence, deterioration factors as external factors can be reduced.

Moreover, as a result of the OH radical containing mist adhering to vegetables and fruits, bacteria on surfaces can be eliminated, so that necrosis of vegetable surface cells caused by bacteria can be prevented. Accordingly, generation of ethylene gas, which is an aging accelerating medium of vegetables and fruits, caused by necrosis of vegetable surface cells can be suppressed.

Furthermore, it has been found that the radical containing fine mist generated at the tip of the atomization electrode 1235 reacts with and decomposes ethylene gas which accelerates aging of vegetables and fruits. As shown in FIG. 77, the decomposition is at high speed, as the fine mist has a decomposition capacity of decomposing 80% ethylene gas in about four hours.

Besides, as a result of measuring an ethylene concentration when apples and the like that tend to emit ethylene are stored in a box of a predetermined capacity as shown in FIG. 78, a present invention product exhibits an extremely small ethylene gas amount equal to or less than a detection limit after three days and after seven days. On the other hand, a conventional product stores at a concentration exceeding 1 ppm. This accelerates aging, thereby accelerating discoloration and also making the apples and the like more perishable. The present invention product suppresses the ethylene gas generation itself, and also acts to decomposes ethylene gas generated from the vegetables and fruits themselves or generated from other vegetables and fruits stored in the same space. In this way, deterioration of vegetables and fruits due to aging progression can be prevented, and freshness preservation can be significantly improved.

Factors for progress of deterioration (in freshness and nutrient) of vegetables and fruits include not only external factors such as a water retention state of the above-mentioned surface layer, the presence of bacteria, ethylene gas, and the like, but also internal factors.

The internal factors include an enzyme reaction, a water retention state inside vegetables and fruits, and the like.

First, regarding low temperature damage of vegetables and fruits, when vegetables and fruits such as bananas that originally grow in tropical and subtropic regions are refrigerated, their skins are blackened due to low temperature damage.

When low temperature damage occurs, tannin on the surfaces of the bananas is oxidatively polymerized by polyphenol oxidase, and becomes solidified and blackened due to low temperature. Unlike black pits on banana surfaces caused by ethylene gas as often seen in normal temperature storage, the entire surfaces are blackened.

This being so, conventionally, even when low temperature storage is performed to prolong storage life, storage while maintaining quality is difficult. Thus, there is a limit to storing vegetables and fruits unsuitable for low temperature storage, in households and the like. This impairs convenience as a refrigerator and causes certain constraints on responding to various demands of dietary habit.

In this embodiment, on the other hand, as described above, though the sprayed fine mist is diffused, the mist containing radicals hardly escapes because the storage containers have small opening areas due to the lid 1222 and the like. Moreover, the mist sprayed by the electrostatic atomization apparatus 1231 using water droplets generated by dew condensation of water in the storage compartment fills the lower storage container 1219 as a fine mist of a small particle diameter having high diffusivity. Further, a mist of a smaller particle diameter having higher intensity in the mist sprayed into the lower storage container 1219 flows into the upper storage container 1220 located in an upper area that is higher in temperature than a lower area, thereby effecting moisture retention. Thus, OH radicals and the like in the fine mist exhibit a function of suppressing low temperature damage. That is, the radicals contained in the fine mist adhere to skins and penetrate from the skins to inhibit an enzyme reaction, thereby suppressing low temperature damage and preventing blackening.

FIG. 74 shows the above-mentioned experimental result. This is the comparison between the present invention product and the conventional product when eight-day storage is performed in the present example.

It can be understood from this that the developed product prevents discoloration and suppresses low temperature damage.

FIGS. 75A, 75B, and 75C respectively show comparison results using carrots, shiitake mushrooms, and eggplants.

In FIG. 75A, carrots are unsusceptible to low temperature, but damage such as surface blackening occurs when their storage environment becomes dry. Especially when storing in a refrigerator, conventionally the storage environment tends to be dry due to on/off switching of cool air. In the developed product, on the other hand, since the nano-level mist adheres to the surfaces of the carrots, it is possible to prevent drying and thus prevent blackening. Moreover, there is no risk of water rot and the like because the mist particles are small.

Likewise, in the result of shiitake mushrooms shown in FIG. 75B, while partial blackening in a dry state is seen in the conventional product, a favorable storage state is observed in the developed product.

Furthermore, in the result of eggplants shown in FIG. 75C, the surfaces have depressions and the like and also become hard in the conventional product. This indicates the occurrence of low temperature damage. Typically, a favorable storage temperature for eggplants is about 10° C., and the above-mentioned situation occurs when eggplants are stored at 5° C. or less.

In the developed product, on the other hand, a good surface state is observed, and also there are no depressions. This indicates that low temperature damage is suppressed.

As can be understood from the above, drying prevention and low temperature damage suppression can be achieved by the present invention.

To further clarify this low temperature damage suppression effect, the following experiment has been conducted.

Typically, on cell membranes, while potassium ions try to leak to outside by osmotic pressure action, ATPase functions as a barrier and prevents such leakage. It is known that, when low temperature damage occurs, this function of ATPase weakens and potassium ions leak. In view of this, the present invention product and the conventional product are compared for each food, as shown in FIG. 76.

According to the results, it is clear that the present invention product suppresses the leakage of potassium ions in the comparison of any food, demonstrating the low temperature damage suppression effect of the present invention.

As described above, according to the present invention, it is possible to maintain freshness preservation of carrots, shiitake mushrooms, and the like that spoil by drying, and also suppress low temperature damage even in a low temperature storage state. Accordingly, while prolonging a storage period in low temperature storage, vegetables and fruits such as the above-mentioned bananas, eggplants, and cucumbers that are frequently used but are susceptible to low temperature storage can be stored while maintaining quality. This enhances convenience as a refrigerator. Since various demands of dietary life can be responded, a unique refrigerator with extremely high practical effectiveness can be provided.

Regarding nutrients of vegetables and fruits, when a fine mist containing radicals adheres to the surfaces of the vegetables, water containing radicals penetrates from leaf surfaces, and becomes signals for secretion of plant hormones such as jasmonic acid. This induces enzyme expression and biological defense reactions, as a result of which antioxidants such as vitamin C, E, and A are generated. In this way, stored broccoli sprouts, white radish sprouts, spinaches, mulukhiyas, and watercresses in this example have increased nutrients such as vitamin, when compared with initial storage. FIGS. 79A to 79D show the results.

It can be understood from this that vitamin C, vitamin A, polyphenol, and the like are increased in nutritive value after three days from storage start.

Moreover, vitamin E is maintained in nutritive value, when compared with the conventional product.

Thus, a temporal nutrient decrease as an internal factor is arrested, and further an onset of nutrient increase effect becomes possible. This makes it possible to provide a refrigerator of high value that is not limited to a refrigerator function of merely suppressing progress of deterioration of vegetables and fruits by low temperature storage but is capable of enhancing food value by increasing nutrients through storage.

Furthermore, regarding internal water retention of vegetables and fruits, when the fine mist containing radicals adheres to the surfaces of the vegetables and fruits, activated water containing radicals penetrates from surface layers, and increases a water retention state from inside for activation. Thus, freshness preservation can be enhanced from both inside and outside the vegetables and fruits, while preventing drying and wilting.

As described above, according to the present invention, the nano-level fine mist containing radicals not only protects vegetables and fruits from external factors, but also penetrates into the vegetables and fruits at a cellular level to thereby activate an internal organic activity and further suppress an enzyme reaction causing deterioration.

That is, not only the external factors can be addressed such as by water retention state maintenance on surfaces of vegetables and fruits, elimination and suppression of fungi, suppression of ethylene gas generation due to necrosis of surface layer cells caused by fungi, and decomposition of generated ethylene gas, but also various effects such as low temperature damage suppression, nutrient increase, nutrient decrease suppression, and activation by activated water penetration can be achieved by fine mist penetration into the vegetables and fruits. Taking a household refrigerator as an example, conventionally, the function of suppressing fungi activities and deterioration factors such as respiration and transpiration of vegetables and fruits by maintaining a low storage temperature is mainly used to prolong a storage period while excluding some vegetables and fruits not suitable for a low temperature environment. According to the present invention, on the other hand, it is possible to provide a refrigerator of extremely high value that has the storage function of not only maintaining freshness but also enhancing food value such as nutrient improvement, while storing a wide range of vegetables of fruits including those not suitable for a low temperature environment regardless of the types of vegetables and fruits. This contributes to a wider variation of dietary habit.

The nano-level fine mist adhering to the vegetable surfaces sufficiently contains OH radicals, a small amount of ozone, and the like. Such a nano-level fine mist is effective in sterilization, antimicrobial activity, microbial elimination, and so on.

Moreover, the generated fine mist is made up of extremely small particles of nano-level and so has high diffusivity. Therefore, the fine mist is diffusively sprayed in the storage compartment according to natural convection in the storage compartment, so that the effect of the fine mist spreads throughout the storage compartment.

As described above, though the sprayed fine mist is diffused, the mist containing radicals hardly escapes because the storage containers have small opening areas due to the lid 1222 and the like. Moreover, the mist sprayed by the electrostatic atomization apparatus 1231 using water droplets generated by dew condensation of water in the storage compartment fills the lower storage container 1219 as a fine mist of a small particle diameter having high diffusivity. Further, a mist of a smaller particle diameter having higher intensity in the mist sprayed into the lower storage container 1219 flows into the upper storage container 1220 located in an upper area that is higher in temperature than a lower area, thereby effecting moisture retention. Thus, the upper storage container 1220 forms a space that is high in temperature and is filled with a highly diffusive fine mist as compared with other storage spaces in the vegetable compartment, so that, in addition to the effect of OH radicals contained in the mist, the effect of suppressing low temperature damage can be further enhanced.

OH radicals are typically short-lived. For instance, the radicals may react with another substance and disappear in several seconds during which the radicals are floating in the storage compartment. However, the radicals according to the present invention are covered with water molecules, and so their life can be increased by about 300 times, that is, extended to about 10 minutes. Such a longer floating period enables the OH radicals and the like to effectively adhere to foods in a sealed environment such as a refrigerator.

When there is no water on the atomization electrode 1235, the discharge distance increases and the air insulation layer cannot be broken down, and therefore no discharge phenomenon takes place. Hence, no current flows between the atomization electrode and the counter electrode. This phenomenon may be detected by the control unit 1246 of the refrigerator 1200 to control on/off of the high voltage of the voltage application unit 1233.

In this embodiment, the voltage application unit 1233 is installed at a relatively low temperature and high humidity position in the storage compartment. Accordingly, a dampproof and waterproof structure by a potting material or a coating material is employed for the voltage application unit 1233 for circuit protection.

Note, however, that the above-mentioned measure is unnecessary in the case where the voltage application unit 1233 is installed outside the storage compartment.

As described above, in the thirty-third embodiment, the thermally insulated storage compartment and the electrostatic atomization apparatus that sprays a mist into the storage compartment are provided. The atomization unit includes the atomization electrode electrically connected to the voltage application unit for generating a high voltage, the counter electrode disposed facing the atomization electrode, and the adjustment unit for the water amount of the atomization electrode. By causing water in the air to build up dew condensation on the atomization electrode and to be sprayed as a mist into the storage compartment, low temperature damage of stored vegetables and fruits can be suppressed by radicals contained in the fine mist.

Moreover, ozone and OH radicals generated simultaneously with the mist contribute to enhanced effects of deodorization, removal of harmful substances from food surfaces, contamination prevention, microbe elimination, and the like.

In particular, by microbe elimination of food surfaces, deterioration, rot, and the like caused by microbe propagation can be prevented.

Besides, ethylene gas generated in the storage compartment can be decomposed by the radicals contained in the fine mist. This suppresses aging acceleration by ethylene gas, and also suppresses discoloration.

In addition, the mist can be directly sprayed over the foods in the vegetable container, and the potentials of the mist and the vegetables are exploited to cause the mist to adhere to the vegetable surfaces. This improves freshness preservation efficiency, and also contributes to enhanced effects of deodorization, removal of harmful substances from food surfaces, contamination prevention, and the like.

Furthermore, dew condensation water having no mineral compositions or impurities is used instead of tap water, so that deterioration in water retentivity caused by water retainer deterioration or clogging in the case of using a water retainer can be prevented.

Though a high-voltage potential difference is generated between the atomization electrode on the reference potential side (0 V) and the counter electrode (+7 kV) in this embodiment, a high-voltage potential difference may be generated by setting the counter electrode on the reference potential side (0 V) and applying a potential (−7 kV) to the atomization electrode. In this case, the counter electrode closer to the storage compartment is on the reference potential side, and therefore an electric shock or the like can be avoided even when a person comes near the counter electrode. Besides, since the mist has a large amount of charge, the amount of radicals sprayed in the storage container increases. Moreover, in the case where the atomization electrode is at −7 kV, the counter electrode may be omitted by setting the storage compartment on the reference potential side.

Though the air path for cooling the metal pin is the freezer compartment discharge air path in this embodiment, the air path may instead be a low temperature air path such as a freezer compartment return air path or an ice compartment discharge air path. This expands an area in which the electrostatic atomization apparatus can be installed.

Though no water retainer is provided around the atomization electrode of the electrostatic atomization apparatus in this embodiment, a water retainer may be provided. This enables dew condensation water generated near the atomization electrode to be retained around the atomization electrode, with it being possible to timely supply the water to the atomization electrode.

Though the storage compartment in the refrigerator is the vegetable compartment in this embodiment, the storage compartment may be any of storage compartments of other temperature zones such as the refrigerator compartment and the switch compartment. In such a case, various applications can be developed.

### Thirty-Fourth Embodiment

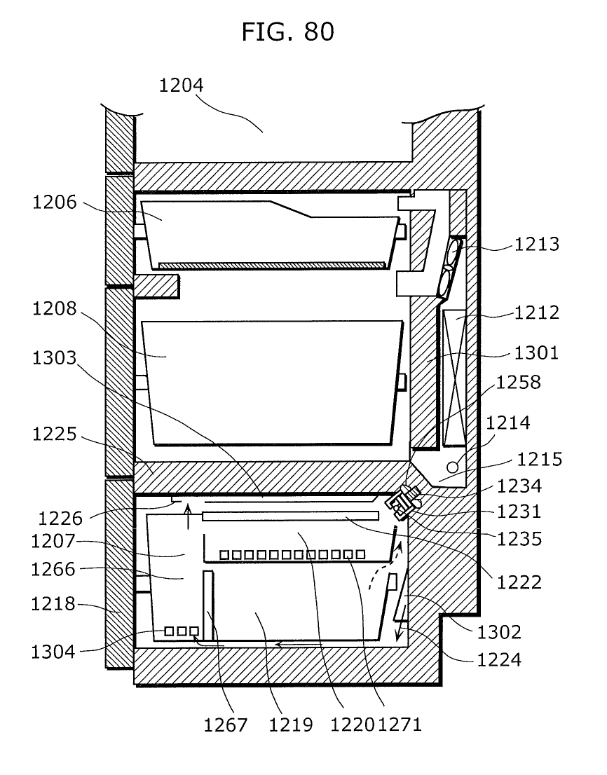

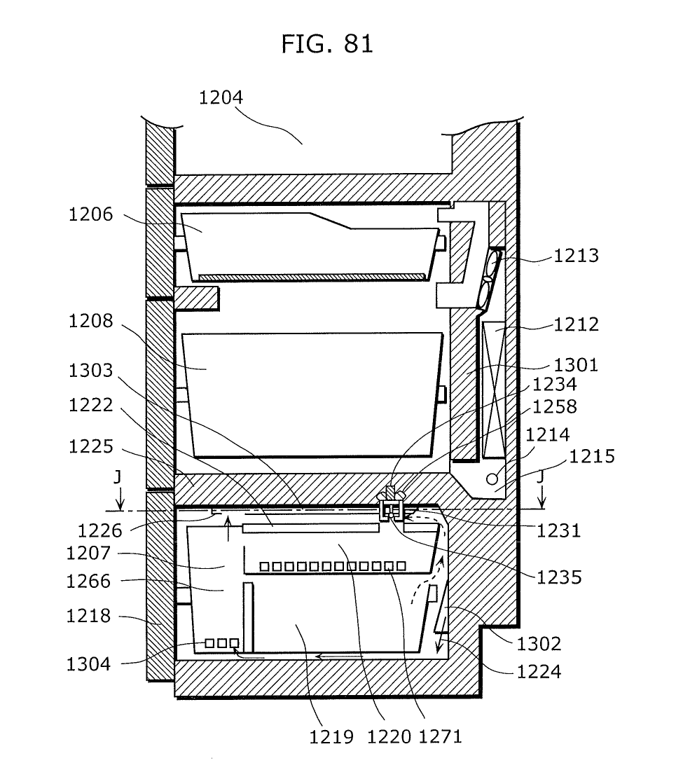

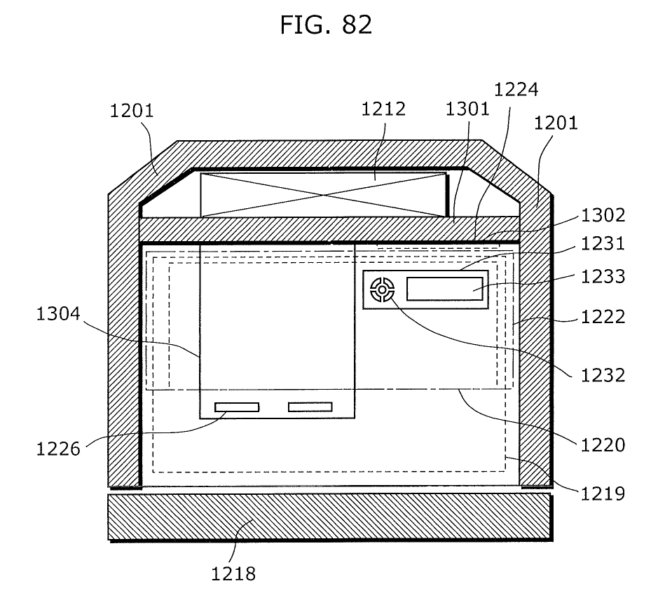

FIG. 80 is a sectional view of a vegetable compartment and its vicinity in a refrigerator in a thirty-fourth embodiment of the present invention. FIG. 81 is a sectional view of a vegetable compartment and its vicinity in a refrigerator of another form in the thirty-fourth embodiment of the present invention. FIG. 82 is a detailed plan view of an electrostatic atomization apparatus and its vicinity taken along line J-J in FIG. 81.

In this embodiment, detailed description is given only for parts that differ from the structure described in the thirty-third embodiment, with description being omitted for parts that are the same as the structure described in the thirty-third embodiment or parts to which the same technical idea is applicable.

As shown in the drawings, the refrigerator compartment 1204 as the first storage compartment is located at the top in the refrigerator 1200. The switch compartment 1205 as the fourth storage compartment and the ice compartment 1206 as the fifth storage compartment are located side by side below the refrigerator compartment 1204. The freezer compartment 1208 is located below the switch compartment 1205 and the ice compartment 1206. The vegetable compartment 1207 is located below the freezer compartment 1208.

A second partition wall 1225 ensures heat insulation properties to separate the temperature zones of the vegetable compartment 1207 and the freezer compartment 1208. A partition wall 1301 is formed at the back of the second partition wall 1225 and at the back of the freezer compartment 1208. The cooler 1212 is installed between the partition wall 1301 and the heat-insulating main body 1201 of the refrigerator, and the radiant heater 1214 for melting frost adhering to the cooler and the drain pan 1215 for receiving melted water are disposed below the cooler 1212. The cooler 1212, the radiant heater 1214, the drain pan 1215, and the cooling fan 1213 for conveying cool air to each compartment constitute the cooling compartment 1210. As shown in FIG. 80, the electrostatic atomization apparatus 1231 as the atomization apparatus which is the mist spray apparatus is installed in the second partition wall 1225 separating the cooling compartment 1210 and the vegetable compartment 1207, so as to utilize the cooling source of the cooling compartment 1210. In particular, a heat insulator of the second partition wall 1225 has a depression for the metal pin 1234 as the heat transfer connection member of the atomization unit 1239, and the metal pin heater 1258 is formed nearby.

As shown in FIG. 80, an air path structure for cooling the vegetable compartment 1207 includes a vegetable compartment discharge air path 1302 that is located on the back of the vegetable compartment 1207 and uses an air path from the refrigerator compartment or an air path from the freezer compartment. Air of a little lower temperature than the vegetable compartment 1207 passes through the vegetable compartment discharge air path 1302 and is discharged from the vegetable compartment discharge port 1224 in a direction from the back toward the bottom of the lower storage container 1219 in the vegetable compartment 1207. The stream of cool air then flows from the bottom to the front of the lower storage container 1219, and flows into the beverage container 1266 in a front part of the storage container. The cool air further flows into the vegetable compartment suction port 1226 formed on the lower surface of the second partition wall 1225, and circulates into the cooler 1212 through a vegetable compartment suction air path 1303.

A part of the upper storage container 1220 at the bottom is located inside the lower storage container 1219. The plurality of air flow holes 1271 are provided in the upper storage container 1220 located inside the lower storage container 1219.

The bottom surface of the upper storage container 1220 has a corrugated shape made up of depressions and projections.

The second partition wall 1225 has an envelope mainly made of a resin such as ABS, and contains urethane foam, styrene foam, or the like inside to thermally insulate the vegetable compartment 1207 from the freezer compartment 1208 and the cooling compartment 1210. In addition, the depression 1211a is formed in a part of a storage compartment side wall surface of the second partition wall 1225 so as to be lower in temperature than other parts, and the electrostatic atomization apparatus 1231 as the atomization apparatus is installed in the depression 1211a.

The metal pin heater 1258 for adjusting the temperature of the metal pin 1234 as the heat transfer connection member included in the electrostatic atomization apparatus 1231 and preventing excessive dew condensation on a peripheral part including the atomization electrode 1235 as the atomization tip is installed near the atomization unit 1239, in the second partition wall 1225 to which the electrostatic atomization apparatus 1231 is fixed.

The metal pin 1234 as the heat transfer connection member is fixed to the external case 1237, where the metal pin 1234 itself has the projection 1234a that protrudes from the external case 1237. The projection 1234a of the metal pin 1234 is located opposite to the atomization electrode 1235, and fit into the second partition wall.

Accordingly, the back of the metal pin 1234 as the heat transfer connection member is positioned close to the cooling compartment 1210.

Here, the cool air generated in the cooling compartment 1210 is used to cool the metal pin 1234 as the heat transfer connection member, and the metal pin 1234 is formed of a metal piece having excellent heat conductivity. Accordingly, the cooling unit can perform necessary cooling just by heat conduction from the cool air generated by the cooler 1212.

The atomization unit 1239 of the electrostatic atomization apparatus 1231 is positioned in a gap between the lid 1222 and the upper storage container 1220, with the atomization electrode tip being directed toward the upper storage container 1220.

In some cases, the atomization electrode 1235 may be vertically attached to the second partition wall 1225 as shown in FIGS. 81 and 82.

In such a case, the metal pin is cooled by heat conduction from the freezer compartment 1208, and also a hole is formed in a part of the lid 1222 so that the mist from the electrostatic atomization apparatus 1231 can be sprayed into the upper storage container.

An operation and working of the refrigerator having the above-mentioned structure are described below.

The second partition wall 1225 in which the electrostatic atomization apparatus 1231 is installed needs to have a wall thickness for thermally insulating the vegetable compartment 1207 from the freezer compartment 1208 and the cooling compartment 1210. Meanwhile, a cooling capacity for cooling the metal pin 1234 to which the atomization electrode 1235 as the atomization tip is fixed is also necessary. Accordingly, the second partition wall 1225 has a smaller wall thickness in a part where the electrostatic atomization apparatus 1231 is disposed, than in other parts. Further, the second partition wall 1225 has a still smaller wall thickness in a deepest depression where the metal pin 1234 is held. As a result, the metal pin 1234 can be cooled by heat conduction from the cooling compartment 1210 which is lower in temperature, with it being possible to cool the atomization electrode 1235. When the temperature of the tip of the atomization electrode 1235 drops to the dew point or below, a water vapor near the atomization electrode 1235 builds up dew condensation on the atomization electrode 1235, thereby reliably generating water droplets.

An outside air temperature variation may cause the temperature control of the freezer compartment 1208 to vary and lead to excessive cooling of the atomization electrode 1235. In view of this, the amount of water on the tip of the atomization electrode 1235 is optimized by adjusting the temperature of the atomization electrode 1235 by the metal pin heater 1258 disposed near the atomization electrode 1235.

Here, the cool air flows in the vegetable compartment 1207 as follows. The cool air lower in temperature than the vegetable compartment passes through the vegetable compartment discharge air path 1302 and is discharged from the vegetable compartment discharge port 1224. The cool air flows in an air path at the bottom of the lower storage container 1220, between the storage container and the heat-insulating main body, thus flowing toward the front door. The cool air then flows into the storage container from an air flow hole 1304 formed in a part of the lower storage container 1220, and cools beverages in the beverage container. At this time, a section at the back of the lower storage container is indirectly cooled. The cool air further flows into the vegetable compartment suction port 1226 formed on the lower surface of the second partition wall 1225, and circulates into the cooler 1212 through the vegetable compartment suction air path 1303. This reduces an influence of the cool air on the upper storage container, so that freshness preservation is maintained.

Thus, in this embodiment, the flow of cool air in the vegetable compartment is controlled in order to effectively use the cool air. First, dry cool air of a low temperature is supplied in a large quantity into the beverage container 1266 in front of the beverage partition plate 1267 where beverages such as PET bottled beverages are often stored, to cause the beverages to be in direct contact with the low temperature cool air to thereby ensure a cooling speed. Next, since the humidity increases as the cool air entering from the front of the vegetable compartment flows toward the back, the back side has a relatively high humidity when compared with the door side. This creates a high humidity atmospheric environment around the electrostatic atomization apparatus 1231 located at the back, so that water in the air easily builds up dew condensation in the electrostatic atomization apparatus 1231. Further, the mist sprayed by the electrostatic atomization apparatus 1231 using water droplets generated by dew condensation of water in the storage compartment fills the upper storage container 1220 and then flows into the lower storage container 1219 for moisture retention, as a fine mist that is made up of fine particles of a nano-level particle diameter and so has high diffusivity.

By controlling the flow of cool air in this manner, when contents to be cooled speedily are stored in the beverage container 1266 in the front part, ordinary vegetables and fruits relatively unsusceptible to low temperature damage and the like are stored in the lower storage container 1219, and vegetables and fruits more susceptible to low temperature damage are stored in the upper storage container 1220, it is possible to perform cooling suitable for each content. This enables a vegetable compartment of higher quality with improved freshness preservation to be provided.

This embodiment is based on the premise that the mist is sprayed. However, since the cooling speed of PET bottled beverages can be increased by releasing the cool air introduced from the vegetable compartment discharge port 1224 first to the PET bottle container, even in the case where the mist spray apparatus is not installed, it is possible to, having increased the cooling speed of PET bottled beverages, improve the moisture retention of the upper storage container 1220.

Therefore, even when the mist spray apparatus is not installed, by forming the air path as in this embodiment so that the low temperature dry cool air first enters into the beverage container 1266 in the door side part of the lower storage container 1219 and then passes through the lower storage container 1219 storing vegetables and the like and flows into the upper storage container 1220, an effect of achieving moisture retention and high temperature of the upper storage container to some extent can be attained. When mist spray is performed in addition to this structure, a synergistic effect of suppressing low temperature damage can be attained.

Though not shown, by installing an inside temperature detection unit, an inside humidity detection unit, an atomization electrode temperature and peripheral humidity detection unit, and the like in the storage compartment, the dew point can be precisely calculated by a predetermined computation according to a change in storage compartment environment.

In this state, the voltage application unit 1233 applies a high voltage (for example, 7.5 kV) between the atomization electrode 1235 and the counter electrode 1236, where the atomization electrode 1235 is on a negative voltage side and the counter electrode 1236 is on a positive voltage side. This causes an air insulation layer to be broken down and corona discharge to occur between the electrodes. Water on the atomization electrode 1235 is atomized from the electrode tip, and a nano-level fine mist carrying an invisible charge less than 1 μm, accompanied by ozone, OH radicals, and so on, is generated.

The generated fine mist is sprayed into the upper storage container 1220. The fine mist sprayed from the electrostatic atomization apparatus 1231 is negatively charged. Meanwhile, vegetables and fruits are stored in the vegetable compartment. In particular, vegetables and fruits susceptible to low temperatures are often stored in the upper storage container. These vegetables and fruits usually tend to be in a rather wilted state as a result of transpiration on the way home from shopping or transpiration during storage, and so are usually positively charged. Accordingly, the sprayed fine mist carrying a negative charge tends to gather on vegetable surfaces. Thus, the sprayed fine mist increases the humidity of the vegetable compartment again and simultaneously adheres to surfaces of vegetables and fruits, thereby suppressing transpiration from the vegetables and fruits and enhancing freshness preservation. The fine mist also penetrates into tissues via intercellular spaces of the vegetables and fruits, as a result of which water is supplied into cells that have wilted due to moisture evaporation to resolve the wilting by cell turgor pressure, and the vegetables and fruits return to a fresh state. Moreover, radicals contained in the mist have functions such as microbial elimination, low temperature damage suppression, and nutrient increase, and also decompose agricultural chemicals by their strong oxidative power to facilitate removal of agricultural chemicals from the vegetable surfaces.

As described above, in the thirty-fourth embodiment, the partition wall for separating the storage compartment and the lower temperature storage compartment on the top side of the storage compartment are provided. The electrostatic atomization apparatus is attached to the partition wall at the top. Thus, in the case where a freezing temperature zone storage compartment such as the cooling compartment, the freezer compartment, or the ice compartment is located above the storage compartment, by installing the electrostatic atomization apparatus in the partition wall at the top separating these compartments, the cooling source of the freezing temperature zone storage compartment can be used to cool and build up dew condensation on the atomization electrode of the electrostatic atomization apparatus. This makes it unnecessary to provide any particular cooling apparatus. Moreover, since the mist is sprayed from the top, the mist can be easily diffused throughout the storage containers. In addition, the atomization unit is difficult to reach by hand, which contributes to enhanced safety.

In this embodiment, the atomization unit generates the mist according to the electrostatic atomization method, where water droplets are finely divided using electrical energy such as a high voltage to thereby form a fine mist. The generated mist is electrically charged. This being so, by causing the mist to carry an opposite charge to vegetables, fruits, and the like to which the mist is intended to adhere, for example, by spraying a negatively charged mist over positively charged vegetables, the adhesion of the mist to the vegetables and fruits increases, as a result of which the mist can adhere to the vegetable surfaces more uniformly. In this way, a mist adhesion ratio can be improved when compared with an uncharged mist. Moreover, the fine mist can be directly sprayed over the foods in the vegetable containers, and the potentials of the fine mist and the vegetables are exploited to cause the fine mist to adhere to the vegetable surfaces. This improves freshness preservation efficiently.

In this embodiment, not tap water supplied from outside but dew condensation water is used as makeup water. Since dew condensation water is free from mineral compositions and impurities, deterioration in water retentivity caused by deterioration or clogging of the tip of the atomization electrode can be prevented.

In this embodiment, the mist contains radicals, so that agricultural chemicals, wax, and the like adhering to the vegetable surfaces can be decomposed and removed with an extremely small amount of water. This benefits water conservation, and also achieves a low input.

### Thirty-Fifth Embodiment

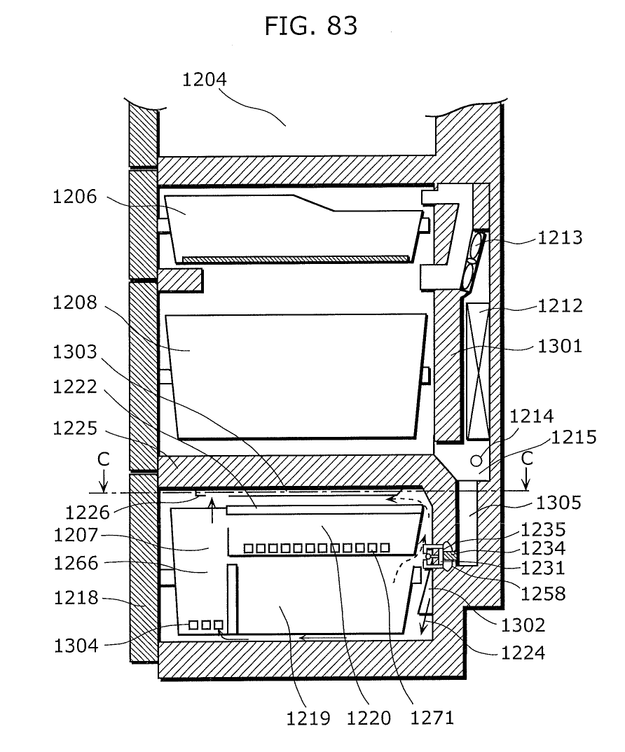

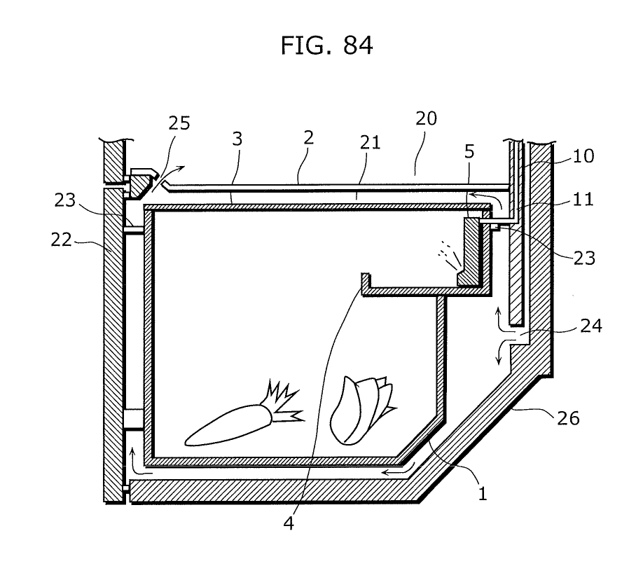

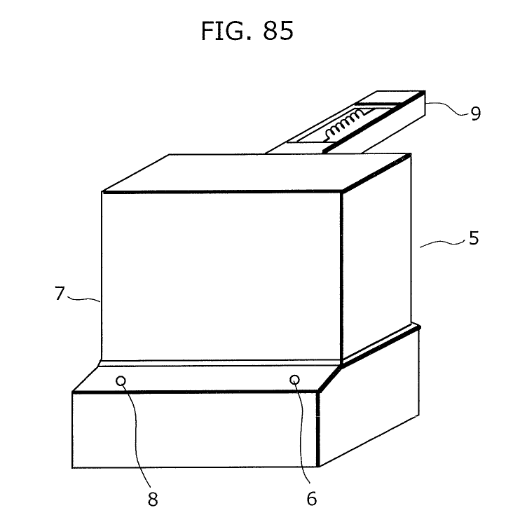

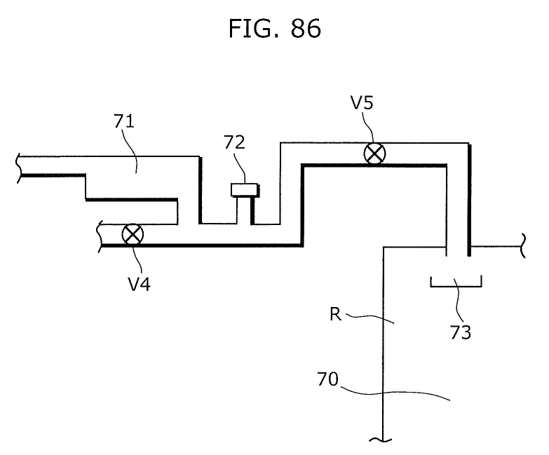

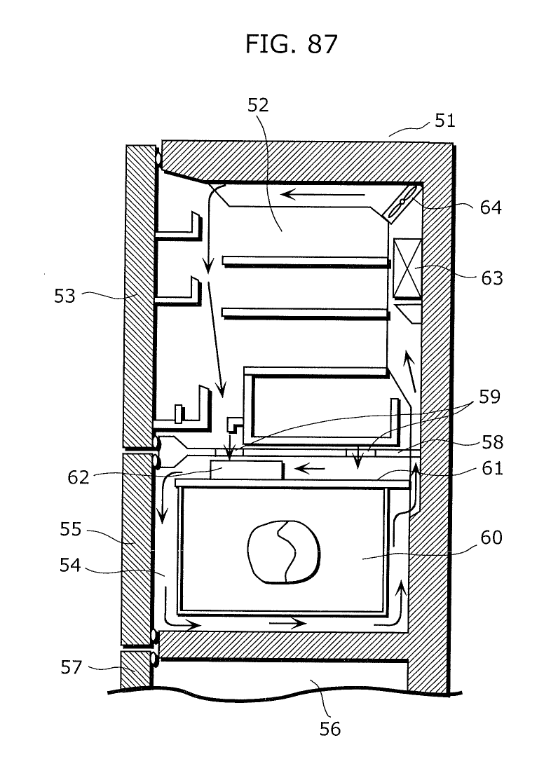

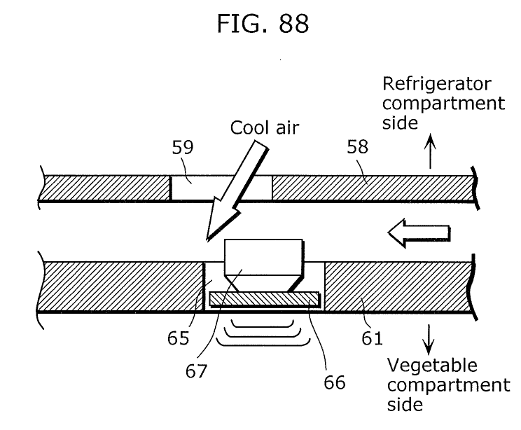

FIG. 83 is a sectional view of a vegetable compartment and its vicinity in a refrigerator in a thirty-fifth embodiment of the present invention.

In this embodiment, detailed description is given only for parts that differ from the structures described in the thirty-third and thirty-fourth embodiments, with description being omitted for parts that are the same as the structure described in the thirty-third and thirty-fourth embodiments or parts to which the same technical idea is applicable.

As shown in the drawing, the refrigerator compartment 1204 as the first storage compartment is located at the top in the refrigerator 1200 of the thirty-fifth embodiment. The switch compartment 1205 as the fourth storage compartment and the ice compartment 1206 as the fifth storage compartment are located side by side below the refrigerator compartment 1204. The freezer compartment 1208 is located below the switch compartment 1205 and the ice compartment 1206. The vegetable compartment 1207 is located below the freezer compartment 1208.

The second partition wall 1225 ensures heat insulation properties to separate the temperature zones of the vegetable compartment 1207 and the freezer compartment 1208. The partition wall 1301 is formed at the back of the second partition wall 1225 and at the back of the freezer compartment 1208. The cooler 1212 is installed between the partition wall 1301 and the heat-insulating main body 1201 of the refrigerator, and the radiant heater 1214 for melting frost adhering to the cooler 1212 and the drain pan 1215 for receiving melted water are disposed below the cooler 1212. The cooler 112, the radiant heater 114, the drain pan 115, and the cooling fan 113 for conveying cool air to each compartment constitute the cooling compartment 1210. An atomization apparatus cooling air path is formed below the cooling compartment 1210. As shown in FIG. 83, the electrostatic atomization apparatus 1231 as the mist spray apparatus is installed in a part of the atomization apparatus cooling air path. In particular, the metal pin 1234 as the heat transfer connection member of the atomization unit 1239 is immediately adjacent to the air path, and the metal pin heater 1258 is formed nearby.

A part of the upper storage container 1220 at the bottom is located inside the lower storage container 1219. The plurality of air flow holes 1271 are provided in the upper storage container 1220 located inside the lower storage container 1219.

The bottom surface of the upper storage container 1220 has a corrugated shape made up of depressions and projections.

The atomization electrode cooling air path 1305 is formed of a resin such as ABS or PP and a heat insulator such as styrene foam. Cool air flowing in the air path is at a relatively low temperature of −15° C. to −25° C. The electrostatic atomization apparatus is installed in the atomization apparatus cooling air path at the back of the vegetable compartment 1207, near a gap between the upper storage container and the lower storage container. Thus, the vegetable compartment has an approximately same structure as the first embodiment.

An operation and working of the refrigerator having the above-mentioned structure are described below.

When the atomization apparatus cooling air path 1305 where the electrostatic atomization apparatus 1231 is installed ensures a cooling capacity for cooling the metal pin 1234 to which the atomization electrode 1235 as the atomization tip is fixed, the vicinity of the electrostatic atomization apparatus 1231 is brought into a high humidity state by transpiration from stored vegetables and the like, and water droplet are reliably generated at the tip of the atomization electrode.

In this state, the voltage application unit 1233 applies a high voltage (for example, 7.5 kV) between the atomization electrode 1235 and the counter electrode 1236, where the atomization electrode 1235 is on a negative voltage side and the counter electrode 1236 is on a positive voltage side. This causes an air insulation layer to be broken down and corona discharge to occur between the electrodes. Water on the atomization electrode 1235 is atomized from the electrode tip, and a nano-level fine mist carrying an invisible charge less than 1 μm, accompanied by ozone, OH radicals, and so on, is generated.

The generated fine mist is sprayed between the upper storage container 1220 and the lower storage container 1219. The fine mist sprayed from the electrostatic atomization apparatus 1231 is negatively charged. Meanwhile, vegetables and fruits are stored in the vegetable compartment. In particular, vegetables and fruits susceptible to low temperatures are often stored in the upper storage container. These vegetables and fruits usually tend to be in a rather wilted state as a result of transpiration on the way home from shopping or transpiration during storage, and so are usually positively charged. Accordingly, the sprayed fine mist carrying a negative charge tends to gather on vegetable surfaces. Thus, the sprayed fine mist increases the humidity of the vegetable compartment again and simultaneously adheres to surfaces of vegetables and fruits, thereby suppressing transpiration from the vegetables and fruits and enhancing freshness preservation. The fine mist also penetrates into tissues via intercellular spaces of the vegetables and fruits, as a result of which water is supplied into cells that have wilted due to moisture evaporation to resolve the wilting by cell turgor pressure, and the vegetables and fruits return to a fresh state. Moreover, radicals contained in the mist have functions such as microbial elimination, low temperature damage suppression, and nutrient increase, and also decompose agricultural chemicals by their strong oxidative power to facilitate removal of agricultural chemicals from the vegetable surfaces.

As described above, in the thirty-fifth embodiment, the partition wall for separating the storage compartment and the atomization apparatus cooling air path for cooling the atomization electrode are provided. The electrostatic atomization apparatus is attached to the air path. Thus, in the case where a freezing temperature zone storage compartment such as the cooling compartment, the freezer compartment, or the ice compartment is located above the storage compartment, the cold heat source of the freezing temperature zone storage compartment can be conveyed to the back of the vegetable compartment through the air path, and the cooling source of the freezing temperature zone storage compartment can be used to cool and build up dew condensation on the atomization electrode of the electrostatic atomization apparatus. This enables the spray to be performed stably. In addition, the atomization unit is difficult to reach by hand because it is attached to the back surface, which contributes to enhanced safety.

In this embodiment, the atomization unit generates the mist according to the electrostatic atomization method, where water droplets are finely divided using electrical energy such as a high voltage to thereby form a fine mist. The generated mist is electrically charged. This being so, by causing the mist to carry an opposite charge to vegetables, fruits, and the like to which the mist is intended to adhere, for example, by spraying a negatively charged mist over positively charged vegetables, the adhesion of the mist to the vegetables and fruits increases, as a result of which the mist can adhere to the vegetable surfaces more uniformly. In this way, a mist adhesion ratio can be improved when compared with an uncharged mist. Moreover, the fine mist can be directly sprayed over the foods in the vegetable containers, and the potentials of the fine mist and the vegetables are exploited to cause the fine mist to adhere to the vegetable surfaces. This improves freshness preservation efficiently.

In this embodiment, not tap water supplied from outside but dew condensation water is used as makeup water. Since dew condensation water is free from mineral compositions and impurities, deterioration in water retentivity caused by deterioration or clogging of the tip of the atomization electrode can be prevented.

In this embodiment, the mist contains radicals, so that agricultural chemicals, wax, and the like adhering to the vegetable surfaces can be decomposed and removed with an extremely small amount of water. This benefits water conservation, and also achieves a low input.

Though the atomization apparatus air path is used for conveying the cold heat source in this embodiment, heat conduction of a solid object such as aluminum or copper or a heat conveyance unit such as a heat pipe or a heat lane may be used. This saves an air path area, thereby reducing an influence on the storage compartment capacity.

As described above, the refrigerator according to the present invention includes: a heat-insulating main body; a storage compartment defined in the heat-insulating main body; and a mist spray apparatus that sprays a fine mist into the storage compartment, wherein the fine mist generated by the mist spray apparatus has a nano-size particle diameter and reduces microorganisms adhering to inside of the storage compartment and to vegetable surfaces, the microorganisms including molds, bacteria, yeasts, and viruses. According to this structure, the sprayed mist enters into fine depressions on the surfaces of vegetables and fruits, and removes microorganisms such as bacteria, molds, viruses, and the like adhering to the depressions by a synergetic effect of physical and chemical actions of the mist. Thus, microorganisms can be easily removed by a small amount of water. In addition, the mist is a nano-size fine mist, and so can be sprayed into the storage compartment uniformly.

Moreover, in the refrigerator according to the present invention, the mist spray apparatus generates the mist containing radicals. According to this structure, the radicals have an extremely high organic matter decomposition capacity, and so are capable of decomposing and eliminating almost all microorganisms living in a daily life environment.

Moreover, in the refrigerator according to the present invention, the mist spray apparatus includes a spray unit that sprays the mist according to an electrostatic atomization method. According to this structure, the mist is sprayed in a state where the radicals are covered with fine water, so that contact and reaction between unstable radicals and water or oxygen in the air are prevented, with it being possible to hold the radicals for a longer period and enhance a frequency of contact with microorganisms. Besides, the charged mist is sprayed and uniformly adheres to vegetables and fruits. This improves the mist adhesion ratio and benefits water conservation.

Moreover, the refrigerator according to the present invention includes: an electrostatic atomization apparatus including: an application electrode for applying a voltage; a counter electrode positioned facing the application electrode; and a voltage application unit that applies a high voltage between the application electrode and the counter electrode; a water collection plate on which water in air in the refrigerator forms dew condensation; and a cooling unit that cools the water collection plate, wherein the water collection plate is provided with a temperature adjustment unit. According to this structure, a water vapor in the storage compartment, a water vapor entering by door opening/closing, a water vapor evaporated from foods, and the like reliably build up dew condensation on the water collection plate to send water to the electrostatic atomization apparatus. An extremely small nano-size mist is then generated by the electrostatic atomization apparatus and directly sprayed over foods in the container. Hence, the inside of the container can be efficiently put in a high humidity state. This improves vegetable freshness preservation. Besides, by adding the effects of antimicrobial activity, microbial elimination, and sterilization by ozone, radicals, and negative ions generated when the mist is generated by the electrostatic atomization apparatus, the function of the vegetable compartment can be improved.

Moreover, in the refrigerator according to the present invention, a negative voltage is applied to the application electrode and a positive voltage is applied to the counter electrode. According to this structure, a negatively charged mist is sprayed and uniformly adheres to positively charged vegetables, fruits, and fungi floating in the air. This improves the mist adhesion ratio and benefits water conservation.

Moreover, the refrigerator according to the present invention includes a light source installed in the storage compartment, the light source including light of a blue light wavelength region. According to this structure, when microorganisms tend to decrease due to ozone and radicals generated from the electrostatic atomization apparatus, the microorganisms are killed by blue light. Hence, microorganism regrowth can be suppressed.

Furthermore, a refrigerator according to the present invention includes: a heat-insulated storage compartment; an atomization unit that sprays a mist into the storage compartment; and an atomization tip included in the atomization unit, the mist being sprayed from the atomization tip, wherein the atomization unit generates the mist that adheres to vegetables and fruits stored in the storage compartment to suppress low temperature damage.

According to this structure, mist particles are sprayed into the storage compartment and adhere to vegetable surfaces, thereby suppressing drying of the vegetable surfaces for moisture retention and also suppressing low temperature damage. Thus, freshness preservation can be improved. This enables a highly usable refrigerator with improved freshness preservation to be provided. In addition, the mist particles can be uniformly sprayed into the storage compartment by the atomization tip.

Moreover, in the refrigerator according to the present invention, the heat-insulated storage compartment is substantially sealed and has a mechanism of keeping a high humidity to prevent drying of the vegetables and fruits, and drying after the mist adheres to the vegetables and fruits is also prevented to suppress drying of the mist containing radicals, thereby suppressing the low temperature damage.

According to this structure, by spraying the mist particles containing radicals into the storage compartment, moisture retention of vegetables can be achieved and also an enzyme reaction can be suppressed. As a result, low temperature damage can be suppressed, with it being possible to improve freshness preservation. This enables a highly usable refrigerator with improved freshness preservation to be provided.

Moreover, in the refrigerator according to the present invention, the mist containing radicals adheres to skins of the vegetables and fruits, and the radicals penetrate from the skins and inhibit an enzyme reaction, thereby suppressing the low temperature damage.

According to this structure, by inhibiting an enzyme reaction of vegetables and fruits which is a direct cause of low temperature damage, low temperature damage of vegetables and fruits can be suppressed more reliably.

Moreover, in the refrigerator according to the present invention, the mist containing radicals adheres to skins of the vegetables and fruits and the radicals penetrate from the skins, thereby suppressing leakage of potassium ions.

According to this structure, leakage of potassium ions generated by low temperature damage can be suppressed, so that vegetables and fruits can be stored in a more fresh state. This enables a highly usable refrigerator with improved freshness preservation to be provided.

Moreover, in the refrigerator according to the present invention, the mist containing radicals sprayed into the storage compartment decomposes ethylene gas.

According to this structure, by decomposing ethylene gas that accelerates aging of vegetables and fruits, the vegetables and fruits can be stored in a more fresh state, and also discoloration by aging can be suppressed. Furthermore, since sprayed radicals suppress bacteria and viruses adhering to food surfaces, food cells are prevented from necrosis, and so ethylene gas generation can be suppressed. Therefore, yellowing due to aging can be prevented. This enables a highly usable refrigerator with improved freshness preservation in visual appearance as well to be provided.

Moreover, the refrigerator according to the present invention includes: the storage compartment that is heat-insulated; a section in the storage compartment, the section being set in a different environment from an environment of the storage compartment; an atomization unit that sprays the mist into the section; an atomization tip included in the atomization unit, the mist being sprayed from the atomization tip; a temperature adjustment unit that adjusts a temperature of the atomization tip; and a temperature detection unit that detects the temperature of the atomization tip, wherein the temperature adjustment unit adjusts the temperature of the atomization tip to a dew point or below, to cause water in air to form dew condensation at the atomization tip and the mist to be sprayed into the storage compartment.

By including the adjustment unit for preventing excessive dew condensation at the atomization tip, the size or amount of liquid droplets building up dew condensation on the atomization electrode can be adjusted. This produces a stable dew condensation state, with it being possible to perform mist spray stably. In addition, the atomization tip is kept from excessive dew condensation, which contributes to improved reliability of the atomization unit.

Moreover, by including the temperature detection unit for detecting the temperature of the atomization unit, the temperature of the atomization tip can be controlled individually via the electrode cooling member according to the detected temperature, regardless of an operation state (temperature control of each compartment) of the refrigerator. Thus, the temperature of the atomization tip can be controlled more efficiently while saving energy.

Accordingly, the amount of water to be atomized can be adjusted by a simple structure, without requiring a complex structure such as a defrost water hose and a purifying filter for supplying mist spray water, a dedicated tank and a water conveyance unit including its path, and a water supply path directly connected to tap water.

Besides, dew condensation can be reliably formed on the atomization electrode easily from an excessive water vapor in the storage compartment, while adjusting the amount of water. The fine mist generated as a result is sprayed and uniformly adheres to the surfaces of foods or vegetables and fruits, thereby suppressing drying of the foods and transpiration of the vegetables and fruits. This improves freshness preservation. In addition, since the storage compartment space can be maintained at a high humidity, unwrapped food storage is possible. Furthermore, the fine mist penetrates into tissues via intercellular spaces, stomata, and the like on the surfaces of the vegetables and fruits, as a result of which water is supplied into wilted cells and the vegetables and fruits return to a fresh state.

Moreover, though microorganisms tend to grow in a high humidity environment, the antimicrobial activity is simultaneously effected by radicals of extremely high reactivity contained in the fine mist according to the present invention. Therefore, cleanness of the storage compartment space and the foods themselves can be improved.

Moreover, in the refrigerator according to the present invention, the atomization unit includes a heat transfer connection member thermally connected to an atomization electrode which is the atomization tip, and the temperature adjustment unit indirectly adjusts the temperature of the atomization tip by cooling or heating the heat transfer connection member.

According to this structure, by combining the cooling unit and the heating unit, the temperature of the atomization tip can be adjusted easily. Hence, by adjusting the amount of water adhering to the atomization tip in an appropriate range, stable discharge occurs, as a result of which the mist spray can be performed stably. Further, excessive dew condensation on the atomization tip can be prevented, which contributes to improved reliability of the atomization unit. This enables a highly usable refrigerator with improved freshness preservation to be provided.

Even when low temperature liquid droplets remain on the atomization electrode tip, by increasing the temperature of the liquid by the heating unit, a surface tension of the liquid droplets can be decreased. This allows a fine mist to be generated by a lower voltage in high voltage application, so that energy efficiency can be enhanced.

Moreover, by cooling the heat transfer connection member instead of directly cooling the atomization tip, the atomization electrode can be cooled indirectly. Here, since the heat transfer connection member has a larger heat capacity than the atomization tip, the atomization tip can be adjusted in temperature while alleviating a direct significant influence of a temperature change of the adjustment unit on the atomization electrode. Therefore, a load fluctuation of the atomization tip can be suppressed, with it being possible to realize mist spray of a stable spray amount.

Furthermore, the temperature control of the atomization tip can be easily performed for preventing excessive dew condensation on the atomization tip, and the size or amount of liquid droplets building up dew condensation on the atomization tip can be adjusted. This allows for stable spray, thereby further contributing to improved reliability. In addition, since the temperature of the atomization tip can be individually adjusted, the atomization tip and the heat transfer connection member can be reliably cooled or heated in an appropriate range, without increasing the temperatures of the atomization tip and the heat transfer connection member more than necessary.

Moreover, in the refrigerator according to the present invention, the temperature adjustment unit that adjusts the temperature of the atomization tip includes a cooling unit and a heating unit.

According to this structure, by combining the cooling unit and the heating unit, the temperature of the atomization tip can be adjusted easily. Hence, by adjusting the amount of water adhering to the atomization tip in an appropriate range, stable discharge occurs, as a result of which the mist spray can be performed stably. Further, excessive dew condensation on the atomization tip can be prevented, which contributes to improved reliability of the atomization unit. This enables a highly usable refrigerator with improved freshness preservation to be provided.

Moreover, in the refrigerator according to the present invention, the cooling unit is a cooling source generated in a refrigeration cycle of the refrigerator, and the heating unit is a heater.

According to this structure, by effectively using the cooling source generated in the refrigeration cycle of the refrigerator, the fine mist can be supplied to the storage compartment by a simple structure, which contributes to improved reliability of the atomization unit. Besides, no apparatus and power for the cooling unit are necessary, so that the mist spray can be performed while saving materials and energy.

Furthermore, the atomization tip can be heated individually via the heat transfer connection member, regardless of an operation state (temperature control of each compartment) of the refrigerator. Hence, the temperature of the atomization tip can be adjusted more efficiently while saving energy.

In addition, the heating unit of the adjustment unit for preventing excessive dew condensation on the atomization tip is a heater, so that the temperature of the atomization tip can be controlled easily. Since the size or amount of liquid droplets building up dew condensation on the atomization tip can be adjusted, stable spray can be performed, which further contributes to improved reliability.

Moreover, in the refrigerator according to the present invention, a main body of the refrigerator includes a plurality of storage compartments and a cooling compartment that houses a cooler for cooling the plurality of storage compartments, and the atomization unit is attached to a partition wall of the storage compartment on a cooling compartment side.

According to this structure, a member such as a refrigerant pipe or a pipe that utilizes cool air of the cooling compartment having a lowest temperature among air cooled using a cooling source generated in the refrigeration cycle of the refrigerator or utilizes heat conduction from the cool air can be set as the cooling unit. Since the cooling unit can be provided by such a simple structure, a highly reliable atomization unit with a low incidence of troubles can be realized. Moreover, the heat transfer connection member and the atomization electrode can be cooled by using the cooling source of the refrigeration cycle, which contributes to energy-efficient atomization.

Besides, by attaching the atomization unit to the partition wall, the atomization unit can be positioned using the gap effectively without greatly bulging into the storage compartment.

Hence, a reduction in storage capacity can be avoided. In addition, the atomization unit is difficult to reach by hand because it is attached to the back surface, which contributes to enhanced safety.

Moreover, in the refrigerator according to the present invention, a main body of the refrigerator includes a plurality of storage compartments, a lower temperature storage compartment kept at a lower temperature than the storage compartment provided with the atomization unit is situated on a bottom side of the storage compartment provided with the atomization unit, and the atomization unit is attached to a partition wall of the storage compartment provided with the atomization unit, on the bottom side.

According to this structure, in the case where a freezing temperature zone storage compartment such as the freezer compartment or the ice compartment is located below the storage compartment, by installing the atomization unit in the partition wall separating these storage compartments, the atomization electrode can be cooled via the heat transfer connection member of the atomization unit by the cooling source of the freezing temperature zone storage compartment, thereby forming dew condensation. Since the atomization unit can be provided by a simple structure with there being no need for a particular cooling apparatus, a highly reliable atomization unit with a low incidence of troubles can be realized.

In addition, since the spray can be performed from the back side at the bottom, spot atomization is possible to maximize the effect only for one area. Besides, since the mist is a fine mist, the mist is easily diffused in the storage compartment space even when atomized from the bottom.

Furthermore, the atomization unit is difficult to reach by hand. This contributes to improved safety.

Moreover, in the refrigerator according to the present invention, a main body of the refrigerator includes at least one air path for conveying cool air to a storage compartment or a cooling compartment, and a cooling unit uses cool air generated in the cooling compartment.

According to this structure, by cooling the heat transfer connection member and the atomization tip by indirect heat conduction using cool air, the atomization tip can be kept from excessive cooling. Excessively cooling the atomization tip causes a large amount of dew condensation, as a result of which an inputted liquid droplet surface area to the atomization unit increases due to a load increase of the atomization unit. This leads to an increase in surface tension, raising concern about an atomization failure of the atomization unit since fine particle division by an electrostatic force cannot be performed. According to the above-mentioned structure, however, such problems due to the load increase of the atomization unit can be avoided. Since an appropriate dew condensation amount can be ensured, stable mist spray can be achieved with a low input.

In addition, since the cooling unit can be provided by such a simple structure, a highly reliable atomization unit with a low incidence of troubles can be realized. Moreover, the heat transfer connection member and the atomization electrode can be cooled by using the cooling source of the refrigeration cycle, with it being possible to cause water droplets to build up dew condensation on the electrode to thereby perform atomization more energy-efficiently.

Moreover, in the refrigerator according to the present invention, the heating unit is a heater integrally formed with the atomization unit.

According to this structure, the heating unit of the adjustment unit for preventing excessive dew condensation on the atomization tip is a heater, so that the temperature of the atomization tip can be controlled easily. Since the size or amount of liquid droplets building up dew condensation on the atomization tip can be adjusted, stable spray can be performed, which further contributes to improved reliability.

Moreover, in the refrigerator according to the present invention, the temperature adjustment unit uses a heat pipe capable of conveying lower temperature heat in or near a cooler.

According to this structure, cool air generated in the cooling compartment having a lowest temperature among air cooled using a cooling source generated in the refrigeration cycle of the refrigerator or a heat source from the cooler itself or a member such as a refrigerant pipe can be heat-transferred by a heat pipe. Since the cooling unit can be provided by such a simple structure, a highly reliable atomization unit with a low incidence of troubles can be realized. In addition, the atomization electrode can be cooled via the electrode cooling member by using the cooling source of the refrigeration cycle, which contributes to energy-efficient atomization. The mist spray can be performed while saving materials and energy, with there being no need for any particular apparatus and power.

Moreover, in the refrigerator according to the present invention, the temperature adjustment unit uses a Peltier element.

According to this structure, the temperature of the atomization electrode can be adjusted just by the voltage applied to the Peltier element, so that the atomization electrode can be individually adjusted to an arbitrary temperature easily.

Besides, both cooling and heating can be carried out simply by input voltage inversion or the like, with there being no need to add a particular apparatus such as a heater as a cooling unit or a heating unit. Both cooling and heating are performed by a simple structure and also temperature responsiveness is accelerated, so that improved accuracy of the atomization unit can be attained.

Moreover, in the refrigerator according to the present invention, an atomization unit includes an atomization electrode, a counter electrode positioned facing the atomization electrode, and a voltage application unit that generates a high-voltage potential difference between the atomization electrode and the counter electrode.

According to this structure, an electric field near the atomization electrode can be formed stably. As a result, an atomization phenomenon and a spray direction are determined, and accuracy of a fine mist sprayed into the storage containers is enhanced, so that improved accuracy of the atomization unit can be attained.

Moreover, the refrigerator according to the present invention includes: the storage compartment; and a holding member installed in the storage compartment and grounded to a reference potential part, wherein the voltage application unit generates the potential difference between the atomization electrode and the holding member.

According to this structure, there is no need to particularly provide the counter electrode, because the potential difference from the atomization electrode can be created to spray the mist by providing the grounded holding member in a part of the storage compartment. In so doing, a stable electric field can be generated by a simpler structure, thereby enabling the mist to be sprayed stably from the atomization unit.

Besides, when the holding member is attached to the storage container side, the entire storage container is at the reference potential, and therefore the sprayed mist can be diffused throughout the storage container. Furthermore, electrostatic charges to surrounding objects can be prevented.

Moreover, the refrigerator according to the present invention includes: a spray unit that generates a mist of a first particle diameter and a mist of a second particle diameter different from the first particle diameter in the storage compartment; and a water supply unit that supplies a liquid to the spray unit. For example, by generating the mist of the first particle diameter and the mist of the second particle diameter different from the first particle diameter in the storage compartment, the mist of the first particle diameter can effect food freshness preservation, and the mist of the second particle diameter can effect food nutrient improvement and microbial elimination/agricultural chemical removal of the foods and the storage compartment. Additionally, generating the mist of the first particle diameter and the mist of the second particle diameter allows for uniform spray in the storage compartment.

Moreover, in the refrigerator according to the present invention, the first particle diameter is micro-size, and the second particle diameter is nano-size. The mist of the micro-size particle diameter makes it possible to ensure a spray amount necessary for food freshness preservation, whilst the mist of the nano-size particle diameter allows for uniform spray in the storage compartment and enters into even small depressions and projections in the foods and the storage compartment.

Moreover, in the refrigerator according to the present invention, the mist of the second particle diameter is an ionized mist. The micro-size mist can effect food freshness preservation, and the nano-size mist containing radicals can effect food nutrient improvement and microbial elimination/agricultural chemical removal of the foods and the storage compartment.

Moreover, in the refrigerator according to the present invention, the spray unit includes an electrostatic atomization apparatus that includes an application electrode for applying a voltage to a liquid, a counter electrode positioned facing the application electrode, and a voltage application unit that applies a high voltage between the application electrode and the counter electrode, and the electrostatic atomization apparatus generates the mist of the second particle diameter. The nano-size mist containing radicals and low-concentration ozone is generated by the electrostatic atomization method, thereby effecting food nutrient improvement and microbial elimination/agricultural chemical removal of the foods and the storage compartment.

Moreover, in the refrigerator according to the present invention, the spray unit is a device that simultaneously generates the mist of the first particle diameter and the mist of the second particle diameter. This makes it possible to simultaneously obtain both effects of the mist of the first particle diameter and the mist of the second particle diameter. Hence, the structure can be simplified and also reduced in size.

Moreover, in the refrigerator according to the present invention, the spray unit includes a first spray unit that generates the mist of the first particle diameter and a second spray unit that generates the mist of the second particle diameter. The first spray unit can effect food freshness preservation, and the second spray unit can effect food nutrient improvement and microbial elimination/agricultural chemical removal of the foods and the storage compartment.

### INDUSTRIAL APPLICABILITY

As described above, the refrigerator according to the present invention can supply a fine mist to a storage compartment stably by a simple structure. Therefore, the present invention is applicable not only to a household or industrial refrigerator and a vegetable case, but also to a food cold chain, storehouse, and so on for vegetables and like. Moreover, the same technical idea can be used to a cooler such as an air conditioner. Furthermore, the technical idea is not limited to the cooler, but can be used so long as a space to which a mist is sprayed and a space in which a cooling pin is included have a significant temperature difference. For example, the present invention is applicable to various appliances such as a dish washer, a cloths washer, a rice cooker, a vacuum cleaner, and so on.

1. A refrigerator comprising:
a heat-insulating main body;
a storage compartment defined in said heat-insulating main body; and
a mist spray apparatus that sprays a fine mist into said storage compartment,
wherein the fine mist generated by said mist spray apparatus has a nano-size particle diameter and reduces microorganisms adhering to inside of said storage compartment and to vegetable surfaces, the microorganisms including molds, bacteria, yeasts, and viruses.

2. The refrigerator according to claim 1,
wherein said mist spray apparatus generates the mist containing radicals.

3. The refrigerator according to claim 1,
wherein said mist spray apparatus includes a spray unit configured to spray the mist according to an electrostatic atomization method.

4. The refrigerator according to claim 3, comprising:
an electrostatic atomization apparatus including: an application electrode for applying a voltage; a counter electrode positioned facing said application electrode; and a voltage application unit configured to apply a high voltage between said application electrode and said counter electrode;
a water collection plate on which water in air in said refrigerator forms dew condensation; and
a cooling unit configured to cool said water collection plate,
wherein said water collection plate is provided with a temperature adjustment unit.

5. The refrigerator according to claim 3 or 4,
wherein a negative voltage is applied to said application electrode and a positive voltage is applied to said counter electrode.

6. The refrigerator according to claim 5, comprising
a light source installed in said storage compartment, said light source including light of a blue light wavelength region.

7. A refrigerator comprising:
a heat-insulated storage compartment;
an atomization unit included in a mist spray apparatus that sprays a mist into said storage compartment; and
an atomization tip included in said atomization unit, the mist being sprayed from said atomization tip,
wherein said atomization unit is configured to generate the mist that adheres to vegetables and fruits stored in said storage compartment to suppress low temperature damage.

8. The refrigerator according to claim 7,
wherein said heat-insulated storage compartment is substantially sealed and has a mechanism of keeping a high humidity to prevent drying of the vegetables and fruits, and drying after the mist adheres to the vegetables and fruits is also prevented to suppress drying of the mist containing radicals, thereby suppressing the low temperature damage.

9. The refrigerator according to claim 7,
wherein the mist containing radicals adheres to skins of the vegetables and fruits, and the radicals penetrate from the skins and inhibit an enzyme reaction, thereby suppressing the low temperature damage.

10. The refrigerator according to claim 7,
wherein the mist containing radicals adheres to skins of the vegetables and fruits and the radicals penetrate from the skins, thereby suppressing leakage of potassium ions.

11. The refrigerator according to claim 1,
wherein the mist containing radicals sprayed into said storage compartment decomposes ethylene gas.

12. The refrigerator according to claim 1, comprising:
said storage compartment that is heat-insulated;
a section in said storage compartment, said section being set in a different environment from an environment of said storage compartment;
an atomization unit included in said mist spray apparatus that sprays the mist into said section;
an atomization tip included in said atomization unit, the mist being sprayed from said atomization tip;
a temperature adjustment unit configured to adjust a temperature of said atomization tip; and
a temperature detection unit configured to detect the temperature of said atomization tip,
wherein said temperature adjustment unit is configured to adjust the temperature of said atomization tip to a dew point or below, to cause water in air to form dew condensation at said atomization tip and the mist to be sprayed into said storage compartment.

13. The refrigerator according to claim 12,
wherein said atomization unit includes a heat transfer connection member thermally connected to an atomization electrode which is said atomization tip, and
said temperature adjustment unit is configured to indirectly adjust the temperature of said atomization tip by cooling or heating said heat transfer connection member.

14. The refrigerator according to claim 12,
wherein said temperature adjustment unit configured to adjust the temperature of said atomization tip includes a cooling unit and a heating unit.

15. The refrigerator according to claim 14,
wherein said cooling unit is a cooling source generated in a refrigeration cycle of said refrigerator, and
said heating unit is a heater.

16. The refrigerator according to claim 12,
wherein a main body of said refrigerator includes a plurality of storage compartments and a cooling compartment that houses a cooler for cooling said plurality of storage compartments, and
said atomization unit is attached to a partition wall of said storage compartment on a cooling compartment side.

17. The refrigerator according to claim 12,
wherein a main body of said refrigerator includes a plurality of storage compartments,
a lower temperature storage compartment kept at a lower temperature than said storage compartment provided with said atomization unit is situated on a bottom side of said storage compartment provided with said atomization unit, and
said atomization unit is attached to a partition wall of said storage compartment provided with said atomization unit, on the bottom side.

18. The refrigerator according to claim 12,
wherein a main body of said refrigerator includes at least one air path for conveying cool air to a storage compartment or a cooling compartment, and
a cooling unit uses cool air generated in said cooling compartment.

19. The refrigerator according to claim 15,
wherein said heating unit is a heater integrally formed with said atomization unit.

20. The refrigerator according to claim 12,
wherein said temperature adjustment unit is configured to use a heat pipe capable of conveying lower temperature heat in or near a cooler.

21. The refrigerator according to claim 12,
wherein said temperature adjustment unit is configured to use a Peltier element.

22. The refrigerator according to claim 1,
wherein an atomization unit included in said mist spray apparatus includes an atomization electrode, a counter electrode positioned facing said atomization electrode, and a voltage application unit configured to generate a high-voltage potential difference between said atomization electrode and said counter electrode.

23. The refrigerator according to claim 22, comprising:
said storage compartment; and
a holding member installed in said storage compartment and grounded to a reference potential part,
wherein said voltage application unit is configured to generate the potential difference between said atomization electrode and said holding member.

24. The refrigerator according to claim 1, comprising
said mist spray apparatus that generates a mist of a first particle diameter and a mist of a second particle diameter different from the first particle diameter.

25. The refrigerator according to claim 24,
wherein the first particle diameter is micro-size, and the second particle diameter is nano-size.

26. The refrigerator according to claim 25,
wherein the mist of the second particle diameter is an ionized mist.

27. The refrigerator according to claim 24,
wherein said mist spray apparatus includes an electrostatic atomization apparatus that includes an application electrode for applying a voltage to a liquid, a counter electrode positioned facing said application electrode, and a voltage application unit configured to apply a high voltage between said application electrode and said counter electrode, and
said electrostatic atomization apparatus generates the mist of the second particle diameter.

28. The refrigerator according to claim 24,
wherein said mist spray apparatus is a spray unit configured to simultaneously generate the mist of the first particle diameter and the mist of the second particle diameter.

29. The refrigerator according to claim 24,
wherein said mist spray apparatus includes a first spray unit configured to generate the mist of the first particle diameter and a second spray unit configured to generate the mist of the second particle diameter.
